(19) United States
(12) Patent Application Publication
(10) Pub. No.: US 2026/0002234 A1
(43) Pub. Date: Jan. 1, 2026

(54) LITHIUM EXTRACTION FROM BRINES WITH MODULATED ION CONCENTRATIONS

(71) Applicant: Lilac Solutions, Inc., Oakland, CA (US)

(72) Inventors: David Henry SNYDACKER, San Francisco, CA (US); Nicolás Andrés GROSSO GIORDANO, Oakland, CA (US); Amos Henokh INDRANADA, Oakland, CA (US); Alysia LUKITO, Emeryville, CA (US); Sophia Patricia MOCK, Berkeley, CA (US); Tejal SAWANT, Oakland, CA (US); Madeline Paige COOKE, San Francisco, CA (US); Mustafa Juzer BOOTWALA, Oakland, CA (US); Edson Barton PACKER, Alameda, CA (US); David James ALT, North Vancouver (CA)

(21) Appl. No.: 19/212,217

(22) Filed: May 19, 2025

Related U.S. Application Data
(63) Continuation of application No. PCT/US2023/080369, filed on Nov. 17, 2023.
(60) Provisional application No. 63/426,878, filed on Nov. 21, 2022.

(51) Int. Cl. C22B 26/12; C22B 3/42

(52) U.S. Cl. CPC C22B 26/12; C22B 3/42

(57) ABSTRACT

The present invention relates to the extraction of lithium from liquid resources such as natural and synthetic brines, leachate solutions from clays and minerals, and recycled products.

### CROSS-REFERENCE

This application is a continuation of International Application No. PCT/US2023/080369, filed Nov. 17, 2023, which claims the benefit of U.S. Provisional Application No. 63/426,878 filed Nov. 21, 2022, which are hereby incorporated by reference in their entirety.

### BACKGROUND OF THE INVENTION

Lithium is an essential element for high-energy rechargeable batteries and other technologies. Lithium can be found in a variety of liquid solutions, including natural and synthetic brines and leachate solutions from minerals and recycled products.

### SUMMARY OF THE INVENTION

Lithium can be extracted from liquid resources using inorganic lithium-selective sorbents with absorb lithium preferentially over other ions. These lithium-selective sorbents include lithium-selective ion exchange materials.

In an aspect, disclosed herein is a method for lithium recovery from a liquid resource, the method comprising: adjusting the concentration of lithium in the liquid resource by addition of an adjusting fluid or adjusting solid to the liquid resource to yield a concentration-adjusted liquid resource; contacting a lithium-selective sorbent to the concentration-adjusted liquid resource, wherein the lithium-selective sorbent absorbs lithium ions from the concentration-adjusted liquid resource to yield a lithium-depleted liquid resource; and contacting the lithium-selective sorbent to an eluent solution, wherein said lithium-selective sorbent releases the sorbed lithium, producing a synthetic lithium solution.

In an aspect, disclosed herein is a system for lithium recovery from a liquid resource, the system comprising: a first subsystem that is configured to adjust the concentration of lithium in the liquid resource by combining the liquid resource with an adjusting fluid to yield a concentration-adjusted liquid resource; and a second subsystem configured to contact a lithium-selective sorbent to said concentration-adjusted liquid resource, wherein the lithium-selective sorbent absorbs lithium ions from said concentration-adjusted liquid resource to yield a lithium-depleted liquid resource that exits the second subsystem, and subsequently contact the lithium-selective sorbent to an eluent solution, wherein the lithium-selective sorbent releases the sorbed lithium to yield a synthetic lithium solution.

In an aspect, disclosed herein is a system for lithium recovery from a liquid resource, the system comprising: a first subsystem that is configured to adjust the concentration of lithium in the liquid resource by combining the liquid resource with an adjusting fluid or adjusting solid to yield a concentration-adjusted liquid resource; a second subsystem configured to contact a lithium-selective sorbent to said concentration-adjusted liquid resource, wherein the lithium-selective sorbent absorbs lithium ions from said concentration-adjusted liquid resource to yield a lithium-depleted liquid resource that exits the second subsystem, and subsequently contact the lithium-selective sorbent to an eluent solution, wherein the lithium-selective sorbent releases the sorbed lithium to yield a synthetic lithium solution; and a third subsystem configured to add a portion of the lithium-depleted liquid resource to the first subsystem to adjust the concentration of lithium in the liquid resource, such that the adjusting fluid comprises the lithium-depleted liquid resource.

In an aspect, disclosed here is a method for lithium recovery from a liquid resource, the method comprising: adding an adjusting ion solution or adjusting ion solid to the liquid resource to form an ion adjusted liquid resource, wherein the ion adjusted liquid resource has an increased buffering capacity relative to the liquid resource; contacting a lithium-selective sorbent to the ion adjusted liquid resource, wherein the lithium-selective sorbent absorbs lithium ions from the ion adjusted liquid resource while releasing protons, to yield a lithium-depleted liquid resource; and contacting the lithium-selective sorbent to an acidic eluent solution, wherein said lithium-selective sorbent releases the sorbed lithium to yield a synthetic lithium solution; wherein the adjusting ion solution comprises one or more adjusting ions and a liquid, and wherein the adjusting ion solid comprises one or more adjusting ions in the solid state. In an aspect, disclosed here is a system for lithium recovery from a liquid resource, the system comprising: a first subsystem that is configured to adjust the concentration of ions in the liquid resource by combining the liquid resource with an ion adjusting fluid or ion adjusting solid to form an ion adjusted liquid resource, wherein the ion adjusted liquid resource has an increased buffering capacity relative to the liquid resource; and a second subsystem configured to contact a lithium-selective sorbent to said ion adjusted liquid resource, wherein the lithium-selective sorbent absorbs lithium ions from said ion adjusted liquid resource to yield a lithium-depleted liquid resource that exits the second subsystem, and subsequently contact the lithium-selective sorbent to an eluent solution, wherein the lithium-selective sorbent releases the sorbed lithium to yield a synthetic lithium solution; wherein the adjusting ion solution comprises one or more adjusting ions and a liquid, and wherein the adjusting ion solid comprises one or more adjusting ions in the solid state.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 presents a diagram of a system configured to carry out a method of lithium recovery from a stream of liquid resource 104 comprising: a treatment system 101 wherein the lithium concentration and pH of a liquid resource may be adjusted, an ion exchange device 102 comprising lithium-selective ion exchange material, and a splitting system 103 configured to direct a fraction of lithium-depleted liquid resource to the treatment system 101 in stream 105 and direct the remainder of lithium-depleted liquid resource to leave the system in stream 106.

FIG. 2A presents a diagram of a system configured to carry out a method of lithium recovery from a stream of liquid resource 204 comprising: a treatment system 201 wherein the lithium concentration and pH of a liquid resource may be adjusted, an ion exchange device 202 comprising lithium-selective ion exchange material, and a splitting system 203 configured to direct a fraction of lithium-depleted liquid resource to the treatment system 201 in stream 205 and direct the remainder of lithium-depleted liquid resource to leave the system in stream 206.

FIG. 2B presents a plot of overall lithium recovery of the system presented in FIG. 2A as a function of the recycle ratio (the ratio of rate of flow of stream 205 to rate of flow of stream 206). The plot demonstrates that even when a system for lithium recovery from a liquid resource comprising an ion exchange device has a lower single-pass lithium recovery, recycling of a portion of raffinate to combine with the liquid resource to again pass through the ion exchange device allows for a greater overall lithium recovery from the liquid resource to be achieved.

FIG. 3 presents a diagram of a system configured to carry out a method of lithium recovery from a stream of liquid resource 304 comprising: a treatment system 301 wherein the lithium concentration and pH of a liquid resource may be adjusted, an ion exchange device 302 comprising lithium-selective ion exchange material, and a lithium crystallization unit 303 configured to produce solid lithium carbonate 306 and a stream of aqueous lithium solution comprising a lithium carbonate mother liquor that is directed to combine with liquid resource 304 in the treatment system 301.

FIG. 4 presents a diagram of a system configured to carry out a method of lithium recovery from a stream of liquid resource 404 comprising: a treatment system 401 wherein the lithium concentration and pH of a liquid resource may be adjusted, an ion exchange device 402 comprising lithium-selective ion exchange material, and a splitting system 403 configured to direct a fraction of lithium-depleted liquid resource to the treatment system 401 in stream 405 and direct the remainder of lithium-depleted liquid resource to leave the system in stream 406, wherein the fraction of lithium-depleted liquid resource directed to the treatment system 401 is modulated continuously in time.

FIG. 5 presents a diagram of a system configured to carry out a method of lithium recovery from a stream of liquid resource 504 comprising: a treatment system 501 wherein the ion concentration of the liquid resource is adjusted by the addition of a boric acid stream 505 followed by the addition of base to achieve a desired pH, an ion exchange device 502 wherein lithium is extracted from the ion adjusted liquid resource to provide a raffinate stream 503.

FIG. 6 presents a diagram of systems configured to carry out methods of lithium recovery wherein: a stream of liquid resource 601A is passed through a ion exchange device 602A that may subsequently provide a lithium eluate 603A comprising a percentage of the lithium originally present in 601A; and a stream of concentration-adjusted liquid resource 601B, provided by combining 601A and a stream of raffinate produced therefrom, is passed through a ion exchange device 602B that may subsequently provide a lithium eluate 603B comprising a greater percentage of the lithium originally present in 601A as compared to a percentage of the lithium originally present in 601A present in the eluate stream 603A.

FIG. 7 presents a diagram of systems wherein an ion exchange device 702 extracts lithium from a liquid resource 701 that has been adjusted in its ion content by addition of stream 704, which comprises a lithium-depleted liquid resource generated by the ion exchange device 702, which is further utilized to provide synthetic lithium solution 703.

### DETAILED DESCRIPTION OF THE INVENTION

Lithium is an essential element for batteries and other technologies. Lithium is found in a variety of liquid resources, including natural and synthetic brines and leachate solutions from minerals, clays, and recycled products. Lithium is optionally extracted from such liquid resources using an ion exchange process based on inorganic ion exchange materials. These inorganic ion exchange materials absorb lithium from a liquid resource while releasing hydrogen, and then elute lithium in acid while absorbing hydrogen. This ion exchange process is optionally repeated to extract lithium from a liquid resource and yield a synthetic lithium solution. The synthetic lithium solution is optionally further processed into chemicals for the battery industry or other industries.

The present disclosure includes integrated systems to adjust the concentration of lithium in the liquid resource, and associated methods for adjusting this concentration with said integrated systems. Exemplary embodiments described herein result in improved performance parameters of the lithium extraction process including, but not limited to, higher pH of the liquid resource during and following the extraction of lithium therefrom by the ion exchange beads, faster uptake of lithium by the ion exchange bead s, higher purity of the lithium comprising the synthetic lithium solution eluted from the ion exchange beads, higher lithium uptake capacity by the ion exchange beads, slower degradation of the ion exchange beads, increased lifetime of the ion exchange beads, faster rate of elution of lithium from the ion exchange beads when placed in contact with an acidic eluate, and lower quantities of acid being required for the elution of lithium from the ion exchange beads.

### Key Terms and Definitions

The terms “lithium”, “lithium ion”, and “Li+” are used interchangeably in the present specification and these terms are synonymous unless specifically noted to the contrary. The terms “hydrogen”, “hydrogen ion”, “proton”, and “H+” are used interchangeably in the present specification and these terms are synonymous unless specifically noted to the contrary.

As used herein, the words “column” and “vessel” are used interchangeably. In some embodiments described herein referring to a “vessel”, the vessel is a column. In some embodiments described herein referring to a “column”, the column is a vessel.

The term “the pH of the system” or “the pH of” a component of a system, for example one or more tanks, vessels, columns, pH modulating units, or pipes used to establish fluid communication between one or more tanks, vessels, columns, or pH modulating units, refers to the pH of the liquid medium contained or present in the system, or contained or present in one or more components thereof. In some embodiments, the liquid medium contained in the system, or one or more components thereof, is a liquid resource. In some embodiments, the liquid medium contained in the system, or one or more components thereof, is a brine. In some embodiments, the liquid medium contained in the system, or one or more components thereof, is an acid solution, an aqueous solution, a wash solution, a salt solution, a salt solution comprising lithium ions, or a lithium-enriched solution. As used herein, pH is equal to the negative logarithmic value of the concentration of protons in the aqueous solution. The pH of the solutions described herein are preferably determined with a pH probe. However, many of the solutions described herein comprise high concentrations of ions (e.g., sodium) that are known to interfere with pH probe sensors. Therefore, solutions with high ion concentrations can lead to shifted readings. In such cases, pH probe values are confirmed by diluting the test solution, for example by 10× or 100×, and remeasuring via pH probe to ensure that the change in pH is consistent with the change in concentration of protons. Alternative methods of pH determination include chemical tests such as titration with colored indicators or litmus tests.

The term “concentration”, as used herein, refers to the amount of a chemical species within a given amount of liquid. In some embodiments, said concentration can be specified as the mass of a species dissolved in an amount of liquid (e.g. mg/L), or the number of moles of a species dissolved in an amount of liquid (e.g. mol/L). In some embodiments, concentration can be specified by the ratio of moles or mass of the species of interest to one or more other species dissolved in the same liquid. In some embodiments, only the mass concentration of an ionic species is stated; for example, a concentration of sodium (Na) is stated to be 100 milligrams per liter (mg/L). In such cases, the stated concentration refers to the mass concentration of the ion in solution, and does not include the mass of the anion; in the example stated above, such an ion may comprise chloride (Cl—), nitrate (NO₃⁻), or sulfate (SO₄²⁻).

As used herein, the term “synthetic lithium solution” describes a solution comprising lithium that is not present in nature and obtained by a process for processing, refining, recovering or purifying lithium. In some embodiments, a synthetic lithium solution can be yielded by placing an acid into contact with a lithium-selective sorbent. In some embodiments, a synthetic lithium solution may be a lithium eluate. In some embodiments, a synthetic lithium solution may be used in place of a liquid resource. In some embodiments, a synthetic lithium solution may be combined with a liquid resource. In some embodiments, a synthetic lithium solution may be used as an adjusting fluid of a component thereof.

As used herein, the term “concentration-adjusted liquid resource” describes a liquid resource that has been subjected to an adjustment of the concentration of lithium and optionally one or more adjusting ions. In some embodiments, a concentration-adjusted liquid resource allows for better performance parameters for lithium recovery to be achieved in contrast to when a liquid resource is instead used. A concentration-adjusted liquid resource may be used, modified, treated, or utilized in any capacity that a liquid resource may be so used, modified, treated, or utilized as detailed herein.

As used herein, the term “ion adjusted liquid resource” describes a liquid resource that has been subjected to an adjustment of the concentration of one or more adjusting ions. In some embodiments, an ion adjusted liquid resource allows for better performance parameters for lithium recovery to be achieved in contrast to when a liquid resource is instead used. An ion adjusted liquid resource may be used, modified, treated, or utilized in any capacity that a liquid resource may be so used, modified, treated, or utilized as detailed herein. In some embodiments, an ion adjusted liquid resource comprises an adjusting ion solid and/or an adjusting ion solution.

As used herein, the term “lithium-depleted liquid resource” describes a liquid solution comprising lithium that is produced following exposure of a liquid resource or a concentration-adjusted liquid resource to an ion exchange material, such that the lithium-depleted liquid resource comprises a lower concentration of lithium as compared to the concentration of lithium in the liquid resource or concentration-adjusted liquid resource from which the lithium-depleted liquid resource was derived. In some embodiments, the lithium-depleted liquid resource may comprise the output from an ion exchange device. In some embodiments, the lithium-depleted liquid resource may comprise a liquid output from a lithium crystallization unit. In some embodiments, the term “lithium-depleted liquid resource” encompasses the term “raffinate”.

As used herein, the term “recycle ratio” describes the ratio of the quantity of lithium-depleted liquid resource combined with liquid resource to generate a concentration-adjusted liquid resource to the quantity of lithium-depleted liquid resource that is not combined with liquid resource. In some embodiments, the recycle ratio may remain constant. In some embodiments, the recycle ratio may be variable. In some embodiments, the recycle ratio is modulated continuously.

As used herein, the term “lithium recovery” refers to the extraction, purification, and/or refinement of lithium as present in a liquid resource. In some embodiments, lithium recovery may comprise ion exchange processes. In some embodiments, lithium recovery may comprise electrolysis processes. In some embodiments, lithium recovery may comprise precipitation processes. In some embodiments, lithium recovery may comprise crystallization processes. In some embodiments, lithium recovery may comprise evaporative processes. In some embodiments, lithium recovery may comprise processes utilized for the purpose of lithium extraction, refinement, and purification. In some embodiments, the outcomes of lithium recovery may be expressed as a percentage of the total lithium present in a liquid resource that is subsequently obtained as a component of a synthetic lithium solution according to the methods and systems described herein. In some embodiments, the outcomes of lithium recovery may be expressed as a percentage of the total lithium present in a liquid resource that is subsequently obtained as one or more lithium chemicals according to the methods and systems described herein.

As used herein, the term “single-pass lithium recovery” is the fraction of lithium extracted from a liquid resource or concentration-adjusted liquid resource by an ion exchange device, wherein the liquid resource or concentration-adjusted liquid resource is input and output from the ion exchange device only one time according to the methods and systems for lithium recovery from a liquid resource as described herein.

As used herein, the term “overall lithium recovery” or “total lithium recovery” or “overall recovery” or “total recovery” is the fraction of lithium extracted from a liquid resource or concentration-adjusted liquid resource by an ion exchange device, wherein the liquid resource or concentration-adjusted liquid resource is input and output from the ion exchange device potentially multiple times according to the methods and systems for lithium recovery from a liquid resource as described herein. In some embodiments, the number of times that a given quantity of lithium may pass through the ion exchange device before exiting the system for lithium recovery from a liquid recourse may be determined, estimated, predicted, or envisioned as a function of one or more variables that comprise the recycle ratio. In some embodiments, the overall lithium recovery may be higher than the single-pass lithium recovery.

As used herein, the term “lithium purity” refers to the chemical purity of a lithium chemical, lithium compound, or a solution that comprises lithium or a lithium compound. In some embodiments, lithium purity can be expressed as the percentage of lithium in a solution as on the basis of the total metal ion content of the solution. In some embodiments, lithium purity may be expressed in terms of the quantities or percentages of specific impurities that may be present in a lithium compound or a solution that comprises lithium.

As used herein, the term “process fluid” may be used to refer to any liquid or solution that may used in any step or process according to the methods and systems for lithium recovery from a liquid resource as described herein. In some embodiments, the process fluid may be the liquid resource. In some embodiments, the process fluid may be the adjusting fluid. In some embodiments, the process fluid may be the raffinate. In some embodiments, the process fluid may be the concentration-adjusted liquid resource. In some embodiments, the process fluid may be water. In some embodiments, the process fluid may be acid. In some embodiments, the process fluid may be base.

As used herein, the term “buffer” may be used to refer to a solution that can resist pH change upon the addition of an acidic or basic components. It is able to neutralize small amounts of added acid or base, thus maintaining the pH of the solution relatively stable. In some embodiments, a buffer is a solution comprising a weak acid and a salt of the corresponding conjugate base. In some embodiments, a buffer is a solution comprising a weak base and a salt of the corresponding conjugate acid. A non-limiting example of a buffer is a solution of boric acid and sodium hydroxide.

The section headings used herein are for organizational purposes only and are not to be construed as limiting the subject matter described or preclude the combination of the subject matter of the disclosure under any one section heading with any other subject matter of the disclosure under any other section heading or any other subject matter of the disclosure. Embodiments described herein with any one or more features may be readily combined with the features of any embodiments described further herein. Embodiments described herein are not limiting so as to wholly describe all embodiments of the disclosure.

### Ion Exchange Materials, Particles, and Beads

In an aspect, disclosed herein are methods and systems for lithium recovery from a liquid resource. In some embodiments, the methods and systems disclosed herein utilize ion exchange materials. In some embodiments, an ion exchange material may be utilized in a variety of forms or as a constituent of a construct that comprises one or more ion exchange materials. In some embodiments, an ion exchange material may be utilized in a form that specifically enables or optimizes the performance of the method or system in which the ion exchange material is utilized. In some embodiments, an ion exchange material may be utilized as a constituent of a construct that specifically enables or optimizes the performance of the method or system in which the ion exchange material is utilized. In some embodiments, ion exchange materials may be coated. In some embodiments, ion exchange materials may comprise a lithium-selective sorbent.

In some embodiments, ion exchange material may be in the form of ion exchange particles. In some embodiments, ion exchange material may be in the form of uncoated ion exchange particles. In some embodiments, ion exchange material may be in the form of coated ion exchange particles. In some embodiments, ion exchange particles may be coated or uncoated. In some embodiments, ion exchange particles may be utilized as a mixture that comprises coated ion exchange particles and uncoated ion exchange particles. In some embodiments, ion exchange particles may comprise one or more ion exchange materials. In some embodiments, ion exchange particles may comprise a lithium-selective sorbent.

In some embodiments, ion exchange beads are a construct that comprises ion exchange material that can be used according to the methods and systems described herein. In some embodiments, ion exchange beads comprise ion exchange material. In some embodiments, the ion exchange material is coated or uncoated. In some embodiments, the ion exchange beads are porous. In some embodiments, ion exchange beads may comprise one or more ion exchange materials. In some embodiments, ion exchange beads may comprise a lithium-selective sorbent.

Ion exchange beads may have diameters less than about one millimeter, contributing to a high pressure difference across a packed bed of ion exchange beads as a liquid resource and other fluids are pumped through the packed bed by application of an appropriate force. To minimize pressure across the packed bed of ion exchange beads and to minimize the associated appropriate force and amount of energy associated with applying said appropriate force, vessels with optimized geometries can be used to reduce the flow distance through the packed bed of ion exchange beads. These vessels may be networked with pH modulation units to achieve adequate control of the pH of the liquid resource.

In some embodiments a network of vessels loaded with ion exchange beads may comprise two vessels, three vessels, four vessels, five vessels, six vessels, seven vessels, eight vessels, nine vessels, 10 vessels, 11 vessels, 12 vessels, 13-14 vessels, 15-20 vessels, 20-30 vessels, 30-50 vessels, 50-70 vessels, 70-100 vessels, or more than 100 vessels.

In some embodiments, ion exchange material, or a form thereof, or a construct comprised thereof, is loaded into an ion exchange device described herein. In some embodiments, an ion exchange device comprises a column, tank, or vessel. In some embodiments, anion exchange device is a component of a system for lithium recovery from a liquid resource. Alternating flows of liquid resource, eluent, and other process fluids are optionally flowed through an ion exchange device to extract lithium from the liquid resource and produce a synthetic lithium solution, which is eluted from the ion exchange device using an eluent. As liquid resource flows through the ion exchange device, the ion exchange material absorb lithium while releasing hydrogen, where both the lithium and hydrogen are cations. After the ion exchange material have absorbed lithium, an eluent is used to elute the lithium from the ion exchange material to produce a lithium eluate. A lithium eluate can be a synthetic lithium solution according to some embodiments. In some embodiments, an eluent may comprise acid or an acid eluent.

Lithium is an essential element for batteries and other technologies. Lithium is found in a variety of liquid resources, including natural and synthetic brines and leachate solutions from minerals, clays, and recycled products. Lithium can be extracted from such liquid resources using an ion exchange process that utilizes ion exchange materials. Ion exchange beads may comprise ion exchange materials in addition to other components and may be utilized in methods for lithium recovery and systems for lithium recovery. Ion exchange materials may absorb lithium from a liquid resource while releasing hydrogen, and then elute lithium in acid while absorbing hydrogen. In methods for lithium recovery from a liquid resource, the ion exchange process may be repeated to extract lithium from a liquid resource and yield a synthetic lithium solution. The synthetic lithium solution may be further processed into chemicals for the battery industry or other industries.

Ion exchange particles may comprise ion exchange materials. Ion exchange particles may be in the form of small particles, which to gether may constitute a fine powder. Small sizes of ion exchange particles may be required to minimize the diffusion distance that lithium must travel to reach the core of the ion exchange particles and ensure the entirety of the ion exchange material within the ion exchange particle may be active and utilized in the course of an ion exchange process or method for lithium recovery. In some cases, ion exchange particles may be coated with coating materials that may minimize dissolution of the ion exchange particles while allowing efficient transfer of lithium and hydrogen to and from the ion exchange particles.

One major challenge for methods of lithium recovery from a liquid recourse that comprise ion exchange particles is the loading of the ion exchange particles into an ion exchange device in such a way that liquid resource and acid may flow through the ion exchange device with minimal clogging. Thus, ion exchange material and/or ion exchange particles may be formed into ion exchange beads that may be loaded into an ion exchange device. Ion exchange beads may comprise ion exchange materials in addition to other components and may be utilized in methods for lithium recovery and systems for lithium recovery. The ion exchange beads, as loaded into an ion exchange device, are loaded such that void spaces are present between the ion exchange beads, and these void spaces may facilitate flow of liquids through the column. In some embodiments, a flow may be initiated, modulated, or terminated by pumping. The ion exchange beads may hold their constituent ion exchange particles in place and prevent free movement of ion exchange particles throughout the ion exchange device.

When ion exchange material is formed into ion exchange beads, the penetration of liquid resource and acid into the ion exchange beads by convention and diffusion may become unacceptably slow. A slow rate of convection and diffusion of the acid and liquid resource into the ion exchange beads may slow the kinetics of lithium absorption and release thereby. Slow kinetics of lithium absorption and release may create problems for the operation of an ion exchange device. Slow kinetics of lithium absorption and release may consequently require correspondingly slow flow rates through an ion exchange device. Slow kinetics of lithium absorption and release may also lead to low lithium recovery from the liquid resource and inefficient use of acid to elute the lithium according to the methods and systems described herein.

In some embodiments, the ion exchange beads are ion exchange beads with networks of pores that facilitate the transport into the ion exchange beads of liquids that are flowed through an ion exchange device. The geometry and physical dimensions of pore networks in ion exchange beads may be strategically controlled to allow for faster and more complete access of liquid resource, washing water, acid, and other process fluids into the interior of the ion exchange bead. Faster and more complete access of liquid resource, washing water, acid, and other process fluids into the interior of the ion exchange bead leads to a more effective delivery lithium and hydrogen to the ion exchange material therein. More effective delivery of lithium and hydrogen to the ion exchange material within an ion exchange bead may lead to greater lithium recovery according to the methods and systems described herein.

In some embodiments, the ion exchange beads are formed by mixing of ion exchange material, a structural matrix material, and a filler material. In some embodiments, the ion exchange beads are formed by mixing of ion exchange material and a structural matrix material. In some embodiments, the ion exchange beads are formed by mixing of ion exchange material and a structural matrix material. In some embodiments, the components of an ion exchange bead combined to form a physical mixture or a composite. In some embodiments wherein an ion exchange bead comprises a filler material, the filler material may be removed therefrom to form network of pores therein and yield a porous ion exchange bead. The filler material is dispersed in the bead in such a way to leave behind a pore structure that enables transport of lithium and hydrogen with fast kinetics. In some embodiments, an ion exchange bead may comprise one or more ion exchange materials, one or more structural matrix materials, and one or more filler materials.

Ion exchange beads according to embodiments as described herein may be porous ion exchange beads.

Another challenge to consider and overcome in a method or system for lithium recovery from a liquid resource using ion exchange materials is the undesired dissolution and degradation of the ion exchange materials. Undesired dissolution and degradation of the ion exchange materials may occur during a step comprising lithium elution from the ion exchange material in acid. Undesired dissolution and degradation of the ion exchange materials may occur a step comprising lithium extraction from a liquid resource by the ion exchange material. In some embodiments, to yield a synthetic lithium solution from the ion exchange process it is desirable to use a concentrated acid solution as an acid eluent in a step comprising lithium elution from the ion exchange material. However, concentrated acid solutions dissolve and degrade ion exchange materials, which decreases the performance and useful lifetime of the materials. Therefore, in some embodiments the ion exchange beads may contain coated ion exchange particles for lithium extraction that are comprised of an ion exchange material and a coating material protecting the particle surface. The coating material protects the ion exchange material from undesired dissolution and degradation during lithium elution from the ion exchange material into acid, during lithium uptake from a liquid resource into the ion exchange material, and during other steps of an ion exchange process according to the methods and systems described herein. In some embodiments, use of ion exchange beads that comprise coated ion exchange particles may allow for the use of a concentrated acid as an acid eluent to yield a synthetic lithium solution.

In one aspect described herein, an ion exchange material may be selected for use in ion exchange beads based on one or more properties of the ion exchange material. In some embodiments, desirable properties of the ion exchange material may comprise high lithium absorption capacity, high selectivity for lithium extraction from a liquid resource relative to extraction of other ions such as sodium and magnesium, strong lithium uptake in liquid resources including those with low concentrations of lithium, facile elution of lithium with a small excess of acid, fast ionic diffusion throughout the ion exchange material, combinations thereof, and sub-combinations thereof. In one aspect described herein, a coating material may be selected for use as a coating for ion exchange particles based on its ability to prevent undesirable dissolution and chemical degradation of the ion exchange particles during lithium elution from the ion exchange particles in acid and also during lithium uptake by the ion exchange particles from liquid resources. In some embodiments, the coating material may also be selected to facilitate one or more of the following objectives: using a coating material that has minimal negative impacts on the diffusion of lithium and hydrogen between the ion exchange material within the ion exchange particles and the liquid resource, enabling adherence of the ion exchange particles to a structural support or structural matrix material, and suppressing structural and mechanical degradation of the ion exchange particles.

In some embodiments, wherein ion exchange beads are used in an ion exchange device, the liquid resource containing lithium is flowed through the ion exchange device so that the ion exchange beads absorb lithium from the liquid resource while releasing hydrogen. After the ion exchange beads have absorbed lithium, an acid is pumped through the ion exchange device so that the ion exchange beads release lithium into the acid while absorbing hydrogen. In some embodiments, the ion exchange device may be operated in a co-flow mode wherein the liquid resource and acid are alternately flowed through the ion exchange device in the same direction. In some embodiments, the ion exchange device may be operated in counter-flow mode wherein the liquid resource and acid are alternately flowed through the ion exchange device in opposite directions. In some embodiments, in between flows of the liquid resource and flows of acid, water or other solutions may be flowed through the ion exchange device for purposes such as adjusting pH in the ion exchange device or removing potential contaminants. In some embodiments, ion exchange beads may form a fixed bed or a moving bed, wherein the moving bed may move in a direction opposed to the flows of liquid resource and acid. In some embodiments, ion exchange beads may be moved between multiple ion exchange devices, wherein the ion exchange beads form a moving bed that may be transferred from one ion exchange device to another. In some embodiments, ion exchange beads may be moved between multiple ion exchange devices, wherein different ion exchange devices are independently configured to accommodate a flow of liquid resource, a flow of acid, a flow of water, or a flow of another process fluid. In some embodiments, before or after the liquid resource is flowed through an ion exchange device, the liquid resource may be subjected to other processes including other ion exchange processes, solvent extraction, evaporation, chemical treatment, precipitation to remove lithium, precipitation to remove other chemical species, or to otherwise treat the liquid resource.

In some embodiments, wherein ion exchange particles are used in an ion exchange device, the liquid resource containing lithium is flowed through the ion exchange device so that the ion exchange particles absorb lithium from the liquid resource while releasing hydrogen. After the ion exchange particles have absorbed lithium, an acid is pumped through the ion exchange device so that the ion exchange particles release lithium into the acid while absorbing hydrogen. In some embodiments, the ion exchange device may be operated in a co-flow mode wherein the liquid resource and acid are alternately flowed through the ion exchange device in the same direction. In some embodiments, the ion exchange device may be operated in counter-flow mode wherein the liquid resource and acid are alternately flowed through the ion exchange device in opposite directions. In some embodiments, in between flows of the liquid resource and flows of acid, water or other solutions may be flowed through the ion exchange device for purposes such as adjusting pH in the ion exchange device or removing potential contaminants. In some embodiments, ion exchange particles may form a fixed bed or a moving bed, wherein the moving bed may move in a direction opposed to the flows of liquid resource and acid. In some embodiments, ion exchange particles may be moved between multiple ion exchange devices, wherein the ion exchange particles form a moving bed that may be transferred from one ion exchange device to another. In some embodiments, ion exchange particles may be moved between multiple ion exchange devices, wherein different ion exchange devices are independently configured to accommodate a flow of liquid resource, a flow of acid, a flow of water, or a flow of another process fluid. In some embodiments, before or after the liquid resource is flowed through an ion exchange device, the liquid resource may be subjected to other processes including other ion exchange processes, solvent extraction, evaporation, chemical treatment, precipitation to remove lithium, precipitation to remove other chemical species, or to otherwise treat the liquid resource.

In some embodiments, when ion exchange material is treated with acid, a synthetic lithium solution is produced. In some embodiments, the synthetic lithium solution may be further processed to produce lithium chemicals. In some embodiments, lithium chemicals produced from synthetic lithium solutions may be provided for an industrial application.

In some embodiments, an ion exchange material may be selected from the following list: an oxide, a phosphate, an oxyfluoride, a fluorophosphate, or combinations thereof. In some embodiments, an ion exchange material may be selected from the following list: Li₄Mn₅O₁₂, Li₄Ti₅O₁₂, Li₂MO₃ (M=Ti, Mn, Sn), LiMn₂O₄, Li_{1.6}Mn_{1.6}O₄, LiMO₂ (M=Al, Cu, Ti), Li₄TiO₄, Li₇Ti₁₁O₂₄, Li₃VO₄, Li₂Si₃O₇, LiFePO₄, LiMnPO₄, Li₂CuP₂O₇, Al(OH)₃, LiCl·xAl(OH)₃·yH₂O, SnO₂·xSb₂O₅·yH₂O, TiO₂·xSb₂O₅·yH₂O, solid solutions thereof, or combinations thereof. In some embodiments, an ion exchange material may be selected from the following list: Li₄Mn₅O₁₂, Li₄Ti₅O₁₂, Li_{1.6}Mn_{1.6}O₄, Li₂MO₃ (M=Ti, Mn, Sn), LiFePO₄, solid solutions thereof, or combinations thereof.

In some embodiments, a coating material used to form a coating on an ion exchange material or on ion exchange particlesthat comprise an ion exchange material may be selected from the following list: a carbide, a nitride, an oxide, a phosphate, a fluoride, a polymer, carbon, a carbonaceous material, or combinations thereof. In some embodiments, a coating material may be selected from the following list: TiO₂, ZrO₂, MoO₂, SnO₂, Nb₂O₅, Ta₂O₅, SiO₂, Li₂TiO₃, Li₂ZrO₃, Li₂SiO₃, Li₂MnO₃, Li₂MoO₃, LiNbO₃, LiTaO₃, AlPO₄, LaPO₄, ZrP₂O₇, MoP₂O₇, Mo₂P₃O₁₂, BaSO₄, AlF₃, SiC, TiC, ZrC, Si₃N₄, ZrN, BN, carbon, graphitic carbon, amorphous carbon, hard carbon, diamond-like carbon, solid solutions thereof, or combinations thereof. In some embodiments, a coating material may be selected from the following list: TiO₂, ZrO₂, MoO₂, SiO₂, Li₂TiO₃, Li₂ZrO₃, Li₂SiO₃, Li₂MnO₃, LiNbO₃, AlF₃, SiC, Si₃N₄, graphitic carbon, amorphous carbon, diamond-like carbon, or combinations thereof.

In some embodiments, the ion exchange particles may have an average diameter that is selected from the following list: less than 10 nm, less than 100 nm, less than 1,000 nm, less than 10,000 nm, or less than 100,000 nm. In some embodiments, the ion exchange particles may have an average size that is selected from the following list: less than 200 nm, less than 2,000 nm, or less than 20,000 nm.

In some embodiments, the ion exchange particles may be secondary particles comprised of smaller primary particles that may have an average diameter selected from the following list: less than 10 nm, less than 100 nm, less than 1,000 nm, or less than 10,000 nm. In some embodiments, smaller primary particles may comprise an ion exchange material.

In some embodiments, the ion exchange material or the ion exchange particles comprising an ion exchange material may have a coating comprising a coating material with a thickness selected from the following list: less than 1 nm, less than 10 nm, less than 100 nm, or less than 1,000 nm. In some embodiments, the coating material has a thickness selected from the following list: less than 1 nm, less than 10 nm, or less than 100 nm.

It is recognized that measurements of average particle diameter (e.g., average diameter of a coated ion exchange particle or an uncoated ion exchange particle, particle size of an ion exchange material) can vary according to the method of determination utilized. Determination of said average particle diameter according to one method to obtain one or more values shall be understood to inherently encompass all other values that may be obtained using other methods. The average particle diameter can be determined using sieve analysis. The average particle diameter can be determined using optical microscopy. The average particle diameter can be determined using electron microscopy. The average particle diameter can be determined using laser diffraction. In some embodiments, the average particle diameter is determined using laser diffraction, wherein a Bettersizer ST instrument is used. In some embodiments, the average particle diameter is determined using a Bettersizer ST instrument. In some embodiments, the average particle diameter is determined using laser diffraction, wherein an Anton-Parr particle size analyzer (PSA) instrument is used. In some embodiments, the average particle diameter is determined using an Anton-Parr PSA instrument. The average particle diameter can be determined using dynamic light scattering. The average particle diameter can be determined using static image analysis. The average particle diameter can be determined using dynamic image analysis.

In some embodiments, the ion exchange material and the coating material may form one or more concentration gradients such that the chemical composition of coated ion exchange particles comprising the ion exchange material and the coating material ranges between two or more compositions. In some embodiments, the ion exchange material and the coating material may form a concentration gradient within the coated ion exchange particles comprising the ion exchange material and the coating material that extends over a thickness selected from the following list: less than 1 nm, less than 10 nm, less than 100 nm, less than 1,000 nm, less than 10,000 nm, or less than 100,000 nm.

In some embodiments, coating thickness may be measured by any one or more of electron microscopy, optical microscopy, couloscopy, nanoindentation, atomic force microscopy, and X-ray fluorescence. In some embodiments, coating thickness may be inferred or extrapolated from data obtained according to an analytical method that indicates the bulk composition of the coated ion exchange particle, or the ion exchange material that further comprises the coating material. In some embodiments, coating thickness may be inferred by differential analysis of data obtained by analysis of ion exchange material that further comprises a coating material and data obtained by analysis ion exchange material that does not further comprise a coating material. In some embodiments, coating thickness may be inferred by differential analysis of data obtained by analysis of one or more coated ion exchange particles and data obtained by analysis of one or more uncoated ion exchange particles.

In some embodiments, the ion exchange material may be synthesized by a method selected from the following list: hydrothermal, solvothermal, sol-gel, solid state, molten salt flux, ion exchange, microwave, ball milling, precipitation, or vapor deposition. In some embodiments, the ion exchange material may be synthesized by a method selected from the following list: hydrothermal, solid state, or microwave.

In some embodiments, a coating material may be deposited to form a coating by a method selected from the following list: chemical vapor deposition, atomic layer deposition, physical vapor deposition, hydrothermal, solvothermal, sol-gel, solid state, molten salt flux, ion exchange, microwave, wet impregnation, precipitation, titration, aging, ball milling, or combinations thereof. In some embodiments, the coating material is deposited to form a coating by a method selected from the following list: chemical vapor deposition, hydrothermal, titration, solvothermal, wet impregnation, sol-gel, precipitation, microwave, or combinations thereof.

In some embodiments, a coating material is deposited to form a coating with physical characteristics selected from the following list: crystalline, amorphous, full coverage, partial coverage, uniform, non-uniform, or combinations thereof.

In some embodiments, multiple coating materials may be deposited to form multiple coatings on the ion exchange material in an arrangement selected from the following list: concentric, patchwork, or combinations thereof.

In some embodiments, the structural matrix material may be selected from the following list: a polymer, an oxide, a phosphate, or combinations thereof. In some embodiments, a structural matrix material is selected from the following list: polyvinyl fluoride, polyvinylidene difluoride, polyvinyl chloride, polyvinylidene dichloride, polyethylene, polypropylene, polyphenylene sulfide, polytetrafluoroethylene, polytetrafluoroethylene, sulfonated polytetrafluoroethylene, polystyrene, polydivinylbenzene, polybutadiene, sulfonated polymer, carboxylated polymer, Nafion, copolymers thereof, and combinations thereof. In some embodiments, a structural matrix material is selected from the following list: polyvinylidene difluoride, polyvinyl chloride, sulfonated polytetrafluoroethylene, polystyrene, polydivinylbenzene, copolymers thereof, or combinations thereof. In some embodiments, a structural matrix material is selected from the following list: titanium dioxide, zirconium dioxide, silicon dioxide, solid solutions thereof, or combinations thereof. In some embodiments, the structural matrix material is selected for its thermal durability, acid resistance, and/or other chemical resistance.

In some embodiments, the porous ion exchange bead is formed by a process comprising mixing ion exchange particles, structural matrix material, and filler material to gether at once. In some embodiments, the porous ion exchange bead is formed by a process comprising mixing the ion exchange particles and the structural matrix material, and then mixing the resulting mixture with the filler material. In some embodiments, the porous ion exchange bead is formed by a process comprising mixing the ion exchange particles and the filler material, and then mixing the resulting mixture with the structural matrix material. In some embodiments, the porous ion exchange bead is formed by a process comprising mixing the structural matrix material and the filler material, and then mixing the resulting mixture with the ion exchange particles.

In some embodiments, the porous ion exchange bead is formed by a process comprising mixing the ion exchange particles, the structural matrix material, and/or the filler material with a solvent that dissolves one or more of the components of the mixture. In some embodiments, the porous ion exchange bead is formed by a process comprising mixing the ion exchange particles, the structural matrix material, and/or the filler material as dry powders in a mixer or ball mill. In some embodiments, the porous ion exchange bead is formed by a process comprising mixing the ion exchange particles, the structural matrix material, and/or the filler material in a spray drier.

In some embodiments, the structural matrix material may be a polymer that is dissolved in a solvent and subsequently mixed with the ion exchange particles and/or filler material using a solvent from the following list: N-methyl-2-pyrrolidone, dimethyl sulfoxide, tetrahydrofuran, dimethylformamide, dimethylacetamide, methyl ethyl ketone, or combinations thereof. In some embodiments, the filler material is a salt that is dissolved in a solvent and subsequently mixed with the ion exchange particles and/or structural matrix material using a solvent from the following list: water, ethanol, isopropyl alcohol, acetone, or combinations thereof.

In some embodiments, the ion exchange beads may comprise a filler material that is a salt that may be dissolved out of the ion exchange bead to form a network of pores within the ion exchange bead. In some embodiments, the ion exchange beads may comprise a filler material that is a salt that may be dissolved out of the ion exchange bead using a solution selected from the following list: water, ethanol, isopropyl alcohol, a surfactant mixture, an acid, a base, or combinations thereof. In some embodiments, the ion exchange beads may comprise a filler material that is a material that thermally decomposes to form a gas at high temperature such that the thermal decomposition of the filler material may form a network of pores within the ion exchange bead. In some embodiments, the ion exchange beads may comprise a filler material that is a material that thermally decomposes to form a gas at high temperature wherein the gas is selected from the following list: water vapor, oxygen, nitrogen, chlorine, carbon dioxide, nitrogen oxides, organic vapors, or combinations thereof.

In some embodiments, the ion exchange beads may be formed from dry powder. In some embodiments, the ion exchange beads may be formed using a mechanical press, a pellet press, a tablet press, a pill press, a rotary press, or combinations thereof. In some embodiments, the ion exchange beads may be formed from a solvent slurry by dripping the solvent slurry into a solution comprising a different solvent. In some embodiments, the solvent slurry may comprise N-methyl-2-pyrrolidone, dimethyl sulfoxide, tetrahydrofuran, dimethylformamide, dimethylacetamide, methyl ethyl ketone, or combinations thereof. In some embodiments, the solution comprising a different solvent may comprise water, ethanol, iso-propyl alcohol, acetone, or combinations thereof.

In some embodiments, the ion exchange beads may be approximately spherical with an average diameter selected from the following list: less than 10 m, less than 100 m, less than 1 mm, less than 1 cm, or less than 10 cm. In some embodiments, the porous ion exchange bead may be approximately spherical with an average diameter selected from the following list: less than 200 m, less than 2 mm, or less than 20 mm.

In some embodiments, the ion exchange beads may be tablet-shaped with a diameter of less than 1 mm, less than 2 mm, less than 4 mm, less than 8 mm, or less than 20 mm and with a height of less than 1 mm, less than 2 mm, less than 4 mm, less than 8 mm, or less than 20 mm.

In some embodiments, the ion exchange beads may be embedded in a support structure, which may be a membrane, a spiral-wound membrane, a hollow fiber membrane, or a mesh. In some embodiments, the ion exchange beads may be embedded on a support structure comprised of a polymer, a ceramic, or combinations thereof. In some embodiments, the ion exchange beads may be loaded directly into anion exchange column with no additional support structure.

In some embodiments, the liquid resource may have a lithium concentration selected from the following list: less than 100,000 mg/L, less than 10,000 mg/L, less than 1,000 mg/L, less than 100 mg/L, less than 10 mg/L, or combinations thereof. In some embodiments, the liquid resource may have a lithium concentration selected from the following list: less than 5,000 mg/L, less than 500 mg/L, less than 50 mg/L, or combinations thereof.

In some embodiments, the acid used for eluting lithium from the ion exchange material is selected from the following list: hydrochloric acid, sulfuric acid, phosphoric acid, hydrobromic acid, chloric acid, perchloric acid, nitric acid, formic acid, acetic acid, or combinations thereof. In some embodiments, the acid used for eluting lithium from the ion exchange material is selected from the following list: hydrochloric acid, sulfuric acid, nitric acid, or combinations thereof.

In some embodiments, the acid used for recovering lithium from the ion exchange material has an acid concentration selected from the following list: less than 0.1 M, less than 1.0 M, less than 5 M, less than 10 M, or combinations thereof.

In some embodiments, the ion exchange material may be utilized in an ion exchange process repeatedly over a number of cycles selected from the following list: greater than 10 cycles, greater than 30 cycles, greater than 100 cycles, greater than 300 cycles, or greater than 1,000 cycles. In some embodiments, the ion exchange material may be utilized in an ion exchange process repeatedly over a number of cycles selected from the following list: greater than 50 cycles, greater than 100 cycles, or greater than 200 cycles.

In some embodiments, the synthetic lithium solution that is yielded from the ion exchange material is further processed into lithium chemicals, lithium compounds, or lithium raw materials using methods selected from the following list: solvent extraction, ion exchange, chemical precipitation, electrodialysis, electrowinning, evaporation with direct solar energy, evaporation with concentrated solar energy, evaporation with a heat transfer medium heated by concentrated solar energy, evaporation with heat from a geothermal brine, evaporation with heat from combustion, or combinations thereof.

In some embodiments, the synthetic lithium solution that is yielded from the ion exchange material is further processed into lithium chemicals selected from the following list: lithium chloride, lithium carbonate, lithium hydroxide, lithium metal, lithium metal oxide, lithium metal phosphate, lithium sulfide, or combinations thereof. In some embodiments, the synthetic lithium solution that is yielded from the ion exchange material is further processed into lithium chemicals that are solid, liquid, hydrated, or anhydrous.

In some embodiments, the lithium chemicals produced using the synthetic lithium solution are used in an industrial application selected from the following list: lithium batteries, metal alloys, glass, grease, or combinations thereof. In some embodiments, the lithium chemicals produced using the synthetic lithium solution derived from the ion exchange material are used in an industrial application selected from the following list: lithium batteries, metal alloys, glass, grease, or combinations thereof. In some embodiments, the lithium chemicals produced using the synthetic lithium solution derived from the coated ion exchange particles are used in an application selected from the following list: lithium batteries, lithium-ion batteries, lithium sulfur batteries, lithium solid-state batteries, and combinations thereof.

In some embodiments, the ion exchange materials may be synthesized in a lithiated state, wherein a sublattice of the ion exchange material is fully or partially occupied by lithium. In some embodiments, the ion exchange materials may be synthesized in a hydrogenated state, wherein a sublattice of the ion exchange material is fully or partially occupied by hydrogen.

### Embodiments Comprising Other Lithium-Selective Sorbents

According to some embodiments of methods and systems for lithium recovery from a liquid resource, lithium is extracted from the liquid resources using inorganic lithium-selective sorbents that absorb lithium ions preferentially over other ions. In some embodiments, lithium-selective sorbents comprise lithium-selective ion exchange materials. As used herein, the term “lithium-selective ion-exchange material” encompasses the term “lithium-selective sorbent”. In some embodiments, the lithium-selective sorbent is a lithium-selective ion-exchange material. In some embodiments, the lithium-selective sorbent comprises lithium-selective ion-exchange beads. In some embodiments, the lithium selective sorbent comprises ion exchange beads. In some embodiments, the lithium-selective sorbent comprises lithium-selective ion-exchange particles. In some embodiments, the lithium selective sorbent comprises ion exchange particles. In some embodiments, the lithium-selective sorbent is an ion exchange material.

In some embodiments, lithium-selective sorbents include other inorganic materials that selectively absorb lithium over other ions. In some embodiments, the lithium-selective sorbent is a crystalline lithium salt aluminate, a lithium aluminum intercalate, LiCl·2Al(OH)₃, crystalline aluminum trihydroxide (Al(OH)₃), gibbsite, beyerite, nordstrandite, alumina hydrate, bauxite, amorphous aluminum trihydroxide, activated alumina layered lithium-aluminum double hydroxides, Li Al₂(OH)₆Cl, combinations thereof, compounds thereof, or solid solutions thereof.

An aspect of the invention described herein is a device wherein the lithium-selective sorbent comprises an ion exchange material. An aspect of the invention described herein is a process wherein the lithium-selective sorbent comprises an ion-exchange material. An aspect of the invention described herein is a system wherein the lithium-selective sorbent comprises an ion-exchange material. An aspect of the invention described herein is a lithium-selective sorbent which extracts lithium from a liquid resource.

An aspect of the disclosure is a device, system, and associated process wherein the lithium-selective sorbent comprises a lithium aluminate intercalate. In some embodiments, the lithium aluminate intercalate mixed with a polymer material. In some embodiments, the polymer material comprises a chloro-polymer, a fluoro-polymer, a chloro-fluoro-polymer, a hydrophilic polymer, a hydrophobic polymer, co-polymers thereof, mixtures thereof, or combinations thereof. In some embodiments, the polymer material comprises a co-polymer, a block co-polymer, a linear polymer, a branched polymer, a cross-linked polymer, a heat-treated polymer, a solution processed polymer, co-polymers thereof, mixtures thereof, or combinations thereof. In some embodiments, the polymer material comprises low density polyethylene, high density polyethylene, polypropylene, polyester, polytetrafluoroethylene (PTFE), types of polyamide, polyether ether ketone (PEEK), polysulfone, polyvinylidene fluoride (PVDF), poly (4-vinyl pyridine-co-styrene) (PVPCS), polystyrene (PS), polybutadiene, acrylonitrile butadiene styrene (ABS), polyvinyl chloride (PVC), ethylene tetrafluoroethylene polymer (ETFE), poly(chlorotrifluoroethylene) (PCTFE), ethylene chlorotrifluoro ethylene (Halar), polyvinylfluoride (PVF), fluorinated ethylene-propylene (FEP), perfluorinated elastomer, chlorotrifluoroethylenevinylidene fluoride (FKM), perfluoropolyether (PFPE), perfluoro-3,6-dioxa-4-methyl-7-octene-sulfonic acid (NAFION® (copolymer of perfluoro-3,6-dioxa-4-methyl-7-octene-sulfonic acid and tetrafluoroethylene)), polyethylene oxide, polyethylene glycol, sodium polyacrylate, polyethylene-block-poly(ethylene glycol), polyacrylonitrile (PAN), polychloroprene (neoprene), polyvinyl butyral (PVB), expanded polystyrene (EPS), polydivinylbenzene, co-polymers thereof, mixtures thereof, or combinations thereof. In some embodiments, the polymer material comprises polyvinylidene fluoride (PVDF), polyvinyl chloride (PVC), ethylene chlorotrifluoro ethylene (Halar), poly (4-vinyl pyridine-co-styrene) (PVPCS), polystyrene (PS), acrylonitrile butadiene styrene (ABS), expanded polystyrene (EPS), polyphenylene sulfide, sulfonated polymer, carboxylated polymer, other polymers, co-polymers thereof, mixtures thereof, or combinations thereof. In some embodiments, the polymer material is combined with the lithium aluminate intercalate particles by dry mixing, mixing in solvent, emulsion, extrusion, bubbling one solvent into another, casting, heating, evaporating, vacuum evaporation, spray drying, vapor deposition, chemical vapor deposition, microwaving, hydrothermal synthesis, polymerization, co-polymerization, cross-linking, irradiation, catalysis, foaming, other deposition methods, or combinations thereof. In some embodiments, the polymer material is combined with the lithium aluminate intercalate particles using a solvent comprising N-methyl-2-pyrrolidone, dimethyl sulfoxide, tetrahydrofuran, dimethylformamide, dimethylacetamide, methyl ethyl ketone, ethanol, acetone, other solvents, or combinations thereof. In a further aspect, a coating may be deposited onto the lithium aluminate intercalate particles using a solvent comprising N-methyl-2-pyrrolidone, dimethyl sulfoxide, tetrahydrofuran, dimethylformamide, dimethylacetamide, methyl ethyl ketone, ethanol, acetone, or combinations thereof.

In some embodiments, the lithium aluminate intercalate comprises particles that have an average diameter less than about 10 nm, less than about 100 nm, less than about 1,000 nm, less than about 10,000 nm, or less than about 100,000 nm. In some embodiments, the lithium aluminate intercalate comprises particles that have an average size less than about 100 nm, less than about 1,000 nm, or less than about 10,000 nm. In some embodiments, the lithium aluminate intercalate particles may comprise secondary particles comprised of smaller primary particles wherein the smaller primary particles have an average diameter less than about 10 nm, less than about 100 nm, less than about 1,000 nm, less than about 10,000 nm, or less than about 100,000 nm.

In a further aspect described herein, the lithium aluminate intercalate particles have an average diameter less than about 10 nm, less than about 100 nm, less than about 1,000 nm, less than about 10,000 nm, or less than about 100,000 nm. In a further aspect, the lithium aluminate intercalate particles have an average size less than about 100 nm, less than about 1,000 nm, or less than about 10,000 nm. In a further aspect, the lithium aluminate intercalate particles are optionally secondary particles comprised of smaller primary particles that have an average diameter less than about 10 nm, less than about 100 nm, less than about 1,000 nm, less than about 10,000 nm, or less than about 100,000 nm.

Embodiments Comprising One or More Filler Materials Mixed within a Bed of Lithium-Selective Sorbent

In some embodiments, the ion exchange material is loaded into an ion exchange device as described herein, wherein the ion exchange material may absorb lithium from a liquid resource placed into contact therewith. In some embodiments, the ion exchange material is loaded into an ion exchange device as described herein, and a non-sorbent material is co-loaded into the same ion exchange device. In some embodiments, the non-sorbent material is inert to all process fluids used in a method or system for lithium recovery from a liquid resource. In some embodiments, the non-sorbent material is inert to liquid resource. In some embodiments, the non-sorbent material is inert to acid. In some embodiments, the non-sorbent material is inert to washing water. In some embodiments, the non-sorbent material is inert to base.

In some embodiments, the lithium-selective sorbent is loaded into an ion exchange device as described herein, wherein the lithium-selective sorbent may absorb lithium from a liquid resource placed into contact therewith. In some embodiments, the lithium-selective sorbent comprises an ion exchange material. In some embodiments, the lithium-selective sorbent is loaded into an ion exchange device as described herein, and a non-sorbent material is co-loaded into the same ion exchange device. In some embodiments, the non-sorbent material is inert to all process fluids used in a method or system for lithium recovery from a liquid resource. In some embodiments, the non-sorbent material is inert to liquid resource. In some embodiments, the non-sorbent material is inert to acid. In some embodiments, the non-sorbent material is inert to washing water. In some embodiments, the non-sorbent material is inert to base.

In some embodiments, the non-sorbent material may be termed a “filler material”, “inert material”, “packing material”, or“packing” such that these terms may be used interchangeably in the present disclosure. In some embodiments, the non-sorbent material is co-loaded into an ion exchange device with a lithium-selective sorbent. In some embodiments, the lithium-selective sorbent is loaded into the ion exchange device first, and the non-sorbent material is subsequently loaded into the ion exchange device. In some embodiments, the non-sorbent material is loaded into the ion exchange device first, and the lithium-selective sorbent is subsequently loaded into the ion exchange device. In some embodiments, loading of the ion exchange device is alternated between non-sorbent material, lithium-selective sorbent, or a mixture thereof, until the ion exchange device is loaded to the intended loading-level. In some embodiments, the non-sorbent material is removed from the ion exchange device after the ion exchange device is loaded with the lithium-selective sorbent.

In some embodiments, the filler material may comprise glass, silica, gravel, activated carbon, ceramic, alumina, zeolite, calcite, diatomaceous earth, cellulose, polymers, copolymers, titanium foam, titanium sponge, mixtures thereof or combinations thereof. In some embodiments, the filler material comprises a porous material. In some embodiments, the filler material is diatomaceous earth. For the purposes of this disclosure, the term “diatomaceous earth” may also refer to “diatomite” or “kieselgur/kieselguhr”, or “celite”. In some embodiments, the filler material may comprise polycarbonate, polyvinyl chloride, high density polyethylene, low density polyethylene, polylactic acid, polyimide, poly(methyl methacrylate), polypropylene, polyvinylidene difluoride, polytetrafluoroethylene, polystyrene, acrylonitrile butadiene styrene, polyether ether ketone, copolymers thereof, mixtures thereof, or combinations thereof. In some embodiments, the filler material may be placed on to p of the vessel, on the bottom of the vessel, or both. In some embodiments, the filler material may be mixed with the ion exchange material, a form thereof, or a construct comprised thereof. Another aspect described herein are ion exchange devices for use according to the methods and systems for lithium recovery from a liquid resource as described herein, wherein the ion exchange device may comprise a vessel loaded with one or more beds comprising ion exchange material and a filler material, wherein the filler material is mixed with the one or more beds of ion exchange material, thereby providing support for the one or more beds and/or enabling for better flow distribution of the liquid resource or process fluid entering, passing through, or exiting the vessel. In some embodiments, better flow distribution may ensure that each quantity or incremental sub-quantity of the ion exchange material within the ion exchange bed may contact the same amount of liquid resource or process fluid and that the hydrostatic pressure required to achieve the desired rate of flow across the bed is about uniform across the surface and within cross sections of the ion exchange bed. In some embodiments, better flow distribution may be efficient flow distribution.

In some embodiments, the filler material may comprise a fibrous material. In some embodiments, said fibrous material comprises fibers. In some embodiments, said fibers may comprise glass fibers, glass wool, ceramic fibers, cellulose fibers, polymer fibers, or combinations thereof. In some embodiments, said polymer fibers may comprise polycarbonate, polyvinyl chloride, high density polyethylene, low density polyethylene, polylactic acid, polyimide, poly(methyl methacrylate), polypropylene, polyvinylidene difluoride, polytetrafluoroethylene, polystyrene, acrylonitrile butadiene styrene, polyether ether ketone, copolymers thereof, mixtures thereof, or combinations thereof. In some embodiments, the fibers may be electrostatically charged through chemical functionalization, surface coating, electret formation, or combinations thereof. In some embodiments, the fibers may be chemically functionalized. In some embodiments, the fibers may be functionalized with an ion exchange material.

In some embodiments, said fibers are defined by a characteristic diameter, and a characteristic length. In some embodiments, said characteristic length and characteristic diameter may be uniform across all fibers. In some embodiments, said characteristic length and characteristic diameter may vary across different fibers. In some embodiments, the fibrous material comprises fibers with an average diameter of less than about 0.5 μm, less than about 1 μm, less than about 5 μm, less than about 10 μm, less than about 20 μm, less than about 30 μm, less than about 40 μm, less than about 50 μm, less than about 60 μm, less than about 70 μm, less than about 80 μm, less than about 90 μm, less than about 100 μm, less than about 200 μm, less than about 300 μm, less than about 400 μm, less than about 500 μm, less than about 600 μm, less than about 700 μm, less than about 800 μm, less than about 900 μm, less than about 1000 μm, less than about 2000 μm; more than about 10 μm, more than about 20 μm, more than about 30 μm, more than about 40 μm, more than about 50 μm, more than about 60 μm, more than about 70 μm, more than about 80 μm, more than about 90 μm, more than about 100 μm, more than about 200 μm, more than about 300 μm, more than about 400 μm, more than about 500 μm, more than about 600 μm, more than about 700 μm, more than about 800 μm, more than about 900 μm, more than about 1000 μm, more than about 2000 μm. In some embodiments, the fibrous material comprises particles with an average diameter of from about 0.01 μm to about 0.1 μm, from about 0.1 μm to about 0.5 μm, from about 0.5 μm to about 1 μm, from about 1 μm to about 5 μm, from about 5 μm to about 10 μm, from about 10 μm to about 20 μm, from about 20 μm to about 40 μm, from about 40 μm to about 80 μm, from about 80 μm to about 200 μm, from about 100 μm to about 400 μm, from about 200 μm to about 800 μm, from about 400 μm to about 1000 μm, from about 600 μm to about 2000 μm, from about 1000 μm to about 2000 μm. In some embodiments, the fibrous material comprises particles with an average diameter from about 0.5 μm to about 10 μm. In some embodiments, the fibrous material comprises fibers with an average length of less than about 10 μm, less than about 20 μm, less than about 30 μm, less than about 40 μm, less than about 50 μm, less than about 60 μm, less than about 70 μm, less than about 80 μm, less than about 90 μm, less than about 100 μm, less than about 200 μm, less than about 300 μm, less than about 400 μm, less than about 500 μm, less than about 600 μm, less than about 700 μm, less than about 800 μm, less than about 900 μm, less than about 1000 μm, less than about 2000 μm; more than about 10 μm, more than about 20 μm, more than about 30 μm, more than about 40 μm, more than about 50 μm, more than about 60 μm, more than about 70 μm, more than about 80 μm, more than about 90 μm, more than about 100 μm, more than about 200 μm, more than about 300 μm, more than about 400 μm, more than about 500 μm, more than about 600 μm, more than about 700 μm, more than about 800 μm, more than about 900 μm, more than about 1000 μm, more than about 2000 μm. In some embodiments, the fibrous material comprises fibers with an average length of from about 1 μm to about 5 μm, from about 5 μm to about 10 μm, from about 10 μm to about 20 μm, from about 20 μm to about 40 μm, from about 40 μm to about 80 μm, from about 80 μm to about 200 μm, from about 100 μm to about 400 μm, from about 200 μm to about 800 μm, from about 400 μm to about 1000 μm, from about 600 μm to about 2000 μm, from about 1000 μm to about 2000 μm. In some embodiments, the fibrous material comprises fibers with an average diameter from about 0.5 μm to about 10 μm.

In some embodiments, said fibers are defined by a characteristic bulk density, a characteristic tap density, or a combination thereof. In some embodiments, said fibers are defined by a characteristic bulk density. In some embodiments, the fibrous material comprises fibers with a characteristic bulk density is less than about 0.1 g/mL, less than about 0.5 g/mL, less than about 1 g/mL, less than about 3 g/mL, less than about 5 g/mL, less than about 10 g/mL. In some embodiments, the bulk density of the fibrous material is more than about 0.1 g/mL, more than about 0.5 g/mL, more than about 1 g/mL, more than about 3 g/mL nm, more than about 5 g/mL, more than about 10 g/mL. In some embodiments, the bulk density of the fibrous material is from about 0.1 g/mL to about 0.5 g/mL, from about 0.5 g/mL to about 1 g/mL, from about 0.5 g/mL to about 3 g/mL, from about 3 g/mL to about 5 g/mL, from about 5 g/mL to about 10 g/mL. In some embodiments, said fibers are defined by a characteristic tap density. In some embodiments, the fibrous material comprises fibers with a characteristic tap density is less than about 0.1 g/mL, less than about 0.5 g/mL, less than about 1 g/mL, less than tap 3 g/mL, less than about 5 g/mL, less than about 10 g/mL. In some embodiments, the tap density of the fibrous material is more than about 0.1 g/mL, more than about 0.5 g/mL, more than about 1 g/mL, more than about 3 g/mL nm, more than about 5 g/mL, more than about 10 g/mL. In some embodiments, the tap density of the fibrous material is from about 0.1 g/mL to about 0.5 g/mL, from about 0.5 g/mL to about 1 g/mL, from about 0.5 g/mL to about 3 g/mL nm, from about 3 g/mL to about 5 g/mL, from about 5 g/mL to about 10 g/mL.

In some embodiments, efficient flow distribution within the ion exchange device occurs via one or more shaped objects or particles that are packed within one or more of the compartments that comprise the ion exchange device. In some embodiments, the filler material comprises one or more shaped objects or particles. In some embodiments, the filler material may be comprised of objects or particles shaped as a sphere, spheroid, ovaloid, cross, tube, to rus, ring, saddle ring, tubes, triangles, other complex geometric shape, or combinations thereof. In some embodiments, the filler material may be distributed in an ion exchange device with a random particle density. In some embodiments, the filler material is distributed in an ion exchange device with a uniform particle density. In some embodiments, the filler material may comprise one of more types of filler material, randomly added and distributed within the ion exchange device. In some embodiments, the filler material consists of one of more types of filler material, added and distributed within the ion exchange device within well-defined regions. In some embodiments, parts, chambers, compartments, or vessels of the of the ion exchange device may be empty while other parts, chambers, compartments, or vessels of the same ion exchange device may contain filler material.

In some embodiments, the non-sorbent material may increase the flow uniformity of the liquid resource through the bed of lithium-selective sorbent mixed with the non-sorbent material, as compared to the flow uniformity when the liquid resource flows through a bed of lithium-selective sorbent that is not mixed with a non-sorbent material. In some embodiments, the fluid pressure required to flow a liquid resource through a bed of lithium-selective sorbent mixed with the non-sorbent material is lower than the fluid pressure required to flow a liquid resource through a bed of lithium-selective sorbent with similar length and at a similar flow rate.

In some embodiments, the filler material may be shaped as a sphere, spheroid, ovaloid, cross, tube, to rus, ring, saddle ring, tubes, triangles, fiber, other complex geometric shape, or a combination thereof. In some embodiments, the filler material may be shaped as a fiber. In some embodiments, the filler material may be shaped as a sphere, spheroid, ovaloid, cross, tube, to rus, ring, saddle ring, tubes, triangles, other complex geometric shape, or a combination thereof. In some embodiments, the filler material may be distributed with a random particle density. In some embodiments, the filler material may be distributed with uniform particle density. In some embodiments, the filler material may comprise one of more types of filler material, randomly added and distributed within the ion exchange device. In some embodiments, the non-sorbent material may comprise one of more types of non-sorbent material, randomly added and distributed within the ion exchange device. In some embodiments, the filler material may comprise one of more types of filler material, added and distributed within the ion exchange device within well-defined regions. In some embodiments, parts, chambers, compartments, or vessels of the of the ion exchange device are empty, and parts, chambers, compartments, or vessels of the same ion exchange device contain filler material. In some embodiments, one end of the ion exchange device containing the lithium-selective sorbent comprises a packed bed of non-sorbent material, such that the liquid resource comprising lithium enters the ion exchange device and first contacts the lithium-selective sorbent, followed by the non-sorbent material. In some embodiments, one end of the ion exchange device containing the lithium-selective sorbent comprises a packed bed of non-sorbent material, such that the liquid resource comprising lithium enters the ion exchange device and first contacts the non-sorbent material, followed by the lithium-selective sorbent. In some embodiments, both ends of the ion exchange device containing the lithium-selective sorbent comprise a packed bed of non-sorbent material, such that the liquid resource comprising lithium enters the ion exchange device and first contacts the non-sorbent material, followed by the lithium-selective sorbent, followed by the same or a different non-sorbent material. In some embodiments, one or more parts, chambers, compartments, or vessels of the ion exchange device containing the lithium-selective sorbent comprise a packed bed of non-sorbent material, such that the liquid resource comprising lithium enters the parts, chambers, compartments, or vessels of the ion exchange device and alternates between contacting the non-sorbent material, followed by the lithium-selective sorbent.

In some embodiments, the non-sorbent material comprises particles with an average diameter of less than about 10 μm, less than about 20 μm, less than about 30 μm, less than about 40 μm, less than about 50 μm, less than about 60 μm, less than about 70 μm, less than about 80 μm, less than about 90 μm, less than about 100 μm, less than ab out 200 μm, less than about 300 μm, less than about 400 μm, less than about 500 μm, less than about 600 μm, less than about 700 μm, less than about 800 μm, less than about 900 μm, less than about 1000 μm, less than about 2000 μm; more than about 10 μm, more than about 20 μm, more than about 30 μm, more than about 40 μm, more than about 50 μm, more than about 60 μm, more than about 70 μm, more than about 80 μm, more than about 90 μm, more than about 100 μm, more than about 200 μm, more than about 300 μm, more than about 400 μm, more than about 500 μm, more than about 600 μm, more than about 700 μm, more than about 800 μm, more than about 900 μm, more than about 1000 μm, more than about 2000 μm. In some embodiments, the non-sorbent material comprises particles with an average diameter of from about 1 μm to about 5 μm, from about 5 μm to about 10 μm, from about 10 μm to about 20 μm, from about 20 μm to about 40 μm, from about 40 μm to about 80 μm, from about 80 μm to about 200 μm, from about 100 μm to about 400 μm, from about 200 μm to about 800 μm, from about 400 μm to about 1000 μm, from about 600 μm to about 2000 μm, from about 1000 μm to about 2000 μm. In some embodiments, the non-sorbent material comprises particles with an average diameter from about 10 μm to about 200 μm.

In some embodiments, the non-sorbent material is porous. In some embodiments, the non-sorbent material has an average pore opening size of less than about 0.1 nm, less than about 1 nm, less than about 10 nm, less than about 100 nm, less than about 1 μm, less than about 10 μm, less than about 20 μm, less than about 30 μm, less than about 40 μm, less than about 50 μm, less than about 60 μm, less than about 70 μm, less than about 80 μm, less than about 90 μm, less than about 100 μm, less than about 200 μm, less than about 300 μm, less than about 400 μm, less than about 500 μm, less than about 600 μm, less than about 700 μm, less than about 800 μm, less than about 900 μm, less than about 1000 μm, less than about 2000 μm. In some embodiments, the non-sorbent material has an average pore opening size of more than about 0.1 nm, more than about 1 nm, more than about 10 nm, more than about 100 nm, more than about 1 μm, more than about 10 μm, more than about 20 μm, more than about 30 μm, more than about 40 μm, more than about 50 μm, more than about 60 μm, more than about 70 μm, more than about 80 μm, more than about 90 μm, more than about 100 μm, more than about 200 μm, more than about 300 μm, more than about 400 μm, more than about 500 μm, more than about 600 μm, more than about 700 μm, more than about 800 μm, more than about 900 μm, more than about 1000 μm, more than about 2000 μm. In some embodiments, the non-sorbent material has an average pore opening size of rom about 0.1 nm to about 1 nm, from about 1 nm to about 10 nm, from about 10 nm to about 100 nm, from about 100 nm to about 1 μm, from 1 μm to about 10 μm, from about 1 μm to about 5 μm, from about 5 μm to about 10 μm, from about 10 μm to about 20 μm, from about 20 μm to about 40 μm, from about 40 μm to about 80 μm, from about 80 μm to about 200 μm, from about 100 μm to about 400 μm, from about 200 μm to about 800 μm, from about 400 μm to about 1000 μm, from about 600 μm to about 2000 μm, from about 1000 μm to about 2000 μm. In some embodiments, the non-sorbent material comprises particles with an average diameter from about 10 μm to about 200 μm.

In some embodiments, the packed density of the non-sorbent material is less than about 0.1 g/mL, less than about 0.5 g/mL, less than about 1 g/mL, less than about 3 g/mL nm, less than about 5 g/mL, less than about 10 g/mL. In some embodiments, the packed density of the non-sorbent material is more than about 0.1 g/mL, more than about 0.5 g/mL, more than about 1 g/mL, more than about 3 g/mL nm, more than about 5 g/mL, more than about 10 g/mL. In some embodiments, the packed density of the non-sorbent material is from about 0.1 g/mL to about 0.5 g/mL, from about 0.5 g/mL to about 1 g/mL, from about 0.5 g/mL to about 3 g/mL nm, from about 3 g/mL to about 5 g/mL, from about 5 g/mL to about 10 g/mL.

In some embodiments, the lithium-selective sorbent is loaded into the ion exchange device as a slurry or suspension. In some embodiments, the liquid component of the slurry is water, acid, base, or a solvent. In some embodiments, the percentage of liquid in the slurry is less than about 1%, less than about, 2%, less than about 5%, less than about 10%, less than about 20%, less than about 50%, less than about 75%, less than about 90%, more than about 1%, more than about, 2%, more than about 5%, more than about 10%, more than about 20%, more than about 50%, more than about 75%, more than about 90%, between about 0% and 5%, between about 5% and 10%, between about 10% and 20%, between about 20% and 50%, between about 50% and 75%, between about 75% and 90%, between about 90% and 100%. In some embodiments, the percentage of solids in the slurry is less than about 1%, less than about, 2%, less than about 5%, less than about 10%, less than about 20%, less than about 50%, less than about 75%, less than about 90%, more than about 1%, more than about, 2%, more than about 5%, more than about 10%, more than about 20%, more than about 50%, more than about 75%, more than about 90%, between about 0% and 5%, between about 5% and 10%, between about 10% and 20%, between about 20% and 50%, between about 50% and 75%, between about 75% and 90%, between about 90% and 100%. In some embodiments, the ion exchange beads are loaded into the ion exchange device as a dry powder. In some embodiments, the ion exchange particles are loaded into the ion exchange device as a dry powder. In some embodiments, the lithium-selective sorbent is loaded into the ion exchange device as a dry powder.

In some embodiments, the non-sorbent material is loaded into the ion-exchange vessel as a slurry or suspension. In some embodiments, the liquid component of such slurry is water, acid, base, or a solvent. In some embodiments, the percentage of liquid in the slurry is less than about 1%, less than about, 2%, less than about 5%, less than about 10%, less than about 20%, less than about 50%, less than about 75%, less than about 90%, more than about 1%, more than about, 2%, more than about 5%, more than about 10%, more than about 20%, more than about 50%, more than about 75%, more than about 90%, between about 0% and 5%, between about 5% and 10%, between about 10% and 20%, between about 20% and 50%, between about 50% and 75%, between about 75% and 90%, between about 90% and 100%. In some embodiments, the percentage of solids in the slurry is less than about 1%, less than about, 2%, less than about 5%, less than about 10%, less than about 20%, less than about 50%, less than about 75%, less than about 90%, more than about 1%, more than about, 2%, more than about 5%, more than about 10%, more than about 20%, more than about 50%, more than about 75%, more than about 90%, between about 0% and 5%, between about 5% and 10%, between about 10% and 20%, between about 20% and 50%, between about 50% and 75%, between about 75% and 90%, between about 90% and 100%. In some embodiments, the non-sorbent material is loaded into the ion-exchange vessel as a dry powder.

In some embodiments, the non-sorbent material is mixed with the lithium-selective sorbent in a tank, then liquid is added and the contents are agitated to make a suspension, and the resulting suspension is loaded into the ion exchange device. In some embodiments, the liquid added to make the suspension is water, acid, base, or a solvent. In some embodiments, the percentage of liquid in the suspension is less than about 1%, less than about, 2%, less than about 5%, less than about 10%, less than about 20%, less than about 50%, less than about 75%, less than about 90%, more than about 1%, more than about, 2%, more than about 5%, more than about 10%, more than about 20%, more than about 50%, more than about 75%, more than about 90%, between about 0% and 5%, between about 5% and 10%, between about 10% and 20%, between about 20% and 50%, between about 50% and 75%, between about 75% and 90%, between about 90% and 100%. In some embodiments, the ion exchange beads are loaded into the ion-exchange vessel as a dry mixture. In some embodiments, the percentage of solids in the suspension is less than about 1%, less than about, 2%, less than about 5%, less than about 10%, less than about 20%, less than about 50%, less than about 75%, less than about 90%, more than about 1%, more than about, 2%, more than about 5%, more than about 10%, more than about 20%, more than about 50%, more than about 75%, more than about 90%, between about 0% and 5%, between about 5% and 10%, between about 10% and 20%, between about 20% and 50%, between about 50% and 75%, between about 75% and 90%, between about 90% and 100%. In some embodiments, the non-sorbent material and the lithium-selective sorbent are loaded into the ion exchange device as a dry mixture.

In some embodiments, the non-sorbent material is loaded into the ion-exchange vessel as a slurry or suspension. In some embodiments, a slurry or suspension comprising a mixture of the non-sorbent material and the lithium-selective sorbent is loaded into the ion exchange device. In some embodiments, said slurry is loaded into the ion exchange device by conveying said slurry into said device by means of a mechanical device. In some embodiments, said mechanical device is a pump. In some embodiments, said slurry is formed and conveyed into the ion exchange device to completely load said device. In some embodiments, said the solid component of the slurry or suspension is recovered by retaining elements, meshes, or screens in the ion exchange device, while the liquid component is recovered. In some embodiment, said recovered liquid component is recycled to continuously dilute the slurry or suspension.

In some embodiments, the ion-exchange device is loaded with a first slurry or suspension. In some embodiments, the ion-exchange device is loaded with a first slurry or suspension until a majority of the solids are retained within the ion-exchange device. In some embodiments, a second slurry or suspension is subsequently loaded into the ion exchange device. In some embodiments, multiple such slurries are loaded into said ion exchange device, until the ion exchange device is fully loaded with a lithium selective sorbent. In some embodiments, one slurry or suspension is loaded into the ion exchange device to fully load said ion exchange device. In some embodiments, two slurries or suspensions are loaded into the ion exchange device to fully load said ion exchange device. In some embodiments, three slurries or suspensions are loaded into the ion exchange device to fully load said ion exchange device. In some embodiments, four slurries or suspensions are loaded into the ion exchange device to fully load said ion exchange device. In some embodiments, five slurries or suspensions are loaded into the ion exchange device to fully load said ion exchange device. In some embodiments, five to seven slurries or suspensions are loaded into the ion exchange device to fully load said ion exchange device. In some embodiments, seven to ten slurries or suspensions are loaded into the ion exchange device to fully load said ion exchange device. In some embodiments, ten to fifteen slurries or suspensions are loaded into the ion exchange device to fully load said ion exchange device. In some embodiments, fifteen to twenty slurries or suspensions are loaded into the ion exchange device to fully load said ion exchange device. In some embodiments, twenty to thirty slurries or suspensions are loaded into the ion exchange device to fully load said ion exchange device. In some embodiments, thirty to fifty slurries or suspensions are loaded into the ion exchange device to fully load said ion exchange device. In some embodiments, fifty to one hundred slurries or suspensions are loaded into the ion exchange device to fully load said ion exchange device. In some embodiments, the composition of said one or more slurries or suspensions is the same. In some embodiments, the composition of said one or more slurries or suspensions is approximately the same. In some embodiments, the composition of said one or more slurries or suspensions is adjusted. In some embodiments, the composition of said one or more slurries or suspensions is adjusted to result in a loaded ion exchange device with optimal flow characteristics. In some embodiments, the composition of said one or more slurries or suspensions is adjusted, wherein said composition may comprise a lithium selective sorbent, a non-sorbent or filler material, or a combination thereof. In some embodiments, one or more said slurries comprise a lithium selective sorbent. In some embodiments, one or more said slurries comprise a non-sorbent or filler material. In some embodiments, slurries comprising a lithium selective sorbent, and slurries comprising a non-sorbent or filler material are alternated. In some embodiments, a slurry comprising a non-sorbent or filler material is loaded into the ion exchange device first, followed by a lithium-selective sorbent. In some embodiments, the composition, rate of loading, and method of loading of the slurry or suspension into the ion exchange device is controlled to result in a loaded ion exchange device with optimal flow characteristics.

In some embodiments, the slurry or suspension loaded into the ion exchange device is continuously generated in a tank by addition of solids to said tank, and said continuously formed slurry or suspension is loaded into the ion exchange device. In some embodiments, said continuously formed slurry is loaded into the ion exchange device until the ion exchange device is continuously loaded. In some embodiments, the composition of said slurry or suspension is continuously adjusted while said slurry or suspension is loaded into said ion exchange device. In some embodiments, the composition of said slurry or suspension is continuously adjusted by varying the amount of lithium selective sorbent to non-sorbent or filler material contained within said slurry or suspension.

### The Liquid Resource

As a liquid resource flows through an ion exchange device, the ion exchange material absorbs lithium while releasing hydrogen, causing a decrease in the pH of the liquid resource from which lithium is being extracted. pH values of less than about 6 in said liquid resource result in sub-optimal performance of the ion-exchange process because the higher hydrogen concentrations found at low pH result in the reversal of ion-exchange, wherein hydrogen is absorbed while lithium is released. Said sub-optimal process performance is manifested as, but is not limited to, a slower uptake of lithium by the ion exchange material, lower purity of the lithium eluted from the ion exchange material, lower lithium uptake capacity of the ion exchange material, degradation of the ion exchange material, decreased lifetime of the ion exchange material which necessitates more frequent replacement thereof, slower elution of lithium from the ion exchange material in the presence of acid, and higher amounts of acid being required for the elution of lithium from the ion exchange material.

In some embodiments, the pH value of the liquid resource can be maintained above a value of 6 by addition of an alkali. In some embodiments, said alkali is added before flow of the liquid resource through a bed or ion exchange material, or after flow of said liquid resource through abed of ion exchange material, but not within the bed of ion exchange material where the lithium extraction process occurs. In some embodiments, the pH of the liquid resource decreases to a suboptimal value of less than about 6 during the time it takes for the liquid resource to flow through a bed of ion exchange material. Thus, in some embodiments systems and methods described herein are used to moderate the decrease in pH of the liquid resource during contact of the liquid resource with ion exchange material.

In some embodiments, a system is used to adjust the concentration of lithium in the liquid resource before it contacts an ion exchange material that extracts lithium from the liquid resource while releasing protons into the liquid resource. In some embodiments, said system decreases the lithium concentration of the liquid resource, such that less lithium is absorbed by the ion exchange material over the same amount of contact time, and therefore fewer protons are released into the liquid resource by the ion exchange material during this absorption process, leading to a higher pH of the liquid resource as it contacts the ion exchange material. In some embodiments, adjustment of the lithium concentration in the liquid resource is achieved by mixing the liquid resource with a raffinate stream, said raffinate stream comprising the liquid resource which has contacted ion exchange material to absorb a portion of the lithium. Raffinate or a raffinate stream may comprise a lithium-depleted liquid resource. A solution comprising a liquid resource and a raffinate may comprise a concentration-adjusted liquid resource according to some embodiments. As a result of combining a raffinate stream with a liquid resource, the lithium remaining in the raffinate stream will be put into contact with the ion exchange material more than once, leading to multiple contacts of said lithium with the ion exchange material and multiple opportunities for uptake of said lithium by the ion exchange material. The result is an increase in the overall recovery of lithium by the methods and systems described herein as compared to methods and systems that do not comprise combining a raffinate with a liquid resource prior to placing the resulting mixture in contact with an ion exchange material.

The production of lithium chemicals and lithium feedstocks suitable for industrial applications can involve the recovery of lithium from resources that contain lithium in addition to other components. Resources containing lithium in addition to other components can be a liquid resource. In some embodiments, the liquid resource is selected from the following list: a natural brine, a dissolved salt flat, a geothermal brine, seawater, concentrated seawater, desalination effluent, a concentrated brine, a processed brine, liquid from an ion exchange process, liquid from a solvent extraction process, a synthetic brine, leachate from ores, leachate from minerals, leachate from clays, leachate from sediments, leachate from recycled products, leachate from recycled materials, or combinations thereof. In some embodiments, a liquid resource is selected from the following list: a natural brine, a dissolved salt flat, a concentrated brine, a processed brine, a synthetic brine, a geothermal brine, liquid from an ion exchange process, liquid from a solvent extraction process, leachate from minerals, leachate from clays, leachate from recycled products, leachate from recycled materials, or combinations thereof. In some embodiments, the liquid resource is optionally pre-treated prior to entering the ion exchange reactor to remove suspended solids, hydrocarbons, organic molecules, iron, certain metals, or other chemical or ionic species. In some embodiments, the liquid resource is optionally fed into the ion exchange reactor without any pre-treatment. In some embodiments, the liquid resource is injected into a reservoir, salt lake, salt flat, basin, or other geologic deposit after lithium has been removed from the liquid resource. In some embodiments, other species are recovered from the liquid resource before or after lithium recovery. In some embodiments, the pH of the liquid resource is adjusted before, during, or after lithium recovery. In some embodiments, a method for lithium recovery may comprise placing a liquid resource or a solution comprising a liquid resource into contact with ion exchange material. In some embodiments, the lithium concentration of the liquid resource is adjusted before, during, or after lithium recovery. In some embodiments, a liquid resource is an aqueous solution comprising lithium suitable for use according to the methods and systems for lithium recovery disclosed herein.

In one embodiment, the liquid resource is a natural brine, a dissolved salt flat, seawater, concentrated seawater, a geothermal brine, a desalination effluent, a concentrated brine, a processed brine, an oilfield brine, a liquid from an ion exchange process, a liquid from a solvent extraction process, a synthetic brine, a leachate from an ore or combination of ores, a leachate from a mineral or combination of minerals, a leachate from a clay or combination of clays, a leachate from recycled products, a leachate from recycled materials, or combinations thereof. In some embodiments, the liquid resource is a brine.

In one embodiment, the liquid resource is at a temperature of −20 to 20° C., 20 to 50° C., 50 to 100° C., 100 to 200° C., or 200 to 400° C. In one embodiment, the liquid resource is heated or cooled to precipitate or dissolve species in the brine, or to facilitate removal of metals from the liquid resource.

In one embodiment, the liquid resource contains lithium at a concentration of less than 1 mg/L, 1 to 50 mg/L, 50 to 200 mg/L, 200 to 500 mg/L, 500 to 2,000 mg/L, 2,000 to 5,000 mg/L, 5,000 to 10,000 mg/L, 10,000 to 20,000 mg/L, 20,000 to 80,000 mg/L, or greater than 80,000 mg/L.

In one embodiment, the liquid resource contains magnesium at a concentration of 0.01 to 0.1 mg/L, 0.1 to 1 mg/L, 1 to 10 mg/L, 10 to 100 mg/L, 100 to 1,000 mg/L, 1,000 to 10,000 mg/L, 10,000 to 50,000 mg/L, 50,000 to 100,000 mg/L, 100,000 to 150,000 mg/L, or greater than 150,000 mg/L. In one embodiment, the liquid resource contains calcium at a concentration of 0.01 to 0.1 mg/L, 0.1 to 1 mg/L, 1 to 10 mg/L, 10 to 100 mg/L, 100 to 1,000 mg/L, 1,000 to 10,000 mg/L, 10,000 to 50,000 mg/L, 50,000 to 100,000 mg/L, 100,000 to 150,000 mg/L, or greater than 150,000 mg/L. In one embodiment, the liquid resource contains strontium at a concentration of 0.01 to 0.1 mg/L, 0.1 to 1 mg/L, 1 to 10 mg/L, 10 to 100 mg/L, 100 to 1,000 mg/L, 1,000 to 10,000 mg/L, 10,000 to 50,000 mg/L, 50,000 to 100,000 mg/L, 100,000 to 150,000 mg/L, or greater than 150,000 mg/L. In one embodiment, the liquid resource contains barium at a concentration of 0.01 to 0.1 mg/L, 0.1 to 1 mg/L, 1 to 10 mg/L, 10 to 100 mg/L, 100 to 1,000 mg/L, 1,000 to 10,000 mg/L, 10,000 to 50,000 mg/L, 50,000 to 100,000 mg/L, 100,000 to 150,000 mg/L, or greater than 150,000 mg/L.

In one embodiment, the liquid resource contains multivalent cations at a concentration of 0.01 to 0.1 mg/L, 0.1 to 1 mg/L, 1 to 10 mg/L, 10 to 100 mg/L, 100 to 1,000 mg/L, 1,000 to 10,000 mg/L, 10,000 to 50,000 mg/L, 50,000 to 100,000 mg/L, 100,000 to 150,000 mg/L, or greater than 150,000 mg/L. In one embodiment, the liquid resource contains multivalent ions at a concentration of 0.01 to 0.1 mg/L, 0.1 to 1 mg/L, 1 to 10 mg/L, 10 to 100 mg/L, 100 to 1,000 mg/L, 1,000 to 10,000 mg/L, 10,000 to 50,000 mg/L, 50,000 to 100,000 mg/L, 100,000 to 150,000 mg/L, or greater than 150,000 mg/L. In one embodiment, the liquid resource contains non-lithium impurities at a concentration of 0.01 to 0.1 mg/L, 0.1 to 1 mg/L, 1 to 10 mg/L, 10 to 100 mg/L, 100 to 1,000 mg/L, 1,000 to 10,000 mg/L, 10,000 to 50,000 mg/L, 50,000 to 100,000 mg/L, 100,000 to 150,000 mg/L, or greater than 150,000 mg/L. In one embodiment, the liquid resource contains transition metals at a concentration of 0.01 to 0.1 mg/L, 0.1 to 1 mg/L, 1 to 10 mg/L, 10 to 100 mg/L, 100 to 1,000 mg/L, 1,000 to 10,000 mg/L, 10,000 to 50,000 mg/L, 50,000 to 100,000 mg/L, 100,000 to 150,000 mg/L, or greater than 150,000 mg/L. In one embodiment, the liquid resource contains iron at a concentration of 0.01 to 0.1 mg/L, 0.1 to 1 mg/L, 1 to 10 mg/L, 10 to 100 mg/L, 100 to 1,000 mg/L, 1,000 to 10,000 mg/L, 10,000 to 50,000 mg/L, 50,000 to 100,000 mg/L, 100,000 to 150,000 mg/L, or greater than 150,000 mg/L. In one embodiment, the liquid resource contains manganese at a concentration of 0.01 to 0.1 mg/L, 0.1 to 1 mg/L, 1 to 10 mg/L, 10 to 100 mg/L, 100 to 1,000 mg/L, 1,000 to 10,000 mg/L, 10,000 to 50,000 mg/L, 50,000 to 100,000 mg/L, 100,000 to 150,000 mg/L, or greater than 150,000 mg/L.

In one embodiment, the liquid resource is treated to produce a pre-treated liquid resource which has certain metals removed. The term liquid resource as used in this disclosure shall be understood to also encompass a pre-treated liquid resource as described herein. In one embodiment, the pre-treated liquid resource contains iron at a concentration of less than 0.01, 0.01 to 0.1 mg/L, mg/L, 0.1 to 1.0 mg/L, 1.0 to 10 mg/L, 10 to 100 mg/L, or 100 to 1,000 mg/L. In one embodiment, the pre-treated liquid resource contains manganese at a concentration of less than 0.01, 0.01 to 0.1 mg/L, mg/L, 0.1 to 1.0 mg/L, 1.0 to 10 mg/L, 10 to 100 mg/L, or 100 to 1,000 mg/L. In one embodiment, the pre-treated liquid resource contains lead at a concentration of less than 0.01, 0.01 to 0.1 mg/L, mg/L, 0.1 to 1.0 mg/L, 1.0 to 10 mg/L, 10 to 100 mg/L, or 100 to 1,000 mg/L. In one embodiment, the pre-treated liquid resource contains zinc at a concentration of less than 0.01, 0.01 to 0.1 mg/L, mg/L, 0.1 to 1.0 mg/L, 1.0 to 10 mg/L, 10 to 100 mg/L, or 100 to 1,000 mg/L. In one embodiment, the pre-treated liquid resource contains lithium at a concentration of 1 to 50 mg/L, 50 to 200 mg/L, 200 to 500 mg/L, 500 to 2,000 mg/L, or greater than 2,000 mg/L.

In one embodiment, the pre-treated liquid resource is processed to recover metals such as lithium and yield a lithium-depleted liquid resource. In some embodiments, a lithium-depleted liquid resource is a raffinate. In one embodiment, the lithium-depleted liquid resource contains residual quantities of the recovered metals at a concentration of less than 0.01, 0.01 to 0.1 mg/L, mg/L, 0.1 to 1.0 mg/L, 1.0 to 10 mg/L, 10 to 100 mg/L, 100 to 1,000 mg/L, or 1,000 to 10,000 mg/L.

In one embodiment, the pH of the liquid resource is corrected to less than 0, 0 to 1, 1 to 2, 2 to 4, 4 to 6, 6 to 8, 4 to 8, 8 to 9, 9 to 10, 9 to 11, or 10 to 12. In one embodiment, the pH of the liquid resource is corrected to 2 to 4, 4 to 6, 6 to 8, 4 to 8, 8 to 9, 9 to 10, 9 to 11, or 10 to 12. In one embodiment, the pH of the liquid resource is corrected to precipitate or dissolve metals.

In one embodiment, metals are precipitated from the liquid resource to form precipitates. In one embodiment, precipitates include transition metal hydroxides, oxy-hydroxides, sulfide, flocculants, aggregate, agglomerates, or combinations thereof. In one embodiment, the precipitates comprise Li, Na, K, Rb, Cs, Fr, Be, Mg, Ca, Sr, Ba, Ra, Sc, Y, Ti, , Zr, Hf, V, Nb, Ta, Cr, Mo, W, Mn, Tc, Fe, Fe, Ru, Os, Co, Rh, Ir, Ni, Pd Pt, Cu, Ag, Au, Zn, Cd, Hg, B, Al, Ga, In, Si, Ge, Sn, Pb, As, Sb, Bi, Se, Te, Po, Br, I, At, other metals, or combinations thereof. In one embodiment, the precipitates may be concentrated into a slurry, a filter cake, a wet filter cake, a dry filter cake, a dense slurry, or a dilute slurry.

In one embodiment, the precipitates contain iron at a concentration of less than 0.01 mg/kg, 0.01 to 1 mg/kg, 1 to 100 mg/kg, 100 to 10,000 mg/kg, or 10,000 to 800,000 mg/kg. In one embodiment, the precipitates contain manganese at a concentration of less than 0.01 mg/kg, 0.01 to 1 mg/kg, 1 to 100 mg/kg, 100 to 10,000 mg/kg, or 10,000 to 800,000 mg/kg. In one embodiment, the precipitates contain lead at a concentration of less than 0.01 mg/kg, 0.01 to 1 mg/kg, 1 to 100 mg/kg, 100 to 10,000 mg/kg, or 10,000 to 800,000 mg/kg. In one embodiment, the precipitates contain arsenic at a concentration of less than 0.01 mg/kg, 0.01 to 1 mg/kg, 1 to 100 mg/kg, 100 to 10,000 mg/kg, or 10,000 to 800,000 mg/kg. In one embodiment, the precipitates contain magnesium at a concentration of less than 0.01 mg/kg, 0.01 to 1 mg/kg, 1 to 100 mg/kg, 100 to 10,000 mg/kg, or 10,000 to 800,000 mg/kg. In one embodiment, the precipitates contain Li, Na, K, Rb, Cs, Fr, Be, Mg, Ca, Sr, Ba, Ra, Sc, Y, Ti, , Zr, Hf, V, Nb, Ta, Cr, Mo, W, Mn, Tc, Fe, Fe, Ru, Os, Co, Rh, Ir, Ni, Pd Pt, Cu, Ag, Au, Zn, Cd, Hg, B, Al, Ga, In, Si, Ge, Sn, Pb, As, Sb, Bi, Se, Te, Po, Br, I, At, or other metals at a concentration of less than 0.01 mg/kg, 0.01 to 1 mg/kg, 1 to 100 mg/kg, 100 to 10,000 mg/kg, or 10,000 to 800,000 mg/kg. In some embodiments, the precipitates are to xic and/or radioactive. In some embodiments, precipitates are redissolved by combining the precipitates with an acidic solution. In one embodiment, precipitates are redissolved by combining the precipitates with an acidic solution in a mixing apparatus. In one embodiment, precipitates are redissolved by combining the precipitates with an acidic solution using a high-shear mixer.

### Treatment of the Liquid Resource

In some embodiments, the pH of the liquid resource is adjusted before, during and/or after contact with ion exchange material to maintain the pH within a range that is suitable, preferred, or ideal for lithium recovery.

To adjust the pH of a liquid resource to be within a range that is suitable, preferred, or ideal for lithium recovery, bases such as NaOH, LiOH, KOH, Mg(OH)₂, Ca(OH)₂, CaO, NH₃, Na₂SO₄, K₂SO₄, NaHSO₄, KHSO₄, NaOCl, KOCl, NaClO₄, KClO₄, NaH₂BO₃, Na₂HBO₃, Na₃BO₃, KH₂BO₃, K₂HBO₃, K₃BO₃, MgHBO₃, CaHBO₃, NaHCO₃, KHCO₃, NaCO₃, KCO₃, MgCO₃, CaCO₃, Na₂O, K₂O, Na₂CO₃, K₂CO₃, Na₃PO₄, Na₂HPO₄, NaH₂PO₄, K₃PO₄, K₂HPO₄, KH₂PO₄, CaHPO₄, MgHPO₄, sodium acetate, potassium acetate, magnesium acetate, poly(vinylpyridine), poly(vinylamine), polyacrylonitrile are optionally added to the liquid resource as solids, aqueous solutions, or other forms. For liquid resources that contain divalent ions such as Mg, Ca, Sr, or Ba, addition of base to the brine can cause the formation of precipitates, such as Mg(OH)₂ or Ca(OH)₂, which can hinder lithium recovery. These precipitates hinder lithium recovery in at least three ways. First, formation of precipitates can remove base from solution, leaving less base available in solution to neutralize protons and maintain pH within a range that is suitable, preferred, or ideal for lithium recovery. Second, precipitates that form due to base addition can hinder flow through an ion exchange device, including hindering flow over the surfaces of ion exchange material, through the pores of porous ion exchange beads, and through the voids between ion exchange material. This hindering of flow can prevent lithium from being absorbed by the ion exchange material that may be utilized in lithium recovery. The hindering of flow can also cause large pressure differences between the inlet and outlet of an ion exchange device that may be utilized for lithium recovery. Third, precipitates in an ion exchange device that may be utilized for lithium recovery may dissolve when placed in contact with an acid eluent, and thereby contaminate the synthetic lithium solution produced by the ion exchange device that may be utilized for lithium recovery.

For ion exchange material to absorb lithium from a liquid resource for the purpose of lithium recovery, an ideal pH range for the liquid resource is optionally 5 to 7, a preferred pH range is optionally 4 to 8, and a suitable pH range is optionally 1 to 9. In one embodiment, an pH range for the liquid resource is optionally about 1 to about 14, about 2 to about 13, about 3 to about 12, about 4 to about 12, about 4.5 to about 11, about 5 to about 10, about 5 to about 9, about 2 to about 5, about 2 to about 4, about 2 to about 3, about 3 to about 8, about 3 to about 7, about 3 to about 6, about 3 to about 5, about 3 to about 4, about 4 to about 10, about 4 to about 9, about 4 to about 8, about 4 to about 7, about 4 to about 6, about 4 to about 5, about 5 to about 6, about 5 to about 7, about 5 to about 8, about 6 to about 7, about 6 to about 8, or about 7 to about 8.

In one embodiment, the liquid resource is subjected to treatment prior to ion exchange. In some embodiments, said treatment comprises filtration, gravity sedimentation, centrifugal sedimentation, magnetic fields, other methods of solid-liquid separation, or combinations thereof. In some embodiments, precipitated metals are removed from the liquid resource using a filter. In some embodiments, the filter is a belt filter, plate-and-frame filter press, pressure vessel containing filter elements, rotary drum filter, rotary disc filter, cartridge filter, a centrifugal filter with a fixed or moving bed, a metal screen, a perforate basket centrifuge, a three-point centrifuge, a peeler type centrifuge, or a pusher centrifuge. In some embodiments, the filter may use a scroll or a vibrating device. In some embodiments, the filter is horizontal, vertical, or may use a siphon.

In some embodiments, a filter cake is prevented, limited, or removed by using gravity, centrifugal force, an electric field, vibration, brushes, liquid jets, scrapers, intermittent reverse flow, vibration, crow-flow filtration, or pumping suspensions across the surface of the filter. In some embodiments, the precipitated metals and a liquid is moved tangentially to the filter to limit filter cake growth. In some embodiments, gravitational, magnetic, centrifugal sedimentation, or other means of solid-liquid separation are used before, during, or after filtering to prevent filter cake formation.

In some embodiments, a filter comprises a screen, a metal screen, a sieve, a sieve bend, a bent sieve, a high frequency electromagnetic screen, a resonance screen, or combinations thereof. In some embodiments, one or more particle traps are a solid-liquid separation apparatus.

In some embodiments, one or more solid-liquid separation apparatuses may be used in series or parallel. In some embodiments, a dilute slurry is removed from the tank, transferred to an external solid-liquid separation apparatus, and separated into a concentrated slurry and a solution with low or no suspended solids. In some embodiments, the concentrated slurry is returned to the tank or transferred to a different tank. In some embodiments, precipitate metals are transferred from a liquid resource tank to another liquid resource tank, from an acid tank to another acid tank, from a washing tank to another washing tank, from a liquid resource tank to a washing tank, from a washing tank to an acid tank, from an acid tank to a washing tank, or from an acid tank to a liquid resource tank.

In some embodiments, solid-liquid separation apparatuses may use gravitational sedimentation. In some embodiments, solid-liquid separation apparatuses may include a settling tank, a thickener, a clarifier, a gravity thickener. In some embodiments, solid-liquid separation apparatuses are operated in batch mode, semi-batch mode, semi-continuous mode, or continuous mode. In some embodiments, solid-liquid separation apparatuses include a circular basin thickener with slurry entering through a central inlet such that the slurry is dispersed into the thickener with one or more raking components that rotate and concentrate the ion exchange particles into a zone where the particles can leave through the bottom of the thickener.

In some embodiments, solid-liquid separation apparatuses comprise a deep cone, a deep cone tank, a deep cone compression tank, or a tank wherein the slurry is compacted by weight. In some embodiments, solid-liquid separation apparatuses comprise a tray thickener with a series of thickeners oriented vertically with a center axle and raking components. In some embodiments, solid-liquid separation apparatuses comprise a lamella type thickener with inclined plates or tubes that may be smooth, flat, rough, or corrugated. In some embodiments, solid-liquid separation apparatuses comprise a gravity clarifier that may be a rectangular basin with feed at one end and overflow at the opposite end optionally with paddles and/or a chain mechanism to move particles. In some embodiments, the solid-liquid separation apparatuses may comprise a particle trap.

In some embodiments, the solid-liquid separation apparatuses use centrifugal sedimentation. In some embodiments, solid-liquid separation apparatuses may comprise a tubular centrifuge, a multi-chamber centrifuge, a conical basket centrifuge, a scroll-type centrifuge, a sedimenting centrifuge, or a disc centrifuge. In some embodiments, precipitated metals are discharged continuously or intermittently from the centrifuge. In some embodiments, the solid-liquid separation apparatus is a hydrocyclone. In some embodiments, solid-liquid separation apparatus is an array of hydrocyclones or centrifuges in series and/or in parallel. In some embodiments, sumps are used to reslurry the precipitated metals. In some embodiments, the hydrocyclones may comprise multiple feed points. In some embodiments, a hydrocyclone is used upside down. In some embodiments, liquid is injected near the apex of the cone of a hydrocyclone to improve sharpness of cut. In some embodiments, a weir rotates in the center of the particle trap with a feed of slurried precipitated metals entering near the middle of the apparatus such that precipitated metals get trapped at the bottom and center of the apparatus due to a “teacup effect”.

### The Lithium Selective Sorbent

For the purposes of this disclosure, the term lithium-selective sorbent comprises all lithium-selective ion exchange materials. Ion exchange materials that selectively absorb and release lithium ions are lithium-selective ion exchange materials. In some embodiments, ion exchange beads may comprise a lithium-selective sorbent. In some embodiments, ion exchange particles may comprise a lithium-selective sorbent. In some embodiments, lithium-selective sorbents comprise an inorganic material that selectively absorbs lithium over other ions. In some embodiments, a lithium selective sorbent is a crystalline lithium salt aluminate, a lithium aluminum intercalate, LiCl·2Al(OH)₃, crystalline aluminum trihydroxide (Al(OH)₃), gibbsite, beyerite, nordstrandite, alumina hydrate, bauxite, amorphous aluminum trihydroxide, activated alumina layered lithium-aluminum double hydroxides, Li Al₂(OH)₆Cl, combinations thereof, compounds thereof, or solid solutions thereof.

Lithium-selective ion exchange materials may be used in a method for lithium recovery from a liquid resource Lithium-selective ion exchange materials may be used in a system for lithium recovery from a liquid resource. Lithium-selective ion exchange materials may be used in an ion exchange device. Lithium-selective ion exchange materials absorb lithium from a liquid resource while releasing hydrogen, and then elute lithium in an eluent while absorbing hydrogen from the eluent. This ion exchange process is optionally repeated to extract lithium from a liquid resource and yield a synthetic lithium solution. The synthetic lithium solution is optionally further processed into chemicals for the battery industry or other industries.

The performance parameters of lithium recovery by an ion exchange material are reflected in the ability of the ion exchange material to absorb lithium from a liquid resource in high quantity and in high purity over long periods time. When a given amount of an ion exchange material contacts a given amount of liquid resource, wash solution, eluent solution, or other process fluids, the effectiveness of selective lithium absorption, washing, lithium release/elution, or other treatment depends on effective contact of process fluids with the ion exchange material. In some embodiments, effective contact implies that a given amount of ion exchange material is contacted with the same amount of process fluid, and that the composition of said fluid is the same as that contacting the entirety of the ion exchange material. As such, in some embodiments, it is essential that devices for lithium recovery be configured in a manner such that the ion exchange material may make uniform contact with process fluids. In some embodiments, uniform contact implies that a liquid resource from which lithium is extracted uniformly contacts an ion exchange material which absorbs lithium while releasing protons.

Optimizing the performance parameters of lithium recovery is advantageous for lithium production from liquid resources using ion exchange processes that utilize one or more ion exchange materials. Disclosed herein are methods and systems for optimizing the performance parameters of lithium recovery using ion exchange materials that comprise lithium-selective sorbents by adjusting the concentration of lithium and pH of a liquid resource to be placed in contact with the ion exchange material. Adjusting the concentration of lithium in a liquid resource may yield a concentration-adjusted liquid resource according to some embodiments.

Adjusting the concentration of lithium in a liquid resource may result in the most optimal utilization of an ion exchange material utilized for lithium recovery and helps ensure a prolonged lifetime of the ion exchange material. In some embodiments, the concentration of lithium in a liquid resource may be increased to result in the most optimal utilization of an ion exchange material. In some embodiments, the concentration of lithium in a liquid resource may be decreased to result in the most optimal utilization of an ion exchange material. In some embodiments, the pH of the liquid resource may be adjusted in addition to the concentration of lithium in a liquid resource to result in the most optimal utilization of an ion exchange material.

In some embodiments, the most optimal utilization of an ion exchange material may result in improved or optimized performance parameters for lithium recovery. In some embodiments, improved or optimized performance parameters comprise a longer useful lifetime of the ion exchange material used in the methods and systems described herein. In some embodiments, improved or optimized performance parameters comprise a higher lithium production rate for flow of the same amount of liquid resource across the ion exchange material used in the methods and systems described herein. In some embodiments, improved or optimized performance parameters comprise a higher lithium purity of the lithium provided by the ion exchange material used in the methods and systems described herein. In some embodiments, improved or optimized performance parameters comprise a greater quantity of lithium provided by a given quantity of ion exchange material over its useful lifetime when the ion exchange material is used according to the methods and systems described herein. In some embodiments, improved or optimized performance parameters comprise an increase in overall lithium recovery.

System for Extracting Lithium from a Liquid Resource

In one aspect described herein, is a system for lithium recovery from a liquid resource comprising an ion exchange device wherein one or more vessels are independently configured to simultaneously accommodate porous ion exchange beads moving in one direction and alternately acid, liquid resource, and optionally other process fluids moving in the net opposite direction. This lithium recovery system produces an eluate that comprises lithium and optionally contains other ions.

In one aspect described herein, is an ion exchange device for lithium recovery from a liquid resource comprising a stirred tank reactor, an ion exchange material, and a pH modulating unit for increasing the pH of the liquid resource in the stirred tank reactor.

In one aspect described herein, is an ion exchange device for lithium recovery from a liquid resource comprising a stirred rank reactor, an ion exchange material, a pH modulating unit for increasing the pH of the liquid resource in the stirred tank reactor, and a compartment for containing the ion exchange material in the stirred tank reactor while allowing for removal of liquid resource, washing fluid, acid, and other process fluids from the stirred tank reactor.

In one embodiment, at least one of the one or more vessels are fitted with a conveyer system suitably outfitted to move porous ion exchange beads upward and simultaneously allow a net flow of acid, liquid resource, and optionally other process fluids, downward. In one embodiment, the conveyor system comprises fins with holes. In one embodiment, the fins may slide upward over a sliding surface that is fixed in place In one embodiment, all of the one or more vessels are fitted with a conveyor system suitably outfitted to move porous ion exchange beads upward and simultaneously allow a net flow of acid, liquid resource, and optionally other process solutions, downward. In one embodiment, there are an even number of vessels. In one embodiment, there are an odd number of vessels. In one embodiment, the vessels are columns.

In some embodiments, structures with holes are used to move the ion exchange material through one or more vessels. In some embodiments, the holes in the structures with holes may be less than 10 microns, less than 100 microns, less than 1,000 microns, or less than 10,000 microns in diameter. In some embodiments, the structures with holes may be attached to a conveyer system. In some embodiments, the structures with holes may comprise a porous compartment, porous partition, or another porous structure. In some embodiments, the structures with holes may contain abed of fixed or fluidized ion exchange material. In some embodiments, the structures with holes may contain ion exchange material while allowing liquid resource, aqueous solution, acid solution, or other process fluids to pass through the structures with holes.

In some embodiments, the porous ion exchange beads comprise one or more ion exchange materials that reversibly exchange lithium and hydrogen and a structural matrix material sufficient to form and support a pore network. In some embodiments, the liquid resource comprises a natural brine, a dissolve salt flat, a concentrated brine, a processed brine, a filtered brine, a liquid from an ion exchange process, a liquid from a solvent extraction process, a synthetic brine, leachate from ores, leachate from minerals, leachate from clays, leachate from recycled products, leachate from recycled materials, or combinations thereof.

### Ion Exchange Devices

In some embodiments, an ion exchange device comprises a column loaded with ion exchange material, or a form thereof, or a construct comprised thereof. In some embodiments, a pH modulating unit is connected to an ion exchange device loaded with ion exchange material. In some embodiments, the pH modulating unit comprises one or more tanks.

In some embodiments, an ion exchange device comprises a vessel loaded with ion exchange material, or a form thereof, or a construct comprised thereof. In some embodiments, the pH modulating unit is in fluid communication with the vessel loaded with ion exchange material.

In some embodiments, an ion exchange device comprises one or more columns loaded with a fixed or fluidized bed of ion exchange beads. In some embodiments, a column comprises a cylindrical construct with an inlet and an outlet. In some embodiments, a column comprises a non-cylindrical construct with an inlet and an outlet. In some embodiments, a column comprises inlets and outlets for pumping of the liquid resource and other process fluids, and additional doors or hatches for loading and unloading ion exchange beads to and from the column. In some embodiments, the column comprises one or more security devices to decrease the risk of theft of the ion exchange beads the column may contain. In some embodiments, ion exchange beads comprise one or more ion exchange materials that can reversibly absorb lithium from a liquid resource and release lithium in an eluent. In some embodiments, the ion exchange material is comprised of ion exchange particles that are optionally protected with coating material such as SiO₂, ZrO₂, TiO₂, polyvinyl chloride, or polyvinyl fluoride to limit dissolution or degradation of the ion exchange material. In some embodiments, the ion exchange beads comprise a structural matrix material such as an acid-resistant polymer that binds the ion exchange material. In some embodiments, the ion exchange beads contain pores that facilitate penetration of liquid resource, acid, aqueous solutions, and other process fluids into the ion exchange beads to, for example, deliver lithium and hydrogen to and from the bead or to wash the bead. In one embodiment, the pores of the ion exchange beads are structured to form a connected network of pores with a distribution of pore sizes. In one embodiment, the pores of the ion exchange beads are structured by incorporating filler materials into the ion exchange beads during production and later removing the filler material using a liquid or gas.

### Recirculating Batch System

In one embodiment of a system for lithium recovery from a liquid resource comprises a recirculating batch system comprising a column containing ion exchange material that is connected to one or more tanks for mixing base into the liquid resource, settling out any precipitates that may form following base addition to the liquid resource, and storing the liquid resource prior to reinjection of the liquid resource into the column or the one or more tanks. In one embodiment of the recirculating batch system, the liquid resource is loaded into the one or more tanks, pumped through the column, pumped through the one or more tanks, and then returned to the column in a loop. In one embodiment, the liquid resource optionally traverses this loop repeatedly. In one embodiment, the liquid resource is configured to recirculate through the column to enable lithium uptake by the ion exchange material. In one embodiment, base is added to the liquid resource such that the pH of the liquid resource adjusted to be within a range that is ideal, preferred, or suitable for lithium uptake by ion exchange material. In one embodiment, base is added to the liquid resource such that the pH of the liquid resource is adjusted to be within a range that minimizes the amount of precipitates in the column.

In one embodiment, as the liquid resource is pumped through the recirculating batch system, the pH of the liquid resource drops in the column due to hydrogen release from the ion exchange material during lithium uptake, and the pH of the liquid resource is adjusted upward by the addition of base as a solid, aqueous solution, or another form. In one embodiment, the column drives the ion exchange reaction to near completion, and the pH of the liquid resource leaving the column approaches the pH of the liquid resource entering the column. In one embodiment, the amount of base added to the liquid resource in the column is modulated to neutralize the hydrogen released by the ion exchange material while preventing the formation of precipitates. In one embodiment, an excess of base or a transient excess of base is added to the liquid resource in the column in such a way that precipitates form. In one embodiment, precipitates form transiently in the column and then are redissolved partially or fully by the hydrogen that is released from the ion exchange material within the column. In some embodiments of a system for lithium recovery from a liquid resource, base is added to the liquid resource prior to the liquid resource entering the column, after the liquid resource has exited the column, prior to the liquid resource entering one or more tanks, or after the liquid resource has exited one or more tanks.

In one embodiment of the recirculating batch system, the one or more tanks comprise a mixing tank where base is mixed with the liquid resource. In one embodiment, the one or more tanks comprise a settling tank, wherein precipitates such as Mg(OH)₂ optionally settle to the bottom of the settling tank to avoid injection of the precipitates into the column. In one embodiment, the one or more tanks comprise a storage tank wherein the liquid resource is stored prior to reinjection into the ion exchange column, mixing tank, settling tank, or other one or more tanks. In one embodiment, the one or more tanks comprise an acid recirculation tank. In one embodiment, one or more tanks in the recirculating batch system may serve a combination of purposes including as a base mixing tank, a settling tank, a acid recirculation tank, or a storage tank. In any embodiment, any one or more tanks may not fulfill two functions at the same time. As one example, a tank may not simultaneously fulfill the functions of a mixing tank and a settling tank.

In some embodiments, the recirculating batch system comprises a mixing tank that comprises a continuous stirrer. In some embodiments, the recirculating batch system is configured such that liquid resource and base or a combination thereof may be added to the mixing tank. In some embodiments, the continuous stirrer may comprise a static mixer, a paddle mixer, or a turbine impeller mixer. In some embodiments, the continuous stirrer may comprise the mixing tank being configured such that liquid resource and base input at the to p of the tank become mixed prior to reaching the bottom of the mixing tank. In some embodiments, the base is added to the mixing tank as a solid or as an aqueous solution. In some embodiments, the base is added to the mixing tank continuously at a constant rate or at a variable rate. In one embodiment, the base is added to the mixing tank discretely in constant or variable aliquots or batches. In one embodiment, the quantity of base added to the mixing tank corresponds to the measurement of one or more pH meters, which optionally sample liquid resource downstream of the ion exchange device or elsewhere in the recirculating batch system. In one embodiment, filters are optionally used to prevent precipitates from leaving the mixing tank. In one embodiment, the filters are optionally plastic mesh screens, packed columns containing granular media such as sand, silica, or alumina, packed columns containing porous filter media, or a membrane.

In one embodiment of the recirculating batch system, the settling tank is optionally a settling tank with influent at bottom and effluent at to p or a settling tank with influent on one end and effluent on another end. In one embodiment, chambered weirs are used to fully settle precipitates before liquid resource is recirculated into a reactor. In one embodiment, solid precipitates are collected at the bottom of the settling tank and recirculated into the mixing tank. In one embodiment, precipitates such as Mg(OH)₂ settle near the bottom of the settling tank. In one embodiment, liquid resource is removed from the to p of the settling tank, preferably wherein the amount of suspended precipitates is minimal. In one embodiment, the precipitates settle under forces such as gravity, centrifugal action, or other forces. In one embodiment, filters are used to prevent precipitates from leaving the settling tank. In one embodiment, the filters are plastic mesh screens, small packed columns containing granular media such as sand, silica, or alumina, small packed columns containing porous media filter, or a membrane. In one embodiment, baffles are optionally used to ensure settling of the precipitate and to prevent the precipitate from exiting the settling tank and entering the column.

In one embodiment of the recirculating batch system, precipitates are collected from the settling tank and combined with the liquid resource in a mixing tank or elsewhere to adjust the pH of the liquid resource.

In one embodiment of the recirculating batch system, one or more ion exchange columns are optionally connected to one or more tanks or set of tanks. In one embodiment of the recirculating batch system, there are multiple ion exchange columns recirculating liquid resource through a shared set of mixing, settling, and storage tanks. In one embodiment of the recirculating batch system, there is optionally one ion exchange column recirculating liquid resource through multiple sets of mixing, settling, and storage tanks.

### Column Interchange System

An aspect of the invention described herein is a system wherein ion exchange material is loaded into a plurality of columns. In some embodiments, the pH modulating unit comprises a plurality of tanks connected to the plurality of columns, wherein each of the plurality of tanks is immediately connected to one of the plurality of columns. In some embodiments, two or more of the plurality of tanks connected to the plurality of columns forms at least one circuit. In some embodiments, three or more of the plurality of tanks connected to the plurality of columns forms at least two circuits. In some embodiments, three or more of the plurality of tanks connected to the plurality of columns forms at least three circuits. In some embodiments, at least one circuit is a liquid resource circuit. In some embodiments, at least one circuit is a water washing circuit. In some embodiments, at least one circuit is an acid circuit, wherein the acid may be an acid eluent. In some embodiments, at least two circuits are water washing circuits.

In one embodiment of a system for lithium recovery, the system comprises a column interchange system wherein a series of columns are connected to form a liquid resource circuit, an acid circuit, a water washing circuit, and optionally other circuits containing process fluids. In one embodiment of the liquid resource circuit, liquid resource flows through a first column in the liquid resource circuit, then into a next column in the liquid resource circuit, and so on, such that lithium is removed from the liquid resource by ion exchange as the liquid resource flows through one or more columns that contain ion exchange material. In one embodiment of the liquid resource circuit, base is added to the liquid resource before or after each column or selected columns in the liquid resource circuit to maintain the pH of the liquid resource in an ideal, preferred, or suitable range for lithium uptake by ion exchange material. In one embodiment of the acid circuit, acid flows through a first column in the acid circuit, then into a next column in the acid circuit, and so on, such that lithium is eluted from the columns with acid eluent to produce a synthetic lithium solution. In one embodiment of the acid circuit, acid flows through a first column in the acid circuit, then optionally into a next column in the acid circuit, and so on, such that lithium is eluted from the columns with acid eluent to produce a synthetic lithium solution. In one embodiment of the water washing circuit, water flows through a first column in the water washing circuit, then optionally into a next column in the water washing circuit, and so on, such that liquid resource or raffinate in the void space, pore space, or head space of the columns and the ion exchange material therein is washed out.

In one embodiment of the column interchange system, columns are interchanged such that each column may be a fluid component of the liquid resource circuit, the water washing circuit, and the acid circuit at selected stages or points in time. In one embodiment, the ion exchange material within the first column of the liquid resource circuit are loaded with lithium by passing a sufficient quantity of liquid resource through the first column, and then the first column is interchanged be a fluid component of the water washing circuit to remove liquid resource and/or raffinate from the void space, pore space, or head space of the first column and the ion exchange material therein. In one embodiment, the first column in the water washing circuit is washed to remove liquid resource and/or raffinate therein, and then the first column is interchanged to be a fluid component of the acid circuit, wherein lithium is eluted from the ion exchange material in the column with acid to yield a synthetic lithium solution. In one embodiment, acid or acid eluent is passed through the first column in the acid circuit and then then interchanged to be a fluid component of the liquid resource circuit, wherein the ion exchange material inside the column may absorb lithium from the liquid resource. In one embodiment of the column interchange system, two water washing circuits are used to wash the columns after both the brine circuit and the acid circuit. In one embodiment of the column interchange system, the columns are interchanged to be a fluid component of the water washing circuit only after the columns have been a fluid component of the liquid resource circuit, such that a column that is a fluid component of the acid circuit is not typically interchanged to be a fluid component of the water washing circuit. In some embodiments of the column interchange system, excess acid in the column after a column has been a fluid component of the acid circuit is typically neutralized once the column is interchanged to be a fluid component of the liquid resource circuit and liquid resource is flowed through the column.

In one embodiment of the column interchange system, the first column in the liquid resource circuit is interchanged to become the last column in the water washing circuit. In one embodiment of the column interchange system, the first column in the water washing circuit is interchanged to become the last column in the acid circuit. In one embodiment of the column interchange system, the first column in the acid circuit is interchanged to become the last column in the liquid resource circuit.

In one embodiment of the column interchange system, each column in the liquid resource circuit contains one or more tanks or junctions that allow for adding base into the liquid resource and optionally settling any precipitates that may form following base addition to the liquid resource. In one embodiment of the column interchange system, each column in the liquid resource circuit has an associated one or more tanks or junctions for removing precipitates or other particles via settling or filtration. In one embodiment of the column interchange system, each column or plurality of columns has an associated one or more settling tanks or filters that remove particulates including particulates that detach from ion exchange material, forms thereof, or constructs comprised thereof.

In one embodiment of the column interchange system, the liquid resource circuit may comprise a number of the columns that is optionally less than about 3, less than about 10, less than about 30, or less than about 100. In one embodiment of the column interchange system, the acid circuit may comprise a number of the columns that is optionally less than about 3, less than about 10, less than about 30, or less than about 100. In one embodiment of the column interchange system, the water washing circuit may comprise a number of the columns that is optionally less than about 3, less than about 10, less than about 30, or less than about 100. In certain embodiments, the liquid resource circuit comprises a number of columns in the inclusive range of 1 to 10. In certain embodiments, the acid circuit comprises a number of columns in the inclusive range of 1 to 10. In certain embodiments, the water washing circuit comprises a number of columns in the inclusive range of 1 to 10.

In one embodiment of the column interchange system, the column interchange system comprises one or more liquid resource circuits, one or more acid circuits, and one or more water washing circuits. In one embodiment of the column interchange system, the ion exchange material within the columns may be removed and replaced with a separate portion of ion exchange material without interruption to operation of the circuits within the column interchange system. In one embodiment of the column interchange system, the ion exchange material within the columns may be removed following its useful lifetime and replaced with a separate portion of ion exchange material that is within its useful lifetime without interruption to operation of the circuits within the column interchange system.

In one embodiment of the column interchange system, the columns contain fluidized beds of ion exchange material. In one embodiment of the column interchange system, the columns comprise means of fluidizing or maintaining the fluidity of a bed of ion exchange material. In some embodiments, means of fluidizing or maintaining the fluidity of a bed of ion exchange material may comprise one or more overhead stirrers and/or one or more pumps. In one embodiment of the column interchange system, the columns contain fluidized beds of ion exchange material.

In one embodiment of a system for lithium recovery, ion exchange material is loaded into columns and following the uptake of lithium from a liquid resource by the ion exchange material, lithium is eluted from the column using an acid recirculation loop. In one embodiment of the acid recirculation loop, acid is flowed through an ion exchange column, into a tank, and then recirculated through the ion exchange column to optimize lithium elution. In some embodiments of the ion exchange system, ion exchange material is loaded into ion exchange columns and following lithium uptake from liquid resource, lithium is eluted from each ion exchange column using a once-through flow of acid. In some embodiments of the ion exchange system, ion exchange material is loaded into an ion exchange column and following lithium uptake from liquid resource, lithium is eluted from the ion exchange column using a column interchange circuit.

In some embodiments of the ion exchange system, ion exchange columns are loaded with lithium by flowing liquid resource through the columns using a recirculating batch system and then lithium is eluted from the columns using a column interchange system. In some embodiments of the ion exchange system, ion exchange columns are loaded with lithium by flowing liquid resource through the columns using a column interchange system and then lithium is eluted from the columns using a recirculating batch system. In some embodiments of the ion exchange system, ion exchange columns are loaded with lithium by flowing liquid resource through the columns using a recirculating batch system and then lithium is eluted from the columns using a recirculating batch system. In some embodiments of the ion exchange system, ion exchange columns are loaded with lithium by flowing liquid resource through the columns using a column interchange system and then lithium is eluted from the columns using a column interchange system.

### Stirred Tank System

An aspect of the invention described herein is a system for lithium recovery wherein the pH modulating unit is a tank comprising: a) one or more compartments; and b) means for moving the liquid resource through the one or more compartments. In an embodiment, ion exchange material is loaded in at least one compartment of the pH modulating unit. In an embodiment, the means for moving the liquid resource through the one or more compartments is a pipe. In a further embodiment, the means for moving the liquid resource through the one or more compartments is a pipe and suitably a configured pump. In an embodiment, the tank further comprises a means for circulating the liquid resource throughout the tank. In an embodiment, the means for circulating the liquid resource throughout the tank is a mixing device. In an embodiment, the tank further comprises an injection port. In some embodiments, the tank further comprises one or more injection ports. In some embodiments, the tank further comprises a plurality of injection ports.

An aspect described herein is a system for lithium recovery from a liquid resource comprising a tank, wherein the tank further comprises: a) one or more compartments; b) ion exchange material; c) a mixing device; and d) a pH modulating unit for adjusting the pH of the liquid within the system, wherein the ion exchange material is used to extract lithium ions from the liquid resource in an ion exchange process. In one embodiment, the pH modulating unit adjusts the pH of the liquid resource in the system. In some embodiments, ion exchange material is loaded into at least one of the one or more compartments of the tank. In some embodiments, the ion exchange material is fluidized in at least one of the one or more compartments of the tank. In some embodiments, the ion exchange material is non-fluidized in at least one of the one or more compartments of the tank. In some embodiments, the ion exchange material occupies a fixed position in at least one of the one or more compartments of the tank.

In some embodiments, the pH modulating unit comprises a pH measuring device and an inlet for adding base to a liquid inside the pH modulating unit. In some embodiments, the pH measuring device is a pH probe. In some embodiments, the inlet is a pipe. In some embodiments, the inlet is an injection port.

In some embodiments, the tank further comprises a porous partition. In some embodiments, the porous partition is a porous polymer partition. In some embodiments, the porous partition is a mesh or membrane. In some embodiments, the porous partition is a polymer mesh or polymer membrane. In some embodiments, the porous partition comprises one or more layers of mesh, membrane, or other porous structure. In some embodiments, the porous partition comprises one or more coarse meshes that provide structural support and one or more fine meshes and/or membranes selected to enable filtration or a filtering action. In some embodiments, the porous partition comprises a polyether ether ketone mesh, a polypropylene mesh, a polyethylene mesh, a polysulfone mesh, a polyester mesh, a polyamide mesh, a polytetrafluoroethylene mesh, an ethylene tetrafluoroethylene polymer mesh, a stainless steel mesh, a stainless steel mesh coated in polymer, a stainless steel mesh coated in ceramic, or a combination thereof, wherein the mesh is a course mesh, a fine mesh, or a combination thereof. In some embodiments, the porous polymer partition comprises a mesh comprising one or more blends of two or more of a polyether ether ketone, a polypropylene, a polyethylene, a polysulfone, a polyester, a polyamide, a polytetrafluoroethylene, or an ethylene tetrafluoroethylene polymer. In some embodiments, the porous partition comprises a polyether ether ketone membrane, a polypropylene membrane, a polyethylene membrane, a polysulfone membrane, a polyester membrane, a polyamide membrane, a polytetrafluoroethylene membrane, an ethylene tetrafluoroethylene polymer membrane, or combinations thereof.

In some embodiments of a system for lithium recovery from a liquid resource, the system comprises a stirred tank system comprised of a tank containing liquid resource and permeable bead compartments such as permeable pallets, cases, boxes, or other containers, wherein the bead permeable compartments are loaded with ion exchange beads and the liquid resource is added to, stirred throughout, and removed from the tank in a batch process. In one embodiment of the stirred tank system, base may be added directly to the tank gradually, in separate aliquots, at a constant rate or a variable rate, or in a single aliquot as a solid or in an aqueous solution. In some embodiments, the stirred tank system is configured to operate in a batch process, wherein the batch process comprises an extraction stage and an elution stage. In some embodiments, the extraction stage comprises the uptake of lithium from the liquid resource by the ion exchange beads within the permeable bead compartments, such that the liquid resource becomes depleted in lithium and the ion exchange beads become enriched in lithium. In some embodiments, the elution stage comprises the release of lithium from the ion exchange beads within the permeable bead compartments into an eluent. In some embodiments an eluent is an acid or an acid eluent. In one embodiment, the stirred tank system comprises one or more additional tanks and the permeable bead containers are placed into the one or more additional tanks for the elution stage. In one embodiment of the stirred tank system, the permeable bead compartments are located at the bottom of the tank during the extraction stage, and after the extraction stage is completed, the liquid resource is removed, and the tank is filled eluent in such a way that the permeable bead compartments are in contact with a volume of eluent that is sufficient to carry out the elution stage.

In some embodiments of a system for lithium recovery from a liquid resource, the system comprises a stirred tank system wherein ion exchange beads are suspended using plastic structural supports in a tank with an internal mixing device. In some embodiments, the stirred tank system is configured to operate in a batch process, wherein the batch process comprises an extraction stage and an elution stage. In some embodiments, the extraction stage comprises the uptake of lithium from the liquid resource by the ion exchange beads, such that the liquid resource becomes depleted in lithium and the ion exchange beads become enriched in lithium. In some embodiments, the elution stage comprises the release of lithium from the ion exchange beads into an eluent. In some embodiments an eluent is an acid or an acid eluent. In one embodiment of the stirred tank system, liquid resource is removed from the tank and passed through a column wherein hydrogen ions in the liquid resource are neutralized using base provided as a solution, as a solid, or as an ion exchange resin to yield a pH-corrected stream. In some embodiment, the pH-corrected stream is input back into the stirred tank system. In one embodiment of the stirred tank system, liquid resource that has passed through the tank containing ion exchange beads is returned to the opposite end of the tank through a pipe that is optionally internal or external to the tank. In one embodiment of the stirred tank system, base is optionally added to the liquid resource inside the tank or added to a separate base addition tank that is outside the tank.

In some embodiments of the stirred tank system, the stirred tank system is configured to operate in a continuous process instead of a batch process. In some embodiments, the continuous process comprises continuous addition and removal of liquid resource from the stirred tank system. In one embodiment of the recirculating batch system, the recirculating batch system is configured to operate in a continuous process instead of a batch process.

In one embodiment of the ion exchange device, liquid resource is combined with ion exchange beads in a stirred tank reactor. In one embodiment, the ion exchange beads may be comprised of coated particles, uncoated particles, porous beads, or combinations thereof.

In one embodiment of the ion exchange device, a stirred tank reactor is used to fluidize the ion exchange material in a liquid resource to enable absorption of lithium from the liquid resource into the ion exchange material. In one embodiment, a stirred tank reactor is used to fluidize the ion exchange material in a washing fluid to remove residual liquid resource, acid, process fluids, contaminants, or combinations thereof from the ion exchange materials. In one embodiment, a stirred tank reactor is used to fluidize the ion exchange material in an acid eluent to elute lithium from the ion exchange beads while replacing the lithium in the ion exchange material with protons. In one embodiment, a single stirred tank reactor is used to mix ion exchange material sequentially and repetitively with a liquid resource, washing fluid, and acid.

In some embodiments, the system for lithium recovery from a liquid resource comprises a tank, wherein the tank further comprises: a) one or more compartments; b) ion exchange material; c) a mixing device; and d) a pH modulating unit for changing the pH of the liquid resource in the system, wherein the ion exchange material is used to extract lithium ions from the liquid resource, further comprises another tank, wherein the other tank further comprises: a) one or more compartments; b) ion exchange beads; c) a mixing device; and d) a pH modulating unit for changing the pH of the liquid resource in the system. In some embodiments, the tank is in fluid communication with the other tank.

In some embodiments, the system for lithium recovery from a liquid resource comprises a tank, wherein the system further comprises another tank, wherein the other tank further comprises: a) one or more compartments; b) ion exchange material; c) a mixing device; and d) an acid inlet for adding acid to the system. In a further embodiment, the ion exchange material is moved between the tank and the other tank.

In some embodiments, the system for lithium recovery from a liquid resource comprises a tank, wherein the tank further comprises: a) one or more compartments; b) ion exchange material; c) a mixing device; and d) a pH modulating unit for changing the pH of the liquid resource in the system, wherein the ion exchange material is used to extract lithium ions from the liquid resource, further comprises a plurality of tanks, each tank further comprising: a) one or more compartments; b) ion exchange material; c) a mixing device; and d) a pH modulating unit for changing the pH of the liquid resource in the system. In some embodiments, each tank of the system is in fluid communication with each other tank of the system.

In some embodiments, the system further comprises another plurality of tanks, wherein each tank further comprises: a) one or more compartments; b) ion exchange material; and c) a mixing device.

In some embodiments, the system for lithium recovery from a liquid resource is configured to operate in a batch mode. In some embodiments, the system for lithium recovery from a liquid resource is configured to operate in a continuous mode. In some embodiments, the system for lithium recovery from a liquid resource is configured to operate in a batch mode and a continuous mode. In some embodiments, one or more tanks in the system for lithium recovery from a liquid resource are configured to operate in a batch mode and one or more tanks in the system are configured to operate in a continuous mode. In some embodiments, one or more tanks in the system for lithium recovery from a liquid resource are configured to operate in a batch mode and one or more tanks in the system are configured to operate in a semi-continuous mode. In some embodiments, one or more tanks in the system for lithium recovery from a liquid resource are configured to operate in a semi-continuous mode and one or more tanks in the system are configured to operate in a continuous mode. In some embodiments, one or more tanks in the system for lithium recovery from a liquid resource are configured to operate in a batch mode, one or more tanks in the system for lithium recovery from a liquid resource are configured to operate in a semi-continuous mode, and one or more tanks in the system are configured to operate in a continuous mode. In some embodiments, the system for lithium recovery from a liquid resource is configured to operate in a semi-continuous mode, a batch mode, a continuous mode, or combinations thereof.

In one embodiment of the system for lithium recovery from a liquid resource, a plurality of stirred tank reactors are used to mix ion exchange material with a liquid resource, washing fluid, and acid eluent. In one embodiment, the stirred tank reactors may be different sizes and may contain different volumes of a liquid resource, washing fluid, and acid eluent. In one embodiment, the stirred tanks may be cylindrical, conical, rectangular, pyramidal, or a combination thereof. In one embodiment of the system for lithium recovery from a liquid resource, the ion exchange material may move through the plurality of stirred tank reactors in the opposite direction of the liquid resource, the washing fluid, or the acid eluent.

In one embodiment of the system for lithium recovery from a liquid resource, a plurality of stirred tank reactors may be used where one or more stirred tank reactors mix the ion exchange material with a liquid resource, one or more stirred tank reactors mix the ion exchange material with a washing fluid, and one or more stirred tank reactors mix the ion exchange material with an acid eluent.

In one embodiment of the system for lithium recovery from a liquid resource, stirred tank reactors may be operated in a continuous, semi-continuous, or batch mode where a liquid resource flows continuously, semi-continuously, or batch-wise through the stirred tank reactor. In one embodiment of the system for lithium recovery from a liquid resource, stirred tank reactors may be operated in a continuous, semi-continuous, or batch mode where the ion exchange material flows continuously, semi-continuously, orb atch-wise through the stirred tank reactor. In one embodiment of the system for lithium recovery from a liquid resource, stirred tank reactors may be operated in a mode where the ion exchange material remain in the tank while flows of liquid resource, washing fluid, or acid eluent are flowed through the tank in continuous, semi-continuous, or batch flows.

In one embodiment, ion exchange material may be loaded into or removed from the stirred tank reactors through the to p, the bottom, or the side of the tank.

In one embodiment of the system for lithium recovery from a liquid resource, stirred tank reactors may comprise one or more compartments. In one embodiment, the compartments may contain ion exchange material in a bed that is fluidized, fixed, partially fluidized, partially fixed, alternatively fluidized, alternatively fixed, or combinations thereof. In one embodiment, the compartments may be comprised of a porous support at the bottom of the compartment, the sizes of the compartment, the to p of the compartment, or combinations thereof. In one embodiment, the compartments may be conical, cylindrical, rectangular, pyramidal, other shapes, or combinations thereof. In one embodiment, the compartment may be located at the bottom of the tank. In one embodiment, the shape of the compartment may conform to the shape of the stirred tank reactor. In one embodiment, the compartment may be partially or fully comprised of the tank of the stirred tank reactor.

In one embodiment, the compartment may be comprised of a porous structure. In one embodiment, the compartment may be comprised of a polymer, a ceramic, a metal, or combinations thereof. In one embodiment, the compartment may be comprised be comprised partially or fully of a porous material or a mesh. In one embodiment, the compartment may be at the to p of the tank. In one embodiment, the compartment may be separated from the rest of the tank with one or more porous materials. In one embodiment, the compartment may be at the to p of the tank. In one embodiment, the compartment may be separated from the rest of the tank with a bilayer mesh comprising one layer of coarse mesh for strength and one layer of fine mesh to contain smaller particles in the compartment. In one embodiment, the compartment may allow liquid or process fluid to flow freely through the stirred tank reactor and through the compartment. In one embodiment, the compartment may be open on the to p. In one embodiment, the compartment may contain the ion exchange material in the tank but allow the ion exchange material to move throughout the tank. In one embodiment, the compartment may comprise a majority or minority of the tank volume. In one embodiment, the compartment may represent a fraction of the volume of the tank that is greater than 1 percent, greater than 10 percent, greater than 50 percent, greater than 90 percent, greater than 99 percent, or greater than 99.9 percent. In one embodiment, one or more devices for stirring, mixing, or pumping may be used to move liquid or process fluid through the compartment, the stirred tank reactor, or combinations thereof.

In one embodiment of the system for lithium recovery from a liquid resource, stirred tank reactors may be arranged into a network where flows of liquid resource, washing fluid, and acid are directed through different columns. In one embodiment, a network of stirred tank reactors may involve physical movement of the ion exchange material through the various stirred tank reactors. In one embodiment, a network of stirred tank reactors may involve no physical movement of the ion exchange material through the various stirred tank reactors. In one embodiment, a network of stirred tank reactors may involve switching of flows of liquid resource, washing fluid, and acid through the various stirred tank reactors. In one embodiment, liquid resource may into stirred tank reactors in continuous or batch mode. In one embodiment, liquid resource may be mixed with ion exchange material in one or more reactors before exiting the system. In one embodiment, a network of stirred tank reactors may involve a liquid resource circuit with counter-current exposure of ion exchange material to flows of liquid resource. In one embodiment, a network of stirred tank reactors may involve a washing circuit with counter-current exposure of ion exchange material to flows of washing fluid. In one embodiment, a network of stirred tank reactors may involve an acid circuit with counter-current exposure of ion exchange material to flows of acid. In one embodiment, the washing fluid may be water, an aqueous solution, or a solution containing an anti-scalant.

In one embodiment of the stirred tank reactor, acid is added at the beginning of elution of lithium from the ion exchange material. In one embodiment of the stirred tank reactor, acid is added at the beginning of elution of lithium from the ion exchange material and again during elution of lithium from the ion exchange material. In one embodiment of the stirred tank reactor, an acid of lower concentration is added at the start of elution of lithium from the ion exchange material and additional acid of higher concentration is added to continue elution of lithium from the ion exchange material.

An aspect described herein is a system for lithium recovery from a liquid resource, comprising: a) ion exchange material; b) a tank comprising one or more compartments; and c) a mixing device, wherein the ion exchange material is used to extract lithium ions from the liquid resource.

In some embodiments, the ion exchange material is loaded in at least one of the one or more compartments. In some embodiments, the ion exchange material is fluidized or partially fluidized in at least one of the one or more compartments. In some embodiments, the ion exchange material occupies a fixed position in at least one of the one or more compartments. In some embodiments, the ion exchange material is mounted in at least one of the one or more compartments.

An aspect described herein is a system for lithium recovery from a liquid resource, comprising: a) a column comprising ion exchange material; and b) a pH modulating unit for changing the pH of the liquid resource in the system for lithium recovery from a liquid resource, wherein the pH modulating unit is in fluid communication with the column, wherein the ion exchange material is used to extract lithium ions from the liquid resource.

### Other Types of Systems

An aspect described herein is a system for lithium recovery from a liquid resource, comprising: a) a plurality of columns, wherein each of the plurality of columns comprises ion exchange material; and b) a pH modulating unit for changing the pH of the liquid resource in the system, wherein the pH modulating unit is in fluid communication with each of the plurality of columns, wherein the ion exchange material is used to extract lithium ions from the liquid resource.

In some embodiments, the pH modulating unit comprises a plurality of tanks, wherein each of the plurality of tanks is immediately connected to one of the plurality of columns. In one embodiment, the pH modulating unit comprises a plurality of tanks, wherein each of the plurality of tanks is in immediate liquid communication with one of the plurality of columns. In some embodiments, two or more of the plurality of tanks connected to two or more of the plurality of columns forms at least one circuit. In some embodiments, two or more of the plurality of tanks connected to two or more of the plurality of columns forms at least two circuits. In some embodiments, three or more of the plurality of tanks connected to three or more of the plurality of columns forms at least two circuits. In some embodiments, three or more of the plurality of tanks connected to three or more of the plurality of columns forms at least three circuits.

In some embodiments, the pH modulating unit comprises a plurality of tanks, wherein each of the plurality of tanks is connected to the of the plurality of columns through a filtration system. In some embodiments, two or more of the plurality of tanks are connected to two or more of the plurality of columns through a filtration system to form at least one circuit. In some embodiments, two or more of the plurality of tanks are connected to two or more of the plurality of columns through a filtration system to form at least two circuits. In some embodiments, three or more of the plurality of tanks are connected to two or more of the plurality of columns through a filtration system to form at least two circuits. In some embodiments, three or more of the plurality of tanks are connected to two or more of the plurality of columns through a filtration system to form at least three circuits.

In some embodiments, the filtration system comprises a bag filter, a candle filter, a cartridge filter, a media filter, a depth filter, a sand filter, a membrane filter, an ultrafiltration system, a microfiltration filter, a nanofiltration filter, a cross-flow filter, a dead-end filter, a drum filter, a filter press, or a combination thereof. In some embodiments, the filtration system comprises one or more perforated outer walls that are an optional component of any one or more tanks, such that a liquid resource or process fluid on one side of the perforated outer wall is filtered when passed through the perforated outer wall. In some embodiments, the perforated outer wall comprises an insert that may be placed into a tank, wherein liquid resource provided to the tank through an inlet is filtered by the perforated outer wall prior to the liquid resource leaving the tank through an outlet. In some embodiments, the filter system comprises one or more filters that independently may have openings of an average size less than about 0.02 μm, less than about 0.1 μm, less than about 0.2 μm, less than about 1 μm, less than about 2 μm, less than about 5 μm, less than about 10 μm, less than about 25 μm, less than about 100 μm, less than about 1000 μm. In some embodiments, the openings in perforated outer walls are more than about 0.02 μm, more than about 0.1 μm, more than about 0.2 μm, more than about 1 μm, more than about 2 μm, more than about 5 μm, more than about 10 μm, more than about 25 μm, more than about 100 μm. In some embodiments, the openings in perforated outer walls are about 0.02 μm to about 0.1 μm, from about 0.1 μm to about 0.2 μm, from about 0.2 μm to about 0.5 μm, from about 0.5 μm to about 1 μm, from about 1 μm to about 5 μm, from about 5 μm to about 10 μm, from about 10 μm to about 25 μm, from about 25 μm to about 100 μm. In some embodiments, a filter, a perforated outer wall, or a means for filtering comprises low density polyethylene, high density polyethylene, polypropylene, polyester, polytetrafluoroethylene (PTFE), types of polyamide, polyether ether ketone (PEEK), polysulfone, polyvinylidene fluoride (PVDF), poly (4-vinyl pyridine-co-styrene) (PVPCS), polystyrene (PS), polybutadiene, acrylonitrile butadiene styrene (ABS), polyvinyl chloride (PVC), ethylene tetrafluoroethylene polymer (ETFE), poly(chlorotrifluoroethylene) (PCTFE), ethylene chlorotrifluoro ethylene (Halar), polyvinylfluoride (PVF), fluorinated ethylene-propylene (FEP), perfluorinated elastomer, chlorotrifluoroethylenevinylidene fluoride (FKM), perfluoropolyether (PFPE), perfluoro-3,6-dioxa-4-methyl-7-octene-sulfonic acid (NAFION® (copolymer of perfluoro-3,6-dioxa-4-methyl-7-octene-sulfonic acid and tetrafluoroethylene)), polyethylene oxide, polyethylene glycol, sodium polyacrylate, polyethylene-block-poly(ethylene glycol), polyacrylonitrile (PAN), polychloroprene (neoprene), polyvinyl butyral (PVB), expanded polystyrene (EPS), polydivinylbenzene, co-polymers thereof, mixtures thereof, or combinations thereof. In some embodiments, a filter, a perforated outer wall, or a means for filtering may comprise a coating material comprising polyvinylidene fluoride (PVDF), polyvinyl chloride (PVC), ethylene chlorotrifluoro ethylene (Halar), poly (4-vinyl pyridine-co-styrene) (PVPCS), polystyrene (PS), acrylonitrile butadiene styrene (ABS), expanded polystyrene (EPS), polyphenylene sulfide, sulfonated polymer, carboxylated polymer, other polymers, co-polymers thereof, mixtures thereof, or combinations thereof. In some embodiments, a filter, a perforated outer wall, or a means for filtering comprises iron, stainless steel, nickel, carbon steel, titanium, Hastelloy, Inconel, zirconium, tantalum, alloys thereof, mixtures thereof, or combinations thereof.

In some embodiments, at least one circuit is a liquid resource circuit. In some embodiments, at least one circuit is a water washing circuit. In some embodiments, at least two circuits are water washing circuits. In some embodiments, at least one circuit is an acid circuit.

An aspect described herein is a system for lithium recovery from a liquid resource comprising ion exchange material and a plurality of vessels, wherein each of the plurality of vessels is configured to transport the ion exchange material along the length of the vessel and the ion exchange material is used to extract lithium ions from the liquid resource. In some embodiments, at least one of the plurality of vessels comprises an acidic solution. In some embodiments, at least one of the plurality of vessels comprises the liquid resource. In some embodiments, each of the plurality of vessels is configured to transport the ion exchange beads by means of a pipe system or an internal conveyer system.

An aspect described herein is a system for lithium recovery from a liquid resource comprising ion exchange material and a plurality of columns, wherein each of the plurality of columns is configured to transport the ion exchange material along the length of the column and the ion exchange material is used to extract lithium ions from the liquid resource.

In some embodiments, at least one of the plurality of columns comprises an acidic solution. In some embodiments, at least one of the plurality of columns comprises the liquid resource. In some embodiments, each of the plurality of columns is configured to transport the ion exchange material by means of a pipe system or an internal conveyer system.

In some embodiments, the ion exchange beads comprise an ion exchange material in the form of ion exchange particles. In some embodiments, at least a portion of the ion exchange material is in the form of ion exchange particles. In some embodiments, the ion exchange particles are selected from uncoated ion exchange particles, coated ion exchange particles, and combinations thereof. In some embodiments, the ion exchange particles may be uncoated ion exchange particles. In some embodiments, the ion exchange particles may be coated ion exchange particles. In some embodiments, the ion exchange particles comprise a mixture of uncoated ion exchange particles and coated ion exchange particles.

In some embodiments, the coated ion exchange particles comprise an ion exchange material and a coating material. In some embodiments, coated ion exchange particles comprise a coating material. In some embodiments, the coating material of the coated ion exchange particles comprises a carbide, a nitride, an oxide, a phosphate, a fluoride, a polymer, carbon, a carbonaceous material, or combinations thereof. In some embodiments, the coating material of the coated ion exchange particles is selected from the group consisting of TiO₂, ZrO₂, MoO₂, SnO₂, Nb₂O₅, Ta₂O₅, SiO₂, Li₂TiO₃, Li₂ZrO₃, Li₂SiO₃, Li₂MnO₃, Li₂MoO₃, LiNbO₃, LiTaO₃, AlPO₄, LaPO₄, ZrP₂O₇, MoP₂O₇, Mo₂P₃O₁₂, BaSO₄, AlF₃, SiC, TiC, ZrC, Si₃N₄, ZrN, BN, carbon, graphitic carbon, amorphous carbon, hard carbon, diamond-like caibon, solid solutions thereof, and combinations thereof.

In some embodiments, the ion exchange material of the coated ion exchange particles comprises an oxide, a phosphate, an oxyfluoride, a fluorophosphate, or combinations thereof. In some embodiments, the ion exchange material of the coated ion exchange particles is selected from the group consisting of Li₄Mn₅O₁₂, Li₄Ti₅O₁₂, Li₂TiO₃, Li₂MnO₃, Li₂SnO₃, LiMn₂O₄, Li_{1.6}Mn_{1.6}O₄, LiAlO₂, LiCuO₂, LiTiO₂, Li₄TiO₄, Li₇Ti₁₁O₂₄, Li₃VO₄, Li₂Si₃O₇, LiFePO₄, LiMnPO₄, Li₂CuP₂O₇, Al(OH)₃, LiCl·xAl(OH)₃·yH₂O, SnO₂·xSb₂O₅·yH₂O, TiO₂·xSb₂O₅·yH₂O, solid solutions thereof, and combinations thereof, wherein x is from 0.1-10; and y is from 0.1-10.

In some embodiments, the uncoated ion exchange particles comprise an ion exchange material. In some embodiments, the ion exchange material of the uncoated ion exchange particles comprises an oxide, a phosphate, an oxyfluoride, a fluorophosphate, or combinations thereof. In some embodiments, the ion exchange material of the uncoated ion exchange particles is selected from the group consisting of Li₄Mn₅O₁₂, Li₄Ti₅O₁₂, Li₂TiO₃, Li₂MnO₃, Li₂SnO₃, LiMn₂O₄, Li_{1.6}Mn_{1.6}O₄, LiAlO₂, LiCuO₂, LiTiO₂, Li₄TiO₄, Li₇Ti₁₁O₂₄, Li₃VO₄, Li₂Si₃O₇, LiFePO₄, LiMnPO₄, Li₂CuP₂O₇, Al(OH)₃, LiCl·xAl(OH)₃·yH₂O, SnO₂·xSb₂O₅·yH₂O, TiO₂·xSb₂O₅·yH₂O, solid solutions thereof, and combinations thereof; wherein x is from 0.1-10; and y is from 0.1-10.

In some embodiments, the ion exchange beads are porous. In some embodiments, the porous ion exchange beads comprise a network of pores that allows liquids, such as process fluids, to move quickly from the surface of the porous ion exchange beads to a plurality of ion exchange particles comprised therein. In some embodiments, a porous ion exchange beads comprise a network of pores that allows a liquid, such as a process fluid, to move from the surface of the porous ion exchange beads to a plurality of ion exchange particles comprised therein. In some embodiments, the porous ion exchange beads comprise a network of pores that allows a liquid to move quickly from the surface of the porous ion exchange bead to a plurality of ion exchange particles comprised therein. In some embodiments, a single ion exchange bead may comprise a network of pores and an ion exchange material in the form of a plurality of ion exchange particles, wherein the ion exchange particles are individually coated or uncoated. In some embodiments, ion exchange beads may comprise a structural matrix material. In some embodiments, a network of pores comprises a structural matrix material. In some embodiments, a structural matrix material is a material that allows for a network of pores to be formed and maintained. In some embodiments, a structural matrix material is a polymer or mixture of polymers.

An aspect of the disclosure described herein is a system for lithium recovery from a liquid resource that may comprise a column, wherein the column further comprises a plurality of injection ports, wherein the plurality of injection ports are used to increase the pH of the liquid resource in the system.

In one embodiment of the system for lithium recovery from a liquid resource, the system is a mixed base system comprising a column and a mixing chamber where base is mixed into the liquid resource immediately prior to injection of the liquid resource into the column.

In one embodiment of the system for lithium recovery from a liquid resource, the system is a ported column system with multiple ports for injection of aqueous solutions of base, wherein the ports are spaced at intervals along the direction of flow of liquid resource through the column. As liquid resource flows through the column, there is a region of the column where the ion exchange material experiences the greatest rate of lithium absorption, and this region moves through the column over time in the direction of liquid resource flow. In some embodiments of the ported column system, base may be injected near the region of the column where the ion exchange material experiences the greatest rate of lithium absorption to neutralize protons released by the ion exchange material. In some embodiments, in regions of the columns where the ion exchange material is enriched in lithium and the rate of release of protons therefrom has slowed, the quantity of base injected into the column may be decreased or terminated to avoid formation of precipitates.

### pH Modulation

In one embodiment of the system for lithium recovery from a liquid resource, the system has a moving bed of ion exchange material that moves in a direction opposite to the direction of flow of liquid resource, wherein base may be injected at one or more fixed points near the region of the column where the ion exchange reaction is proceeding at a maximum rate to neutralize the protons released from the ion exchange material. In one embodiment of the system for lithium recovery from a liquid resource, the base added to the liquid resource may comprise NaOH, LiOH, KOH, Mg(OH)₂, Ca(OH)₂, CaO, NH₃, Na₂SO₄, K₂SO₄, NaHSO₄, KHSO₄, NaOCl, KOCl, NaClO₄, KClO₄, NaH₂BO₃, Na₂HBO₃, Na₃BO₃, KH₂BO₃, K₂HBO₃, K₃BO₃, MgHBO₃, CaHBO₃, NaHCO₃, KHCO₃, NaCO₃, KCO₃, MgCO₃, CaCO₃, Na₂O, K₂O, Na₂CO₃, K₂CO₃, Na₃PO₄, Na₂HPO₄, NaH₂PO₄, K₃PO₄, K₂HPO₄, KH₂PO₄, CaHPO₄, MgHPO₄, sodium acetate, potassium acetate, magnesium acetate, poly(vinylpyridine), poly(vinylamine), polyacrylonitrile, other bases, or combinations thereof. In one embodiment, the base may be added to the liquid resource in its pure form or as an aqueous solution. In one embodiment, the base may be added to the liquid resource in a gaseous state such as, in a non-limiting example, gaseous NH3. In one embodiment, the base may be added to the liquid resource in a steady stream, a variable stream, in steady aliquots, or in variable aliquots. In some embodiments, the base may be generated in the liquid resource in situ by using an electrochemical cell to remove H₂ and Cl₂ gases from the liquid resource. In some embodiments, H₂ and Cl₂ gases generated from a liquid resource using an electrochemical cell may be combined to create HCl acid for subsequent use in acid, acid eluent, or other process fluids.

In some embodiments, a solid base is mixed with a liquid resource to create a basic solution. In some embodiments, a solid base is mixed with a liquid resource to create a basic solution, and the resulting basic solution is added to a second volume of a liquid resource to increase the pH of the second volume of a liquid resource. In some embodiments, solid base is mixed with a liquid resource to create a basic solution, wherein the resulting basic solution is used to adjust or control the pH of a second solution. In some embodiments, a solid base is mixed with a liquid resource to create a basic slurry. In some embodiments, a solid base is mixed with a liquid resource to create a basic slurry, and the resulting basic slurry is added to a second volume of a liquid resource to increase the pH of the second volume of a liquid resource. In some embodiments, solid base is mixed with a liquid resource to create a basic slurry, wherein the resulting basic slurry is used to adjust or control the pH of a second solution. In some embodiments, base may be added to a liquid resource as a mixture or slurry of base and liquid resource.

In one embodiment of the system for lithium recovery from a liquid resource, the liquid resource flows through a pH control column containing solid base particles that may comprise NaOH, CaO, or Ca(OH)₂, which dissolve into the liquid resource and raise the pH of the liquid resource. In some embodiments of the system for lithium recovery from a liquid resource, the liquid resource flows through a pH control column containing immobilized regeneratable hydroxyl-containing ion exchange resins which react with hydrogen ions, or regeneratable base species such as immobilized polypyridine that conjugates acid, thereby neutralizing acid in the liquid resource. When the ion exchange resin has been depleted of its hydroxyl groups or is fully conjugated with acid, it may be regenerated with a base such as NaOH.

In some embodiments of the system for lithium recovery from a liquid resource, pH meters may be installed in tanks, pipes, columns, and other components of the system to monitor pH and control the rates and amounts of base addition at various locations throughout the system.

In some embodiments of the system for lithium recovery from a liquid resource, the columns, tanks, pipes, and other components of the system are optionally constructed using plastic, metal with a plastic lining, or other materials that are resistant to corrosion by liquid resource, base, or acid.

In some embodiments of the system for lithium recovery from a liquid resource, the columns are optionally washed with water that is mildly acidic, optionally including a buffer, to remove any basic precipitates from the column prior to acid elution.

In some embodiments, after the ion exchange material within an ion exchange device becomes saturated or nearly saturated with lithium, the lithium is flushed out of the ion exchange device using acid. In some embodiments, the acid may be flowed through the ion exchange device one or more times to elute the lithium. In some embodiments, the acid may be flowed through the ion exchange device using a recirculating batch system that comprises the ion exchange device in fluid connection to a tank. In some embodiments, a recirculating batch system may comprise one or more tanks. In some embodiments, a tank within a recirculating batch system may comprise an ion exchange device. In some embodiments, the tank may be configured to accommodate a flow of liquid resource or acid. In some embodiments, a plurality of tanks may configured to accommodate a flow of acid flows in one or more tanks and a separate flow of liquid resource in a separate one or more tanks. In some embodiments, acid may be input into the to p of an ion exchange device, be allowed to percolate through the ion exchange device by means of a natural or applied force, and be immediately recirculated into the ion exchange device. In some embodiments, acid may be added to an ion exchange device without utilizing a tank configured to accommodate acid or a flow of acid.

In one embodiment of the system for lithium recovery from a liquid resource, the ion exchange device is may be washed with water after liquid resource and acid have been passed through the ion exchange device, wherein the effluent water produced by washing the ion exchange device with water may be treated using pH neutralization and reverse osmosis to yield water suitable for use as a process fluid.

In some embodiments of the system for lithium recovery from a liquid resource, the ion exchange device is optionally shaped like a cylinder, a rectangle, or another shape. In some embodiments, the ion exchange device optionally has a cylinder shape with a height that is greater or less than its diameter. In some embodiments, the ion exchange device may have a cylinder shape with a height that is less than 10 cm, less than 1 meter, or less than 10 meters. In some embodiments, the ion exchange device may have a cylinder shape with a diameter that is less than 10 cm, less than 1 meter, or less than 10 meters.

In some embodiments of the system for lithium recovery from a liquid resource, the system is optionally resupplied with ion exchange material by swapping out an ion exchange device with a new ion exchange device loaded with ion exchange material. In some embodiments of the system for lithium recovery from a liquid resource, the system is optionally resupplied with ion exchange material by removing ion exchange material from the ion exchange device and loading ion exchange material into the ion exchange device that does not comprise the removed ion exchange material. In some embodiments of the system for lithium recovery from a liquid resource, ion exchange material is resupplied to all ion exchange devices in the system simultaneously. In some embodiments of the system for lithium recovery from a liquid resource, ion exchange material may be resupplied to one or more ion exchange devices at a time. In one embodiment of the system for lithium recovery from a liquid resource, ion exchange material may be resupplied to one or more ion exchange devices without interrupting the operation of other ion exchange devices within the system.

In some embodiments of system for lithium recovery from a liquid resource, a point of lithium saturation may comprise a set of conditions wherein ion exchange material may be unable to extract lithium ions from liquid resource or extract lithium ions from liquid resource at an acceptable rate despite the liquid resource having a pH value and lithium concentration that are ideal, preferred, or suitable for the extraction of lithium therefrom by ion exchange material. In some embodiments of the system for lithium recovery from a liquid resource, pumping of the liquid resource may continue until the ion exchange material approaches a point of lithium saturation over a period of time that is optionally less than about 1 hours, less than about 2 hours, less than about 4 hours, less than about 8 hours, less than about 24 hours, less than about 48 hours, or less than about one week. In some embodiments of system for lithium recovery from a liquid resource, pumping of the liquid resource may continue until the ion exchange material approaches a point of lithium saturation over a period of time that is optionally greater than about one week. In some embodiments of system for lithium recovery from a liquid resource, pumping of the liquid resource may continue until the ion exchange material approaches a point of lithium saturation over a period of time that is optionally between 30 minutes and 24 hours.

In some embodiments of system for lithium recovery from a liquid resource, a point of hydrogen saturation may comprise a set of conditions wherein ion exchange material may be unable to extract hydrogen ions from acid at an acceptable rate despite the acid having a pH value that is ideal, preferred, or suitable for the extraction of hydrogen therefrom by ion exchange beads. In some embodiments of system for lithium recovery from a liquid resource, pumping of acid may continue until the ion exchange material approaches a point of hydrogen saturation over a period of time that is optionally less than about 1 hours, less than about 2 hours, less than about 4 hours, less than about 8 hours, less than about 24 hours, or less than about 48 hours. In some embodiments of system for lithium recovery from a liquid resource, pumping of acid may continue until the ion exchange material approaches a point of hydrogen saturation over a period of time that is optionally greater than about one 48 hours. In some embodiments of system for lithium recovery from a liquid resource, pumping of acid may continue until the ion exchange material approaches a point of hydrogen saturation over a period of time that is optionally between 30 minutes and 24 hours.

### Base and Acid Generation

In some embodiments of the methods and systems described herein, acid and base may be generated using an electrochemical cell. In some embodiments, acid and base are generated using an electrochemical cell that comprises electrodes. In some embodiments, acid and base are generated using an ion-conducting membrane. In some embodiments, the ion-conducting membrane is a cation-conducting membrane, an anion-conducting membrane or combinations thereof. In some embodiments, the ion-conducting membrane comprises sulfonated tetrafluoroethylene-based fluoropolymer-copolymer, sulfonated polytetrafluoroethylene, sulfonated fluoropolymer, MK-40, co-polymers, or combinations thereof.

In some embodiments, the ion-conducting membrane comprises a functionalized polymer structure. In some embodiments, the functionalized polymer structure comprises polyarylene ethers, polysulfones, polyether ketones, polyphenylenes, perfluorinated polymers, polybenzimidazole, polyepichlorohydrins, unsaturated polypropylene, polyethylene, polystyrene, polyvinylbenzyl chlorides, polyphosphazenes, polyvinyl alcohol, polytetrafluoroethylene, polyvinyl chloride, polyvinylidene fluoride, alterations of these polymers or other kinds of polymers, or composites thereof. In some embodiments, the ion-conducting membrane comprises a cation-conducting membrane that allows for transfer of lithium ions across the ion-conducting membrane but prevents transfer of anion groups across the ion-conducting membrane. In some embodiments, the ion-conducting membrane has a thickness from about 1 μm to about 1000 μm. In some embodiments, the ion-conducting membrane has a thickness from about 1 mm to about 10 mm.

In some embodiments, acid and base are generated using an electrochemical cell that comprises electrodes. In some embodiments, the electrodes may be comprised of titanium, niobium, zirconium, tantalum, magnesium, titanium dioxide, oxides thereof, or combinations thereof. In some embodiments, the electrodes may comprise a coating thereon of platinum, TiO₂, ZrO₂, Nb₂O₅, Ta₂O₅, SnO₂, IrO₂, RuO₂, mixed metal oxides, graphene, derivatives thereof, or combinations thereof.

In some embodiments of a system for lithium recovery from a liquid resource, a chlor-alkali plant may be used to generate HCl and NaOH from an aqueous NaCl solution. In some embodiments, the HCl generated by the chlor-alkali plant may be used as an acid or as an acid eluent. In some embodiments, the NaOH generated by the chlor-alkali plant may be used to adjust the pH of the liquid resource. In some embodiments, the NaOH generated by the chlor-alkali plant may be used to precipitate impurities from a synthetic lithium solution.

In some embodiments of a system for lithium recovery from a liquid resource, the system comprises one or more electrochemical or electrolysis systems. The terms “electrochemical” and “electrolysis” are used interchangeably in the present specification and these terms are synonymous unless specifically noted to the contrary. In some embodiments, an electrolysis system is comprised of one or more electrochemical cells. In some embodiments, an electrochemical system is used to produce HCl and NaOH. In some embodiments, an electrochemical system converts a salt solution into acid and base. In some embodiments, an electrochemical system converts a salt solution containing NaCl, KCl, and/or other chlorides into base and acid. In some embodiments, a salt solution comprising precipitates recovered from the liquid resource may be fed into an electrochemical system to produce acid and base. In some embodiments, an electrolysis system may convert a lithium salt solution to form a lithium hydroxide solution, an acidified solution, and optionally a dilute lithium salt solution. In some embodiments, the lithium salt solution comprises a synthetic lithium solution provided according to the methods and systems described herein that has optionally been concentrated and/or purified. In some embodiments, the acidified solution generated from an electrolysis system is provided to an ion exchange device to elute lithium in the form of a synthetic lithium solution.

In some embodiments, a lithium salt solution may comprise acid derived from an acid eluent or an ion exchange device. In some embodiments, acid in the lithium salt solution derived from an acid eluent or an ion exchange device may pass through an electrolysis system wherein the acid is further acidified to form an acidified solution. In some embodiments, a lithium salt solution derived may be purified to remove impurities without neutralizing the acid in the lithium salt solution prior to the lithium salt solution being fed into an electrolysis system.

In some embodiments, an acidified solution produced by an electrolysis system comprises lithium ions from the lithium salt solution fed into the electrolysis system. In some embodiments, an acidified solution comprising lithium ions leaves the electrolysis system and is provided to an ion exchange device to elute lithium in the form of a synthetic lithium solution.

In some embodiments of an electrolysis system, the electrolysis cells are electrochemical cells. In some embodiments of an electrochemical cell, the ion-conducting membranes may be cation-conducting and/or anion-conducting membranes. In some embodiments, the electrochemical cell is a two-compartment cell with a cation-conducting membrane that allows for transfer of lithium ions between the compartments but prevents transfer of anion groups such as chloride, sulfate, and hydroxide groups between the compartments.

In some embodiments of an electrolysis system, the electrolysis cells are electrodialysis cells. In some embodiments of an electrodialysis cell, the ion-conducting membranes may be cation-conducting and/or anion-conducting membranes. In some embodiments, the electrodialysis cell is a two-compartment cell with a cation-conducting membrane that allows for transfer of lithium ions between the compartments but prevents transfer of anion groups such as chloride, sulfate, and hydroxide groups between the compartments.

In some embodiments of an electrolysis system, the electrolysis cells are membrane electrolysis cells. In some embodiments of a membrane electrolysis cell, the ion-conducting membranes may be cation-conducting and/or anion-conducting membranes. In some embodiments, the membrane electrolysis cell is a two-compartment cell with a cation-conducting membrane that allows for transfer of lithium ions between the compartments but prevents transfer of anion groups such as chloride, sulfate, and hydroxide groups between the compartments.

In some embodiments, the membrane electrolysis cell is a three-compartment cell with a cation-conducting membrane that allows for transfer of lithium ions separating a compartment with an electrochemically reducing electrode from a central compartment and with an anion-conducting membrane that allows for transfer of anions separating a compartment with an electrochemically oxidizing electrode from the central compartment. In some embodiments, the cation-conducting membrane prevents transfer of anions such as chloride, sulfate, or hydroxide. In some embodiments, the anion-conducting membrane prevents transfer of cations such as lithium, sodium, or protons.

In some embodiments of the membrane electrolysis cell, the ion-conducting membranes may be comprised of Nafion®, sulfonated tetrafluoroethylene, sulfonated fluoropolymer, MK-40, co-polymers, other membrane materials, composites, or combinations thereof. In some embodiments of the membrane electrolysis cell, the cation-conducting membranes are comprised of a functionalized polymer structure which may be Nafion®, sulfonated tetrafluoroethylene, sulfonated fluoropolymer, co-polymers, different polymers, composites of polymers, or combinations thereof. In some embodiments of the membrane electrolysis cell, the cation-conducting membrane may comprise the polymer structures functionalized with sulfone groups, carboxylic acid groups, phosphate groups, other negatively charged functional groups, or combinations thereof.

In some embodiments of the electrochemical cell, the ion-conducting membranes may be comprised of Nafion®, sulfonated tetrafluoroethylene, sulfonated fluoropolymer, MK-40, co-polymers, other membrane materials, composites, or combinations thereof. In some embodiments of the electrochemical cell, the cation-conducting membranes are comprised of a functionalized polymer structure which may be Nafion®, sulfonated tetrafluoroethylene, sulfonated fluoropolymer, co-polymers, different polymers, composites of polymers, or combinations thereof. In some embodiments of the electrochemical cell, the cation-conducting membranes may comprise the polymer structures functionalized with sulfone groups, carboxylic acid groups, phosphate groups, other negatively charged functional groups, or combinations thereof.

In some embodiments of the electrodialysis cell, the membranes may be comprised of Nafion®, sulfonated tetrafluoroethylene, sulfonated fluoropolymer, MK-40, co-polymers, other membrane materials, composites, or combinations thereof. In some embodiments of the electrodialysis cell, the cation-conducting membranes are comprised of a functionalized polymer structure which may be Nafion®, sulfonated tetrafluoroethylene, sulfonated fluoropolymer, co-polymers, different polymers, composites of polymers, or combinations thereof. In some embodiments of the electrodialysis cell, the cation-conducting membranes may comprise polymer structures functionalized with sulfone groups, carboxylic acid groups, phosphate groups, other negatively charged functional groups, or combinations thereof.

In some embodiments of the membrane electrolysis cell, an anion-conducting membrane is comprised of a functionalized polymer structure. In some embodiments of the electrochemical cell, an anion-conducting membrane may be comprised of a functionalized polymer structure. In some embodiments of the electrodialysis cell, an anion-conducting membrane may be comprised of a functionalized polymer structure. In some embodiments, a functionalized polymer structure may be comprised of polyarylene ethers, polysulfones, polyether ketones, polyphenylenes, perfluorinated polymers, polybenzimidazole, polyepichlorohydrins, unsaturated polypropylene, polyethylene, polystyrene, polyvinylbenzyl chlorides, polyphosphazenes, polyvinyl alcohol, polytetrafluoroethylene, polyvinyl chloride, polyvinylidene fluoride, alterations of these polymers or other kinds of polymers, or composites thereof. In some embodiments of the ion-conducting membrane, the functional groups are part of the polymer backbone. In some embodiments of the ion-conducting membrane, functional groups are added using plasma techniques, radiation-grafting, or by other functionalization reactions. In some embodiments of the ion-conducting membrane, the functional groups may be benzyltrialkylammonium, alkyl-side-chain quaternary ammonium groups, crosslinking diammonium groups, quinuclidinium-based quaternary ammonium groups, imidazolium groups, pyridinium groups, pentamethylguanidinium groups, alkali stabilised quaternary phosphonium groups, metal containing cation groups, other cation containing groups, or combinations thereof.

In some embodiments of the membrane electrolysis cell, the ion-conducting membrane may have a thickness of less than 10 μm, less than 50 μm, less than 200 μm, less than 400 μm, or less than 1,000 μm. In some embodiments of the membrane electrolysis cell, the ion-conducting membranes may have a thickness of greater than 1,000 μm. In some embodiments of the membrane electrolysis cell, the ion-conducting membrane may have a thickness of about 1 μm to about 1000 μm, about 1 μm to about 800 μm, about 1 μm to about 600 μm, about 1 μm to about 400 μm, about 1 μm to about 200 μm, about 1 μm to about 100 μm, about 1 μm to about 90 μm, about 1 μm to about 80 μm, about 1 μm to about 70 μm, about 1 μm to about 60 μm, about 1 μm to about 50 μm, about 1 μm to about 40 μm, about 1 μm to about 30 μm, about 1 μm to about 20 μm, about 1 μm to about 15 μm, or about 1 μm to about 10 μm.

In some embodiments of the electrochemical cell, the ion-conducting membrane may have a thickness of less than 10 μm, less than 50 μm, less than 200 μm, less than 400 μm, or less than 1,000 μm. In some embodiments of the electrochemical cell, the ion-conducting membranes may have a thickness of greater than 1,000 um. In some embodiments of the electrochemical cell, the ion-conducting membrane may have a thickness of about 1 μm to about 1000 μm, about 1 μm to about 800 μm, about 1 μm to about 600 μm, about 1 μm to about 400 μm, about 1 μm to about 200 μm, about 1 μm to about 100 μm, about 1 μm to about 90 μm, about 1 μm to about 80 μm, about 1 μm to about 70 μm, about 1 μm to about 60 μm, about 1 μm to about 50 μm, about 1 μm to about 40 μm, about 1 μm to about 30 μm, about 1 μm to about 20 μm, about 1 μm to about 15 μm, or about 1 μm to about 10 μm.

In some embodiments of the electrodialysis cell, the ion-conducting membrane may have a thickness of less than 10 μm, less than 50 μm, less than 200 μm, less than 400 μm, or less than 1,000 μm. In some embodiments of the electrodialysis cell, the ion-conducting membranes may have a thickness of greater than 1,000 km. In some embodiments of the electrodialysis cell, the ion-conducting membrane may have a thickness of about 1 μm to about 1000 μm, about 1 μm to about 800 μm, about 1 μm to about 600 μm, about 1 μm to about 400 μm, about 1 μm to about 200 μm, about 1 μm to about 100 μm, about 1 μm to about 90 μm, about 1 μm to about 80 μm, about 1 μm to about 70 μm, about 1 μm to about 60 μm, about 1 μm to about 50 μm, about 1 μm to about 40 μm, about 1 μm to about 30 μm, about 1 μm to about 20 μm, about 1 μm to about 15 μm, or about 1 μm to about 10 μm.

In some embodiments, an electrolysis system contains electrolysis cells that may be two-compartment electrolysis cells or three-compartment electrolysis cells.

In some embodiments of a two-compartment electrolysis cell, the cell contains a first compartment that contains an electrochemically oxidizing electrode. A lithium salt solution enters the first compartment and is converted into an acidified solution. In some embodiments of a two-compartment electrolysis cell, the cell contains a second compartment containing an electrochemically reducing electrode. This second compartment takes as an input water or a dilute LiOH solution and produces as an output a more concentrated LiOH solution. In some embodiments, the compartments of an electrolysis cell are separated by a cation-conducting membrane that limits transport of anions between the compartments.

In some embodiments of a three-compartment electrolysis cell, the cell contains a first compartment containing an electrochemically oxidizing electrode. The first compartment takes as an input water or a dilute salt solution, and produces as an output an acidified solution. In some embodiments of a three-compartment electrolysis cell, the cell contains a second compartment containing an electrochemically reducing electrode. This second compartment takes as an input a water or dilute hydroxide solution, and produces as an output a more concentrated hydroxide solution. In some embodiments of a three-compartment electrolysis cell, the cell contains a third compartment containing no electrode, which is located between the first and second compartment, and takes as an input a concentrated lithium salt solution, and produces as an output a dilute lithium salt solution. In some embodiments, the first and the third compartments are separated by an anion-conducting membrane that limits transport of cations between the compartments. In one embodiment, the second and the third compartments are separated by a cation-conducting membrane that limits transport of anions between the compartments.

In some embodiments of the electrolysis cell, the electrodes may be comprised of titanium, niobium, zirconium, tantalum, magnesium, titanium dioxide, oxides thereof, or combinations thereof. In one embodiment of the electrolysis cell, the electrodes may be coated with platinum, TiO₂, ZrO₂, Nb₂O₅, Ta₂O₅, SnO₂, IrO₂, RuO₂, PtOx, mixed metal oxides, graphene, derivatives thereof, or combinations thereof. In some embodiments of the electrolysis cell, the electrodes may be comprised of steel, stainless steel, nickel, nickel alloys, steel alloys, or graphite.

In some embodiments of the electrolysis system, the lithium salt solution is a LiCl solution optionally containing HCl. In one embodiment of the electrolysis system, the electrochemically oxidizing electrode oxides chloride ions to produce chlorine gas.

In some embodiments of the electrolysis system, the lithium salt solution is a Li₂SO₄ solution optionally containing H₂SO₄. In some embodiments of the electrolysis system, the electrochemically oxidizing electrode oxidizes water, hydroxide, or other species to produce oxygen gas.

In some embodiments of the electrolysis system, the electrochemically reducing electrode reduces hydrogen ions to produce hydrogen gas. In some embodiments of the electrolysis system, the chamber containing the electrochemically reducing electrode produces a hydroxide solution or increases the hydroxide concentration of a solution.

In some embodiments of the electrolysis system, chlorine and hydrogen gas are burned to produce HCl in an HCl burner. In some embodiments, the HCl burner is a column maintained at approximately 100-300 or 300-2,000 degrees Celsius. In some embodiments, HCl produced in the HCl burner is cooled through a heat exchange process and subsequently dissolved into water in an absorption to wer configured to produce aqueous HCl solution. In some embodiments, the HCl solution produced from the HCl burner is used as an acid eluent to elute lithium from an ion exchange device to yield a synthetic lithium solution.

In some embodiments, the pH of the acidified solution leaving the electrolysis cell may be 0 to 1, −2 to 0, 1 to 2, less than 2, less than 1, or less than 0. In some embodiments, the membrane electrolysis cell is an electrodialysis cell with multiple compartments. In some embodiments, the electrodialysis cell may have more than about two, more than about five, more than about 10, or more than about twenty compartments.

In some embodiments, the base added to precipitate metals from the liquid resource may be calcium hydroxide or sodium hydroxide. In some embodiments, the base may be added to the liquid resource as an aqueous solution with a base concentration that may be less than 1 N, 1-2 N, 2-4 N, 4-10 N, 10-20 N, or 20-40 N. In some embodiments, the base may be added to the liquid resource as a solid.

In some embodiments, the acid may be added to the precipitated metals to dissolve the precipitated metals before mixing the redissolved metals with the liquid resource. In some embodiments, the acid may be added to the liquid resource to acidify the liquid resource, such that the precipitated metals may then be combined with the liquid resource to redissolve the precipitated metals.

In some embodiments, acid from the electrochemical cell may be used as an acid eluent to elute lithium from an ion exchange device to yield a synthetic lithium solution. In some embodiments, base from the electrochemical cell may be used to neutralize protons released from the ion exchange material.

### Methods of Generating a Synthetic Lithium Solution

An aspect of the disclosure described herein are methods and systems for lithium recovery from a liquid resource. In some embodiments, lithium provided according to the methods and systems for lithium recovery from a liquid resource described herein is in the form of a synthetic lithium solution. In some embodiments, a synthetic lithium solution is an aqueous solution comprising lithium that is produced by a process contacting an acid or acid eluent with ion exchange material. In some embodiments, an aqueous solution comprising lithium that is produced by a process contacting an acid eluent with ion exchange material may be referred to as a lithium eluate. In some embodiments, a synthetic lithium solution may be a lithium eluate. For the purposes of this disclosure, a lithium eluate according to all embodiments described herein is a synthetic lithium solution.

In some embodiments, a method for generating a synthetic lithium solution from a liquid resource may comprise: providing an ion exchange device comprising a tank, ion exchange particles that selectively absorbs lithium from a liquid resource and elute a synthetic lithium solution when treated with an acid after absorbing lithium ions from said liquid resource, one or more particle traps, and optionally a means of modulating the pH of the liquid resource; flowing a liquid resource into said ion exchange device thereby allowing the ion exchange particles to selectively absorb lithium from the liquid resource; treating the ion exchange particles with an acid to yield the synthetic lithium solution; and passing the synthetic lithium solution through the one or more particle traps prior to collecting the synthetic lithium solution. In some embodiments, the method for generating a synthetic lithium solution from a liquid resource may further comprise one or more steps wherein the ion exchange material is washed with washing water.

In some embodiments, the system for lithium recovery from a liquid resource may comprise a tank. In some embodiments, the tank has a spherical shape. In some embodiments, the tank has a cylindrical shape. In some embodiments, the tank has a rectangular shape. In some embodiments, the tank has a conical shape. In some embodiments, the tank has a partially conical shape. In some embodiments, the conical shape allows the ion exchange particles to settle into a settled bed so that liquid can be removed from above the settled bed. In some embodiments, the partial conical shape allows the ion exchange particles to settle into a settled bed so that liquid can be removed from above the settled bed.

In some embodiments, modulation of the pH of the liquid resource may occur in the tank. In some embodiments, modulation of the pH of the liquid resource occurs prior to injection into the tank. In some embodiments, one or more particle traps comprise one or more filters inside the tank. In some embodiments, one or more particle traps comprise one filter. In some embodiments, one or more particle traps comprise one filter. In some embodiments, one or more particle traps comprise two filters. In some embodiments, one or more particle traps comprise three filters. In some embodiments, one or more particle traps comprise four filters. In some embodiments, one or more particle traps comprise five filters.

In some embodiments, one or more particle traps may be located at the bottom of the tank. In some embodiments, one or more particle traps may be located close to the bottom of the tank. In some embodiments, one or more particle traps may be located above the bottom of the tank. In some embodiments, one or more particle traps may be located in the middle the bottom of the tank. In some embodiments, one or more particle traps may be located at the to p of the tank. In some embodiments, one or more particle traps may be located atvarious locations of the tank.

In some embodiments, one or more particle traps comprise one or more meshes. In some embodiments, one or more particle traps comprises one mesh. In some embodiments, one or more particle traps comprises two meshes. In some embodiments, one or more particle traps comprises three meshes. In some embodiments, one or more particle traps comprises four meshes. In some embodiments, one or more particle traps comprises five meshes. In some embodiments, all the meshes of the one or more particle traps are identical. In some embodiments, at least one of the meshes of the one or more particle traps is not identical to the other the meshes of the one or more particle traps.

In some embodiments, one or more meshes comprise a pore size of less than about 200 microns, less than about 175 microns, less than about 150 microns, less than about 100 microns, less than about 75 microns, less than about 50 microns, less than about 25 microns, less than about 10 microns, more than about 1 micron, more than about 5 micron, more than about 10 microns, more than about 20 microns, more than about 30 microns, more than about 40 microns, more than about 50 microns, more than about 60 microns, more than about 70 microns, more than about 80 microns, more than about 90 microns, more than about 100 microns, more than about 125 microns, more than about 150 microns, more than about 175 microns from about 1 micron to about 200 microns, from about 5 microns to about 175 microns, from about 10 microns to about 150 microns, from about 10 microns to about 100 microns, from about 10 microns to about 90 microns, from about 10 microns to about 80 microns, from about 10 microns to about 70 microns, from about 10 microns to about 60 microns, or from about 10 microns to about 50 microns.

In some embodiments, one or more particle traps comprise multi-layered meshes. In some embodiments, the multi-layered meshes comprise at least one finer mesh for filtration and at least one coarser mesh for structural support. In some embodiments, one or more particle traps comprise one or more meshes supported by a structural support. In some embodiments, one or more particle traps comprise one or more polymer meshes. In some embodiments, the one or more polymer meshes are selected from the group consisting of polyetheretherketone, ethylene tetrafluorethylene, polyethylene terephthalate, polypropylene, and combinations thereof. In some embodiments, the one or more meshes comprise a monofilament mesh. In some embodiments, the one or more meshes comprise a multi-weave mesh. In some embodiments, the one or more meshes may be constructed from one or more types of fibers. In some embodiments, said one or more fibers are weaved into one or more weave patterns. In some embodiments, said weave patterns comprise a plain weave, a twilled weave, a plain filter loth weave, a Dutch Weave, a twilled filter cloth weave, a twilled Dutch Weave, a micron weave, mixtures thereof, or combinations thereof.

In some embodiments, one or more particle traps comprise one or more meshes comprising a metal wire mesh. In some embodiments, the metal wire mesh is coated with a polymer. In some embodiments, the ion exchange device is configured to move ion exchange material into one or more columns for washing. In some embodiments, the ion exchange device is configured to allow the ion exchange material to settle into one or more columns for washing. In some embodiments, the columns are affixed to the bottom of the tank. In some embodiments, the one or more particle traps comprise one or more filters mounted in one or more ports through the wall of the tank.

In some embodiments, the one or more particle traps comprise one or more filters external to the tank, and with provision for fluid communication between said one or more filters and the tank. In some embodiments, the one or more particle traps comprise one or more gravity sedimentation devices external to the tank, and with provision for fluid communication between said one or more gravity sedimentation devices and the tank. In some embodiments, the one or more particle traps comprise one or more filter presses external to the tank. In some embodiments, the one or more particle traps comprise one or more vertical pressure filters external to the tank. In some embodiments, the one or more particle traps comprise one or more pressure leaf filters external to the tank. In some embodiments, the one or more particle traps comprise one or more belt filters external to the tank.

In some embodiments, one or more particle traps comprise one or more gravity sedimentation devices internal to the tank. In some embodiments, one or more particle traps comprise one or more centrifugal sedimentation devices external to the tank, and with provision for fluid communication between said one or more centrifugal sedimentation devices and the tank. In some embodiments, said sedimentations devices comprise a clarifier, a lamellar clarifier, a reflux clarifier, or any other device design to sediment the solids to the bottom while facilitating flow of a solid-lean liquid from the to p. In some embodiments, one or more particle traps comprise one or more centrifugal sedimentation devices internal to the tank. In some embodiments, one or more particle traps comprise one or more settling tanks, one or more centrifugal devices, or combinations thereof external to the tank, and with provision for fluid communication between the one or more settling tanks, centrifugal devices, or combinations thereof, and the tank. In some embodiments, one or more particle traps comprise one or more meshes, one or more centrifugal devices, or combinations thereof external to the tank, and with provision for fluid communication between said one or more meshes, centrifugal devices, or combinations thereof, and the tank. In some embodiments, one or more particle traps comprise one or more settling tanks, one or more meshes, or combinations thereof external to the tank, and with provision for fluid communication between said one or more settling tanks, meshes, or combinations thereof, and the tank. In some embodiments, one or more particle traps comprise one or more meshes, one or more settling tanks, one or more centrifugal devices, or combinations thereof external to the tank, and with provision for fluid communication between said one or more meshes, one or more settling tanks, centrifugal devices, or combinations thereof, and the tank.

In some embodiments, the ion exchange particles are stirred. In some embodiments, the ion exchange particles are stirred by a mixer. In some embodiments, the ion exchange particles are stirred by a propeller. In some embodiments, the ion exchange particles are stirred by a hydrofoil. In some embodiments, the stirring or agitation of the ion exchange particles is aided by the presence of one or more baffles in the tank. In some embodiments, said baffles are oriented perpendicular to the direction of rotation of the mixing device. In some embodiments, the ion exchange particles are fluidized by pumping solution into the tank near the bottom of the tank. In some embodiments, the ion exchange particles are fluidized by pumping solution from the tank back into the tank near the bottom of the tank. In some embodiments, the ion exchange particles are fluidized by pumping a slurry of the ion exchange particles from near the bottom of the tank to a higher level in the tank. In some embodiments, the ion exchange particles are fluidized by injecting a gas into a flow distributor at the bottom of said tank. In some embodiments, the gas comprises compressed air, air, nitrogen, argon, oxygen, or a combination thereof.

In some embodiments, the method for lithium recovery from a liquid resource further comprises one or more staged elution tanks, wherein intermediate eluate solutions comprising mixtures of protons and lithium ions are stored and used further to elute lithium from ion exchange particles. In some embodiments, the method for lithium recovery from a liquid resource further comprises one or more staged elution tanks, wherein intermediate eluate solutions comprising mixtures of protons and lithium ions are mixed with acid and used further to elute lithium from ion exchange particles.

In some embodiments, the ion exchange particles further comprise a coating material. In some embodiments, the coating material is a polymer. In some embodiments, the coating of the coating material comprises a chloro-polymer, a fluoro-polymer, a chloro-fluoro-polymer, a hydrophilic polymer, a hydrophobic polymer, co-polymers thereof, mixtures thereof, or combinations thereof.

In some embodiments of the methods and systems for lithium recovery from a liquid resource disclosed herein, the pH of the intermediate eluate solutions may be modulated to control elution of lithium and/or non-lithium impurities from the ion exchange material. In some embodiments, pH of the intermediate eluate solutions may be modulated by adding protons, such as in an acid and/or an acidic solution, to the intermediate eluate solutions. In some embodiments, pH of the intermediate eluate solutions is modulated by adding protons, such as in an acid and/or an acidic solution, to the intermediate eluate solutions prior to removing impurities therefrom.

In some embodiments, the acid added to the intermediate eluate solutions may comprise sulfuric acid, phosphoric acid, hydrochloric acid, hydrobromic acid, carbonic acid, nitric acid, or combinations thereof. In some embodiments, the acid added to the intermediate eluate solutions comprises the same acid as does the acid eluent originally contacted with the ion exchange material. In some embodiments, the acid added to the intermediate eluate solutions comprises a different acid than does the acid eluent originally contacted with the ion exchange material.

In some embodiments, more protons are added to the intermediate eluate solutions, forming protonated intermediate eluate solutions that may be again contacted with ion exchange material to elute more lithium into the protonated intermediate eluate solutions. In some embodiments, more protons are added to the intermediate eluate solutions by adding an acid or acidic solution thereto to form protonated intermediate eluate solutions. In some embodiments, protons are added to intermediate eluate solutions before passing the resulting protonated intermediate eluate solutions through one or more ion exchange devices as described herein.

In some embodiments of the methods and systems for lithium recovery from a liquid resource disclosed herein, an anti-scalant or chelating agent may be added to the liquid resource to limit formation of precipitates. In some embodiments, ion exchange material may be utilized in the form of packed beds wherein the packed beds may be partially or temporarily fluidized. In some embodiments, ion exchange material may be utilized in the form of fluidized beds wherein the fluidized beds may be partially or temporarily packed. In some embodiments, ion exchange material may be washed using water or an aqueous washing solution before and/or after contacting the ion exchange material with liquid resource and/or acid. In some embodiments, washing water may comprise an aqueous washing solution. In some embodiments, an aqueous washing solution may comprise water, salt, chelating compounds, ethylenediaminetetraacetic acid, salts of ethylenediaminetetraacetate, compounds of ethylenediaminetetraacetate, and/or anti-scalants. In some embodiments, the eluent used to elute lithium from the ion exchange material may comprise water, salt, chelating compounds, ethylenediaminetetraacetic acid, salt of ethylenediaminetetraacetate, compounds of ethylenediaminetetraacetate, and/or anti-scalants.

In some embodiments, a chelating agent or anti-scalant may be used to form a soluble complex to avoid the formation of precipitates in a synthetic lithium solution. In some embodiments, a chelating agent or anti-scalant may be used to form a soluble complex to avoid or redissolve precipitates. In some embodiments, a chelating agent or anti-scalants may be used to limit or reduce precipitation of multivalent cations. In some embodiments, the chelating agent or anti-scalant may be selected from ethylenediaminetetraacetic acid (EDTA), disodium EDTA, calcium disodium EDTA, tetrasodium EDTA, citric acid, maleic acid, silicate compounds, amorphous silicate compounds, crystalline layered silicate compounds, phosphonic acid compounds, aminotris(methylenephosphonic acid) (ATMP), nitrilotrimethylphosphonic acid (NTMP), ethylenediamine tetra(methylene phosphonic acid) (EDTMP), diethylenetriamine penta(methylene phosphonic acid) (DTPMP), polyphosphonate, polyacrylate, polyacrylic acid, nitrilotriacetic acid (NTA), sodium hexametaphosphate (SHMP), or combinations thereof. In some embodiments, a threshold inhibitor is used to block the formation of nuclei that may initiate precipitate formation in a synthetic lithium solution. In some embodiments, a retardant is used to prevent the growth of precipitates in synthetic lithium solution. In some embodiments, a threshold inhibitor or retardant comprises one or more compounds that to limit, control, eliminate, or redissolve precipitates. In some embodiments, compounds that limit, control, eliminate, or redissolve precipitates include phosphinopolycarboxylic acid, sulfonated polymer, polyacrylic acid, p-tagged sulfonated polymer, diethylenetriamine penta, bis-hexamethylene triamine, compounds thereof, modifications thereof, or combinations thereof.

In some embodiments, anti-scalants, chelating agents, or other means of anti-scaling are used to avoid scaling in the nanofiltration membrane units.

In some embodiments, lithium may be eluted from an ion exchange material enriched in lithium by contacting an eluent with the ion exchange material to provide a synthetic lithium solution. In some embodiments, the lithium purity of the synthetic lithium solution may change in time as a portion of eluent is contacted with the ion exchange material. In some embodiments, the lithium purity of the synthetic lithium solution may increase as additional eluentis contacted with the ion exchange material. In some embodiments, multiple aliquots of eluent may be used to elute lithium from a given quantity of ion exchange material. In some embodiments, aliquots of eluent may be of different volumes. In some embodiments, aliquots of eluent may be of substantially the same volume. In some embodiments, the first aliquot of eluent may be contacted with the ion exchange material to provide a first aliquot of synthetic lithium solution. In some embodiments, subsequent aliquots of eluent may then be contacted with the ion exchange material to produce subsequent aliquots of synthetic lithium solution. In some embodiments, the first aliquot of synthetic lithium solution may comprise lower lithium purity than subsequent aliquots of synthetic lithium solution. In some embodiments, the volume of the first aliquot of eluent may be selected to provide a first aliquot of synthetic lithium solution that is enriched in impurities such that the subsequent aliquots of synthetic lithium solution comprise a higher lithium purity than does the first aliquot of synthetic lithium solution. In some embodiments, adjusting fluid may comprise synthetic lithium solution that is enriched in impurities.

### Methods and Systems for Modulating the Ion Concentration of a Liquid Resource

According to the methods and systems for lithium recovery from a liquid resource as disclosed herein, the concentration of lithium the liquid resource can have impacts on the performance parameters of ion exchange processes, ion exchange devices, and ion exchange materials. In some embodiments, the lithium concentration of a liquid resource can be adjusted or modulated to a value that has a positive impact on the performance parameters of ion exchange processes, ion exchange devices, and ion exchange materials. In some embodiments, the lithium concentration of a liquid resource can be increased to realize a positive impact on the performance parameters of ion exchange processes, ion exchange devices, and ion exchange materials. In one embodiment, the lithium concentration in a liquid resource can be decreased to realize a positive impact on the performance parameters of ion exchange processes, ion exchange devices, and ion exchange materials. In some embodiments, the lithium concentration of a liquid resource can be increased to realize a positive impact on the performance parameters of an ion exchange device that comprises a fixed bed of ion exchange material. In some embodiments, the lithium concentration of a liquid resource can be increased to realize a positive impact on the performance parameters of an ion exchange device that comprises a fluidized bed of ion exchange material.

In some embodiments, a liquid resource that has been subjected to a step or process that adjusts the concentration of lithium in said liquid resource for the purpose of realizing improved performance parameters of ion exchange processes and ion exchange devices may be termed a concentration-adjusted liquid resource. In some embodiments, the concentration of lithium in a liquid resource may be adjusted in a step or process prior to a lithium-selective ion exchange process. In some embodiments, the concentration of lithium in a liquid resource may be adjusted in a step or process prior to contacting the resulting concentration-adjusted liquid resource with ion exchange material. In some embodiments, ion exchange material may comprise a lithium-selective sorbent. In some embodiments, a concentration-adjusted liquid resource may be used in place of a liquid resource according to any of the methods or systems described herein.

In some embodiments, a concentration-adjusted liquid resource may have a lithium concentration of about 50 mg/L to about 100,000 mg/L. In some embodiments, a concentration-adjusted liquid resource may have a lithium concentration of about 50 mg/L to about 100 mg/L, about 50 mg/L to about 200 mg/L, about 50 mg/L to about 500 mg/L, about 50 mg/L to about 1,000 mg/L, about 50 mg/L to about 5,000 mg/L, about 50 mg/L to about 10,000 mg/L, about 50 mg/L to about 20,000 mg/L, about 50 mg/L to about 30,000 mg/L, about 50 mg/L to about 50,000 mg/L, about 50 mg/L to about 75,000 mg/L, about 50 mg/L to about 100,000 mg/L, about 100 mg/L to about 200 mg/L, about 100 mg/L to about 500 mg/L, about 100 mg/L to about 1,000 mg/L, about 100 mg/L to about 5,000 mg/L, about 100 mg/L to about 10,000 mg/L, about 100 mg/L to about 20,000 mg/L, about 100 mg/L to about 30,000 mg/L, about 100 mg/L to about 50,000 mg/L, about 100 mg/L to about 75,000 mg/L, about 100 mg/L to about 100,000 mg/L, about 200 mg/L to about 500 mg/L, about 200 mg/L to about 1,000 mg/L, about 200 mg/L to about 5,000 mg/L, about 200 mg/L to about 10,000 mg/L, about 200 mg/L to about 20,000 mg/L, about 200 mg/L to about 30,000 mg/L, about 200 mg/L to about 50,000 mg/L, about 200 mg/L to about 75,000 mg/L, about 200 mg/L to about 100,000 mg/L, about 500 mg/L to about 1,000 mg/L, about 500 mg/L to about 5,000 mg/L, about 500 mg/L to about 10,000 mg/L, about 500 mg/L to about 20,000 mg/L, about 500 mg/L to about 30,000 mg/L, about 500 mg/L to about 50,000 mg/L, about 500 mg/L to about 75,000 mg/L, about 500 mg/L to about 100,000 mg/L, about 1,000 mg/L to about 5,000 mg/L, about 1,000 mg/L to about 10,000 mg/L, about 1,000 mg/L to about 20,000 mg/L, about 1,000 mg/L to about 30,000 mg/L, about 1,000 mg/L to about 50,000 mg/L, about 1,000 mg/L to about 75,000 mg/L, about 1,000 mg/L to about 100,000 mg/L, about 5,000 mg/L to about 10,000 mg/L, about 5,000 mg/L to about 20,000 mg/L, about 5,000 mg/L to about 30,000 mg/L, about 5,000 mg/L to about 50,000 mg/L, about 5,000 mg/L to about 75,000 mg/L, about 5,000 mg/L to about 100,000 mg/L, about 10,000 mg/L to about 20,000 mg/L, about 10,000 mg/L to about 30,000 mg/L, about 10,000 mg/L to about 50,000 mg/L, about 10,000 mg/L to about 75,000 mg/L, about 10,000 mg/L to about 100,000 mg/L, about 20,000 mg/L to about 30,000 mg/L, about 20,000 mg/L to about 50,000 mg/L, about 20,000 mg/L to about 75,000 mg/L, about 20,000 mg/L to about 100,000 mg/L, about 30,000 mg/L to about 50,000 mg/L, about 30,000 mg/L to about 75,000 mg/L, about 30,000 mg/L to about 100,000 mg/L, about 50,000 mg/L to about 75,000 mg/L, about 50,000 mg/L to about 100,000 mg/L, or about 75,000 mg/L to about 100,000 mg/L. In some embodiments, a concentration-adjusted liquid resource may have a lithium concentration of about 50 mg/L, about 100 mg/L, about 200 mg/L, about 500 mg/L, about 1,000 mg/L, about 5,000 mg/L, about 10,000 mg/L, about 20,000 mg/L, about 30,000 mg/L, about 50,000 mg/L, about 75,000 mg/L, or about 100,000 mg/L. In some embodiments, a concentration-adjusted liquid resource may have a lithium concentration of at least about 50 mg/L, about 100 mg/L, about 200 mg/L, about 500 mg/L, about 1,000 mg/L, about 5,000 mg/L, about 10,000 mg/L, about 20,000 mg/L, about 30,000 mg/L, about 50,000 mg/L, or about 75,000 mg/L. In some embodiments, a concentration-adjusted liquid resource may have a lithium concentration of at most about 100 mg/L, about 200 mg/L, about 500 mg/L, about 1,000 mg/L, about 5,000 mg/L, about 10,000 mg/L, about 20,000 mg/L, about 30,000 mg/L, about 50,000 mg/L, about 75,000 mg/L, or about 100,000 mg/L.

In some embodiments, performance parameters may comprise purity of lithium obtained, quantity of lithium obtained, useful lifetime of ion exchange material employed to recover lithium from a liquid resource, quantities of reagents or additives required to maintain optimal performance of one or more ion exchange devices, or the time required for the ion exchange material or ion exchange bead to complete a lithium extraction step. In some embodiments, performance parameters may comprise the time required for the ion exchange material or ion exchange bead to complete a lithium extraction step. In some embodiments, performance parameters may comprise purity of lithium obtained, quantity of lithium obtained, useful lifetime of ion exchange material employed to recover lithium from a liquid resource, and quantities of reagents or additives required to maintain optimal performance of one or more ion exchange devices. In some embodiments, a system for lithium recovery from a liquid resource may be configured to adjust the concentration of lithium in a liquid resource prior to contacting the liquid resource with a lithium-selective sorbent in order to alter one or more performance parameters of ion exchange processes and ion exchange devices.

In some embodiments, the concentration of lithium in a liquid resource may be adjusted in batches. In some embodiments, the concentration of lithium in a liquid resource may be adjusted continuously. In some embodiments, the lithium concentration of a liquid resource may be adjusted simultaneously to treatments of the liquid resource as described herein. In some embodiments, the lithium concentration of a liquid resource may be adjusted simultaneously to additions to the liquid resource as described herein. In some embodiments, the lithium concentration of a liquid resource may be adjusted simultaneously to combining or mixing with the liquid resource as described herein. In some embodiments, the lithium concentration of a liquid resource may be adjusted before treatments of the liquid resource as described herein. In some embodiments, the lithium concentration of a liquid resource may be adjusted after treatments of the liquid resource as described herein. In some embodiments, a system or subsystem may be configured to adjust the concentration of lithium in a liquid resource to provide a concentration-adjusted liquid resource.

In some embodiments, the treatments, processes, and methods disclosed herein are applicable to a concentration-adjusted liquid resource just as they are applicable to a liquid resource. In some embodiments, the systems and subsystems disclosed herein may be configured to utilize a concentration-adjusted liquid resource as an input just as they are configured to utilize a liquid resource as an input. In some embodiments, a dedicated system may be configured to utilize a liquid resource as an input and provide a concentration-adjusted liquid resource as an output, wherein the output is then fed into a system for lithium recovery from a liquid resource. In some embodiments, a subsystem may be configured to utilize a liquid resource as an input and provide a concentration-adjusted liquid resource as an output, wherein the output is then fed into a different subsystem of a system for lithium recovery from a liquid resource.

In some embodiments, the concentration of lithium in a liquid resource may be adjusted by adding an adjusting fluid. In one embodiment, the adjusting fluid is water. In some embodiments, the adjusting fluid is an aqueous solution. In some embodiments, the adjusting fluid is an aqueous solution containing lithium. In some embodiments, the adjusting fluid is an aqueous solution comprising one or more adjusting ions or protonated forms thereof. In some embodiments, the adjusting fluid is an aqueous solution that alters the pH of the liquid resource. In some embodiments, the adjusting fluid is a lithium-depleted liquid resource. In some embodiments, a lithium-depleted liquid resource is used as an adjusting fluid such that a portion of lithium present in the lithium-depleted liquid resource may be recovered by an ion exchange process or an ion exchange device. In some embodiments, the adjusting fluid comprises raffinate. In some embodiments, adjusting fluid may comprise be reject water provided by reverse osmosis. In some embodiments, adjusting fluid may comprise material provided by a chloralkali plant. In some embodiments, adjusting fluid may comprise material provided by an intermediate or terminal step of a method for lithium recovery as described herein. In some embodiments, adjusting fluid may comprise material provided by an intermediate or terminal subsystem of a system for lithium recovery as described herein. In some embodiments, adjusting fluid may comprise material provided by purification or processing of a synthetic lithium solution. In some embodiments, adjusting fluid may comprise material provided by purification or processing of a lithium-depleted liquid resource. In some embodiments, purification or processing may comprise an ion exchange process. In some embodiments, material provided by purification or processing may comprise calcium. In some embodiments, material provided by purification or processing may comprise boron. In some embodiments, material provided by purification or processing may comprise magnesium. In some embodiments, material provided by purification or processing may comprise reject water provided by reverse osmosis.

In some embodiments, the concentration of lithium in a liquid resource may be adjusted by adding an adjusting solid. In some embodiments, the adjusting solid is a solid comprising lithium. In some embodiments, the adjusting solid may comprise one or more adjusting ions or protonated forms thereof. In some embodiments, the adjusting solid is a solid alters the pH of the liquid resource. In some embodiments, the adjusting solid comprises material obtained from a lithium-depleted liquid resource. In some embodiments, a lithium-depleted liquid resource is processed to provide the adjusting solid such that a portion of lithium present in the lithium-depleted liquid resource may be recovered by an ion exchange process or an ion exchange device. In some embodiments, the adjusting solid comprises material obtained by processing of raffinate. In some embodiments, adjusting solid may comprise material provided by reverse osmosis. In some embodiments, adjusting solid may comprise material provided by a chloralkali plant. In some embodiments, adjusting solid may comprise material provided by an intermediate or terminal step of a method for lithium recovery as described herein. In some embodiments, adjusting solid may comprise material provided by an intermediate or terminal subsystem of a system for lithium recovery as described herein. In some embodiments, adjusting solid may comprise material provided by purification or processing of a synthetic lithium solution. In some embodiments, adjusting solid may comprise precipitates as described herein. In some embodiments, adjusting fluid may comprise material provided by purification or processing of a lithium-depleted liquid resource. In some embodiments, purification or processing may comprise an ion exchange process. In some embodiments, material provided by purification or processing may comprise calcium. In some embodiments, material provided by purification or processing may comprise boron. In some embodiments, material provided by purification or processing may comprise magnesium.

In some embodiments, an adjusting solid comprises a base. In some embodiments, an adjusting fluid comprises a base. In some embodiments, the pH of a concentration-adjusted liquid resource may be altered by the addition of one or more bases. In some embodiments, a base may include NaOH, LiOH, KOH, Mg(OH)₂, Ca(OH)₂, CaO, NH₃, Na₂SO₄, K₂SO₄, NaHSO₄, KHSO₄, NaOCl, KOCl, NaClO₄, KClO₄, NaH₂BO₃, Na₂HBO₃, Na₃BO₃, KH₂BO₃, K₂HBO₃, K₃BO₃, MgHBO₃, CaHBO₃, NaHCO₃, KHCO₃, NaCO₃, KCO₃, MgCO₃, CaCO₃, Na₂O, K₂O, Na₂CO₃, K₂CO₃, Na₃PO₄, Na₂HPO₄, NaH₂PO₄, K₃PO₄, K₂HPO₄, KH₂PO₄, CaHPO₄, MgHPO₄, sodium acetate, potassium acetate, magnesium acetate, poly(vinylpyridine), poly(vinylamine), polyacrylonitrile, or combinations thereof.

In some embodiments, a liquid stream may comprise liquid resource. In some embodiments, a liquid stream may comprise concentration-adjusted liquid resource. In some embodiments, a liquid stream may comprise ion adjusted liquid resource. In some embodiments, a liquid stream may comprise adjusting fluid. In some embodiments, a liquid stream may comprise adjusting ion solution. In some embodiments, a liquid stream may comprise process fluid. In some embodiments, a liquid stream may comprise a base. In some embodiments, a liquid stream may comprise lithium-depleted liquid resource. In some embodiments, a liquid stream may comprise raffinate.

In some embodiments, a dedicated system may be configured to mix two or more liquid streams and provide the resulting mixture to a system for lithium recovery from a liquid resource. In some embodiments, a subsystem may be configured to mix two or more liquid streams, wherein the subsystem is a component of a system for lithium recovery from a liquid resource.

In some embodiments, mixing of two or more liquid streams may occur in a tank. In some embodiments, the tank may comprise two or more baffles. In some embodiments, the tank is an agitated tank. In some embodiments, the agitated tank comprises a propeller, hydrofoil, high-shear mixer, or other device to facilitate the mixing of liquid streams. In some embodiments, the tank is structurally comprised of one or more of steel, carbon steel, stainless steel, coated steel, titanium, Hastelloy, nickel, tantalum, zirconium, plastic, polyethylene, polypropylene, fiberglass, glass, mixtures, or combinations thereof. In some embodiments, the contents of the tank are agitated by means of recirculating the liquid contents of the tank through a pump. In some embodiments, the mixing is further aided by an eductor, wherein the eductor comprises a nozzle that increases the recirculation rate in the tank for a given amount of liquid being pumped. In some embodiments, the contents of the tank are agitated by air that is introduced through nozzles and air distributors at the bottom of the tank. In some embodiments, the two liquids in the tank are agitated by means of an in-line mixer, wherein the in-line mixer comprises to rtuous flow paths arranged to increase the turbulence of the liquid as it traverses the flow paths.

In some embodiments, two or more liquid streams are introduced into the tank simultaneously and are subsequently mixed. In some embodiments, one liquid stream is introduced into the tank in a batchwise manner. In some embodiments, one liquid stream is introduced into the tank by means of an eductor.

In some embodiments, one or more liquid streams may be mixed by means of an in-line mixer, wherein said in line mixer is configured to combine the flow of two separate liquid streams into a single liquid stream. In some embodiments, one or more liquid streams may be mixed by means of an in-line mixer, wherein said in line mixer is configured to combine the flow of three or more separate liquid streams into a single liquid stream.

In some embodiments, solids are added to the two or more liquid streams in the tank. In some embodiments, the solids are introduced to the tank by means of an auger. In some embodiments, the solids are mixed into the liquid streams and dissolved. In some embodiments, the solids remain in suspension in the liquid streams. In some embodiments, the solids are dispersed in the liquid streams. In some embodiments, the solids are suspended or dissolved into the liquid streams by a high shear mixer.

In an aspect of the methods and systems for lithium recovery from a liquid resource disclosed herein, following contacting a liquid resource with a lithium-selective sorbent, the liquid resource becomes depleted in lithium. In some embodiments, a liquid resource depleted in lithium generated by an ion exchange device is a lithium-depleted liquid resource. In some embodiments, a liquid resource depleted in lithium that is output by an ion exchange device is a raffinate. In some embodiments, a lithium-depleted liquid resource is a raffinate.

In some embodiments, the raffinate may be combined with a liquid resource to provide a concentration-adjusted liquid resource. In some embodiments, the raffinate may be combined with a liquid resource to provide a concentration-adjusted liquid resource that has a lower lithium concentration than the liquid resource.

In some embodiments, all of the raffinate generated by an ion exchange device may be combined with a liquid resource to provide a concentration-adjusted liquid resource. In some embodiments, a fraction of the raffinate generated by an ion exchange device may be combined with a liquid resource to provide a concentration-adjusted liquid resource. In some embodiments, a system or subsystem may be configured to combine a constant fraction of the raffinate generated by an ion exchange device with a liquid resource to provide a concentration-adjusted liquid resource. In some embodiments, a system or subsystem may be configured to combine a continuously modulated fraction of the raffinate generated by an ion exchange device with a liquid resource to provide a concentration-adjusted liquid resource. In some embodiments, a system for lithium recovery from a liquid resource may comprise a splitting system configured to optionally combine the raffinate or a fraction thereof with a liquid resource.

In some embodiments, a recycle ratio is the ratio of the volume of raffinate directed to combine with the liquid resource to provide a concentration-adjusted liquid resource to the volume of raffinate not directed to combine with the liquid resource. In some embodiments, raffinate not directed to combine with the liquid resource may be directed to waste. In some embodiments, raffinate not directed to combine with the liquid resource may be directed to exit a system for lithium recovery as described herein. In some embodiments, a recycle ratio may be constant. In some embodiments, a recycle ratio may be continuously modulated. In some embodiments, continuous modulation of the recycle ratio may allow for the concentration of lithium in the concentration-adjusted liquid resource to remain at about a constant value. In some embodiments, continuous modulation of the recycle ratio may allow for the concentration of lithium in the concentration-adjusted liquid resource to remain at about a constant value despite a significant variance in the lithium concentration of the liquid resource prior to adjustment of its lithium concentration. In some embodiments, continuous modulation of the recycle ratio leads a positive impact on the performance parameters of ion exchange processes, ion exchange devices, and ion exchange materials. In some embodiments, the modulation of the recycle ratio may lead to positive impacts on the performance parameters for lithium recovery. In some embodiments, the modulation of the recycle ratio may lead to positive impacts on the performance parameters for lithium recovery as exemplified in a non-limiting manner by the increased lithium recoveries described in Example 2. In some embodiments, the recycle ratio may be modulated according to the concentration of one or more adjusting ions present in the liquid resource. In some embodiments, the recycle ratio may be modulated according to the concentration of one or more adjusting ions present in the raffinate.

In some embodiments, the recycle ratio may be about 0.05 to about 1. In some embodiments, the recycle ratio may be about 0.05 to about 0.1, about 0.05 to about 0.15, about 0.05 to about 0.2, about 0.05 to about 0.3, about 0.05 to about 0.4, about 0.05 to about 0.5, about 0.05 to about 0.6, about 0.05 to about 0.7, about 0.05 to about 0.8, about 0.05 to about 0.9, about 0.05 to about 1, about 0.1 to about 0.15, about 0.1 to about 0.2, about 0.1 to about 0.3, about 0.1 to about 0.4, about 0.1 to about 0.5, about 0.1 to about 0.6, about 0.1 to about 0.7, about 0.1 to about 0.8, about 0.1 to about 0.9, about 0.1 to about 1, about 0.15 to about 0.2, about 0.15 to about 0.3, about 0.15 to about 0.4, about 0.15 to about 0.5, about 0.15 to about 0.6, about 0.15 to about 0.7, about 0.15 to about 0.8, about 0.15 to about 0.9, about 0.15 to about 1, about 0.2 to about 0.3, about 0.2 to about 0.4, about 0.2 to about 0.5, about 0.2 to about 0.6, about 0.2 to about 0.7, about 0.2 to about 0.8, about 0.2 to about 0.9, about 0.2 to about 1, about 0.3 to about 0.4, about 0.3 to about 0.5, about 0.3 to about 0.6, about 0.3 to about 0.7, about 0.3 to about 0.8, about 0.3 to about 0.9, about 0.3 to about 1, about 0.4 to about 0.5, about 0.4 to about 0.6, about 0.4 to about 0.7, about 0.4 to about 0.8, about 0.4 to about 0.9, about 0.4 to about 1, about 0.5 to about 0.6, about 0.5 to about 0.7, about 0.5 to about 0.8, about 0.5 to about 0.9, about 0.5 to about 1, about 0.6 to about 0.7, about 0.6 to about 0.8, about 0.6 to about 0.9, about 0.6 to about 1, about 0.7 to about 0.8, about 0.7 to about 0.9, about 0.7 to about 1, about 0.8 to about 0.9, about 0.8 to about 1, or about 0.9 to about 1. In some embodiments, the recycle ratio may be about 0.05, about 0.1, about 0.15, about 0.2, about 0.3, about 0.4, about 0.5, about 0.6, about 0.7, about 0.8, about 0.9, or about 1. In some embodiments, the recycle ratio may be at least about 0.05, about 0.1, about 0.15, about 0.2, about 0.3, about 0.4, about 0.5, about 0.6, about 0.7, about 0.8, or about 0.9. In some embodiments, the recycle ratio may be at most about 0.1, about 0.15, about 0.2, about 0.3, about 0.4, about 0.5, about 0.6, about 0.7, about 0.8, about 0.9, or about 1.

In some embodiments, the recycle ratio may be about 1 to about 10. In some embodiments, the recycle ratio may be about 1 to about 2, about 1 to about 3, about 1 to about 4, about 1 to about 5, about 1 to about 6, about 1 to about 7, about 1 to about 8, about 1 to about 9, about 1 to about 10, about 2 to about 3, about 2 to about 4, about 2 to about 5, about 2 to about 6, about 2 to about 7, about 2 to about 8, about 2 to about 9, about 2 to about 10, about 3 to about 4, about 3 to about 5, about 3 to about 6, about 3 to about 7, about 3 to about 8, about 3 to about 9, about 3 to about 10, about 4 to about 5, about 4 to about 6, about 4 to about 7, about 4 to about 8, about 4 to about 9, about 4 to about 10, about 5 to about 6, about 5 to about 7, about 5 to about 8, about 5 to about 9, about 5 to about 10, about 6 to about 7, about 6 to about 8, about 6 to about 9, about 6 to about 10, about 7 to about 8, about 7 to about 9, about 7 to about 10, about 8 to about 9, about 8 to about 10, or about 9 to about 10. In some embodiments, the recycle ratio may be about 1, about 2, about 3, about 4, about 5, about 6, about 7, about 8, about 9, or about 10. In some embodiments, the recycle ratio may be at least about 1, about 2, about 3, about 4, about 5, about 6, about 7, about 8, or about 9. In some embodiments, the recycle ratio may be at most about 2, about 3, about 4, about 5, about 6, about 7, about 8, about 9, or about 10.

In some embodiments, the recycle ratio may be less than 1 to 10. In some embodiments, the recycle ratio may be less than 1 to 2, 1 to 3, 1 to 4, 1 to 5, 1 to 6, 1 to 7, 1 to 8, 1 to 9, 1 to 10, 2 to 3, 2 to 4, 2 to 5, 2 to 6, 2 to 7, 2 to 8, 2 to 9, 2 to 10, 3 to 4, 3 to 5, 3 to 6, 3 to 7, 3 to 8, 3 to 9, 3 to 10, 4 to 5, 4 to 6, 4 to 7, 4 to 8, 4 to 9, 4 to 10, 5 to 6, 5 to 7, 5 to 8, 5 to 9, 5 to 10, 6 to 7, 6 to 8, 6 to 9, 6 to 10, 7 to 8, 7 to 9, 7 to 10, 8 to 9, 8 to 10, or 9 to 10. In some embodiments, the recycle ratio may be less than 1, 2, 3, 4, 5, 6, 7, 8, 9, or 10. In some embodiments, the recycle ratio may be less than at least 1, 2, 3, 4, 5, 6, 7, 8, or 9. In some embodiments, the recycle ratio may be less than at most 2, 3, 4, 5, 6, 7, 8, 9, or 10.

In some embodiments, the recycle ratio may be more than 1 to 10. In some embodiments, the recycle ratio may be more than 1 to 2, 1 to 3, 1 to 4, 1 to 5, 1 to 6, 1 to 7, 1 to 8, 1 to 9, 1 to 10, 2 to 3, 2 to 4, 2 to 5, 2 to 6, 2 to 7, 2 to 8, 2 to 9, 2 to 10, 3 to 4, 3 to 5, 3 to 6, 3 to 7, 3 to 8, 3 to 9, 3 to 10, 4 to 5, 4 to 6, 4 to 7, 4 to 8, 4 to 9, 4 to 10, 5 to 6, 5 to 7, 5 to 8, 5 to 9, 5 to 10, 6 to 7, 6 to 8, 6 to 9, 6 to 10, 7 to 8, 7 to 9, 7 to 10, 8 to 9, 8 to 10, or 9 to 10. In some embodiments, the recycle ratio may be more than 1, 2, 3, 4, 5, 6, 7, 8, 9, or 10. In some embodiments, the recycle ratio may be more than at least 1, 2, 3, 4, 5, 6, 7, 8, or 9. In some embodiments, the recycle ratio may be more than at most 2, 3, 4, 5, 6, 7, 8, 9, or 10.

In some embodiments, the lithium concentration of a liquid resource may be adjusted to provide a concentration-adjusted liquid resource through the addition of lithium compounds to the liquid resource. In some embodiments, the lithium concentration of a liquid resource may be adjusted by addition of lithium chemicals in either a solid or a liquid form. In some embodiments, lithium compounds suitable for adjusting the lithium concentration of a liquid resource may comprise LiCl, LiBr, LiOH, LiNO₃, Li₂CO₃, LiHCO₃, Li₂SO₄, LiHSO₄, Li₂HBO₃, LiH₂BO₃, Li₃BO₃, Li₂HPO₄, LiH₂PO₄, or Li₃PO₄. In some embodiments, two or more different liquid resources may be combined to provide a concentration-adjusted liquid resource.

In some embodiments, the lithium concentration of a liquid resource may be adjusted to provide a concentration-adjusted liquid resource through the addition of an aqueous lithium solution. In some embodiments, an aqueous lithium solution may be provided by a method or system for the precipitation or crystallization of lithium from solution. In some embodiments, an aqueous lithium solution provided by a method or system for the precipitation or crystallization of lithium from solution may comprise lithium and carbonate.

In some embodiments, a system for lithium recovery from a liquid resource may comprise a subsystem for combining a liquid resource with an adjusting fluid. In some embodiments, a subsystem for combining a liquid resource with an adjusting fluid may comprise a tank. In some embodiments, a subsystem for combining a liquid resource with an adjusting fluid may comprise an in-line mixer. In some embodiments, a subsystem for combining a liquid resource with an adjusting fluid may comprise a pH modulating unit. In some embodiments, a subsystem for combining a liquid resource with an adjusting fluid may comprise a plurality of pipes for combining multiple streams of liquid. In an aspect, a system for lithium recovery from a liquid resource may comprise a subsystem for combining a liquid resource with raffinate. In some embodiments, a system for lithium recovery from a liquid resource may comprise a subsystem for combining a liquid resource with lithium compounds. In some embodiments, a system for lithium recovery from a liquid resource may comprise a subsystem for combining a liquid resource with one or more additional liquid resources. In some embodiments, a system for lithium recovery from a liquid resource may comprise a subsystem for combining a liquid resource with an aqueous lithium solution. In some embodiments, a system for lithium recovery from a liquid resource may comprise a subsystem for combining a liquid resource with an aqueous lithium solution provided by a method or system for the precipitation or crystallization of lithium from solution.

In some embodiments, the raffinate combined with the liquid resource to provide a concentration-adjusted liquid resource comprises lithium that would have otherwise been disposed of if the raffinate had not been combined with the liquid resource. In some embodiments, the aqueous lithium solution combined with the liquid resource to provide a concentration-adjusted liquid resource comprises lithium that would have otherwise been disposed of if the aqueous lithium solution had not been combined with the liquid resource.

In some embodiments, utilizing a concentration-adjusted liquid resource as an input to an ion exchange device allows for a greater total recovery of lithium from a liquid resource. In some embodiments, utilizing a concentration-adjusted liquid resource as an input to an ion exchange device allows fora greater total recovery of lithium from a liquid resource by virtue of contacting the lithium therein with a lithium-selective sorbent multiple times. In some embodiments, utilizing a concentration-adjusted liquid resource as an input to an ion exchange device allows for a greater total recovery of lithium from a liquid resource by virtue of contacting the lithium in the raffinate with a lithium-selective sorbent multiple times. In some embodiments, utilizing a concentration-adjusted liquid resource as an input to an ion exchange device allows for a greater total recovery of lithium from a liquid resource by virtue of contacting the lithium in the aqueous lithium solution with a lithium-selective sorbent multiple times. In some embodiments, the lithium present in a raffinate is a fraction of the lithium present in the liquid resource, such that recovery of lithium from the raffinate comprises further recovery of lithium from the liquid resource. In some embodiments, the lithium present in an aqueous lithium solution is a fraction of the lithium present in the liquid resource, such that recovery of lithium from the aqueous lithium solution comprises further recovery of lithium from the liquid resource.

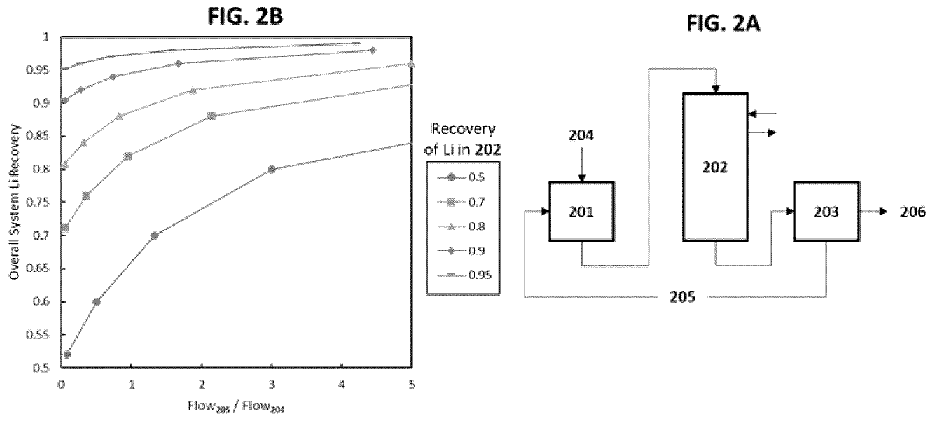

In some embodiments, utilizing a concentration-adjusted liquid resource as an input to an ion exchange device allows for a greater total recovery of lithium from a liquid resource. In some embodiments, the greater total recovery of lithium varies as described in Example 2 and FIG. 2B. In some embodiments, the total recovery of lithium from the liquid resource is greater than about 99.9%, greater than about 99%, greater than about 98%, greater than about 95%, greater than about 90%, greater than about 80%, greater than about 70%, greater than about 60%, greater than about 50%, greater than about 25%, greater than about 10%. In some embodiments, the total recovery of lithium from the liquid resource is about 70% to about 98%. In some embodiments, the total recovery of lithium from the liquid resource is about 70% to about 75%, about 70% to about 80%, about 70% to about 85%, about 70% to about 86%, about 70% to about 87%, about 70% to about 88%, about 70% to about 89%, about 70% to about 90%, about 70% to about 92%, about 70% to about 95%, about 70% to about 98%, about 75% to about 80%, about 75% to about 85%, about 75% to about 86%, about 75% to about 87%, about 75% to about 88%, about 75% to about 89%, about 75% to about 90%, about 75% to about 92%, about 75% to about 95%, about 75% to about 98%, about 80% to about 85%, about 80% to about 86%, about 80% to about 87%, about 80% to about 88%, about 80% to about 89%, about 80% to about 90%, about 80% to about 92%, about 80% to about 95%, about 80% to about 98%, about 85% to about 86%, about 85% to about 87%, about 85% to about 88%, about 85% to about 89%, about 85% to about 90%, about 85% to about 92%, about 85% to about 95%, about 85% to about 98%, about 86% to about 87%, about 86% to about 88%, about 86% to about 89%, about 86% to about 90%, about 86% to about 92%, about 86% to about 95%, about 86% to about 98%, about 87% to about 88%, about 87% to about 89%, about 87% to about 90%, about 87% to about 92%, about 87% to about 95%, about 870% to about 98%, about 88% to about 89%, about 88% to about 900%, about 880% to about 920%, about 88% to about 95%, about 88% to about 98%, about 89% to about 90%, about 89% to about 92%, about 89% to about 95%, about 89% to about 98%, about 90% to about 92%, about 90% to about 95%, about 90% to about 98%, about 92% to about 95%, about 92% to about 98%, or about 95% to about 98%. In some embodiments, the total recovery of lithium from the liquid resource is about 70%, about 75%, about 80%, about 85%, about 86%, about 87%, about 88%, about 89%, about 90%, about 92%, about 95%, or about 98%. In some embodiments, the total recovery of lithium from the liquid resource is at least about 70%, about 75%, about 80%, about 85%, about 86%, about 87%, about 88%, about 89%, about 90%, about 92%, or about 95%. In some embodiments, the total recovery of lithium from the liquid resource is at most about 75%, about 80%, about 85%, about 86%, about 87%, about 88%, about 89%, about 90%, about 92%, about 95%, or about 98%.

In some embodiments, a raffinate may be filtered prior to combining with a liquid resource to provide a concentration-adjusted liquid resource. In some embodiments, a raffinate may have its pH adjusted prior to combining with a liquid resource to provide a concentration-adjusted liquid resource. In some embodiments, an aqueous lithium solution may be filtered prior to combining with a liquid resource to provide a concentration-adjusted liquid resource. In some embodiments, an aqueous lithium solution may have its pH adjusted prior to combining with a liquid resource to provide a concentration-adjusted liquid resource.

In some embodiments, a dedicated system may be configured to direct a portion of raffinate to combine with liquid resource to provide a concentration-adjusted liquid resource that is subsequently input to a system for lithium recovery from a liquid resource. In some embodiments, the dedicated system may be a splitting system. In some embodiments, a subsystem may be configured to direct a portion of raffinate to combine with liquid resource to provide a concentration-adjusted liquid resource, wherein the subsystem is a component of a system for lithium recovery from a liquid resource. In some embodiments, the subsystem may be a splitting system.

In some embodiments, the splitting system may comprise a filter. In some embodiments, the filter is a belt filter, plate-and-frame filter press, pressure vessel containing filter elements, rotary drum filter, rotary disc filter, cartridge filter, a centrifugal filter with a fixed or moving bed, a metal screen, a perforate basket centrifuge, a three-point centrifuge, a peeler type centrifuge, or a pusher centrifuge. In some embodiments, the filter may use a scroll or a vibrating device. In some embodiments, the filter may be a dead-end filter or a cross-flow filter. In some embodiments, the filter may comprise one or more microfiltration, ultrafiltration, or nanofiltration membranes. In some embodiments, filtration membranes may comprise hollow fibers, tubular fibers, or spiral wound elements, together with other structural components required to maintain effective fluid flow through said membranes. In some embodiments, the filter is horizontal, vertical, or may use a siphon. In some embodiments, more than one filter may be used, wherein a first filter excludes particles above a first particle size, while the subsequent filters exclude particles above a second particle size smaller than the first particle size.

In some embodiments, the filters are configured such that particles above a certain characteristic dimension are excluded from passing through the filters. In some embodiments, a system or subsystem for adjusting a liquid resource may comprise a filter. In some embodiments, the adjusting fluid may be added to a liquid resource prior to the liquid resource being subjected to a filtration step or filtration system. In some embodiments, the adjusting fluid may be added to a liquid resource after the liquid resource has been subjected to a filtration step or filtration system.

In some embodiments, a filter may be configured to exclude particles that are 5 nm in size to 900 nm in size. In some embodiments, a filter may be configured to exclude particles that are 900 nm in size to 800 nm in size, 900 nm in size to 700 nm in size, 900 nm in size to 600 nm in size, 900 nm in size to 500 nm in size, 900 nm in size to 400 nm in size, 900 nm in size to 300 nm in size, 900 nm in size to 200 nm in size, 900 nm in size to 100 nm in size, 900 nm in size to 50 nm in size, 900 nm in size to 10 nm in size, 900 nm in size to 5 nm in size, 800 nm in size to 700 nm in size, 800 nm in size to 600 nm in size, 800 nm in size to 500 nm in size, 800 nm in size to 400 nm in size, 800 nm in size to 300 nm in size, 800 nm in size to 200 nm in size, 800 nm in size to 100 nm in size, 800 nm in size to 50 nm in size, 800 nm in size to 10 nm in size, 800 nm in size to 5 nm in size, 700 nm in size to 600 nm in size, 700 nm in size to 500 nm in size, 700 nm in size to 400 nm in size, 700 nm in size to 300 nm in size, 700 nm in size to 200 nm in size, 700 nm in size to 100 nm in size, 700 nm in size to 50 nm in size, 700 nm in size to 10 nm in size, 700 nm in size to 5 nm in size, 600 nm in size to 500 nm in size, 600 nm in size to 400 nm in size, 600 nm in size to 300 nm in size, 600 nm in size to 200 nm in size, 600 nm in size to 100 nm in size, 600 nm in size to 50 nm in size, 600 nm in size to 10 nm in size, 600 nm in size to 5 nm in size, 500 nm in size to 400 nm in size, 500 nm in size to 300 nm in size, 500 nm in size to 200 nm in size, 500 nm in size to 100 nm in size, 500 nm in size to 50 nm in size, 500 nm in size to 10 nm in size, 500 nm in size to 5 nm in size, 400 nm in size to 300 nm in size, 400 nm in size to 200 nm in size, 400 nm in size to 100 nm in size, 400 nm in size to 50 nm in size, 400 nm in size to 10 nm in size, 400 nm in size to 5 nm in size, 300 nm in size to 200 nm in size, 300 nm in size to 100 nm in size, 300 nm in size to 50 nm in size, 300 nm in size to 10 nm in size, 300 nm in size to 5 nm in size, 200 nm in size to 100 nm in size, 200 nm in size to 50 nm in size, 200 nm in size to 10 nm in size, 200 nm in size to 5 nm in size, 100 nm in size to 50 nm in size, 100 nm in size to 10 nm in size, 100 nm in size to 5 nm in size, 50 nm in size to 10 nm in size, 50 nm in size to 5 nm in size, or 10 nm in size to 5 nm in size. In some embodiments, a filter may be configured to exclude particles that are 900 nm in size, 800 nm in size, 700 nm in size, 600 nm in size, 500 nm in size, 400 nm in size, 300 nm in size, 200 nm in size, 100 nm in size, 50 nm in size, 10 nm in size, or 5 nm in size. In some embodiments, a filter may be configured to exclude particles that are at least 900 nm in size, 800 nm in size, 700 nm in size, 600 nm in size, 500 nm in size, 400 nm in size, 300 nm in size, 200 nm in size, 100 nm in size, 50 nm in size, or 10 nm in size. In some embodiments, a filter may be configured to exclude particles that are at most 800 nm in size, 700 nm in size, 600 nm in size, 500 nm in size, 400 nm in size, 300 nm in size, 200 nm in size, 100 nm in size, 50 nm in size, 10 nm in size, or 5 nm in size.

In some embodiments, a filter may be configured to exclude particles that are 5 nm in size to 100 nm in size. In some embodiments, a filter may be configured to exclude particles that are 100 nm in size to 90 nm in size, 100 nm in size to 80 nm in size, 100 nm in size to 70 nm in size, 100 nm in size to 60 nm in size, 100 nm in size to 50 nm in size, 100 nm in size to 40 nm in size, 100 nm in size to 30 nm in size, 100 nm in size to 20 nm in size, 100 nm in size to 10 nm in size, 100 nm in size to 5 nm in size, 90 nm in size to 80 nm in size, 90 nm in size to 70 nm in size, 90 nm in size to 60 nm in size, 90 nm in size to 50 nm in size, 90 nm in size to 40 nm in size, 90 nm in size to 30 nm in size, 90 nm in size to 20 nm in size, 90 nm in size to 10 nm in size, 90 nm in size to 5 nm in size, 80 nm in size to 70 nm in size, 80 nm in size to 60 nm in size, 80 nm in size to 50 nm in size, 80 nm in size to 40 nm in size, 80 nm in size to 30 nm in size, 80 nm in size to 20 nm in size, 80 nm in size to 10 nm in size, 80 nm in size to 5 nm in size, 70 nm in size to 60 nm in size, 70 nm in size to 50 nm in size, 70 nm in size to 40 nm in size, 70 nm in size to 30 nm in size, 70 nm in size to 20 nm in size, 70 nm in size to 10 nm in size, 70 nm in size to 5 nm in size, 60 nm in size to 50 nm in size, 60 nm in size to 40 nm in size, 60 nm in size to 30 nm in size, 60 nm in size to 20 nm in size, 60 nm in size to 10 nm in size, 60 nm in size to 5 nm in size, 50 nm in size to 40 nm in size, 50 nm in size to 30 nm in size, 50 nm in size to 20 nm in size, 50 nm in size to 10 nm in size, 50 nm in size to 5 nm in size, 40 nm in size to 30 nm in size, 40 nm in size to 20 nm in size, 40 nm in size to 10 nm in size, 40 nm in size to 5 nm in size, 30 nm in size to 20 nm in size, 30 nm in size to 10 nm in size, 30 nm in size to 5 nm in size, 20 nm in size to 10 nm in size, 20 nm in size to 5 nm in size, or 10 nm in size to 5 nm in size. In some embodiments, a filter may be configured to exclude particles that are 100 nm in size, 90 nm in size, 80 nm in size, 70 nm in size, 60 nm in size, 50 nm in size, 40 nm in size, 30 nm in size, 20 nm in size, 10 nm in size, or 5 nm in size. In some embodiments, a filter may be configured to exclude particles that are at least 100 nm in size, 90 nm in size, 80 nm in size, 70 nm in size, 60 nm in size, 50 nm in size, 40 nm in size, 30 nm in size, 20 nm in size, or 10 nm in size. In some embodiments, a filter may be configured to exclude particles that are at most 90 nm in size, 80 nm in size, 70 nm in size, 60 nm in size, 50 nm in size, 40 nm in size, 30 nm in size, 20 nm in size, 10 nm in size, or 5 nm in size.

In some embodiments, a filter may be configured to exclude particles that are 1 micron in size to 100 microns in size. In some embodiments, a filter may be configured to exclude particles that are 100 microns in size to 90 microns in size, 100 microns in size to 70 microns in size, 100 microns in size to 50 microns in size, 100 microns in size to 40 microns in size, 100 microns in size to 30 microns in size, 100 microns in size to 20 microns in size, 100 microns in size to 10 microns in size, 100 microns in size to 5 microns in size, 100 microns in size to 3 microns in size, 100 microns in size to 2 microns in size, 100 microns in size to 1 micron in size, 90 microns in size to 70 microns in size, 90 microns in size to 50 microns in size, 90 microns in size to 40 microns in size, 90 microns in size to 30 microns in size, 90 microns in size to 20 microns in size, 90 microns in size to 10 microns in size, 90 microns in size to 5 microns in size, 90 microns in size to 3 microns in size, 90 microns in size to 2 microns in size, 90 microns in size to 1 micron in size, 70 microns in size to 50 microns in size, 70 microns in size to 40 microns in size, 70 microns in size to 30 microns in size, 70 microns in size to 20 microns in size, 70 microns in size to 10 microns in size, 70 microns in size to 5 microns in size, 70 microns in size to 3 microns in size, 70 microns in size to 2 microns in size, 70 microns in size to 1 micron in size, 50 microns in size to 40 microns in size, 50 microns in size to 30 microns in size, 50 microns in size to 20 microns in size, 50 microns in size to 10 microns in size, 50 microns in size to 5 microns in size, 50 microns in size to 3 microns in size, 50 microns in size to 2 microns in size, 50 microns in size to 1 micron in size, 40 microns in size to 30 microns in size, 40 microns in size to 20 microns in size, 40 microns in size to 10 microns in size, 40 microns in size to 5 microns in size, 40 microns in size to 3 microns in size, 40 microns in size to 2 microns in size, 40 microns in size to 1 micron in size, 30 microns in size to 20 microns in size, 30 microns in size to 10 microns in size, 30 microns in size to 5 microns in size, 30 microns in size to 3 microns in size, 30 microns in size to 2 microns in size, 30 microns in size to 1 micron in size, 20 microns in size to 10 microns in size, 20 microns in size to 5 microns in size, 20 microns in size to 3 microns in size, 20 microns in size to 2 microns in size, 20 microns in size to 1 micron in size, 10 microns in size to 5 microns in size, 10 microns in size to 3 microns in size, 10 microns in size to 2 microns in size, 10 microns in size to 1 micron in size, 5 microns in size to 3 microns in size, 5 microns in size to 2 microns in size, 5 microns in size to 1 micron in size, 3 microns in size to 2 microns in size, 3 microns in size to 1 micron in size, or 2 microns in size to 1 micron in size. In some embodiments, a filter may be configured to exclude particles that are 100 microns in size, 90 microns in size, 70 microns in size, 50 microns in size, 40 microns in size, 30 microns in size, 20 microns in size, 10 microns in size, 5 microns in size, 3 microns in size, 2 microns in size, or 1 micron in size. In some embodiments, a filter may be configured to exclude particles that are at least 100 microns in size, 90 microns in size, 70 microns in size, 50 microns in size, 40 microns in size, 30 microns in size, 20 microns in size, 10 microns in size, 5 microns in size, 3 microns in size, or 2 microns in size. In some embodiments, a filter may be configured to exclude particles that are at most 90 microns in size, 70 microns in size, 50 microns in size, 40 microns in size, 30 microns in size, 20 microns in size, 10 microns in size, 5 microns in size, 3 microns in size, 2 microns in size, or 1 micron in size. In some embodiments, a filter may be configured to exclude particles that are 100 microns in size to 2,000 microns in size. In some embodiments, a filter may be configured to exclude particles that are 2,000 microns in size to 1,500 microns in size, 2,000 microns in size to 1,000 microns in size, 2,000 microns in size to 900 microns in size, 2,000 microns in size to 800 microns in size, 2,000 microns in size to 700 microns in size, 2,000 microns in size to 600 microns in size, 2,000 microns in size to 500 microns in size, 2,000 microns in size to 400 microns in size, 2,000 microns in size to 300 microns in size, 2,000 microns in size to 200 microns in size, 2,000 microns in size to 100 microns in size, 1,500 microns in size to 1,000 microns in size, 1,500 microns in size to 900 microns in size, 1,500 microns in size to 800 microns in size, 1,500 microns in size to 700 microns in size, 1,500 microns in size to 600 microns in size, 1,500 microns in size to 500 microns in size, 1,500 microns in size to 400 microns in size, 1,500 microns in size to 300 microns in size, 1,500 microns in size to 200 microns in size, 1,500 microns in size to 100 microns in size, 1,000 microns in size to 900 microns in size, 1,000 microns in size to 800 microns in size, 1,000 microns in size to 700 microns in size, 1,000 microns in size to 600 microns in size, 1,000 microns in size to 500 microns in size, 1,000 microns in size to 400 microns in size, 1,000 microns in size to 300 microns in size, 1,000 microns in size to 200 microns in size, 1,000 microns in size to 100 microns in size, 900 microns in size to 800 microns in size, 900 microns in size to 700 microns in size, 900 microns in size to 600 microns in size, 900 microns in size to 500 microns in size, 900 microns in size to 400 microns in size, 900 microns in size to 300 microns in size, 900 microns in size to 200 microns in size, 900 microns in size to 100 microns in size, 800 microns in size to 700 microns in size, 800 microns in size to 600 microns in size, 800 microns in size to 500 microns in size, 800 microns in size to 400 microns in size, 800 microns in size to 300 microns in size, 800 microns in size to 200 microns in size, 800 microns in size to 100 microns in size, 700 microns in size to 600 microns in size, 700 microns in size to 500 microns in size, 700 microns in size to 400 microns in size, 700 microns in size to 300 microns in size, 700 microns in size to 200 microns in size, 700 microns in size to 100 microns in size, 600 microns in size to 500 microns in size, 600 microns in size to 400 microns in size, 600 microns in size to 300 microns in size, 600 microns in size to 200 microns in size, 600 microns in size to 100 microns in size, 500 microns in size to 400 microns in size, 500 microns in size to 300 microns in size, 500 microns in size to 200 microns in size, 500 microns in size to 100 microns in size, 400 microns in size to 300 microns in size, 400 microns in size to 200 microns in size, 400 microns in size to 100 microns in size, 300 microns in size to 200 microns in size, 300 microns in size to 100 microns in size, or 200 microns in size to 100 microns in size. In some embodiments, a filter may be configured to exclude particles that are 2,000 microns in size, 1,500 microns in size, 1,000 microns in size, 900 microns in size, 800 microns in size, 700 microns in size, 600 microns in size, 500 microns in size, 400 microns in size, 300 microns in size, 200 microns in size, or 100 microns in size. In some embodiments, a filter may be configured to exclude particles that are at least 2,000 microns in size, 1,500 microns in size, 1,000 microns in size, 900 microns in size, 800 microns in size, 700 microns in size, 600 microns in size, 500 microns in size, 400 microns in size, 300 microns in size, or 200 microns in size. In some embodiments, a filter may be configured to exclude particles that are at most 1,500 microns in size, 1,000 microns in size, 900 microns in size, 800 microns in size, 700 microns in size, 600 microns in size, 500 microns in size, 400 microns in size, 300 microns in size, 200 microns in size, or 100 microns in size.

In some embodiments, one or more particle traps comprise one or more meshes. In some embodiments, one or more particle traps comprises one mesh. In some embodiments, one or more particle traps comprises two meshes. In some embodiments, one or more particle traps comprises three meshes. In some embodiments, one or more particle traps comprises four meshes. In some embodiments, one or more particle traps comprises five meshes. In some embodiments, all the meshes of the one or more particle traps are identical. In some embodiments, at least one of the meshes of the one or more particle traps is not identical to the other the meshes of the one or more particle traps.

In some embodiments, one or more meshes comprise a pore size of less than about 200 microns, less than about 175 microns, less than about 150 microns, less than about 100 microns, less than about 75 microns, less than about 50 microns, less than about 25 microns, less than about 10 microns, more than about 1 micron, more than about 5 micron, more than about 10 microns, more than about 20 microns, more than about 30 microns, more than about 40 microns, more than about 50 microns, more than about 60 microns, more than about 70 microns, more than about 80 microns, more than about 90 microns, more than about 100 microns, more than about 125 microns, more than about 150 microns, more than about 175 microns from about 1 micron to about 200 microns, from about 5 microns to about 175 microns, from about 10 microns to about 150 microns, from about 10 microns to about 100 microns, from about 10 microns to about 90 microns, from about 10 microns to about 80 microns, from about 10 microns to about 70 microns, from about 10 microns to about 60 microns, or from about 10 microns to about 50 microns.

In some embodiments, one or more particle traps comprise multi-layered meshes. In some embodiments, the multi-layered meshes comprise at least one finer mesh for filtration and at least one coarser mesh for structural support. In some embodiments, one or more particle traps comprise one or more meshes supported by a structural support. In some embodiments, one or more particle traps comprise one or more polymer meshes. In some embodiments, the one or more polymer meshes are selected from the group consisting of polyetheretherketone, ethylene tetrafluorethylene, polyethylene terephthalate, polypropylene, and combinations thereof. In some embodiments, the one or more meshes comprise a monofilament mesh. In some embodiments, the one or more meshes comprise a multi-weave mesh. In some embodiments, the one or more meshes may be constructed from one or more types of fibers. In some embodiments, said one or more fibers are weaved into one or more weave patterns. In some embodiments, said weave patterns comprise a plain weave, a twilled weave, a plain filter loth weave, a Dutch Weave, a twilled filter cloth weave, a twilled Dutch Weave, a micron weave, mixtures thereof, or combinations thereof.

In some embodiments, one or more particle traps comprise one or more meshes comprising a metal wire mesh. In some embodiments, the metal wire mesh is coated with a polymer. In some embodiments, the ion exchange device is configured to move ion exchange material into one or more columns for washing. In some embodiments, the ion exchange device is configured to allow the ion exchange material to settle into one or more columns for washing. In some embodiments, the columns are affixed to the bottom of the tank. In some embodiments, the one or more particle traps comprise one or more filters mounted in one or more ports through the wall of the tank.

In some embodiments, the one or more particle traps comprise one or more filters external to the tank, and with provision for fluid communication between said one or more filters and the tank. In some embodiments, the one or more particle traps comprise one or more gravity sedimentation devices external to the tank, and with provision for fluid communication between said one or more gravity sedimentation devices and the tank. In some embodiments, the one or more particle traps comprise one or more filter presses external to the tank. In some embodiments, the one or more particle traps comprise one or more vertical pressure filters external to the tank. In some embodiments, the one or more particle traps comprise one or more pressure leaf filters external to the tank. In some embodiments, the one or more particle traps comprise one or more belt filters external to the tank.

In some embodiments, one or more particle traps comprise one or more gravity sedimentation devices internal to the tank. In some embodiments, one or more particle traps comprise one or more centrifugal sedimentation devices external to the tank, and with provision for fluid communication between said one or more centrifugal sedimentation devices and the tank. In some embodiments, said sedimentations devices comprise a clarifier, a lamellar clarifier, a reflux clarifier, or any other device design to sediment the solids to the bottom while facilitating flow of a solid-lean liquid from the top. In some embodiments, one or more particle traps comprise one or more centrifugal sedimentation devices internal to the tank. In some embodiments, one or more particle traps comprise one or more settling tanks, one or more centrifugal devices, or combinations thereof external to the tank, and with provision for fluid communication between the one or more settling tanks, centrifugal devices, or combinations thereof, and the tank. In some embodiments, one or more particle traps comprise one or more meshes, one or more centrifugal devices, or combinations thereof external to the tank, and with provision for fluid communication between said one or more meshes, centrifugal devices, or combinations thereof, and the tank. In some embodiments, one or more particle traps comprise one or more settling tanks, one or more meshes, or combinations thereof external to the tank, and with provision for fluid communication between said one or more settling tanks, meshes, or combinations thereof, and the tank. In some embodiments, one or more particle traps comprise one or more meshes, one or more settling tanks, one or more centrifugal devices, or combinations thereof external to the tank, and with provision for fluid communication between said one or more meshes, one or more settling tanks, centrifugal devices, or combinations thereof, and the tank.

In some embodiments, the concentration-adjusted liquid resource may have a lower viscosity than the liquid resource. In some embodiments, the concentration-adjusted liquid resource may have a greater viscosity than the liquid resource. In some embodiments, the concentration-adjusted liquid resource may have the same viscosity as the liquid resource. In some embodiments, the concentration-adjusted liquid resource may have a lower density than the liquid resource. In some embodiments, the concentration-adjusted liquid resource may have a greater density than the liquid resource. In some embodiments, the concentration-adjusted liquid resource may have the same density as the liquid resource.

In some embodiments, the viscosity of a concentration-adjusted liquid resource may be 0 cP to 50 cP. In some embodiments, the viscosity of a concentration-adjusted liquid resource may be 50 cP to 30 cP, 50 cP to 20 cP, 50 cP to 10 cP, 50 cP to 8 cP, 50 cP to 6 cP, 50 cP to 5 cP, 50 cP to 4 cP, 50 cP to 3 cP, 50 cP to 2 cP, 50 cP to 1 cP, 50 cP to 0 cP, 30 cP to 20 cP, 30 cP to 10 cP, 30 cP to 8 cP, 30 cP to 6 cP, 30 cP to 5 cP, 30 cP to 4 cP, 30 cP to 3 cP, 30 cP to 2 cP, 30 cP to 1 cP, 30 cP to 0 cP, 20 cP to 10 cP, 20 cP to 8 cP, 20 cP to 6 cP, 20 cP to 5 cP, 20 cP to 4 cP, 20 cP to 3 cP, 20 cP to 2 cP, 20 cP to 1 cP, 20 cP to 0 cP, 10 cP to 8 cP, 10 cP to 6 cP, 10 cP to 5 cP, 10 cP to 4 cP, 10 cP to 3 cP, 10 cP to 2 cP, 10 cP to 1 cP, 10 cP to 0 cP, 8 cP to 6 cP, 8 cP to 5 cP, 8 cP to 4 cP, 8 cP to 3 cP, 8 cP to 2 cP, 8 cP to 1 cP, 8 cP to 0 cP, 6 cP to 5 cP, 6 cP to 4 cP, 6 cP to 3 cP, 6 cP to 2 cP, 6 cP to 1 cP, 6 cP to 0 cP, 5 cP to 4 cP, 5 cP to 3 cP, 5 cP to 2 cP, 5 cP to 1 cP, 5 cP to 0 cP, 4 cP to 3 cP, 4 cP to 2 cP, 4 cP to 1 cP, 4 cP to 0 cP, 3 cP to 2 cP, 3 cP to 1 cP, 3 cP to 0 cP, 2 cP to 1 cP, 2 cP to 0 cP, or 1 cP to 0 cP. In some embodiments, the viscosity of a concentration-adjusted liquid resource may be 50 cP, 30 cP, 20 cP, 10 cP, 8 cP, 6 cP, 5 cP, 4 cP, 3 cP, 2 cP, 1 cP, or 0 cP. In some embodiments, the viscosity of a concentration-adjusted liquid resource may be at least 50 cP, 30 cP, 20 cP, 10 cP, 8 cP, 6 cP, 5 cP, 4 cP, 3 cP, 2 cP, or 1 cP. In some embodiments, the viscosity of a concentration-adjusted liquid resource may be at most 30 cP, 20 cP, 10 cP, 8 cP, 6 cP, 5 cP, 4 cP, 3 cP, 2 cP, 1 cP, or 0 cP.

In some embodiments, the density of a concentration-adjusted liquid resource may be 1 g/mL to 1.3 g/mL. In some embodiments, the density of a concentration-adjusted liquid resource may be 1.3 g/mL to 1.25 g/mL, 1.3 g/mL to 1.2 g/mL, 1.3 g/mL to 1.15 g/mL, 1.3 g/mL to 1.1 g/mL, 1.3 g/mL to 1.05 g/mL, 1.3 g/mL to 1 g/mL, 1.25 g/mL to 1.2 g/mL, 1.25 g/mL to 1.15 g/mL, 1.25 g/mL to 1.1 g/mL, 1.25 g/mL to 1.05 g/mL, 1.25 g/mL to 1 g/mL, 1.2 g/mL to 1.15 g/mL, 1.2 g/mL to 1.1 g/mL, 1.2 g/mL to 1.05 g/mL, 1.2 g/mL to 1 g/mL, 1.15 g/mL to 1.1 g/mL, 1.15 g/mL to 1.05 g/mL, 1.15 g/mL to 1 g/mL, 1.1 g/mL to 1.05 g/mL, 1.1 g/mL to 1 g/mL, or 1.05 g/mL to 1 g/mL. In some embodiments, the density of a concentration-adjusted liquid resource may be 1.3 g/mL, 1.25 g/mL, 1.2 g/mL, 1.15 g/mL, 1.1 g/mL, 1.05 g/mL, or 1 g/mL. In some embodiments, the density of a concentration-adjusted liquid resource may be at least 1.3 g/mL, 1.25 g/mL, 1.2 g/mL, 1.15 g/mL, 1.1 g/mL, or 1.05 g/mL. In some embodiments, the density of a concentration-adjusted liquid resource may be at most 1.25 g/mL, 1.2 g/mL, 1.15 g/mL, 1.1 g/mL, 1.05 g/mL, or 1 g/mL.

In some embodiments, the concentration-adjusted liquid resource may have a lower pH than the liquid resource. In some embodiments, the raffinate may have a lower pH than the liquid resource such that addition of raffinate to the liquid resource results in a lowering of the pH of the liquid resource. In some embodiments, the raffinate has a lower pH relative to the liquid resource as a result of an ion exchange process that extracts lithium ions from solution and releases hydrogen ions into solution. In some embodiments, a pH modulating unit may adjust the pH of the liquid resource or the concentration adjusted liquid resource. In some embodiments, a pH modulating unit may adjust the pH of the raffinate. In some embodiments, an ion exchange device may comprise a pH modulating unit that is configured to increase the pH of the raffinate leaving the ion exchange device. In some embodiments, use of a pH modulating unit may lead to improved performance parameters for ion exchange processes, ion exchange devices, and ion exchange materials.

In some embodiments, the pH of the concentration-adjusted liquid resource prior to lithium extraction may be 5.5 to 12. In some embodiments, the pH of the concentration-adjusted liquid resource prior to lithium extraction may be 12 to 11, 12 to 10, 12 to 9.5, 12 to 9, 12 to 8.5, 12 to 8, 12 to 7.5, 12 to 7, 12 to 6.5, 12 to 6, 12 to 5.5, 11 to 10, 11 to 9.5, 11 to 9, 11 to 8.5, 11 to 8, 11 to 7.5, 11 to 7, 11 to 6.5, 11 to 6, 11 to 5.5, 10 to 9.5, 10 to 9, 10 to 8.5, 10 to 8, 10 to 7.5, 10 to 7, 10 to 6.5, 10 to 6, 10 to 5.5, 9.5 to 9, 9.5 to 8.5, 9.5 to 8, 9.5 to 7.5, 9.5 to 7, 9.5 to 6.5, 9.5 to 6, 9.5 to 5.5, 9 to 8.5, 9 to 8, 9 to 7.5, 9 to 7, 9 to 6.5, 9 to 6, 9 to 5.5, 8.5 to 8, 8.5 to 7.5, 8.5 to 7, 8.5 to 6.5, 8.5 to 6, 8.5 to 5.5, 8 to 7.5, 8 to 7, 8 to 6.5, 8 to 6, 8 to 5.5, 7.5 to 7, 7.5 to 6.5, 7.5 to 6, 7.5 to 5.5, 7 to 6.5, 7 to 6, 7 to 5.5, 6.5 to 6, 6.5 to 5.5, or 6 to 5.5. In some embodiments, the pH of the concentration-adjusted liquid resource prior to lithium extraction may be 12, 11, 10, 9.5, 9, 8.5, 8, 7.5, 7, 6.5, 6, or 5.5. In some embodiments, the pH of the concentration-adjusted liquid resource prior to lithium extraction may be at least 12, 11, 10, 9.5, 9, 8.5, 8, 7.5, 7, 6.5, or 6. In some embodiments, the pH of the concentration-adjusted liquid resource prior to lithium extraction may be at most 11, 10, 9.5, 9, 8.5, 8, 7.5, 7, 6.5, 6, or 5.5. In some embodiments, the pH of the concentration-adjusted liquid resource prior to lithium extraction may be about 5.5 to about 12. In some embodiments, the pH of the concentration-adjusted liquid resource prior to lithium extraction may be about 12 to about 11, about 12 to about 10, about 12 to about 9.5, about 12 to about 9, about 12 to about 8.5, about 12 to about 8, about 12 to about 7.5, about 12 to about 7, about 12 to about 6.5, about 12 to about 6, about 12 to about 5.5, about 11 to about 10, about 11 to about 9.5, about 11 to about 9, about 11 to about 8.5, about 11 to about 8, about 11 to about 7.5, about 11 to about 7, about 11 to about 6.5, about 11 to about 6, about 11 to about 5.5, about 10 to about 9.5, about 10 to about 9, about 10 to about 8.5, about 10 to about 8, about 10 to about 7.5, about 10 to about 7, about 10 to about 6.5, about 10 to about 6, about 10 to about 5.5, about 9.5 to about 9, about 9.5 to about 8.5, about 9.5 to about 8, about 9.5 to about 7.5, about 9.5 to about 7, about 9.5 to about 6.5, about 9.5 to about 6, about 9.5 to about 5.5, about 9 to about 8.5, about 9 to about 8, about 9 to about 7.5, about 9 to about 7, about 9 to about 6.5, about 9 to about 6, about 9 to about 5.5, about 8.5 to about 8, about 8.5 to about 7.5, about 8.5 to about 7, about 8.5 to about 6.5, about 8.5 to about 6, about 8.5 to about 5.5, about 8 to about 7.5, about 8 to about 7, about 8 to about 6.5, about 8 to about 6, about 8 to about 5.5, about 7.5 to about 7, about 7.5 to about 6.5, about 7.5 to about 6, about 7.5 to about 5.5, about 7 to about 6.5, about 7 to about 6, about 7 to about 5.5, about 6.5 to about 6, about 6.5 to about 5.5, or about 6 to about 5.5. In some embodiments, the pH of the concentration-adjusted liquid resource prior to lithium extraction may be about 12, about 11, about 10, about 9.5, about 9, about 8.5, about 8, about 7.5, about 7, about 6.5, about 6, or about 5.5. In some embodiments, the pH of the concentration-adjusted liquid resource prior to lithium extraction may be at least about 12, about 11, about 10, about 9.5, about 9, about 8.5, about 8, about 7.5, about 7, about 6.5, or about 6. In some embodiments, the pH of the concentration-adjusted liquid resource prior to lithium extraction may be at most about 11, about 10, about 9.5, about 9, about 8.5, about 8, about 7.5, about 7, about 6.5, about 6, or about 5.5.

In some embodiments, the pH of the lithium-depleted liquid resource following lithium extraction may be 5.5 to 12. In some embodiments, the pH of the lithium-depleted liquid resource following lithium extraction may be 12 to 11, 12 to 10, 12 to 9.5, 12 to 9, 12 to 8.5, 12 to 8, 12 to 7.5, 12 to 7, 12 to 6.5, 12 to 6, 12 to 5.5, 11 to 10, 11 to 9.5, 11 to 9, 11 to 8.5, 11 to 8, 11 to 7.5, 11 to 7, 11 to 6.5, 11 to 6, 11 to 5.5, 10 to 9.5, 10 to 9, 10 to 8.5, 10 to 8, 10 to 7.5, 10 to 7, 10 to 6.5, 10 to 6, 10 to 5.5, 9.5 to 9, 9.5 to 8.5, 9.5 to 8, 9.5 to 7.5, 9.5 to 7, 9.5 to 6.5, 9.5 to 6, 9.5 to 5.5, 9 to 8.5, 9 to 8, 9 to 7.5, 9 to 7, 9 to 6.5, 9 to 6, 9 to 5.5, 8.5 to 8, 8.5 to 7.5, 8.5 to 7, 8.5 to 6.5, 8.5 to 6, 8.5 to 5.5, 8 to 7.5, 8 to 7, 8 to 6.5, 8 to 6, 8 to 5.5, 7.5 to 7, 7.5 to 6.5, 7.5 to 6, 7.5 to 5.5, 7 to 6.5, 7 to 6, 7 to 5.5, 6.5 to 6, 6.5 to 5.5, or 6 to 5.5. In some embodiments, the pH of the lithium-depleted liquid resource following lithium extraction may be 12, 11, 10, 9.5, 9, 8.5, 8, 7.5, 7, 6.5, 6, or 5.5. In some embodiments, the pH of the lithium-depleted liquid resource following lithium extraction may be at least 12, 11, 10, 9.5, 9, 8.5, 8, 7.5, 7, 6.5, or 6. In some embodiments, the pH of the lithium-depleted liquid resource following lithium extraction may be at most 11, 10, 9.5, 9, 8.5, 8, 7.5, 7, 6.5, 6, or 5.5. In some embodiments, the pH of the lithium-depleted liquid resource following lithium extraction may be about 5.5 to about 12. In some embodiments, the pH of the lithium-depleted liquid resource following lithium extraction may be about 12 to about 11, about 12 to about 10, about 12 to about 9.5, about 12 to about 9, about 12 to about 8.5, about 12 to about 8, about 12 to about 7.5, about 12 to about 7, about 12 to about 6.5, about 12 to about 6, about 12 to about 5.5, about 11 to about 10, about 11 to about 9.5, about 11 to about 9, about 11 to about 8.5, about 11 to about 8, about 11 to about 7.5, about 11 to about 7, about 11 to about 6.5, about 11 to about 6, about 11 to about 5.5, about 10 to about 9.5, about 10 to about 9, about 10 to about 8.5, about 10 to about 8, about 10 to about 7.5, about 10 to about 7, about 10 to about 6.5, about 10 to about 6, about 10 to about 5.5, about 9.5 to about 9, about 9.5 to about 8.5, about 9.5 to about 8, about 9.5 to about 7.5, about 9.5 to about 7, about 9.5 to about 6.5, about 9.5 to about 6, about 9.5 to about 5.5, about 9 to about 8.5, about 9 to about 8, about 9 to about 7.5, about 9 to about 7, about 9 to about 6.5, about 9 to about 6, about 9 to about 5.5, about 8.5 to about 8, about 8.5 to about 7.5, about 8.5 to about 7, about 8.5 to about 6.5, about 8.5 to about 6, about 8.5 to about 5.5, about 8 to about 7.5, about 8 to about 7, about 8 to about 6.5, about 8 to about 6, about 8 to about 5.5, about 7.5 to about 7, about 7.5 to about 6.5, about 7.5 to about 6, about 7.5 to about 5.5, about 7 to about 6.5, about 7 to about 6, about 7 to about 5.5, about 6.5 to about 6, about 6.5 to about 5.5, or about 6 to about 5.5. In some embodiments, the pH of the lithium-depleted liquid resource following lithium extraction may be about 12, about 11, about 10, about 9.5, about 9, about 8.5, about 8, about 7.5, about 7, about 6.5, about 6, or about 5.5. In some embodiments, the pH of the lithium-depleted liquid resource following lithium extraction may be at least about 12, about 11, about 10, about 9.5, about 9, about 8.5, about 8, about 7.5, about 7, about 6.5, or about 6. In some embodiments, the pH of the lithium-depleted liquid resource following lithium extraction may be at most about 11, about 10, about 9.5, about 9, about 8.5, about 8, about 7.5, about 7, about 6.5, about 6, or about 5.5.

In some embodiments, the decrease in pH of the concentration-adjusted liquid resource over the course of lithium extraction may be 1 to 10. In some embodiments, the decrease in pH of the concentration-adjusted liquid resource over the course of lithium extraction may be 10 to 9, 10 to 8, 10 to 7, 10 to 6, 10 to 5, 10 to 4, 10 to 3, 10 to 2, 10 to 1, 9 to 8, 9 to 7, 9 to 6, 9 to 5, 9 to 4, 9 to 3, 9 to 2, 9 to 1, 8 to 7, 8 to 6, 8 to 5, 8 to 4, 8 to 3, 8 to 2, 8 to 1, 7 to 6, 7 to 5, 7 to 4, 7 to 3, 7 to 2, 7 to 1, 6 to 5, 6 to 4, 6 to 3, 6 to 2, 6 to 1, 5 to 4, 5 to 3, 5 to 2, 5 to 1, 4 to 3, 4 to 2, 4 to 1, 3 to 2, 3 to 1, or 2 to 1. In some embodiments, the decrease in pH of the concentration-adjusted liquid resource over the course of lithium extraction may be 10, 9, 8, 7, 6, 5, 4, 3, 2, or 1. In some embodiments, the decrease in pH of the concentration-adjusted liquid resource over the course of lithium extraction may beat least 10, 9, 8, 7, 6, 5, 4, 3, or 2. In some embodiments, the decrease in pH of the concentration-adjusted liquid resource over the course of lithium extraction may be at most 9, 8, 7, 6, 5, 4, 3, 2, or 1. In some embodiments, the decrease in pH of the concentration-adjusted liquid resource over the course of lithium extraction may be about 1 to about 10. In some embodiments, the decrease in pH of the concentration-adjusted liquid resource over the course of lithium extraction may be about 10 to about 9, about 10 to about 8, about 10 to about 7, about 10 to about 6, about 10 to about 5, about 10 to about 4, about 10 to about 3, about 10 to about 2, about 10 to about 1, about 9 to about 8, about 9 to about 7, about 9 to about 6, about 9 to about 5, about 9 to about 4, about 9 to about 3, about 9 to about 2, about 9 to about 1, about 8 to about 7, about 8 to about 6, about 8 to a bout 5, about 8 to about 4, about 8 to about 3, about 8 to about 2, about 8 to about 1, about 7 to about 6, about 7 to about 5, about 7 to about 4, about 7 to about 3, about 7 to about 2, about 7 to about 1, about 6 to about 5, about 6 to about 4, about 6 to about 3, about 6 to about 2, about 6 to about 1, about 5 to about 4, about 5 to about 3, about 5 to about 2, about 5 to about 1, about 4 to about 3, about 4 to about 2, about 4 to about 1, about 3 to about 2, about 3 to about 1, or about 2 to about 1. In some embodiments, the decrease in pH of the concentration-adjusted liquid resource over the course of lithium extraction may be about 10, about 9, about 8, about 7, about 6, about 5, about 4, about 3, about 2, or about 1. In some embodiments, the decrease in pH of the concentration-adjusted liquid resource over the course of lithium extraction may be at least about 10, about 9, about 8, about 7, about 6, about 5, about 4, about 3, or about 2. In some embodiments, the decrease in pH of the concentration-adjusted liquid resource over the course of lithium extraction may be at most about 9, about 8, about 7, about 6, about 5, about 4, about 3, about 2, or about 1.

In some embodiments, the system for lithium recovery may comprise one or more pH modulating units. In some embodiments, the one or more pH modulating units may be located prior to the inlet of the ion exchange device. In some embodiments, the one or more pH modulating units are located within the system or system for combining the liquid resource with adjusting fluids, adjusting ion solutions, or adjusting ion solids. In some embodiments, the one or more pH modulating units may be located within the ion exchange device. In some embodiments, the one or more pH modulating units are located after the outlet of the ion exchange device wherein the liquid resource or concentrated-adjusted liquid resource has undergone lithium extraction to provide a lithium-depleted liquid resource. In some embodiments, the one or more pH modulating units may be located within the splitting system.

In some embodiments, the pH of the liquid resource, the concentration adjusted liquid resource, the raffinate, or the aqueous lithium solution may be adjusted by the addition of one or more bases. In some embodiments, bases may include NaOH, LiOH, KOH, Mg(OH)₂, Ca(OH)₂, CaO, NH₃, Na₂SO₄, K₂SO₄, NaHSO₄, KHSO₄, NaOCl, KOCl, NaClO₄, KClO₄, NaH₂BO₃, Na₂HBO₃, Na₃BO₃, KH₂BO₃, K₂HBO₃, K₃BO₃, MgHBO₃, CaHBO₃, NaHCO₃, KHCO₃, NaCO₃, KCO₃, MgCO₃, CaCO₃, Na₂O, K₂O, Na₂CO₃, K₂CO₃, Na₃PO₄, Na₂HPO₄, NaH₂PO₄, K₃PO₄, K₂HPO₄, KH₂PO₄, CaHPO₄, MgHPO₄, sodium acetate, potassium acetate, magnesium acetate, poly(vinylpyridine), poly(vinylamine), polyacrylonitrile. In some embodiments, a pH modulating unit may be configured to add base.

In some embodiments, a concentration-adjusted liquid resource may have a pH of about 5 to about 10.5. In some embodiments, a concentration-adjusted liquid resource may have a pH of about 5 to about 5.5, about 5 to about 6, about 5 to about 6.5, about 5 to about 7, about 5 to about 7.5, about 5 to about 8, about 5 to about 8.5, about 5 to about 9, about 5 to about 9.5, about 5 to about 10, about 5 to about 10.5, about 5.5 to about 6, about 5.5 to about 6.5, about 5.5 to about 7, about 5.5 to about 7.5, about 5.5 to about 8, about 5.5 to about 8.5, about 5.5 to about 9, about 5.5 to about 9.5, about 5.5 to about 10, about 5.5 to about 10.5, about 6 to about 6.5, about 6 to about 7, about 6 to about 7.5, about 6 to about 8, about 6 to about 8.5, about 6 to about 9, about 6 to about 9.5, about 6 to about 10, about 6 to about 10.5, about 6.5 to about 7, about 6.5 to about 7.5, about 6.5 to about 8, about 6.5 to about 8.5, about 6.5 to about 9, about 6.5 to about 9.5, about 6.5 to about 10, about 6.5 to about 10.5, about 7 to about 7.5, about 7 to about 8, about 7 to about 8.5, about 7 to about 9, about 7 to about 9.5, about 7 to about 10, about 7 to about 10.5, about 7.5 to about 8, about 7.5 to about 8.5, about 7.5 to about 9, about 7.5 to about 9.5, about 7.5 to about 10, about 7.5 to about 10.5, about 8 to about 8.5, about 8 to about 9, about 8 to about 9.5, about 8 to about 10, about 8 to about 10.5, about 8.5 to about 9, about 8.5 to about 9.5, about 8.5 to about 10, about 8.5 to about 10.5, about 9 to about 9.5, about 9 to about 10, about 9 to about 10.5, about 9.5 to about 10, about 9.5 to about 10.5, or about 10 to about 10.5. In some embodiments, a concentration-adjusted liquid resource may have a pH of about 5, about 5.5, about 6, about 6.5, about 7, about 7.5, about 8, about 8.5, about 9, about 9.5, about 10, or about 10.5. In some embodiments, a concentration-adjusted liquid resource may have a pH of at least about 5, about 5.5, about 6, about 6.5, about 7, about 7.5, about 8, about 8.5, about 9, about 9.5, or about 10. In some embodiments, a concentration-adjusted liquid resource may have a pH of at most about 5.5, about 6, about 6.5, about 7, about 7.5, about 8, about 8.5, about 9, about 9.5, about 10, or about 10.5.

In some embodiments, the liquid resource, the concentration adjusted liquid resource, the raffinate, or the aqueous lithium solution may be adjusted by the addition of one or more bases. In some embodiments, a base may be added following the addition of an acid in order to provide a liquid resource that has been adjusted to comprise a desired concentration of a desired adjusting ion. In a non-limiting example, a liquid resource may be adjusted by first adding a first quantity of H₂SO₄ to the liquid resource, followed by adding a second quantity of NaOH to the liquid resource to provide a liquid resource adjusted to contain desired concentrations of SO₄²⁻ and HSO₄⁻. In some embodiments, a liquid resource may be adjusted by the addition of one or more acids or bases in order to provide an ion adjusted liquid resource. In some embodiments, a liquid resource may be adjusted by the addition of one or more adjusting ion solutions or adjusting ion solids in order to provide an ion adjusted liquid resource. In some embodiments, an adjusting ion solid or ion adjusting solution may comprise an acid. In some embodiments, an adjusting ion solid or ion adjusting solution may comprise a base. In some embodiments, an adjusting ion solid or ion adjusting solution may comprise lithium. In some embodiments, an adjusting ion solid or ion adjusting solution may comprise one or more adjusting ions. In some embodiments, the adjusting ion solid or ion adjusting solution may comprise reject water provided by reverse osmosis. In some embodiments, the adjusting ion solid or ion adjusting solution may comprise material provided by a chloralkali plant. In some embodiments, the adjusting ion solid or ion adjusting solution may comprise material provided by an intermediate or terminal step of a method for lithium recovery as described herein. In some embodiments, the adjusting ion solid or ion adjusting solution may comprise material provided by an intermediate or terminal subsystem of a system for lithium recovery as described herein. In some embodiments, the adjusting ion solid or ion adjusting solution may comprise material provided by purification or processing of a synthetic lithium solution. In some embodiments, the adjusting ion solid or ion adjusting solution may comprise material provided by purification or processing of a lithium-depleted liquid resource. In some embodiments, purification or processing may comprise an ion exchange process. In some embodiments, material provided by purification or processing may comprise calcium. In some embodiments, material provided by purification or processing may comprise boron. In some embodiments, material provided by purification or processing may comprise magnesium. In some embodiments, material provided by purification or processing may comprise reject water provided by reverse osmosis.

In some embodiments, the lithium concentration of a liquid resource and the adjusting ion content of a liquid resource may be modulated within the same system or subsystem. In some embodiments, the lithium concentration of a liquid resource and the adjusting ion content of a liquid resource may be modulated within different systems or subsystems. In some embodiments, the lithium concentration of a liquid resource may be adjusted prior to the addition of acid or base. In some embodiments, the lithium concentration of a liquid resource may be adjusted following to the addition of acid or base. In some embodiments, the lithium concentration of a liquid resource may be adjusted simultaneously to the addition of acid or base. In some embodiments, an adjusting fluid for use according to the methods and systems described herein may comprise an acid. In some embodiments, an adjusting fluid for use according to the methods and systems described herein may comprise a base. In some embodiments, adjusting fluid may comprise material provided by an intermediate or terminal step of a method for lithium recovery as described herein. In some embodiments, adjusting fluid may comprise material provided by an intermediate or terminal subsystem of a system for lithium recovery as described herein. In some embodiments, adjusting fluid may comprise material provided by purification or processing of a synthetic lithium solution. In some embodiments, adjusting fluid may comprise material provided by purification or processing of a lithium-depleted liquid resource.

In some embodiments, an ion adjusted liquid resource can comprise a desired concentration of one or more adjusting ions. In some embodiments, an adjusting ion may comprise OH—, NH₃, SO₄²⁻, HSO₄⁻, ClO₄⁻, H₂BO₃⁻, HBO₃²⁻, BO₃³⁻, HCO₃⁻, CO₃²⁻, PO₄₃⁻, HPO₄²⁻, H₂PO₄, acetate, citrate, or malonate. In some embodiments, an adjusting ion may comprise boron. In some embodiments, boron may comprise H₂BO₃⁻, HBO₃²⁻, BO₃³⁻, [B(OH)₄]⁻, [B₂O₄(OH)₄]²⁻, [BO₂]⁻, [B₂O₅]⁴⁻, [B₂O₇]²⁻, [B₄O₅(OH)₄]²⁻, [B₄O₉]⁶⁻, [B₅O₈]⁻, [B₈O₁₃]²⁻, BO₃³⁻, a positive counterion, mixtures thereof, hydrates thereof, or combination thereof. In some embodiments, an adjusting ion may comprise a buffer. In some embodiments, the concentrations of one or more adjusting ions in a solution may be correlated to the buffering capacity of the solution. In some embodiments, the addition of one or more adjusting ions added to a liquid resource may yield an ion adjusted liquid resource with a greater buffering capacity than that of the liquid resource. In some embodiments, the addition of one or more adjusting ions added to a liquid resource may yield an ion adjusted liquid resource with a lower buffering capacity than that of the liquid resource. In some embodiments, the addition of one or more adjusting ions added to a liquid resource may yield an ion adjusted liquid resource with an identical buffering capacity to that of the liquid resource.

In some embodiments, an ion adjusted liquid resource can comprise a desired concentration of one or more adjusting ions. In some embodiments, the desired concentration of an adjusting ion in a liquid resource may correlate to the lithium concentration in the liquid resource. In some embodiments, the desired concentration of an adjusting ion in a liquid resource may correlate to the lithium concentration in the concentration-adjusted liquid resource. In some embodiments, the desired concentration of an adjusting ion may be 1-100% of the lithium concentration. In some embodiments, the desired concentration of an adjusting ion may be 1-10% of the lithium concentration. In some embodiments, the desired concentration of an adjusting ion may be 10-20% of the lithium concentration. In some embodiments, the desired concentration of an adjusting ion may be 20-30% of the lithium concentration. In some embodiments, the desired concentration of an adjusting ion may be 30-40% of the lithium concentration. In some embodiments, the desired concentration of an adjusting ion may be 40-50% of the lithium concentration. In some embodiments, the desired concentration of an adjusting ion may be 50-60% of the lithium concentration. In some embodiments, the desired concentration of an adjusting ion may be 60-70% of the lithium concentration. In some embodiments, the desired concentration of an adjusting ion may be 70-80% of the lithium concentration. In some embodiments, the desired concentration of an adjusting ion may be 80-90% of the lithium concentration. In some embodiments, the desired concentration of an adjusting ion may be 90-100% of the lithium concentration. In some embodiments, the desired concentration of an adjusting ion may be 100-150% of the lithium concentration. In some embodiments, the desired concentration of an adjusting ion may be 1₀₀-2₀₀% of the lithium concentration. In some embodiments, the desired concentration of an adjusting ion may be 100% of the lithium concentration.

In some embodiments, an ion adjusted liquid resource may comprise an adjusting ion at a concentration of about 0.01 M to about 6 M. In some embodiments, an ion adjusted liquid resource may comprise an adjusting ion at a concentration of about 0.01 M to about 0.05 M, about 0.01 M to about 0.1 M, about 0.01 M to about 0.25 M, about 0.01 M to about 0.5 M, about 0.01 M to about 0.75 M, about 0.01 M to about 1 M, about 0.01 M to about 2 M, about 0.01 M to about 3 M, about 0.01 M to about 4 M, about 0.01 M to about 5 M, about 0.01 M to about 6 M, about 0.05 M to about 0.1 M, about 0.05 M to about 0.25 M, about 0.05 M to about 0.5 M, about 0.05 M to about 0.75 M, about 0.05 M to about 1 M, about 0.05 M to about 2 M, about 0.05 M to about 3 M, about 0.05 M to about 4 M, about 0.05 M to about 5 M, about 0.05 M to about 6 M, about 0.1 M to about 0.25 M, about 0.1 M to about 0.5 M, about 0.1 M to about 0.75 M, about 0.1 M to about 1 M, about 0.1 M to about 2 M, about 0.1 M to about 3 M, about 0.1 M to about 4 M, about 0.1 M to about 5 M, about 0.1 M to about 6 M, about 0.25 M to about 0.5 M, about 0.25 M to about 0.75 M, about 0.25 M to about 1 M, about 0.25 M to about 2 M, about 0.25 M to about 3 M, about 0.25 M to about 4 M, about 0.25 M to about 5 M, about 0.25 M to about 6 M, about 0.5 M to about 0.75 M, about 0.5 M to about 1 M, about 0.5 M to about 2 M, about 0.5 M to about 3 M, about 0.5 M to about 4 M, about 0.5 M to about 5 M, about 0.5 M to about 6 M, about 0.75 M to about 1 M, about 0.75 M to about 2 M, about 0.75 M to about 3 M, about 0.75 M to about 4 M, about 0.75 M to about 5 M, about 0.75 M to about 6 M, about 1 M to about 2 M, about 1 M to about 3 M, about 1 M to about 4 M, about 1 M to about 5 M, about 1 M to about 6 M, about 2 M to about 3 M, about 2 M to about 4 M, about 2 M to about 5 M, about 2 M to about 6 M, about 3 M to about 4 M, about 3 M to about 5 M, about 3 M to about 6 M, about 4 M to about 5 M, about 4 M to about 6 M, or about 5 M to about 6 M. In some embodiments, an ion adjusted liquid resource may comprise an adjusting ion at a concentration of about 0.01 M, about 0.05 M, about 0.1 M, about 0.25 M, about 0.5 M, about 0.75 M, about 1 M, about 2 M, about 3 M, about 4 M, about 5 M, or about 6 M. In some embodiments, anion adjusted liquid resource may comprise an adjusting ion at a concentration of at least about 0.01 M, about 0.05 M, about 0.1 M, about 0.25 M, about 0.5 M, about 0.75 M, about 1 M, about 2 M, about 3 M, about 4 M, or about 5 M. In some embodiments, an ion adjusted liquid resource may comprise an adjusting ion at a concentration of at most about 0.05 M, about 0.1 M, about 0.25 M, about 0.5 M, about 0.75 M, about 1 M, about 2 M, about 3 M, about 4 M, about 5 M, or about 6 M.

In some embodiments, an ion adjusted liquid resource will allow for a faster rate of lithium extraction by an ion exchange device as compared to the rate of lithium extraction by an ion exchange device from a liquid resource. In some embodiments, an ion adjusted liquid resource will allow for a faster rate of lithium extraction by an ion exchange device as compared to the rate of lithium extraction by an ion exchange device from a liquid resource owing to the presence of adjusting ions in the ion adjusted liquid resource that may neutralize the hydrogen ions released by the ion exchange material within the ion exchange device.

In some embodiments, an ion adjusted liquid resource will allow for a greater single-pass lithium recovery by an ion exchange device as compared to the single-pass lithium recovery by the ion exchange device from a liquid resource. In some embodiments, an ion adjusted liquid resource will allow for a greater single-pass lithium recovery by an ion exchange device as compared to the single-pass lithium recovery by the ion exchange device from a liquid resource owing to the presence of adjusting ions in the ion adjusted liquid resource that may neutralize the hydrogen ions released by the ion exchange material within the ion exchange device.

In some embodiments, an ion adjusted liquid resource will allow for a faster rate of lithium extraction by an ion exchange device as compared to the rate of lithium extraction by an ion exchange device from a liquid resource. One non-limiting embodiment of such effect is described in Example 7. In some embodiments, an ion adjusted liquid resource will allow for a faster rate of lithium extraction by an ion exchange device as compared to the rate of lithium extraction by an ion exchange device from a liquid resource owing to the presence of adjusting ions in the ion adjusted liquid resource that may neutralize the hydrogen ions released by the ion exchange material within the ion exchange device.

In some embodiments, rate of lithium extraction by an ion exchange device is determined by the extraction time required for the ion exchange material or ion exchange bead to complete a lithium extraction step. In some embodiments, said time required is determined by the overall lithium recovery of the lithium extraction system, wherein said overall recovery depends on the use of the raffinate to produce a concentration-adjusted liquid resource. In some embodiments, said overall recovery is higher than the single-pass lithium recovery. In some embodiment, the extraction time required for the ion exchange material or ion exchange bead to complete a lithium extraction step is chosen to maximize the economical operation of the lithium extraction system. In some embodiments, said extraction step requires 5 hours to complete to 4.5 hours to complete, 5 hours to complete to 4 hours to complete, 5 hours to complete to 3.5 hours to complete, 5 hours to complete to 3 hours to complete, 5 hours to complete to 2.5 hours to complete, 5 hours to complete to 2 hours to complete, 5 hours to complete to 1.5 hours to complete, 5 hours to complete to 1 hour to complete, 5 hours to complete to 0.5 hours to complete, 5 hours to complete to 0.25 hours to complete, 5 hours to complete to 0.1 hours to complete, 4.5 hours to complete to 4 hours to complete, 4.5 hours to complete to 3.5 hours to complete, 4.5 hours to complete to 3 hours to complete, 4.5 hours to complete to 2.5 hours to complete, 4.5 hours to complete to 2 hours to complete, 4.5 hours to complete to 1.5 hours to complete, 4.5 hours to complete to 1 hour to complete, 4.5 hours to complete to 0.5 hours to complete, 4.5 hours to complete to 0.25 hours to complete, 4.5 hours to complete to 0.1 hours to complete, 4 hours to complete to 3.5 hours to complete, 4 hours to complete to 3 hours to complete, 4 hours to complete to 2.5 hours to complete, 4 hours to complete to 2 hours to complete, 4 hours to complete to 1.5 hours to complete, 4 hours to complete to 1 hour to complete, 4 hours to complete to 0.5 hours to complete, 4 hours to complete to 0.25 hours to complete, 4 hours to complete to 0.1 hours to complete, 3.5 hours to complete to 3 hours to complete, 3.5 hours to complete to 2.5 hours to complete, 3.5 hours to complete to 2 hours to complete, 3.5 hours to complete to 1.5 hours to complete, 3.5 hours to complete to 1 hour to complete, 3.5 hours to complete to 0.5 hours to complete, 3.5 hours to complete to 0.25 hours to complete, 3.5 hours to complete to 0.1 hours to complete, 3 hours to complete to 2.5 hours to complete, 3 hours to complete to 2 hours to complete, 3 hours to complete to 1.5 hours to complete, 3 hours to complete to 1 hour to complete, 3 hours to complete to 0.5 hours to complete, 3 hours to complete to 0.25 hours to complete, 3 hours to complete to 0.1 hours to complete, 2.5 hours to complete to 2 hours to complete, 2.5 hours to complete to 1.5 hours to complete, 2.5 hours to complete to 1 hour to complete, 2.5 hours to complete to 0.5 hours to complete, 2.5 hours to complete to 0.25 hours to complete, 2.5 hours to complete to 0.1 hours to complete, 2 hours to complete to 1.5 hours to complete, 2 hours to complete to 1 hour to complete, 2 hours to complete to 0.5 hours to complete, 2 hours to complete to 0.25 hours to complete, 2 hours to complete to 0.1 hours to complete, 1.5 hours to complete to 1 hour to complete, 1.5 hours to complete to 0.5 hours to complete, 1.5 hours to complete to 0.25 hours to complete, 1.5 hours to complete to 0.1 hours to complete, 1 hour to complete to 0.5 hours to complete, 1 hour to complete to 0.25 hours to complete, 1 hour to complete to 0.1 hours to complete, 0.5 hours to complete to 0.25 hours to complete, 0.5 hours to complete to 0.1 hours to complete, or 0.25 hours to complete to 0.1 hours to complete. In some embodiments, said extraction step requires 5 hours to complete, 4.5 hours to complete, 4 hours to complete, 3.5 hours to complete, 3 hours to complete, 2.5 hours to complete, 2 hours to complete, 1.5 hours to complete, 1 hour to complete, 0.5 hours to complete, 0.25 hours to complete, or 0.1 hours to complete. In some embodiments, useful lifetime of an ion exchange material or ion exchange bead may end when a lithium extraction step requires at least 5 hours to complete, 4.5 hours to complete, 4 hours to complete, 3.5 hours to complete, 3 hours to complete, 2.5 hours to complete, 2 hours to complete, 1.5 hours to complete, 1 hour to complete, 0.5 hours to complete, or 0.25 hours to complete. In some embodiments, useful lifetime of an ion exchange material or ion exchange bead may end when a lithium extraction step requires at most 4.5 hours to complete, 4 hours to complete, 3.5 hours to complete, 3 hours to complete, 2.5 hours to complete, 2 hours to complete, 1.5 hours to complete, 1 hour to complete, 0.5 hours to complete, 0.25 hours to complete, or 0.1 hours to complete.

In some embodiments, the extraction time required for the ion exchange material or ion exchange bead to complete a lithium extraction step while maintaining the same overall recovery of lithium decreases when lithium is extracted from an ion adjusted liquid resource, as compared to from the liquid resource. In some embodiments, said decrease is due to the overall-recovery being maintained at a lower single-pass lithium recovery. In some embodiments, said decrease is due to the overall-recovery being maintained at a lower single-pass lithium recovery, because lithium atoms that are not recovered in a single-pass of the ion adjusted liquid resource are recycled to adjust the concentration of liquid resource, and thereby contact the lion exchange material or ion exchange bead more than one time. In some embodiments, the extraction time required for the ion exchange material or ion exchange bead to complete a lithium extraction step while maintaining the same overall recovery of lithium decreases by about 0.1%, by about 1^{%}, by about 5%, by about 10%, by about 20%, by about 30%, by about 40%, by about 50%, by about 60%, by about 70%, by about 90%, by about 99%. In some embodiments, the extraction time required for the ion exchange material or ion exchange bead to complete a lithium extraction step while maintaining the same overall recovery of lithium decreases from about 0.1% to about 1%, from about 1% to about 5%, from about 5% to about 10%, from about 10% to about 20%, from about 20% to about 30%, from about 30% to about 40%, from about 40% to about 60%, from about 60% to about 90% from about 90% to about 99%. In some embodiments, the extraction time decreases by about 5% to about 80%. In some embodiments, the extraction time decreases by about 5% to about 10%, about 5% to about 15%, about 5% to about 20%, about 5% to about 25%, about 5% to about 30%, about 5% to about 35%, about 5% to about 40%, about 5% to about 45%, about 5% to about 50%, about 5% to about 60%, about 5% to about 80%, about 10% to about 15%, about 10% to about 20%, about 10% to about 25%, about 10% to about 30%, about 10% to about 35%, about 10% to about 40%, about 10% to about 45%, about 10% to about 50%, about 10% to about 60%, about 10% to about 80%, about 15% to about 20%, about 15% to about 25%, about 15% to about 30%, about 15% to about 35%, about 15% to about 40%, about 15% to about 45%, about 15% to about 50%, about 15% to about 60%, about 15% to about 80%, about 20% to about 25%, about 20% to about 30%, about 20% to about 35%, about 20% to about 40%, about 20% to about 45%, about 20% to about 50%, about 20% to about 60%, about 20% to about 80%, about 25% to about 30%, about 25% to about 35%, about 25% to about 40%, about 25% to about 45%, about 25% to about 50%, about 25% to about 60%, about 25% to about 80%, about 30% to about 35%, about 30% to about 40%, about 30% to about 45%, about 30% to about 50%, about 30% to about 60%, about 30% to about 80%, about 35% to about 40%, about 35% to about 45%, about 35% to about 50%, about 35% to about 60%, about 35% to about 80%, about 40% to about 45%, about 40% to about 50%, about 40% to about 60%, about 40% to about 80%, about 45% to about 50%, about 45% to about 60%, about 45% to about 80%, about 50% to about 60%, about 50% to about 80%, or about 60% to about 80%. In some embodiments, the extraction time decreases by about 5%, about 10%, about 15%, about 20%, about 25%, about 30%, about 35%, about 40%, about 45%, about 50%, about 60%, or about 80%. In some embodiments, the extraction time decreases by at least about 5%, about 10%, about 15%, about 20%, about 25%, about 30%, about 35%, about 40%, about 45%, about 50%, or about 60%. In some embodiments, the extraction time decreases by at most about 10%, about 15%, about 20%, about 25%, about 30%, about 35%, about 40%, about 45%, about 50%, about 60%, or about 80%.

In some embodiments, the extraction time required for the ion exchange material or ion exchange bead to complete a lithium extraction step while maintaining the same overall recovery of lithium decreases from about 10 hours to about 9 hours, to about 7 hours, to about 5 hours, to about 3 hours, to about 2 hours, to about 1 hour, to about 30 minutes, to about 15 minutes, or to about 5 minutes. In some embodiments, the extraction time required for the ion exchange material or ion exchange bead to complete a lithium extraction step while maintaining the same overall recovery of lithium decreases from about 5 hours to about 3 hours, to about 2 hours, to about 1 hour, to about 30 minutes, to about 15 minutes, orto about 5 minutes. In some embodiments, the extraction time required for the ion exchange material or ion exchange bead to complete a lithium extraction step while maintaining the same overall recovery of lithium decreases from about 3 hours to about 2 hours, to about 1 hour, to about 30 minutes, to about 15 minutes, or to about 5 minutes. In some embodiments, the extraction time required for the ion exchange material or ion exchange bead to complete a lithium extraction step while maintaining the same overall recovery of lithium decreases from about 2 hours to about 1 hour, to about 30 minutes, to about 15 minutes, or to about 5 minutes. In some embodiments, the extraction time required for the ion exchange material or ion exchange bead to complete a lithium extraction step while maintaining the same overall recovery of lithium decreases from about 1 hour to about 30 minutes, to about 15 minutes, or to about 5 minutes.

In some embodiments, the lithium purity of the synthetic lithium solution produced by the lithium extraction system is higher when said system extracts lithium from an ion adjusted liquid resource, as compared to from the liquid resource. One non-limiting embodiment of such effect is described in Example 7. In some embodiments, said purity increases by about 0.1%, by about 1%, by about 5%, by about 10%, by about 20%, by about 30%, by about 40%, by about 50%, by about 60%, by about 70%, by about 90%, or by about 99%. In some embodiments, said purity increases by about 1% to about 20%. In some embodiments, said purity increases by about 1% to about 2%, about 1% to about 3%, about 1% to about 4%, about 1% to about 5%, about 1% to about 6%, about 1% to about 7%, about 1% to about 8%, about 1% to about 9%, about 1% to about 10%, about 1% to about 15%, about 1% to about 20%, about 2% to about 3%, about 2% to about 4%, about 2% to about 5%, about 2% to about 6%, about 2% to about 7%, about 2% to about 8%, about 2% to about 9%, about 2% to about 10%, about 2% to about 15%, about 2% to about 20%, about 3% to about 4%, about 3% to about 5%, about 3% to about 6%, about 3% to about 7%, about 3% to about 8%, about 3% to about 9%, about 3% to about 10%, about 3% to about 15%, about 3% to about 20%, about 4% to about 5%, about 4% to about 6%, about 4% to about 7%, about 4% to about 8%, about 4% to about 9%, about 4% to about 10%, about 4% to about 15%, about 4% to about 20%, about 5% to about 6%, about 5% to about 7%, about 5% to about 8%, about 5% to about 9%, about 5% to about 10%, about 5% to about 15%, about 5% to about 20%, about 6% to about 7%, about 6% to about 8%, about 6% to about 9%, about 6% to about 10%, about 6% to about 15%, about 6% to about 20%, about 7% to about 8%, about 7% to about 9%, about 7% to about 10%, about 7% to about 15%, about 7% to about 20%, about 8% to about 9%, about 8% to about 10%, about 8% to about 15%, about 8% to about 20%, about 9% to about 10%, about 9% to about 15%, about 9% to about 20%, about 10% to about 15%, about 10% to about 20%, or about 15% to about 20%. In some embodiments, said purity increases by about 1%, about 2%, about 3%, about 4%, about 5%, about 6%, about 7%, about 8%, about 9%, about 10%, about 15%, or about 20%. In some embodiments, said purity increases by at least about 1%, about 2%, about 3%, about 4%, about 5%, about 6%, about 7%, about 8%, about 9%, about 10%, or about 15%. In some embodiments, said purity increases by at most about 2%, about 3%, about 4%, about 5%, about 6%, about 7%, about 8%, about 9%, about 10%, about 15%, or about 20%.

In some embodiments, the purity is measured as the molar concentration of lithium compared to that of other cations in solution. In some embodiments, said purity is from about 10% to about 20%, from about 20% to about 40%, from about 40% to about 60%, from about 60% to about 80%, from about 80% to about 90%, from about 90% to about 95%, from about 95% to about 99%, from about 99.9%. In some embodiments, the lithium purity of the synthetic lithium solution produced by the lithium extraction system increases when said system extracts lithium from an ion adjusted liquid resource, as compared to from the liquid resource. In some embodiments, said increase is from about 80% to about 90%, from about 90% to about 95%, from about 95% to about 97%, from about 97% to about 99%.

In some embodiments, the purity is measured as the mass ratio of lithium to the mass of other cations. In some embodiments, said cations include sodium, potassium, calcium, magnesium, strontium, boron, iron, manganese, a different cation, or a combination thereof. In some embodiments, said ratio is from about 0.1 to about 0.2, from about 0.2 to about 0.5, from about 0.5 to about 1, from about 1 to about 2, from about 2 to about 5, from about 5 to about 10, from about 20 to about 20, from about 20 to about 50, from about 50 to about 100, from about 100 to about 500, from about 500 to about 1000. In some embodiments, said ratio increases when the synthetic lithium solution produced by the lithium extraction system extracts lithium from an ion adjusted liquid resource, as compared to from the liquid resource.

In some embodiments, an ion adjusted liquid resource will allow for a smaller change in pH of the ion adjusted liquid resource following lithium extraction by an ion exchange device as compared to the change in pH of a liquid resource following lithium extraction by an ion exchange device. In some embodiments, an ion adjusted liquid resource will allow for a smaller change in pH of the ion adjusted liquid resource following lithium extraction by an ion exchange device as compared to the change in pH of a liquid resource following lithium extraction by an ion exchange device owing to the presence of adjusting ions in the ion adjusted liquid resource that may neutralize the hydrogen ions released by the ion exchange material within the ion exchange device. In some embodiments, a smaller change in pH following lithium extraction by an ion exchange device may be correlated to a faster rate of lithium extraction by the ion exchange device. In some embodiments, a smaller change in pH following lithium extraction by an ion exchange device may be correlated to greater single-pass lithium recovery.

In some embodiments, the raffinate provided following lithium recovery from an ion adjusted liquid resource will comprise one or more adjusting ions. In some embodiments, the raffinate combining adjusting ions may be combined with a liquid resource to provide a concentration-adjusted liquid resource. In some embodiments, combining the raffinate comprising adjusting ions with the liquid resource leads to a lower quantity of acid or base being necessary to modulate the ion concentration of the resulting concentration-adjusted liquid resource. In some embodiments, combining the raffinate with the liquid resource provides a concentration-adjusted liquid resource with a higher pH than the liquid resource. In some embodiments, combining the raffinate with the liquid resource provides a concentration-adjusted liquid resource with a lower pH than the liquid resource. In some embodiments, combining the raffinate with the liquid resource provides a concentration-adjusted liquid resource with the same pH than the liquid resource.

In some embodiments, an ion adjusted liquid resource may experience a decrease in pH following lithium extraction by an ion exchange device of about 0.01 to about 6. In some embodiments, an ion adjusted liquid resource may experience a decrease in pH following lithium extraction by an ion exchange device of about 0.01 to about 0.05, about 0.01 to about 0.1, about 0.01 to about 0.25, about 0.01 to about 0.5, about 0.01 to about 0.75, about 0.01 to about 1, about 0.01 to about 2, about 0.01 to about 3, about 0.01 to about 4, about 0.01 to about 5, about 0.01 to about 6, about 0.05 to about 0.1, about 0.05 to about 0.25, about 0.05 to about 0.5, about 0.05 to about 0.75, about 0.05 to about 1, about 0.05 to about 2, about 0.05 to about 3, about 0.05 to about 4, about 0.05 to about 5, about 0.05 to about 6, about 0.1 to about 0.25, about 0.1 to about 0.5, about 0.1 to about 0.75, about 0.1 to about 1, about 0.1 to about 2, about 0.1 to about 3, about 0.1 to about 4, about 0.1 to about 5, about 0.1 to about 6, about 0.25 to about 0.5, about 0.25 to about 0.75, about 0.25 to about 1, about 0.25 to about 2, about 0.25 to about 3, about 0.25 to about 4, about 0.25 to about 5, about 0.25 to about 6, about 0.5 to about 0.75, about 0.5 to about 1, about 0.5 to about 2, about 0.5 to about 3, about 0.5 to about 4, about 0.5 to about 5, about 0.5 to about 6, about 0.75 to about 1, about 0.75 to about 2, about 0.75 to about 3, about 0.75 to about 4, about 0.75 to about 5, about 0.75 to about 6, about 1 to about 2, about 1 to about 3, about 1 to about 4, about 1 to about 5, about 1 to about 6, about 2 to about 3, about 2 to about 4, about 2 to about 5, about 2 to about 6, about 3 to about 4, about 3 to about 5, about 3 to about 6, about 4 to about 5, about 4 to about 6, or about 5 to about 6. In some embodiments, an ion adjusted liquid resource may experience a decrease in pH following lithium extraction by an ion exchange device of about 0.01, about 0.05, about 0.1, about 0.25, about 0.5, about 0.75, about 1, about 2, about 3, about 4, about 5, or about 6. In some embodiments, an ion adjusted liquid resource may experience a decrease in pH following lithium extraction by an ion exchange device of at least about 0.01, about 0.05, about 0.1, about 0.25, about 0.5, about 0.75, about 1, about 2, about 3, about 4, or about 5. In some embodiments, an ion adjusted liquid resource may experience a decrease in pH following lithium extraction by an ion exchange device of at most about 0.05, about 0.1, about 0.25, about 0.5, about 0.75, about 1, about 2, about 3, about 4, about 5, or about 6.

In some embodiments, the concentration-adjusted liquid resource may comprise a variable molar ratio of carbonate to lithium. In some embodiments, said carbonates are found in the form of bicarbonate (also known as hydrogen carbonate ions), the specific quantity of carbonate vs bicarbonate being determined by the pH of the solution. In some embodiments, the concentration-adjusted liquid resource may comprise a chosen molar ratio of carbonate to lithium. In some embodiments, the ion adjusted liquid resource may comprise a variable molar ratio of carbonate to lithium. In some embodiments, the ion adjusted liquid resource may comprise a chosen molar ratio of carbonate to lithium. In some embodiments, the molar ratio of carbonate to lithium is 0.01. In some embodiments, the molar ratio of carbonate to lithium is about 10. In some embodiments, the molar ratio of carbonate to lithium is from about 1.0 to about 1.5. In some embodiments, the molar ratio of carbonate to lithium is in the inclusive range of 1.0 to 1.5.

In some embodiments, the molar ratio of carbonate to lithium is less than 0.01 to 10. In some embodiments, the molar ratio of carbonate to lithium is less than 0.01 to 0.1, 0.01 to 0.25, 0.01 to 0.5, 0.01 to 1, 0.01 to 1.5, 0.01 to 2, 0.01 to 3, 0.01 to 4, 0.01 to 5, 0.01 to 7.5, 0.01 to 10, 0.1 to 0.25, 0.1 to 0.5, 0.1 to 1, 0.1 to 1.5, 0.1 to 2, 0.1 to 3, 0.1 to 4, 0.1 to 5, 0.1 to 7.5, 0.1 to 10, 0.25 to 0.5, 0.25 to 1, 0.25 to 1.5, 0.25 to 2, 0.25 to 3, 0.25 to 4, 0.25 to 5, 0.25 to 7.5, 0.25 to 10, 0.5 to 1, 0.5 to 1.5, 0.5 to 2, 0.5 to 3, 0.5 to 4, 0.5 to 5, 0.5 to 7.5, 0.5 to 10, 1 to 1.5, 1 to 2, 1 to 3, 1 to 4, 1 to 5, 1 to 7.5, 1 to 10, 1.5 to 2, 1.5 to 3, 1.5 to 4, 1.5 to 5, 1.5 to 7.5, 1.5 to 10, 2 to 3, 2 to 4, 2 to 5, 2 to 7.5, 2 to 10, 3 to 4, 3 to 5, 3 to 7.5, 3 to 10, 4 to 5, 4 to 7.5, 4 to 10, 5 to 7.5, 5 to 10, or 7.5 to 10.

In some embodiments, the molar ratio of carbonate to lithium is less than 0.01, 0.1, 0.25, 0.5, 1, 1.5, 2, 3, 4, 5, 7.5, or 10. In some embodiments, the molar ratio of carbonate to lithium is less than at least 0.01, 0.1, 0.25, 0.5, 1, 1.5, 2, 3, 4, 5, or 7.5. In some embodiments, the molar ratio of carbonate to lithium is less than at most 0.1, 0.25, 0.5, 1, 1.5, 2, 3, 4, 5, 7.5, or 10. In some embodiments, the molar ratio of carbonate to lithium is more than 0.01 to 10. In some embodiments, the molar ratio of carbonate to lithium is more than 0.01 to 0.1, 0.01 to 0.25, 0.01 to 0.5, 0.01 to 1, 0.01 to 1.5, 0.01 to 2, 0.01 to 3, 0.01 to 4, 0.01 to 5, 0.01 to 7.5, 0.01 to 10, 0.1 to 0.25, 0.1 to 0.5, 0.1 to 1, 0.1 to 1.5, 0.1 to 2, 0.1 to 3, 0.1 to 4, 0.1 to 5, 0.1 to 7.5, 0.1 to 10, 0.25 to 0.5, 0.25 to 1, 0.25 to 1.5, 0.25 to 2, 0.25 to 3, 0.25 to 4, 0.25 to 5, 0.25 to 7.5, 0.25 to 10, 0.5 to 1, 0.5 to 1.5, 0.5 to 2, 0.5 to 3, 0.5 to 4, 0.5 to 5, 0.5 to 7.5, 0.5 to 10, 1 to 1.5, 1 to 2, 1 to 3, 1 to 4, 1 to 5, 1 to 7.5, 1 to 10, 1.5 to 2, 1.5 to 3, 1.5 to 4, 1.5 to 5, 1.5 to 7.5, 1.5 to 10, 2 to 3, 2 to 4, 2 to 5, 2 to 7.5, 2 to 10, 3 to 4, 3 to 5, 3 to 7.5, 3 to 10, 4 to 5, 4 to 7.5, 4 to 10, 5 to 7.5, 5 to 10, or 7.5 to 10. In some embodiments, the molar ratio of carbonate to lithium is more than 0.01, 0.1, 0.25, 0.5, 1, 1.5, 2, 3, 4, 5, 7.5, or 10. In some embodiments, the molar ratio of carbonate to lithium is more than at least 0.01, 0.1, 0.25, 0.5, 1, 1.5, 2, 3, 4, 5, or 7.5.

In some embodiments, the molar ratio of carbonate to lithium is more than at most 0.1, 0.25, 0.5, 1, 1.5, 2, 3, 4, 5, 7.5, or 10. In some embodiments, the molar ratio of carbonate to lithium is about 0.01 to about 10. In some embodiments, the molar ratio of carbonate to lithium is about 0.01 to about 0.1, about 0.01 to about 0.25, about 0.01 to about 0.5, about 0.01 to about 1, about 0.01 to about 1.5, about 0.01 to about 2, about 0.01 to about 3, about 0.01 to about 4, about 0.01 to about 5, about 0.01 to about 7.5, about 0.01 to about 10, about 0.1 to about 0.25, about 0.1 to about 0.5, about 0.1 to about 1, about 0.1 to about 1.5, about 0.1 to about 2, about 0.1 to about 3, about 0.1 to about 4, about 0.1 to about 5, about 0.1 to about 7.5, about 0.1 to about 10, about 0.25 to about 0.5, about 0.25 to about 1, about 0.25 to about 1.5, about 0.25 to about 2, about 0.25 to about 3, about 0.25 to about 4, about 0.25 to about 5, about 0.25 to about 7.5, about 0.25 to about 10, about 0.5 to about 1, about 0.5 to about 1.5, about 0.5 to about 2, about 0.5 to about 3, about 0.5 to about 4, about 0.5 to about 5, about 0.5 to about 7.5, about 0.5 to about 10, about 1 to about 1.5, about 1 to about 2, about 1 to about 3, about 1 to about 4, about 1 to about 5, about 1 to about 7.5, about 1 to about 10, about 1.5 to about 2, about 1.5 to about 3, about 1.5 to about 4, about 1.5 to about 5, about 1.5 to about 7.5, about 1.5 to about 10, about 2 to about 3, about 2 to about 4, about 2 to about 5, about 2 to about 7.5, about 2 to about 10, about 3 to about 4, about 3 to about 5, about 3 to about 7.5, about 3 to about 10, about 4 to about 5, about 4 to about 7.5, about 4 to about 10, about 5 to about 7.5, about 5 to about 10, or about 7.5 to about 10. In some embodiments, the molar ratio of carbonate to lithium is about 0.01, about 0.1, about 0.25, about 0.5, about 1, about 1.5, about 2, about 3, about 4, about 5, about 7.5, or about 10. In some embodiments, the molar ratio of carbonate to lithium is at least about 0.01, about 0.1, about 0.25, about 0.5, about 1, about 1.5, about 2, about 3, about 4, about 5, or about 7.5. In some embodiments, the molar ratio of carbonate to lithium is at most about 0.1, about 0.25, about 0.5, about 1, about 1.5, about 2, about 3, about 4, ab out 5, about 7.5, or about 10.

In some embodiments, the concentration-adjusted liquid resource may comprise a variable molar ratio of carbonate to lithium. In some embodiments, carbonate may be added to the liquid resource as a solid in the form of an adjusting ion solid. In some embodiments, carbonate may be added to the liquid resource as a liquid in the form of an adjusting ion solution. In some embodiments, the carbonate added to the liquid resource may originate from a carbonate removal system. In some embodiments, the carbonate removal system may remove carbonate from a synthetic lithium solution that is being purified. In some embodiments, the carbonate removal system may comprise ion exchange. In some embodiments, the carbonate removal system may comprise solvent extraction.

In some embodiments, the concentration-adjusted liquid resource may comprise a variable molar ratio of boron to lithium. In some embodiments, the concentration-adjusted liquid resource may comprise a chosen molar ratio of boron to lithium. In some embodiments, the ion adjusted liquid resource may comprise a variable molar ratio of boron to lithium. In some embodiments, the ion adjusted liquid resource may comprise a chosen molar ratio of boron to lithium. In some embodiments, the molar ratio of boron to lithium is 0.01. In some embodiments, the molar ratio of boron to lithium is about 10. In some embodiments, the molar ratio of boron to lithium is from about 1.0 to about 1.5. In some embodiments, the molar ratio of boron to lithium is in the inclusive range of 1.0 to 1.5. In some embodiments, boron may comprise BO₃³⁻, HBO₃²⁻, H₂BO₃⁻, H₃BO₃, or mixtures thereof, or combinations thereof. In some embodiments, boron may comprise [B(OH)₄]⁻, [B₂O₄(OH)₄]²⁻, [BO₂]⁻, [B₂O₅]⁴⁻, [B₂O₇]²⁻, [B₄O₅(OH)₄]²⁻, [B₄O₉]⁶⁻, [B₅O₈]⁻, [B₈O₁₃]²⁻, BO₃³⁻, a positive counterion, mixtures thereof, hydrates thereof, or combination thereof.

In some embodiments, the molar ratio of boron to lithium is less than 0.01 to 10. In some embodiments, the molar ratio of boron to lithium is less than 0.01 to 0.1, 0.01 to 0.25, 0.01 to 0.5, 0.01 to 1, 0.01 to 1.5, 0.01 to 2, 0.01 to 3, 0.01 to 4, 0.01 to 5, 0.01 to 7.5, 0.01 to 10, 0.1 to 0.25, 0.1 to 0.5, 0.1 to 1, 0.1 to 1.5, 0.1 to 2, 0.1 to 3, 0.1 to 4, 0.1 to 5, 0.1 to 7.5, 0.1 to 10, 0.25 to 0.5, 0.25 to 1, 0.25 to 1.5, 0.25 to 2, 0.25 to 3, 0.25 to 4, 0.25 to 5, 0.25 to 7.5, 0.25 to 10, 0.5 to 1, 0.5 to 1.5, 0.5 to 2, 0.5 to 3, 0.5 to 4, 0.5 to 5, 0.5 to 7.5, 0.5 to 10, 1 to 1.5, 1 to 2, 1 to 3, 1 to 4, 1 to 5, 1 to 7.5, 1 to 10, 1.5 to 2, 1.5 to 3, 1.5 to 4, 1.5 to 5, 1.5 to 7.5, 1.5 to 10, 2 to 3, 2 to 4, 2 to 5, 2 to 7.5, 2 to 10, 3 to 4, 3 to 5, 3 to 7.5, 3 to 10, 4 to 5, 4 to 7.5, 4 to 10, 5 to 7.5, 5 to 10, or 7.5 to 10. In some embodiments, the molar ratio of boron to lithium is less than 0.01, 0.1, 0.25, 0.5, 1, 1.5, 2, 3, 4, 5, 7.5, or 10. In some embodiments, the molar ratio of boron to lithium is less than at least 0.01, 0.1, 0.25, 0.5, 1, 1.5, 2, 3, 4, 5, or 7.5. In some embodiments, the molar ratio of boron to lithium is less than at most 0.1, 0.25, 0.5, 1, 1.5, 2, 3, 4, 5, 7.5, or 10.

In some embodiments, the molar ratio of boron to lithium is more than 0.01 to 10. In some embodiments, the molar ratio of boron to lithium is more than 0.01 to 0.1, 0.01 to 0.25, 0.01 to 0.5, 0.01 to 1, 0.01 to 1.5, 0.01 to 2, 0.01 to 3, 0.01 to 4, 0.01 to 5, 0.01 to 7.5, 0.01 to 10, 0.1 to 0.25, 0.1 to 0.5, 0.1 to 1, 0.1 to 1.5, 0.1 to 2, 0.1 to 3, 0.1 to 4, 0.1 to 5, 0.1 to 7.5, 0.1 to 10, 0.25 to 0.5, 0.25 to 1, 0.25 to 1.5, 0.25 to 2, 0.25 to 3, 0.25 to 4, 0.25 to 5, 0.25 to 7.5, 0.25 to 10, 0.5 to 1, 0.5 to 1.5, 0.5 to 2, 0.5 to 3, 0.5 to 4, 0.5 to 5, 0.5 to 7.5, 0.5 to 10, 1 to 1.5, 1 to 2, 1 to 3, 1 to 4, 1 to 5, 1 to 7.5, 1 to 10, 1.5 to 2, 1.5 to 3, 1.5 to 4, 1.5 to 5, 1.5 to 7.5, 1.5 to 10, 2 to 3, 2 to 4, 2 to 5, 2 to 7.5, 2 to 10, 3 to 4, 3 to 5, 3 to 7.5, 3 to 10, 4 to 5, 4 to 7.5, 4 to 10, 5 to 7.5, 5 to 10, or 7.5 to 10. In some embodiments, the molar ratio of boron to lithium is more than 0.01, 0.1, 0.25, 0.5, 1, 1.5, 2, 3, 4, 5, 7.5, or 10. In some embodiments, the molar ratio of boron to lithium is more than at least 0.01, 0.1, 0.25, 0.5, 1, 1.5, 2, 3, 4, 5, or 7.5. In some embodiments, the molar ratio of boron to lithium is more than at most 0.1, 0.25, 0.5, 1, 1.5, 2, 3, 4, 5, 7.5, or 10.

In some embodiments, the molar ratio of boron to lithium is about 0.01 to about 10. In some embodiments, the molar ratio of boron to lithium is about 0.01 to about 0.1, about 0.01 to about 0.25, about 0.01 to about 0.5, about 0.01 to about 1, about 0.01 to about 1.5, about 0.01 to about 2, about 0.01 to about 3, about 0.01 to about 4, about 0.01 to about 5, about 0.01 to about 7.5, about 0.01 to about 10, about 0.1 to about 0.25, about 0.1 to about 0.5, about 0.1 to about 1, about 0.1 to about 1.5, about 0.1 to about 2, about 0.1 to about 3, about 0.1 to about 4, about 0.1 to about 5, about 0.1 to about 7.5, about 0.1 to about 10, about 0.25 to about 0.5, about 0.25 to about 1, about 0.25 to about 1.5, about 0.25 to about 2, about 0.25 to about 3, about 0.25 to about 4, about 0.25 to about 5, about 0.25 to about 7.5, about 0.25 to about 10, about 0.5 to about 1, about 0.5 to about 1.5, about 0.5 to about 2, about 0.5 to about 3, about 0.5 to about 4, about 0.5 to about 5, about 0.5 to about 7.5, about 0.5 to about 10, about 1 to about 1.5, about 1 to about 2, about 1 to about 3, about 1 to about 4, about 1 to about 5, about 1 to about 7.5, about 1 to about 10, about 1.5 to about 2, about 1.5 to about 3, about 1.5 to about 4, about 1.5 to about 5, about 1.5 to about 7.5, about 1.5 to about 10, about 2 to about 3, about 2 to about 4, about 2 to about 5, about 2 to about 7.5, about 2 to about 10, about 3 to about 4, about 3 to about 5, about 3 to about 7.5, about 3 to about 10, about 4 to about 5, about 4 to about 7.5, about 4 to about 10, about 5 to about 7.5, about 5 to about 10, or about 7.5 to about 10. In some embodiments, the molar ratio of boron to lithium is about 0.01, about 0.1, about 0.25, about 0.5, about 1, about 1.5, about 2, about 3, about 4, about 5, about 7.5, or about 10. In some embodiments, the molar ratio of boron to lithium is at least about 0.01, about 0.1, about 0.25, about 0.5, about 1, about 1.5, about 2, about 3, about 4, about 5, or about 7.5. In some embodiments, the molar ratio of boron to lithium is at most about 0.1, about 0.25, about 0.5, about 1, about 1.5, about 2, about 3, about 4, about 5, about 7.5, or about 10.

In some embodiments, the concentration-adjusted liquid resource may comprise a variable molar ratio of boron to lithium. In some embodiments, boron may be added to the liquid resource as a solid in the form of an adjusting ion solid. In some embodiments, boron may be added to the liquid resource as a liquid in the form of an adjusting ion solution. In some embodiments, the boron added to the liquid resource may originate from a boron removal system. In some embodiments, the boron removal system may remove boron from a synthetic lithium solution that is being purified. In some embodiments, the boron removal system may comprise ion exchange. In some embodiments, the boron removal system may comprise solvent extraction.

In some embodiments, particular molar ratios one or more adjusting ions to lithium may have an associated buffering capacity. In some embodiments, particular molar concentrations one or more adjusting ions and lithium in a concentration-adjusted liquid resource may have an associated buffering capacity. In some embodiments, a buffering capacity is expressed as the moles of hydrogen necessary to lower the pH of a concentration-adjusted liquid resource below a certain value In some embodiments, a buffering capacity is expressed as the moles of hydrogen necessary to lower the pH of a concentration-adjusted liquid resource below a certain as a function of the moles of lithium in the concentration-adjusted liquid resource, wherein the hydrogen atoms are released into the concentration-adjusted liquid resource as the lithium ions are extracted from concentration-adjusted liquid resource.

In some embodiments, increasing the concentration of one or more adjusting ions in a concentration-adjusted liquid resource may increase the buffering capacity of the concentration-adjusted liquid resource. In some embodiments, lowering the concentration of one or more adjusting ions in a concentration-adjusted liquid resource may lower the buffering capacity of the concentration-adjusted liquid resource. In some embodiments, lowering the concentration of one or more adjusting ions in a concentration-adjusted liquid resource may increase the buffering capacity of the concentration-adjusted liquid resource. In some embodiments, increasing the concentration of one or more adjusting ions in a concentration-adjusted liquid resource may lower the buffering capacity of the concentration-adjusted liquid resource.

In some embodiments, increasing the concentration of lithium in a concentration-adjusted liquid resource may increase the buffering capacity of the concentration-adjusted liquid resource. In some embodiments, lowering the concentration of lithium in a concentration-adjusted liquid resource may lower the buffering capacity of the concentration-adjusted liquid resource. In some embodiments, lowering the concentration of lithium in a concentration-adjusted liquid resource may increase the buffering capacity of the concentration-adjusted liquid resource. In some embodiments, increasing the concentration of lithium in a concentration-adjusted liquid resource may lower the buffering capacity of the concentration-adjusted liquid resource.

In some embodiments, increasing the concentration of one or more adjusting ions in an ion adjusted liquid resource may increase the buffering capacity of the concentration-adjusted liquid resource. In some embodiments, lowering the concentration of one or more adjusting ions in an ion adjusted liquid resource may lower the buffering capacity of the ion adjusted liquid resource. In some embodiments, lowering the concentration of one or more adjusting ions in an ion adjusted liquid resource may increase the buffering capacity of the ion adjusted liquid resource. In some embodiments, increasing the concentration of one or more adjusting ions in an ion adjusted liquid resource may lower the buffering capacity of the ion adjusted liquid resource.

In some embodiments, increasing the concentration of lithium in an ion adjusted liquid resource may increase the buffering capacity of the ion adjusted liquid resource. In some embodiments, lowering the concentration of lithium in an ion adjusted liquid resource may lower the buffering capacity of the ion adjusted liquid resource. In some embodiments, lowering the concentration of lithium in an ion adjusted liquid resource may increase the buffering capacity of the ion adjusted liquid resource. In some embodiments, increasing the concentration of lithium in an ion adjusted liquid resource may lower the buffering capacity of the ion adjusted liquid resource.

In an aspect, the methods and systems disclosed herein are applicable for lithium recovery from a liquid resource. In some embodiments, the liquid resource may be a concentration-adjusted liquid resource. In some embodiments, a concentration-adjusted liquid resource comprises lithium that has previously been subjected to a method or system for lithium recovery. In some embodiments, a concentration-adjusted liquid resource comprises the raffinate provided by an ion exchange device. In some embodiments, a concentration-adjusted liquid resource comprises the aqueous lithium solution provided by a lithium crystallization unit.

In some embodiments, the raffinate comprises lithium that was not successfully extracted from the liquid resource by an ion exchange device used for lithium recovery. In some embodiments, combining the raffinate with the liquid resource to provide a concentration-adjusted liquid resource allows for the lithium in the raffinate to subsequently be extracted by an ion exchange device used for lithium recovery. In some embodiments, the aqueous lithium solution comprises lithium that was not successfully extracted from the liquid resource by an ion exchange device used for lithium recovery. In some embodiments, combining the aqueous lithium solution with a liquid resource to provide a concentration-adjusted liquid resource allows for the lithium in the aqueous lithium solution to subsequently be extracted by an ion exchange device used for lithium recovery.

In some embodiments, use of a concentration-adjusted liquid resource that comprises the raffinate in place of a liquid resource may lead to a greater overall lithium recovery according to the methods and systems described herein. In some embodiments, use of a concentration-adjusted liquid resource that comprises the aqueous lithium solution in place of a liquid resource may lead to a greater overall lithium recovery according to the methods and systems described herein. In some embodiments, use of a concentration-adjusted liquid resource that comprises the raffinate in place of a liquid resource may lead to a greater lithium purity in the synthetic lithium solution provided by lithium recovery according to the methods and systems described herein. In some embodiments, use of a concentration-adjusted liquid resource that comprises the aqueous lithium solution in place of a liquid resource may lead to a greater lithium purity in the synthetic lithium solution provided by lithium recovery according to the methods and systems described herein.

In some embodiments, the single-pass lithium recovery according to the methods and systems described herein may be lower when a concentration-adjusted liquid resource is used in place of a liquid resource. In some embodiments, the single-pass lithium recovery according to the methods and systems described herein may be higher when a concentration-adjusted liquid resource is used in place of a liquid resource. In some embodiments, the lithium purity in the synthetic lithium solution may be higher as a result of a set of conditions that lowers the single-pass lithium recovery according to the methods and systems described herein. In some embodiments, a set of conditions that lowers the single-pass lithium recovery may consequently raise the lithium purity in the synthetic lithium solution.

In some embodiments, the overall lithium recovery according to the methods and systems described herein may be higher when a concentration-adjusted liquid resource is used in place of a liquid resource. In some embodiments, the overall lithium recovery according to the methods and systems described herein may be higher when a concentration-adjusted liquid resource is used in place of a liquid resource, even when the single-pass lithium recovery under the same conditions is lower. In some embodiments, the overall lithium recovery according to the methods and systems described herein may be higher when a concentration-adjusted liquid resource is used in place of a liquid resource, wherein the concentration-adjusted liquid resource comprises a quantity of raffinate. In some embodiments, the overall lithium recovery according to the methods and systems described herein may be higher when a concentration-adjusted liquid resource is used in place of a liquid resource, wherein the concentration-adjusted liquid resource comprises a quantity of aqueous lithium solution provided by a lithium crystallization unit.

In some embodiments, use of a concentration-adjusted liquid resource in place of a liquid resource may increase overall lithium recovery to a value of 60% to 99.9%. In some embodiments, use of a concentration-adjusted liquid resource in place of a liquid resource may increase overall lithium recovery to a value of 99.9% to 99%, 99.9% to 98%, 99.9% to 97%, 99.9% to 95%, 99.9% to 90%, 99.9% to 85%, 99.9% to 80, 99.9% to 75%, 99.9% to 70%, 99.9% to 65%, 99.9% to 60%, 99% to 98%, 99% to 97%, 99% to 95%, 99% to 90%, 99% to 85%, 99% to 80%, 99% to 75%, 99% to 70%, 99% to 65%, 99% to 60%, 98% to 97%, 98% to 95%, 98% to 90%, 98% to 85%, 98% to 80%, 98% to 75%, 98% to 700%, 98% to 65%, 98% to 60%, 97% to 95%, 97% to 90%, 97% to 85%, 97% to 80%, 97% to 75%, 97% to 70%, 97% to 65%, 97% to 60%, 95% to 90%, 95% to 85%, 95% to 80%, 95% to 75%, 95% to 70%, 95% to 65%, 95% to 60%, 9% to 85%, 9% to 80%, 9% to 75%, 9% to 70%, 9% to 65%, 9% to 60%, 85% to 80%, 85% to 75%, 85% to 7%, 85% to 65%, 85% to 60%, 8% to 75%, 8% to 70%, 8% to 65%, 8% to 6%, 75% to 70%, 75% to 65%, 75% to 6%, 7% to 65%, 7% to 6%, or 65% to 60%. In some embodiments, use of a concentration-adjusted liquid resource in place of a liquid resource may increase overall lithium recovery to a value of 99.9%, 99%, 98%, 97%, 95%, 90%, 85%, 80%, 75%, 70%, 65%, or 60%. In some embodiments, use of a concentration-adjusted liquid resource in place of a liquid resource may increase overall lithium recovery to a value of at least 99.9%, 99%, 98%, 97%, 95%, 90%, 85%, 80%, 75%, 70%, or 65%. In some embodiments, use of a concentration-adjusted liquid resource in place of a liquid resource may increase overall lithium recovery to a value of at most 99%, 98%, 97%, 95%, 90%, 85%, 80%, 75%, 70%, 65%, or 60%.

In some embodiments, use of a concentration-adjusted liquid resource in place of a liquid resource may increase overall lithium recovery by a factor of 1.01 to 5. In some embodiments, use of a concentration-adjusted liquid resource in place of a liquid resource may increase overall lithium recovery by a factor of 5 to 4, 5 to 3, 5 to 2.5, 5 to 2.25, 5 to 2, 5 to 1.75, 5 to 1.5, 5 to 1.25, 5 to 1.1, 5 to 1.05, 5 to 1.01, 4 to 3, 4 to 2.5, 4 to 2.25, 4 to 2, 4 to 1.75, 4 to 1.5, 4 to 1.25, 4 to 1.1, 4 to 1.05, 4 to 1.01, 3 to 2.5, 3 to 2.25, 3 to 2, 3 to 1.75, 3 to 1.5, 3 to 1.25, 3 to 1.1, 3 to 1.05, 3 to 1.01, 2.5 to 2.25, 2.5 to 2, 2.5 to 1.75, 2.5 to 1.5, 2.5 to 1.25, 2.5 to 1.1, 2.5 to 1.05, 2.5 to 1.01, 2.25 to 2, 2.25 to 1.75, 2.25 to 1.5, 2.25 to 1.25, 2.25 to 1.1, 2.25 to 1.05, 2.25 to 1.01, 2 to 1.75, 2 to 1.5, 2 to 1.25, 2 to 1.1, 2 to 1.05, 2 to 1.01, 1.75 to 1.5, 1.75 to 1.25, 1.75 to 1.1, 1.75 to 1.05, 1.75 to 1.01, 1.5 to 1.25, 1.5 to 1.1, 1.5 to 1.05, 1.5 to 1.01, 1.25 to 1.1, 1.25 to 1.05, 1.25 to 1.01, 1.1 to 1.05, 1.1 to 1.01, or 1.05 to 1.01. In some embodiments, use of a concentration-adjusted liquid resource in place of a liquid resource may increase overall lithium recovery by a factor of 5, 4, 3, 2.5, 2.25, 2, 1.75, 1.5, 1.25, 1.1, 1.05, or 1.01. In some embodiments, use of a concentration-adjusted liquid resource in place of a liquid resource may increase overall lithium recovery by a factor of at least 5, 4, 3, 2.5, 2.25, 2, 1.75, 1.5, 1.25, 1.1, or 1.05. In some embodiments, use of a concentration-adjusted liquid resource in place of a liquid resource may increase overall lithium recovery by a factor of at most 4, 3, 2.5, 2.25, 2, 1.75, 1.5, 1.25, 1.1, 1.05, or 1.01. In some embodiments, use of a concentration-adjusted liquid resource in place of a liquid resource may increase overall lithium recovery by a factor of about 1.01 to about 5. In some embodiments, use of a concentration-adjusted liquid resource in place of a liquid resource may increase overall lithium recovery by a factor of about 5 to about 4, about 5 to about 3, about 5 to about 2.5, about 5 to about 2.25, about 5 to about 2, about 5 to about 1.75, about 5 to about 1.5, about 5 to about 1.25, about 5 to about 1.1, about 5 to about 1.05, about 5 to about 1.01, about 4 to about 3, about 4 to about 2.5, about 4 to about 2.25, about 4 to about 2, about 4 to about 1.75, about 4 to about 1.5, about 4 to about 1.25, about 4 to about 1.1, about 4 to about 1.05, about 4 to about 1.01, about 3 to about 2.5, about 3 to about 2.25, about 3 to about 2, about 3 to about 1.75, about 3 to about 1.5, about 3 to about 1.25, about 3 to about 1.1, about 3 to about 1.05, about 3 to about 1.01, about 2.5 to about 2.25, about 2.5 to about 2, about 2.5 to about 1.75, about 2.5 to about 1.5, about 2.5 to about 1.25, about 2.5 to about 1.1, about 2.5 to about 1.05, about 2.5 to about 1.01, about 2.25 to about 2, about 2.25 to about 1.75, about 2.25 to about 1.5, about 2.25 to about 1.25, about 2.25 to about 1.1, about 2.25 to about 1.05, about 2.25 to about 1.01, about 2 to about 1.75, about 2 to about 1.5, about 2 to about 1.25, about 2 to about 1.1, about 2 to about 1.05, about 2 to about 1.01, about 1.75 to about 1.5, about 1.75 to about 1.25, about 1.75 to about 1.1, about 1.75 to about 1.05, about 1.75 to about 1.01, about 1.5 to about 1.25, about 1.5 to about 1.1, about 1.5 to about 1.05, about 1.5 to about 1.01, about 1.25 to about 1.1, about 1.25 to about 1.05, about 1.25 to about 1.01, about 1.1 to about 1.05, about 1.1 to about 1.01, or about 1.05 to about 1.01. In some embodiments, use of a concentration-adjusted liquid resource in place of a liquid resource may increase overall lithium recovery by a factor of about 5, about 4, about 3, about 2.5, about 2.25, about 2, about 1.75, about 1.5, about 1.25, about 1.1, about 1.05, or about 1.01. In some embodiments, use of a concentration-adjusted liquid resource in place of a liquid resource may increase overall lithium recovery by a factor of at least about 5, about 4, about 3, about 2.5, about 2.25, about 2, about 1.75, about 1.5, about 1.25, about 1.1, or about 1.05. In some embodiments, use of a concentration-adjusted liquid resource in place of a liquid resource may increase overall lithium recovery by a factor of at most about 4, about 3, about 2.5, about 2.25, about 2, about 1.75, about 1.5, about 1.25, about 1.1, about 1.05, or about 1.01.

In some embodiments, use of a concentration-adjusted liquid resource in place of a liquid resource according to the methods and systems described herein may lead to a longer useful lifetime of an ion exchange material. In some embodiments, the ion exchange material is a lithium-selective sorbent. In some embodiments, the useful lifetime of an ion exchange material may be associated with the total quantity of lithium recovered by the ion exchange material before the ion exchange material must be replaced to maintain satisfactory performance parameters. In some embodiments, a longer useful lifetime of an ion exchange material reduces the costs associated with replacing the ion exchange material by virtue of allowing the ion exchange material to be replaced with lower frequency. In some embodiments, a longer useful lifetime of an ion exchange material increases the purity of lithium in the synthetic lithium solution by virtue of reducing dissolution and degradation of the ion exchange material.

In some embodiments, use of a concentration-adjusted liquid resource in place of a liquid resource according to the methods and systems described herein may lead to a lower quantity of acid or base being required to achieve the purification of a given quantity of lithium in the form of a synthetic lithium solution or one or more lithium chemicals. In some embodiments, use of a concentration-adjusted liquid resource in place of a liquid resource according to the methods and systems described herein may allow for a fixed bed of ion exchange material or ion exchange beads to be utilized under a set of conditions where a fluidized bed of ion exchange material or ion exchange beads would otherwise provide better performance parameters. In some embodiments, use of a concentration-adjusted liquid resource in place of a liquid resource according to the methods and systems described herein may allow for a fluidized bed of ion exchange material or ion exchange beads to be utilized under a set of conditions where a fixed bed of ion exchange material or ion exchange beads would otherwise provide better performance parameters.

In some embodiments, use of a concentration-adjusted liquid resource in place of a liquid resource according to the methods and systems described herein may lead to a diminished physical degradation of an ion exchange bead or ion exchange material. In some embodiments, use of a concentration-adjusted liquid resource in place of a liquid resource according to the methods and systems described herein may lead to a diminished chemical degradation of an ion exchange material or ion exchange bead. In some embodiments, said diminished physical or chemical degradation leads to longer useful lifetime of the ion exchange material or ion exchange bead for lithium extraction.

In some embodiments, the useful lifetime of an ion exchange material or ion exchange bead may be quantified in terms of the number of ion exchange cycles that may be conducted before the lithium purity of the synthetic lithium solution provided by the ion exchange material or ion exchange bead falls below a determined value. In some embodiments, the useful lifetime of an ion exchange material or ion exchange bead may be quantified in terms of the number of ion exchange cycles that may be conducted before the single-pass lithium recovery of the ion exchange material or ion exchange bead falls below a determined value. In some embodiments, the useful lifetime of an ion exchange material or ion exchange bead may be quantified in terms of the number of ion exchange cycles that may be conducted before the single-pass lithium recovery of an ion exchange device comprising the ion exchange material or ion exchange bead falls below a determined value.

In some embodiments, the useful lifetime of an ion exchange material or ion exchange bead may be quantified in terms of the total lithium extraction time that may pass before the lithium purity of the synthetic lithium solution provided by the ion exchange material or ion exchange bead falls below a determined value. In some embodiments, the useful lifetime of an ion exchange material or ion exchange bead may be quantified in terms of the total lithium extraction time that may pass before the single-pass lithium recovery of the ion exchange material or ion exchange bead falls below a determined value. In some embodiments, the useful lifetime of an ion exchange material or ion exchange bead may be quantified in terms of the total lithium extraction time that may pass before the single-pass lithium recovery of an ion exchange device comprising the ion exchange material or ion exchange bead falls below a determined value.

In some embodiments, the useful lifetime of an ion exchange material or ion exchange bead may be quantified in terms of the lithium absorption capacity of the ion exchange material or ion exchange bead falling below a determined value.

In some embodiments, the useful lifetime of an ion exchange material or ion exchange bead may be quantified in terms of the extraction time required for the ion exchange material or ion exchange bead to complete a lithium extraction step rising above a determined value.

In some embodiments, the useful lifetime of an ion exchange material or ion exchange bead may be quantified in terms of the total quantity of lithium produced by the ion exchange material or ion exchange bead.

In some embodiments, the useful lifetime of an ion exchange material or ion exchange bead may end when the lithium purity of the synthetic lithium solution falls below 30% to 95%. In some embodiments, the useful lifetime of an ion exchange material or ion exchange bead may end when the lithium purity of the synthetic lithium solution falls below 95% to 90%, 95% to 85%, 95% to 80%, 95% to 75%, 95% to 70%, 95% to 65%, 95% to 60%, 95% to 55%, 95% to 50%, 95% to 40%, 95% to 30%, 90% to 85%, 90% to 80%, 90% to 75%, 90% to 70%, 90% to 65%, 90% to 60%, 90% to 55%, 90% to 50%, 90% to 40%, 90% to 30%, 85% to 80%, 85% to 75%, 85% to 70%, 85% to 65%, 85% to 60%, 85% to 55%, 85% to 50%, 85% to 40%, 85% to 30%, 80% to 75%, 80% to 70%, 80% to 65%, 80% to 60%, 80% to 55%, 80% to 50%, 80% to 40%, 80% to 30%, 75% to 70%, 75% to 65%, 75% to 60%, 75% to 55%, 75% to 50%, 75% to 40%, 75% to 30%, 70% to 65%, 70% to 60%, 70% to 55%, 70% to 50%, 70% to 40%, 70% to 30%, 65% to 60%, 65% to 55%, 65% to 50%, 65% to 40%, 65% to 30%, 60% to 55%, 60% to 50%, 60% to 40%, 60% to 30%, 55% to 50%, 55% to 40%, 55% to 30%, 50% to 40%, 50% to 30%, or 40% to 30%. In some embodiments, the useful lifetime of an ion exchange material or ion exchange bead may end when the lithium purity of the synthetic lithium solution falls below 95%, 90%, 85%, 80%, 75%, 70%, 65%, 60%, 55%, 50%, 40%, or 30%. In some embodiments, the useful lifetime of an ion exchange material or ion exchange bead may end when the lithium purity of the synthetic lithium solution falls below at least 95%, 90%, 85%, 80%, 75%, 70%, 65%, 60%, 55%, 50%, or 40%. In some embodiments, the useful lifetime of an ion exchange material or ion exchange bead may end when the lithium purity of the synthetic lithium solution falls below at most 90%, 85%, 80%, 75%, 70%, 65%, 60%, 55%, 50%, 40%, or 30%.

In some embodiments, the useful lifetime of an ion exchange material or ion exchange bead may end when the single-pass lithium recovery falls below 30% to 95%. In some embodiments, the useful lifetime of an ion exchange material or ion exchange bead may end when the single-pass lithium recovery falls below 95% to 90%, 95% to 85%, 95% to 80%, 95% to 75%, 95% to 70%, 95% to 65%, 95% to 60%, 95% to 55%, 95% to 50%, 95% to 40%, 95% to 30%, 90% to 85%, 90% to 80%, 90% to 75%, 90% to 70%, 90% to 65%, 90% to 60%, 90% to 55%, 90% to 50%, 90% to 40%, 90% to 30%, 85% to 80%, 85% to 75%, 85% to 70%, 85% to 65%, 85% to 60%, 85% to 55%, 85% to 50%, 85% to 40%, 85% to 30%, 80% to 75%, 80% to 70%, 80% to 65%, 80% to 600%, 80% to 55%, 80% to 50%, 80% to 40%, 80% to 30%, 75% to 70%, 75% to 65%, 75% to 60%, 75% to 55%, 75% to 50%, 75% to 40%, 75% to 30%, 70% to 65%, 70% to 60%, 70% to 55%, 70% to 50%, 70% to 40%, 70% to 30%, 65% to 60%, 65% to 55%, 65% to 50%, 65% to 40%, 65% to 30%, 60% to 55%, 60% to 50%, 60% to 40%, 60% to 30%, 55% to 50%, 55% to 40%, 55% to 30%, 50% to 40%, 50% to 30%, or 40% to 30%. In some embodiments, the useful lifetime of an ion exchange material or ion exchange bead may end when the single-pass lithium recovery falls below 95%, 90%, 85%, 80%, 75%, 70%, 65%, 60%, 55%, 50%, 40%, or 30%. In some embodiments, the useful lifetime of an ion exchange material or ion exchange bead may end when the single-pass lithium recovery falls below at least 95%, 90%, 85%, 80%, 75%, 70%, 65%, 60%, 55%, 50%, or 40%. In some embodiments, the useful lifetime of an ion exchange material or ion exchange bead may end when the single-pass lithium recovery falls below at most 90%, 85%, 80%, 75%, 70%, 65%, 60%, 55%, 50%, 40%, or 30%.

In some embodiments, useful lifetime is defined by the number of ion exchange cycles (e.g., cycles) during which a quantity of lithium-selective sorbent is used before the lithium-selective sorbent needs to be replaced. For example, according to some embodiments, if the useful lifetime is increased by 50%, then the number of ion exchange cycles (e.g., cycles) during which a quantity of lithium-selective sorbent is used before the lithium-selective sorbent needs to be replaced is increased by 50%.

In some embodiments, useful lifetime of an ion exchange material or bead may be 100 ion exchange cycles to 6,000 ion exchange cycles (e.g., 100 cycles to 6000 cycles). In some embodiments, useful lifetime of an ion exchange material or bead may be 6,000 ion exchange cycles to 5,500 ion exchange cycles, 6,000 ion exchange cycles to 5,000 ion exchange cycles, 6,000 ion exchange cycles to 4,500 ion exchange cycles, 6,000 ion exchange cycles to 4,000 ion exchange cycles, 6,000 ion exchange cycles to 3,500 ion exchange cycles, 6,000 ion exchange cycles to 3,000 ion exchange cycles, 6,000 ion exchange cycles to 2,000 ion exchange cycles, 6,000 ion exchange cycles to 1,000 ion exchange cycles, 6,000 ion exchange cycles to 500 ion exchange cycles, 6,000 ion exchange cycles to 250 ion exchange cycles, 6,000 ion exchange cycles to 100 ion exchange cycles, 5,500 ion exchange cycles to 5,000 ion exchange cycles, 5,500 ion exchange cycles to 4,500 ion exchange cycles, 5,500 ion exchange cycles to 4,000 ion exchange cycles, 5,500 ion exchange cycles to 3,500 ion exchange cycles, 5,500 ion exchange cycles to 3,000 ion exchange cycles, 5,500 ion exchange cycles to 2,000 ion exchange cycles, 5,500 ion exchange cycles to 1,000 ion exchange cycles, 5,500 ion exchange cycles to 500 ion exchange cycles, 5,500 ion exchange cycles to 250 ion exchange cycles, 5,500 ion exchange cycles to 100 ion exchange cycles, 5,000 ion exchange cycles to 4,500 ion exchange cycles, 5,000 ion exchange cycles to 4,000 ion exchange cycles, 5,000 ion exchange cycles to 3,500 ion exchange cycles, 5,000 ion exchange cycles to 3,000 ion exchange cycles, 5,000 ion exchange cycles to 2,000 ion exchange cycles, 5,000 ion exchange cycles to 1,000 ion exchange cycles, 5,000 ion exchange cycles to 500 ion exchange cycles, 5,000 ion exchange cycles to 250 ion exchange cycles, 5,000 ion exchange cycles to 100 ion exchange cycles, 4,500 ion exchange cycles to 4,000 ion exchange cycles, 4,500 ion exchange cycles to 3,500 ion exchange cycles, 4,500 ion exchange cycles to 3,000 ion exchange cycles, 4,500 ion exchange cycles to 2,000 ion exchange cycles, 4,500 ion exchange cycles to 1,000 ion exchange cycles, 4,500 ion exchange cycles to 500 ion exchange cycles, 4,500 ion exchange cycles to 250 ion exchange cycles, 4,500 ion exchange cycles to 100 ion exchange cycles, 4,000 ion exchange cycles to 3,500 ion exchange cycles, 4,000 ion exchange cycles to 3,000 ion exchange cycles, 4,000 ion exchange cycles to 2,000 ion exchange cycles, 4,000 ion exchange cycles to 1,000 ion exchange cycles, 4,000 ion exchange cycles to 500 ion exchange cycles, 4,000 ion exchange cycles to 250 ion exchange cycles, 4,000 ion exchange cycles to 100 ion exchange cycles, 3,500 ion exchange cycles to 3,000 ion exchange cycles, 3,500 ion exchange cycles to 2,000 ion exchange cycles, 3,500 ion exchange cycles to 1,000 ion exchange cycles, 3,500 ion exchange cycles to 500 ion exchange cycles, 3,500 ion exchange cycles to 250 ion exchange cycles, 3,500 ion exchange cycles to 100 ion exchange cycles, 3,000 ion exchange cycles to 2,000 ion exchange cycles, 3,000 ion exchange cycles to 1,000 ion exchange cycles, 3,000 ion exchange cycles to 500 ion exchange cycles, 3,000 ion exchange cycles to 250 ion exchange cycles, 3,000 ion exchange cycles to 100 ion exchange cycles, 2,000 ion exchange cycles to 1,000 ion exchange cycles, 2,000 ion exchange cycles to 500 ion exchange cycles, 2,000 ion exchange cycles to 250 ion exchange cycles, 2,000 ion exchange cycles to 100 ion exchange cycles, 1,000 ion exchange cycles to 500 ion exchange cycles, 1,000 ion exchange cycles to 250 ion exchange cycles, 1,000 ion exchange cycles to 100 ion exchange cycles, 500 ion exchange cycles to 250 ion exchange cycles, 500 ion exchange cycles to 100 ion exchange cycles, or 250 ion exchange cycles to 100 ion exchange cycles. In some embodiments, useful lifetime of an ion exchange material or bead may be 6,000 ion exchange cycles, 5,500 ion exchange cycles, 5,000 ion exchange cycles, 4,500 ion exchange cycles, 4,000 ion exchange cycles, 3,500 ion exchange cycles, 3,000 ion exchange cycles, 2,000 ion exchange cycles, 1,000 ion exchange cycles, 500 ion exchange cycles, 250 ion exchange cycles, or 100 ion exchange cycles. In some embodiments, useful lifetime of an ion exchange material or bead may be at least 6,000 ion exchange cycles, 5,500 ion exchange cycles, 5,000 ion exchange cycles, 4,500 ion exchange cycles, 4,000 ion exchange cycles, 3,500 ion exchange cycles, 3,000 ion exchange cycles, 2,000 ion exchange cycles, 1,000 ion exchange cycles, 500 ion exchange cycles, or 250 ion exchange cycles. In some embodiments, useful lifetime of an ion exchange material or bead may be at most 5,500 ion exchange cycles, 5,000 ion exchange cycles, 4,500 ion exchange cycles, 4,000 ion exchange cycles, 3,500 ion exchange cycles, 3,000 ion exchange cycles, 2,000 ion exchange cycles, 1,000 ion exchange cycles, 500 ion exchange cycles, 250 ion exchange cycles, or 100 ion exchange cycles.

In some embodiments, useful lifetime is defined by the lithium extraction time during which a quantity of lithium-selective sorbent is used before the lithium-selective sorbent needs to be replaced. For example, according to some embodiments, if the useful lifetime is increased by 50%, then the lithium extraction time during which a quantity of lithium-selective sorbent is used before the lithium-selective sorbent needs to be replaced is increased by 50%.

In some embodiments, useful lifetime of an ion exchange material or bead may be 100 hours of lithium extraction time to 6,000 hours of lithium extraction time. In some embodiments, useful lifetime of an ion exchange material or bead may be 6,000 hours of lithium extraction time to 5,500 hours of lithium extraction time, 6,000 hours of lithium extraction time to 5,000 hours of lithium extraction time, 6,000 hours of lithium extraction time to 4,500 hours of lithium extraction time, 6,000 hours of lithium extraction time to 4,000 hours of lithium extraction time, 6,000 hours of lithium extraction time to 3,500 hours of lithium extraction time, 6,000 hours of lithium extraction time to 3,000 hours of lithium extraction time, 6,000 hours of lithium extraction time to 2,000 hours of lithium extraction time, 6,000 hours of lithium extraction time to 1,000 hours of lithium extraction time, 6,000 hours of lithium extraction time to 500 hours of lithium extraction time, 6,000 hours of lithium extraction time to 250 hours of lithium extraction time, 6,000 hours of lithium extraction time to 100 hours of lithium extraction time, 5,500 hours of lithium extraction time to 5,000 hours of lithium extraction time, 5,500 hours of lithium extraction time to 4,500 hours of lithium extraction time, 5,500 hours of lithium extraction time to 4,000 hours of lithium extraction time, 5,500 hours of lithium extraction time to 3,500 hours of lithium extraction time, 5,500 hours of lithium extraction time to 3,000 hours of lithium extraction time, 5,500 hours of lithium extraction time to 2,000 hours of lithium extraction time, 5,500 hours of lithium extraction time to 1,000 hours of lithium extraction time, 5,500 hours of lithium extraction time to 500 hours of lithium extraction time, 5,500 hours of lithium extraction time to 250 hours of lithium extraction time, 5,500 hours of lithium extraction time to 100 hours of lithium extraction time, 5,000 hours of lithium extraction time to 4,500 hours of lithium extraction time, 5,000 hours of lithium extraction time to 4,000 hours of lithium extraction time, 5,000 hours of lithium extraction time to 3,500 hours of lithium extraction time, 5,000 hours of lithium extraction time to 3,000 hours of lithium extraction time, 5,000 hours of lithium extraction time to 2,000 hours of lithium extraction time, 5,000 hours of lithium extraction time to 1,000 hours of lithium extraction time, 5,000 hours of lithium extraction time to 500 hours of lithium extraction time, 5,000 hours of lithium extraction time to 250 hours of lithium extraction time, 5,000 hours of lithium extraction time to 100 hours of lithium extraction time, 4,500 hours of lithium extraction time to 4,000 hours of lithium extraction time, 4,500 hours of lithium extraction time to 3,500 hours of lithium extraction time, 4,500 hours of lithium extraction time to 3,000 hours of lithium extraction time, 4,500 hours of lithium extraction time to 2,000 hours of lithium extraction time, 4,500 hours of lithium extraction time to 1,000 hours of lithium extraction time, 4,500 hours of lithium extraction time to 500 hours of lithium extraction time, 4,500 hours of lithium extraction time to 250 hours of lithium extraction time, 4,500 hours of lithium extraction time to 100 hours of lithium extraction time, 4,000 hours of lithium extraction time to 3,500 hours of lithium extraction time, 4,000 hours of lithium extraction time to 3,000 hours of lithium extraction time, 4,000 hours of lithium extraction time to 2,000 hours of lithium extraction time, 4,000 hours of lithium extraction time to 1,000 hours of lithium extraction time, 4,000 hours of lithium extraction time to 500 hours of lithium extraction time, 4,000 hours of lithium extraction time to 250 hours of lithium extraction time, 4,000 hours of lithium extraction time to 100 hours of lithium extraction time, 3,500 hours of lithium extraction time to 3,000 hours of lithium extraction time, 3,500 hours of lithium extraction time to 2,000 hours of lithium extraction time, 3,500 hours of lithium extraction time to 1,000 hours of lithium extraction time, 3,500 hours of lithium extraction time to 500 hours of lithium extraction time, 3,500 hours of lithium extraction time to 250 hours of lithium extraction time, 3,500 hours of lithium extraction time to 100 hours of lithium extraction time, 3,000 hours of lithium extraction time to 2,000 hours of lithium extraction time, 3,000 hours of lithium extraction time to 1,000 hours of lithium extraction time, 3,000 hours of lithium extraction time to 500 hours of lithium extraction time, 3,000 hours of lithium extraction time to 250 hours of lithium extraction time, 3,000 hours of lithium extraction time to 100 hours of lithium extraction time, 2,000 hours of lithium extraction time to 1,000 hours of lithium extraction time, 2,000 hours of lithium extraction time to 500 hours of lithium extraction time, 2,000 hours of lithium extraction time to 250 hours of lithium extraction time, 2,000 hours of lithium extraction time to 100 hours of lithium extraction time, 1,000 hours of lithium extraction time to 500 hours of lithium extraction time, 1,000 hours of lithium extraction time to 250 hours of lithium extraction time, 1,000 hours of lithium extraction time to 100 hours of lithium extraction time, 500 hours of lithium extraction time to 250 hours of lithium extraction time, 500 hours of lithium extraction time to 100 hours of lithium extraction time, or 250 hours of lithium extraction time to 100 hours of lithium extraction time. In some embodiments, useful lifetime of an ion exchange material or bead may be 6,000 hours of lithium extraction time, 5,500 hours of lithium extraction time, 5,000 hours of lithium extraction time, 4,500 hours of lithium extraction time, 4,000 hours of lithium extraction time, 3,500 hours of lithium extraction time, 3,000 hours of lithium extraction time, 2,000 hours of lithium extraction time, 1,000 hours of lithium extraction time, 500 hours of lithium extraction time, 250 hours of lithium extraction time, or 100 hours of lithium extraction time. In some embodiments, useful lifetime of an ion exchange material or bead may be at least 6,000 hours of lithium extraction time, 5,500 hours of lithium extraction time, 5,000 hours of lithium extraction time, 4,500 hours of lithium extraction time, 4,000 hours of lithium extraction time, 3,500 hours of lithium extraction time, 3,000 hours of lithium extraction time, 2,000 hours of lithium extraction time, 1,000 hours of lithium extraction time, 500 hours of lithium extraction time, or 250 hours of lithium extraction time. In some embodiments, useful lifetime of an ion exchange material or bead may be at most 5,500 hours of lithium extraction time, 5,000 hours of lithium extraction time, 4,500 hours of lithium extraction time, 4,000 hours of lithium extraction time, 3,500 hours of lithium extraction time, 3,000 hours of lithium extraction time, 2,000 hours of lithium extraction time, 1,000 hours of lithium extraction time, 500 hours of lithium extraction time, 250 hours of lithium extraction time, or 100 hours of lithium extraction time.

In some embodiments, useful lifetime of an ion exchange material or ion exchange bead may end when the lithium absorption capacity falls below 1 mg of lithium per gram of material or beads to 100 mg of lithium per gram of material or beads. In some embodiments, useful lifetime of an ion exchange material or ion exchange bead may end when the lithium absorption capacity falls below 100 mg of lithium per gram of material or beads to 90 mg of lithium per gram of material or beads, 100 mg of lithium per gram of material or beads to 80 mg of lithium per gram of material or beads, 100 mg of lithium per gram of material or beads to 70 mg of lithium per gram of material or beads, 100 mg of lithium per gram of material or beads to 60 mg of lithium per gram of material or beads, 100 mg of lithium per gram of material or beads to 50 mg of lithium per gram of material or beads, 100 mg of lithium per gram of material or beads to 40 mg of lithium per gram of material or beads, 100 mg of lithium per gram of material or beads to 30 mg of lithium per gram of material or beads, 100 mg of lithium per gram of material or beads to 20 mg of lithium per gram of material or beads, 100 mg of lithium per gram of material or beads to 10 mg of lithium per gram of material or beads, 100 mg of lithium per gram of material or beads to 5 mg of lithium per gram of material or beads, 100 mg of lithium per gram of material or beads to 1 mg of lithium per gram of material or beads, 90 mg of lithium per gram of material or beads to 80 mg of lithium per gram of material or beads, 90 mg of lithium per gram of material or beads to 70 mg of lithium per gram of material or beads, 90 mg of lithium per gram of material or beads to 60 mg of lithium per gram of material or beads, 90 mg of lithium per gram of material or beads to 50 mg of lithium per gram of material or beads, 90 mg of lithium per gram of material or beads to 40 mg of lithium per gram of material or beads, 90 mg of lithium per gram of material or beads to 30 mg of lithium per gram of material or beads, 90 mg of lithium per gram of material or beads to 20 mg of lithium per gram of material or beads, 90 mg of lithium per gram of material or beads to 10 mg of lithium per gram of material or beads, 90 mg of lithium per gram of material or beads to 5 mg of lithium per gram of material or beads, 90 mg of lithium per gram of material or beads to 1 mg of lithium per gram of material or beads, 80 mg of lithium per gram of material or beads to 70 mg of lithium per gram of material or beads, 80 mg of lithium per gram of material or beads to 60 mg of lithium per gram of material or beads, 80 mg of lithium per gram of material or beads to 50 mg of lithium per gram of material or beads, 80 mg of lithium per gram of material or beads to 40 mg of lithium per gram of material or beads, 80 mg of lithium per gram of material or beads to 30 mg of lithium per gram of material or beads, 80 mg of lithium per gram of material or beads to 20 mg of lithium per gram of material or beads, 80 mg of lithium per gram of material or beads to 10 mg of lithium per gram of material or beads, 80 mg of lithium per gram of material or beads to 5 mg of lithium per gram of material or beads, 80 mg of lithium per gram of material or beads to 1 mg of lithium per gram of material or beads, 70 mg of lithium per gram of material or beads to 60 mg of lithium per gram of material or beads, 70 mg of lithium per gram of material or beads to 50 mg of lithium per gram of material or beads, 70 mg of lithium per gram of material or beads to 40 mg of lithium per gram of material or beads, 70 mg of lithium per gram of material or beads to 30 mg of lithium per gram of material or beads, 70 mg of lithium per gram of material or beads to 20 mg of lithium per gram of material or beads, 70 mg of lithium per gram of material or beads to 10 mg of lithium per gram of material or beads, 70 mg of lithium per gram of material or beads to 5 mg of lithium per gram of material or beads, 70 mg of lithium per gram of material or beads to 1 mg of lithium per gram of material or beads, 60 mg of lithium per gram of material or beads to 50 mg of lithium per gram of material or beads, 60 mg of lithium per gram of material or beads to 40 mg of lithium per gram of material or beads, 60 mg of lithium per gram of material or beads to 30 mg of lithium per gram of material or beads, 60 mg of lithium per gram of material or beads to 20 mg of lithium per gram of material or beads, 60 mg of lithium per gram of material or beads to 10 mg of lithium per gram of material or beads, 60 mg of lithium per gram of material or beads to 5 mg of lithium per gram of material or beads, 60 mg of lithium per gram of material or beads to 1 mg of lithium per gram of material or beads, 50 mg of lithium per gram of material or beads to 40 mg of lithium per gram of material or beads, 50 mg of lithium per gram of material or beads to 30 mg of lithium per gram of material or beads, 50 mg of lithium per gram of material or beads to 20 mg of lithium per gram of material or beads, 50 mg of lithium per gram of material or beads to 10 mg of lithium per gram of material or beads, 50 mg of lithium per gram of material or beads to 5 mg of lithium per gram of material or beads, 50 mg of lithium per gram of material or beads to 1 mg of lithium per gram of material or beads, 40 mg of lithium per gram of material or beads to 30 mg of lithium per gram of material or beads, 40 mg of lithium per gram of material or beads to 20 mg of lithium per gram of material or beads, 40 mg of lithium per gram of material or beads to 10 mg of lithium per gram of material or beads, 40 mg of lithium per gram of material or beads to 5 mg of lithium per gram of material or beads, 40 mg of lithium per gram of material or beads to 1 mg of lithium per gram of material or beads, 30 mg of lithium per gram of material or beads to 20 mg of lithium per gram of material or beads, 30 mg of lithium per gram of material or beads to 10 mg of lithium per gram of material or beads, 30 mg of lithium per gram of material or beads to 5 mg of lithium per gram of material or beads, 30 mg of lithium per gram of material or beads to 1 mg of lithium per gram of material or beads, 20 mg of lithium per gram of material or beads to 10 mg of lithium per gram of material or beads, 20 mg of lithium per gram of material or beads to 5 mg of lithium per gram of material or beads, 20 mg of lithium per gram of material or beads to 1 mg of lithium per gram of material or beads, 10 mg of lithium per gram of material or beads to 5 mg of lithium per gram of material or beads, 10 mg of lithium per gram of material or beads to 1 mg of lithium per gram of material or beads, or 5 mg of lithium per gram of material or beads to 1 mg of lithium per gram of material or beads. In some embodiments, useful lifetime of an ion exchange material or ion exchange bead may end when the lithium absorption capacity falls below 100 mg of lithium per gram of material or beads, 90 mg of lithium per gram of material or beads, 80 mg of lithium per gram of material or beads, 70 mg of lithium per gram of material or beads, 60 mg of lithium per gram of material or beads, 50 mg of lithium per gram of material or beads, 40 mg of lithium per gram of material or beads, 30 mg of lithium per gram of material or beads, 20 mg of lithium per gram of material or beads, 10 mg of lithium per gram of material or beads, 5 mg of lithium per gram of material or beads, or 1 mg of lithium per gram of material or beads. In some embodiments, useful lifetime of an ion exchange material or ion exchange bead may end when the lithium absorption capacity falls below at least 100 mg of lithium per gram of material or beads, 90 mg of lithium per gram of material or beads, 80 mg of lithium per gram of material or beads, 70 mg of lithium per gram of material or beads, 60 mg of lithium per gram of material or beads, 50 mg of lithium per gram of material or beads, 40 mg of lithium per gram of material or beads, 30 mg of lithium per gram of material or beads, 20 mg of lithium per gram of material or beads, 10 mg of lithium per gram of material or beads, or 5 mg of lithium per gram of material or beads. In some embodiments, useful lifetime of an ion exchange material or ion exchange bead may end when the lithium absorption capacity falls below at most 90 mg of lithium per gram of material or beads, 80 mg of lithium per gram of material or beads, 70 mg of lithium per gram of material or beads, 60 mg of lithium per gram of material or beads, 50 mg of lithium per gram of material or beads, 40 mg of lithium per gram of material or beads, 30 mg of lithium per gram of material or beads, 20 mg of lithium per gram of material or beads, 10 mg of lithium per gram of material or beads, 5 mg of lithium per gram of material or beads, or 1 mg of lithium per gram of material or beads.

In some embodiments, useful lifetime of an ion exchange material or ion exchange bead may end when a lithium extraction step requires 0.1 hours to complete to 5 hours to complete. In some embodiments, useful lifetime of an ion exchange material or ion exchange bead may end when a lithium extraction step requires 5 hours to complete to 4.5 hours to complete, 5 hours to complete to 4 hours to complete, 5 hours to complete to 3.5 hours to complete, 5 hours to complete to 3 hours to complete, 5 hours to complete to 2.5 hours to complete, 5 hours to complete to 2 hours to complete, 5 hours to complete to 1.5 hours to complete, 5 hours to complete to 1 hour to complete, 5 hours to complete to 0.5 hours to complete, 5 hours to complete to 0.25 hours to complete, 5 hours to complete to 0.1 hours to complete, 4.5 hours to complete to 4 hours to complete, 4.5 hours to complete to 3.5 hours to complete, 4.5 hours to complete to 3 hours to complete, 4.5 hours to complete to 2.5 hours to complete, 4.5 hours to complete to 2 hours to complete, 4.5 hours to complete to 1.5 hours to complete, 4.5 hours to complete to 1 hour to complete, 4.5 hours to complete to 0.5 hours to complete, 4.5 hours to complete to 0.25 hours to complete, 4.5 hours to complete to 0.1 hours to complete, 4 hours to complete to 3.5 hours to complete, 4 hours to complete to 3 hours to complete, 4 hours to complete to 2.5 hours to complete, 4 hours to complete to 2 hours to complete, 4 hours to complete to 1.5 hours to complete, 4 hours to complete to 1 hour to complete, 4 hours to complete to 0.5 hours to complete, 4 hours to complete to 0.25 hours to complete, 4 hours to complete to 0.1 hours to complete, 3.5 hours to complete to 3 hours to complete, 3.5 hours to complete to 2.5 hours to complete, 3.5 hours to complete to 2 hours to complete, 3.5 hours to complete to 1.5 hours to complete, 3.5 hours to complete to 1 hour to complete, 3.5 hours to complete to 0.5 hours to complete, 3.5 hours to complete to 0.25 hours to complete, 3.5 hours to complete to 0.1 hours to complete, 3 hours to complete to 2.5 hours to complete, 3 hours to complete to 2 hours to complete, 3 hours to complete to 1.5 hours to complete, 3 hours to complete to 1 hour to complete, 3 hours to complete to 0.5 hours to complete, 3 hours to complete to 0.25 hours to complete, 3 hours to complete to 0.1 hours to complete, 2.5 hours to complete to 2 hours to complete, 2.5 hours to complete to 1.5 hours to complete, 2.5 hours to complete to 1 hour to complete, 2.5 hours to complete to 0.5 hours to complete, 2.5 hours to complete to 0.25 hours to complete, 2.5 hours to complete to 0.1 hours to complete, 2 hours to complete to 1.5 hours to complete, 2 hours to complete to 1 hour to complete, 2 hours to complete to 0.5 hours to complete, 2 hours to complete to 0.25 hours to complete, 2 hours to complete to 0.1 hours to complete, 1.5 hours to complete to 1 hour to complete, 1.5 hours to complete to 0.5 hours to complete, 1.5 hours to complete to 0.25 hours to complete, 1.5 hours to complete to 0.1 hours to complete, 1 hour to complete to 0.5 hours to complete, 1 hour to complete to 0.25 hours to complete, 1 hour to complete to 0.1 hours to complete, 0.5 hours to complete to 0.25 hours to complete, 0.5 hours to complete to 0.1 hours to complete, or 0.25 hours to complete to 0.1 hours to complete. In some embodiments, useful lifetime of an ion exchange material or ion exchange bead may end when a lithium extraction step requires 5 hours to complete, 4.5 hours to complete, 4 hours to complete, 3.5 hours to complete, 3 hours to complete, 2.5 hours to complete, 2 hours to complete, 1.5 hours to complete, 1 hour to complete, 0.5 hours to complete, 0.25 hours to complete, or 0.1 hours to complete. In some embodiments, useful lifetime of an ion exchange material or ion exchange bead may end when a lithium extraction step requires at least 5 hours to complete, 4.5 hours to complete, 4 hours to complete, 3.5 hours to complete, 3 hours to complete, 2.5 hours to complete, 2 hours to complete, 1.5 hours to complete, 1 hour to complete, 0.5 hours to complete, or 0.25 hours to complete. In some embodiments, useful lifetime of an ion exchange material or ion exchange bead may end when a lithium extraction step requires at most 4.5 hours to complete, 4 hours to complete, 3.5 hours to complete, 3 hours to complete, 2.5 hours to complete, 2 hours to complete, 1.5 hours to complete, 1 hour to complete, 0.5 hours to complete, 0.25 hours to complete, or 0.1 hours to complete.

In some embodiments, useful lifetime is defined by the amount of lithium produced by a quantity of a lithium-selective sorbent before the lithium-selective sorbent needs to be replaced. For example, according to some embodiments, if the useful lifetime is increased by 50%, then the amount of lithium produced by a quantity of a lithium-selective sorbent before the lithium-selective sorbent needs to be replaced is increased by 50%.

In some embodiments, use of a concentration-adjusted liquid resource in place of a liquid resource according to the methods and systems disclosed herein may increase the useful lifetime of an ion exchange material or ion exchange bead. In some embodiments, use of an ion adjusted liquid resource in place of a liquid resource according to the methods and systems disclosed herein may increase the useful lifetime of an ion exchange material or ion exchange bead. In some embodiments, the useful lifetime of the ion exchange material may be increased by decreasing the rate of degradation of the ion exchange material or ion exchange bead. In some embodiments, the useful lifetime of the ion exchange material or ion exchange bead is increased by a multiple of 1.5 times to 10 times. In some embodiments, the useful lifetime of the ion exchange material or ion exchange bead is increased by a multiple of 10 times to 9 times, 10 times to 8 times, 10 times to 7 times, 10 times to 6 times, 10 times to 5 times, 10 times to 4 times, 10 times to 3 times, 10 times to 2.5 times, 10 times to 2 times, 10 times to 1.5 times, 9 times to 8 times, 9 times to 7 times, 9 times to 6 times, 9 times to 5 times, 9 times to 4 times, 9 times to 3 times, 9 times to 2.5 times, 9 times to 2 times, 9 times to 1.5 times, 8 times to 7 times, 8 times to 6 times, 8 times to 5 times, 8 times to 4 times, 8 times to 3 times, 8 times to 2.5 times, 8 times to 2 times, 8 times to 1.5 times, 7 times to 6 times, 7 times to 5 times, 7 times to 4 times, 7 times to 3 times, 7 times to 2.5 times, 7 times to 2 times, 7 times to 1.5 times, 6 times to 5 times, 6 times to 4 times, 6 times to 3 times, 6 times to 2.5 times, 6 times to 2 times, 6 times to 1.5 times, 5 times to 4 times, 5 times to 3 times, 5 times to 2.5 times, 5 times to 2 times, 5 times to 1.5 times, 4 times to 3 times, 4 times to 2.5 times, 4 times to 2 times, 4 times to 1.5 times, 3 times to 2.5 times, 3 times to 2 times, 3 times to 1.5 times, 2.5 times to 2 times, 2.5 times to 1.5 times, or 2 times to 1.5 times. In some embodiments, the useful lifetime of the ion exchange material or ion exchange bead is increased by a multiple of 10 times, 9 times, 8 times, 7 times, 6 times, 5 times, 4 times, 3 times, 2.5 times, 2 times, or 1.5 times. In some embodiments, the useful lifetime of the ion exchange material or ion exchange bead is increased by a multiple of at least 10 times, 9 times, 8 times, 7 times, 6 times, 5 times, 4 times, 3 times, 2.5 times, or 2 times. In some embodiments, the useful lifetime of the ion exchange material or ion exchange bead is increased by a multiple of at most 9 times, 8 times, 7 times, 6 times, 5 times, 4 times, 3 times, 2.5 times, 2 times, or 1.5 times. In some embodiments, the useful lifetime of the ion exchange material or ion exchange bead is increased by 50 to 100%. In some embodiments, the useful lifetime of the ion exchange material or ion exchange bead is increased by 50 to 200%. In some embodiments, the useful lifetime of the ion exchange material or ion exchange bead is increased by 50 to 300%. In some embodiments, the useful lifetime of the ion exchange material or ion exchange bead is increased by about 100% (e.g., from about 500 cycles to about 1000 cycles). In some embodiments, the useful lifetime of the ion exchange material or ion exchange bead is increased by about 200% (e.g., from about 500 cycles to about 1500 cycles). In some embodiments, the useful lifetime of the ion exchange material or ion exchange bead is increased by about 300% (e.g., from about 500 cycles to about 2000 cycles). In some embodiments, the useful lifetime of the ion exchange material or ion exchange bead is increased by about 400% (e.g., from about 500 cycles to about 2500 cycles). In some embodiments, the useful lifetime of the ion exchange material or ion exchange bead is increased by about 500% (e.g., from about 500 cycles to about 3000 cycles). In some embodiments, the useful lifetime of the ion exchange material or ion exchange bead is increased by about 600% (e.g., from about 500 cycles to about 3500 cycles). In some embodiments, the useful lifetime of the ion exchange material or ion exchange bead is increased by about 700% (e.g., from about 500 cycles to about 4000 cycles). In some embodiments, the useful lifetime of the ion exchange material or ion exchange bead is increased by about 800% (e.g., from about 500 cycles to about 4500 cycles). In some embodiments, the useful lifetime of the ion exchange material or ion exchange bead is increased by about 900% (e.g., from about 500 cycles to about 500 cycles). In some embodiments, the useful lifetime of the ion exchange material or ion exchange bead is increased by about 1000% (e.g., from about 500 cycles to about 5500 cycles). In some embodiments, the useful lifetime of the ion exchange material or ion exchange bead is increased by more than 50% (e.g., from about 500 cycles to more than about 750 cycles). In some embodiments, the useful lifetime of the ion exchange material or ion exchange bead is increased by more than 100% (e.g., from about 500 cycles to more than about 100 cycles). In some embodiments, the useful lifetime of the ion exchange material or ion exchange bead is increased by more than 200% (e.g., from about 500 cycles to more than about 1500 cycles). In some embodiments, the useful lifetime of the ion exchange material or ion exchange bead is increased by more than 300% (e.g., from about 500 cycles to more than about 2000 cycles). In some embodiments, the useful lifetime of the ion exchange material or ion exchange bead is increased by more than 400% (e.g., from about 500 cycles to more than about 2500 cycles). In some embodiments, the useful lifetime of the ion exchange material or ion exchange bead is increased by more than 500% (e.g., from about 500 cycles to more than about 3000 cycles). In some embodiments, the useful lifetime of the ion exchange material or ion exchange bead is increased by more than 600% (e.g., from about 500 cycles to more than about 3500 cycles). In some embodiments, the useful lifetime of the ion exchange material or ion exchange bead is increased by more than 700% (e.g., from about 500 cycles to more than about 4000 cycles). In some embodiments, the useful lifetime of the ion exchange material or ion exchange bead is increased by more than 800% (e.g., from about 500 cycles to more than about 4500 cycles). In some embodiments, the useful lifetime of the ion exchange material or ion exchange bead is increased by more than 900% (e.g., from about 500 cycles to more than about 5000 cycles). In some embodiments, the useful lifetime of the ion exchange material or ion exchange bead is increased by more than 1000% (e.g., from about 500 cycles to more than about 5500 cycles).

### Some Embodiments of the Disclosure

Detailed below are certain non-limiting embodiments of the present disclosure.
Embodiment 1. A method for lithium recovery from a liquid resource, the method comprising:
   a) adjusting the concentration of lithium in the liquid resource by addition of an adjusting fluid or adjusting solid to the liquid resource to yield a concentration-adjusted liquid resource;
   b) contacting a lithium-selective sorbent to the concentration-adjusted liquid resource, wherein the lithium-selective sorbent absorbs lithium ions from the concentration-adjusted liquid resource to yield a lithium-depleted liquid resource; and
   c) contacting the lithium-selective sorbent to an eluent solution, wherein said lithium-selective sorbent releases the sorbed lithium, producing a synthetic lithium solution.
Embodiment 2. The method of Embodiment 1, wherein said adjusting fluid is the lithium-depleted liquid resource, produced as per step (b).
Embodiment 3. The method of Embodiment 1, wherein said adjusting fluid is the synthetic lithium solution, produced as per step (c).
Embodiment 4. The method of Embodiment 1, wherein said adjusting fluid is water.
Embodiment 5. The method of Embodiment 1, wherein said adjusting fluid is an aqueous solution.
Embodiment 6. The method of Embodiment 5, wherein said adjusting fluid is an aqueous solution comprising one or more adjusting ions.
Embodiment 7. The method of Embodiment 5, wherein said adjusting fluid is an aqueous solution comprising lithium.
Embodiment 8. The method of Embodiment 7, wherein said adjusting fluid is an aqueous solution comprising lithium chloride.
Embodiment 9. The method of Embodiment 7, wherein said adjusting fluid is an aqueous solution comprising lithium carbonate.
Embodiment 10. The method of Embodiment 7, wherein the adjusting fluid is an aqueous solution comprising lithium hydroxide.
Embodiment 11. The method of Embodiment 7, wherein said adjusting fluid is an aqueous solution produced by further processing the synthetic lithium solution of step (c).
Embodiment 12. The method of any one of Embodiments 2 to 11, wherein said adjusting fluid further comprises boron.
Embodiment 13. The method of any one of Embodiments 2 to 12, wherein said adjusting fluid further comprises a carbonate.
Embodiment 14. The method of any one of Embodiments 2 to 13, wherein said adjusting fluid further comprises a phosphate.
Embodiment 15. The method of any one of Embodiments 2 to 14, wherein said adjusting fluid further comprises citric acid, a citrate, acetic acid, an acetate, mixtures, or combinations thereof.
Embodiment 16. The method of any one of Embodiments 2 to 15, wherein the adjusting fluid is filtered before it is added to the liquid resource.
Embodiment 17. The method of any one of Embodiments 1 to 16, wherein step (a) further comprises adjusting the pH of the liquid resource.
Embodiment 18. The method of any one of Embodiments 1 to 17, wherein the concentration-adjusted liquid resource is filtered before contacting the lithium-selective sorbent.
Embodiment 19. The method of any one of Embodiments 1 to 18, wherein the method is repeated in cycles.
Embodiment 20. The method of any one of Embodiments 1 to 19, wherein the lithium-selective sorbent exhibits a longer durability when contacted with the concentration-adjusted liquid resource as compared to the liquid resource, wherein said durability is determined by the amount of lithium produced by a given quantity of the lithium-selective sorbent over its useful lifetime.
Embodiment 21. The method of any one of Embodiments 1 to 20, wherein the lithium-selective sorbent degrades at a slower rate, such that the lithium-selective sorbent has a useful lifetime of 2 times or more compared to that of a lithium-selective sorbent used in a method without step (a).
Embodiment 22. The method of any one of Embodiments 1 to 21, wherein the lithium-selective sorbent degrades at a slower rate, such that the lithium-selective sorbent has a useful lifetime of 3 times or more compared to that of a lithium-selective sorbent used in a method without step (a).
Embodiment 23. The method of any one of Embodiments 1 to 22, wherein the lithium-selective sorbent degrades at a slower rate, such that the lithium-selective sorbent has a useful lifetime of 4 times or more compared to that of a lithium-selective sorbent used in a method without step (a).
Embodiment 24. The method of any one of Embodiments 1 to 23, wherein the lithium-selective sorbent degrades at a slower rate, such that the lithium-selective sorbent has a useful lifetime of 5 times or more compared to that of a lithium-selective sorbent used in a method without step (a).
Embodiment 25. The method of any one of Embodiments 1 to 20, wherein the lithium-selective sorbent degrades at a slower rate, such that the lithium-selective sorbent has a useful lifetime between 1.5 and 10 times that of a lithium-selective sorbent used in a method without step (a).
Embodiment 26. The method of any one of Embodiments 1 to 20, wherein the lithium-selective sorbent degrades at a slower rate, such that the lithium-selective sorbent has a useful lifetime between 2 to 5 times that of a lithium-selective sorbent used in a method without step (a).
Embodiment 27. The method of any one of Embodiments 1 to 26, wherein the purity of the lithium in the synthetic lithium solution obtained per step (c) is increased when the concentration of lithium in the liquid resource is adjusted per step (a), as compared to when the concentration of lithium in the liquid resource is not adjusted prior to steps (b) and (c).
Embodiment 28. The method of any one of Embodiments 1 to 26, wherein the purity of the lithium in the synthetic lithium solution obtained per step (c) is increased by about 1% to about 10% when the concentration of lithium in the liquid resource is adjusted per step (a), as compared to when the concentration of lithium in the liquid resource is not adjusted prior to steps (b) and (c).
Embodiment 29. The method of any one of Embodiments 1 to 26, wherein the purity of the lithium in the synthetic lithium solution obtained per step (c) is increased by about 1% to about 5% when the concentration of lithium in the liquid resource is adjusted per step (a), as compared to when the concentration of lithium in the liquid resource is not adjusted prior to steps (b) and (c).
Embodiment 30. The method of any one of Embodiments 1 to 26, wherein the purity of the lithium in the synthetic lithium solution obtained per step (c) is increased by about 5% to about 10% when the concentration of lithium in the liquid resource is adjusted per step (a), as compared to when the concentration of lithium in the liquid resource is not adjusted prior to steps (b) and (c).
Embodiment 31. The method of any one of Embodiments 1 to 26, wherein the purity of the lithium in the synthetic lithium solution obtained per step (c) is increased by about 5% or more when the concentration of lithium in the liquid resource is adjusted per step (a), as compared to when the concentration of lithium in the liquid resource is not adjusted prior to steps (b) and (c).
Embodiment 32. The method of any one of Embodiments 1 to 26, wherein the purity of the lithium in the synthetic lithium solution obtained per step (c) is increased by about 10% or more when the concentration of lithium in the liquid resource is adjusted per step (a), as compared to when the concentration of lithium in the liquid resource is not adjusted prior to steps (b) and (c).
Embodiment 33. The method of any one of Embodiments 1 to 26, wherein the purity of the lithium in the synthetic lithium solution obtained per step (c) is increased by 15% or more when the concentration of lithium in the liquid resource is adjusted per step (a), as compared to when the concentration of lithium in the liquid resource is not adjusted prior to steps (b) and (c).
Embodiment 34. The method of any one of Embodiments 1 to 33, wherein the value of pH of the lithium-depleted liquid resource provided according to step (b) is higher when step (a) is conducted versus when step (a) is not conducted.
Embodiment 35. The method of any one of Embodiments 1 to 34, wherein the quantity of reagents needed to maintain the pH of the liquid resource at an optimal value is lower when the lithium concentration in said liquid resource is adjusted per step (a), as compared to when the lithium concentration of the liquid resource is not adjusted per step (a).
Embodiment 36. The method of any of the Embodiments 1 to 35, wherein the recovery of lithium from the liquid resource is increased when the lithium concentration in said liquid resource is adjusted per step (a), as compared to when the lithium concentration of the liquid resource is not adjusted per step (a).
Embodiment 37. The method of any one of Embodiments 1 to 35, wherein step (b) is carried out by suspending the lithium-selective sorbent in the concentration-adjusted liquid resource.
Embodiment 38. The method of any one of Embodiments 1 to 35, wherein step (b) is carried out by flowing the concentration-adjusted liquid resource through an immobile bed of lithium-selective sorbent.
Embodiment 39. The method of any one of Embodiments 1 to 38, wherein step (a) decreases the concentration of lithium in the concentration-adjusted liquid resource relative to the concentration of lithium in the liquid resource.
Embodiment 40. The method of any one of Embodiments 1 to 38, wherein step (a) increases the concentration of lithium in the concentration-adjusted liquid resource relative to the concentration of lithium in the liquid resource.
Embodiment 41. The method of any one of Embodiments 1 to 40, wherein the concentration of lithium in the concentration-adjusted liquid resource provided according to step (a) is adjusted two or more times.
Embodiment 42. The method of any one of Embodiments 1 to 41, wherein the concentration of lithium in the concentration-adjusted liquid resource provided according to step (a) is maintained at a constant value.
Embodiment 43. The method of any one of Embodiments 1 to 42, wherein the pH of the concentration-adjusted liquid resource provided by step (a) is adjusted over time.
Embodiment 44. The method of any one of Embodiments 1 to 43, wherein the pH of the concentration-adjusted liquid resource provided by step (a) is higher than that of the liquid resource prior to step (a).
Embodiment 45. The method of any one of Embodiments 1 to 43, wherein the pH of the concentration-adjusted liquid resource provided by step (a) is lower than that of the liquid resource prior to step (a).
Embodiment 46. The method of any one of Embodiments 1 to 45, wherein the pH of the liquid resource is adjusted per step (a) with base selected form NaOH, LiOH, Ca(OH)₂, CaO, KOH, NH₃, or combinations thereof.
Embodiment 47. The method of Embodiment 46 wherein the base is added as a solid base, pure liquid, pure gas, or dissolved in a solution.
Embodiment 48. The method of any one of Embodiments 1 to 47, wherein the pH of the liquid resource is adjusted with NaOH.
Embodiment 49. The method of any one of Embodiments 1 to 47, wherein the pH of the liquid resource is adjusted with LiOH.
Embodiment 50. The method of any one of Embodiments 1 to 47, wherein the pH of the liquid resource is adjusted with Ca(OH)₂.
Embodiment 51. The method of any one of Embodiments 1 to 47, wherein the pH of the liquid resource is adjusted per step (a) with CaO.
Embodiment 52. The method of any one of Embodiments 1 to 51, wherein the ratio of liquid resource to adjusting liquid that is combined according to step (a) is from about 1:0.01 to about 1:1000.
Embodiment 53. The method of any one of Embodiments 1 to 51, wherein the ratio of liquid resource to adjusting liquid that is combined according to step (a) is from about 1:0.1 to about 1:100.
Embodiment 54. The method of any one of Embodiments 1 to 51, wherein the ratio of liquid resource to adjusting liquid that is combined according to step (a) is from about 1:0.1 to about 1:1.
Embodiment 55. The method of any one of Embodiments 1 to 51, wherein the ratio of liquid resource to adjusting liquid that is combined according to step (a) is from about 1:1 to about 1:10.
Embodiment 56. The method of any one of Embodiments 1 to 55, wherein the ratio of liquid resource to adjusting liquid that is combined according to step (a) is varied.
Embodiment 57. The method of any one of Embodiments 1 to 56, wherein the wherein the ratio of liquid resource to adjusting liquid that is combined according to step (a) is varied as a function of the kinetics of lithium absorption from the liquid resource by the lithium-selective sorbent.
Embodiment 58. The method of any one of Embodiments 1 to 56, wherein the wherein the ratio of liquid resource to adjusting liquid that is combined according to step (a) is varied as a function of the remaining useful lifetime of the lithium-selective sorbent.
Embodiment 59. The method of any one of Embodiments 1 to 58, wherein the concentration of lithium in the concentration-adjusted liquid resource provided according to step (a) is from about 1 to about 10,000 mg/L.
Embodiment 60. The method of any one of Embodiments 1 to 58, wherein the concentration of lithium in the concentration-adjusted liquid resource provided according to step (a) is from about 10 to about 3,000 mg/L.
Embodiment 61. The method of any one of Embodiments 1 to 58, wherein the concentration of lithium in the concentration-adjusted liquid resource provided according to step (a) is from about 10 to about 100 mg/L.
Embodiment 62. The method of any one of Embodiments 1 to 58, wherein the concentration of lithium in the concentration-adjusted liquid resource provided according to step (a) is from about 100 to about 1,000 mg/L.
Embodiment 63. The method of any one of Embodiments 1 to 58, wherein the concentration of lithium in the concentration-adjusted liquid resource provided according to step (a) is from about 100 to about 500 mg/L.
Embodiment 64. The method of any one of Embodiments 1 to 58, wherein the concentration of lithium in the concentration-adjusted liquid resource provided according to step (a) is from about 1,000 to about 3,000 mg/L.
Embodiment 65. The method of any one of Embodiments 1 to 58, wherein the concentration of lithium in the concentration-adjusted liquid resource provided according to step (a) is monitored and optionally adjusted one or more times to maintain a lithium concentrations between 1 to about 10,000 mg/L.
Embodiment 66. The method of any one of Embodiments 1 to 65, wherein the amount of lithium produced by a quantity of lithium selective sorbant according to steps (b) and (c) during its useful lifetime increases by from about 50% to about 250% when the concentration of lithium in the liquid resource is adjusted according to step (a), as compared to the amount of lithium produced by an identical quantity of lithium-selective sorbent according to steps (b) and (c) during its useful lifetime when the lithium concentration of the liquid resource is not adjusted according to step (a).
Embodiment 67. The method of any one of Embodiments 1 to 66, wherein the lithium concentration in the concentration-adjusted liquid resource is configured to increase the pH of the lithium-depleted liquid resource provided according to step (b).
Embodiment 68. The method of any one of Embodiments 1 to 67, wherein the lithium concentration in the concentration-adjusted liquid resource is modulated to increase the number of protons that can be released by the lithium-selective sorbent over the course of step (b) for a given decrease in measured pH of the lithium-depleted liquid resource provided according to step (b) as compared to the pH of the concentration-adjusted liquid resource provided according to step (a).
Embodiment 69. The method of any one of Embodiments 1 to 68, wherein the lithium concentration in the concentration-adjusted liquid resource is modulated such that the pH of the concentration-adjusted liquid resource provided according to step (a) is 7 or above, 8 or above, 9 or above, or 10 or above.
Embodiment 70. The method of any one of Embodiments 1 to 69, wherein the lithium concentration in the concentration-adjusted liquid resource is modulated such that the pH of the lithium-depleted liquid resource provided according to step (b) is 1 or above, 2 or above, 3 or above, 4 or above, 5 or above, 6 or above, or 7 or above.
Embodiment 71. The method of any one of Embodiments 1 to 70, wherein the pH of the concentration-adjusted liquid resource provided according to step (a) is about 9, and the pH of the lithium-depleted liquid resource provided according to step (b) is about 6.
Embodiment 72. The method of any one of Embodiments 1 to 70, wherein the pH of the concentration-adjusted liquid resource provided according to step (a) is about 10, and the pH of the lithium-depleted liquid resource provided according to step (b) is about 7.
Embodiment 73. The method of any one of Embodiments 1 to 70, wherein the pH of the concentration-adjusted liquid resource provided according to step (a) is about 9, and the pH of the lithium-depleted liquid resource provided according to step (b) is about 5.
Embodiment 74. The method of any one of Embodiments 1 to 70, wherein the pH of the concentration-adjusted liquid resource provided according to step (a) is about 8, and the pH of the lithium-depleted liquid resource provided according to step (b) is about 7.
Embodiment 75. The method of any one of Embodiments 1 to 70, wherein the pH of the concentration-adjusted liquid resource provided according to step (a) is about 8, and the pH of the lithium-depleted liquid resource provided according to step (b) is about 6.
Embodiment 76. The method of any one of Embodiments 1 to 70, wherein the pH of the concentration-adjusted liquid resource provided according to step (a) is about 8, and the pH of the lithium-depleted liquid resource provided according to step (b) is about 5.
Embodiment 77. The method of any one of Embodiments 1 to 70, wherein the pH of the concentration-adjusted liquid resource provided according to step (a) is about 7, and the pH of the lithium-depleted liquid resource provided according to step (b) is about 5.
Embodiment 78. The method of any one of Embodiments 1 to 70, wherein the pH of the concentration-adjusted liquid resource provided according to step (a) is about 7, and the pH of the lithium-depleted liquid resource provided according to step (b) is about 6.
Embodiment 79. The method of any one of Embodiments 1 to 70, wherein the pH of the concentration-adjusted liquid resource provided according to step (a) is about 10, and the pH of the lithium-depleted liquid resource provided according to step (b) is about 3.
Embodiment 80. The method of any one of Embodiments 1 to 70, wherein the pH of the concentration-adjusted liquid resource provided according to step (a) is about 9, and the pH of the lithium-depleted liquid resource provided according to step (b) is about 4.
Embodiment 81. The method of any one of Embodiments 1 to 70, wherein the pH of the concentration-adjusted liquid resource provided according to step (a) is about 9, and the pH of the lithium-depleted liquid resource provided according to step (b) is about 2.
Embodiment 82. The method of any one of Embodiments 1 to 70, wherein the pH of the concentration-adjusted liquid resource provided according to step (a) is about 8, and the pH of the lithium-depleted liquid resource provided according to step (b) is about 4.
Embodiment 83. The method of any one of Embodiments 1 to 70, wherein the pH of the concentration-adjusted liquid resource provided according to step (a) is about 8, and the pH of the lithium-depleted liquid resource provided according to step (b) is about 3.
Embodiment 84. The method of any one of Embodiments 1 to 70, wherein the pH of the concentration-adjusted liquid resource provided according to step (a) is about 8, and the pH of the lithium-depleted liquid resource provided according to step (b) is about 2.
Embodiment 85. The method of any one of Embodiments 1 to 70, wherein the pH of the concentration-adjusted liquid resource provided according to step (a) is about 7, and the pH of the lithium-depleted liquid resource provided according to step (b) is about 2.
Embodiment 86. The method of any one of Embodiments 1 to 70, wherein the pH of the concentration-adjusted liquid resource provided according to step (a) is about 7, and the pH of the lithium-depleted liquid resource provided according to step (b) is about 4.
Embodiment 87. The method of any one of Embodiments 1 to 70, wherein the pH of the concentration-adjusted liquid resource provided according to step (a) is about 9, and the pH of the lithium-depleted liquid resource provided according to step (b) is about 1.
Embodiment 88. The method of any one of Embodiments 1 to 70, wherein the pH of the concentration-adjusted liquid resource provided according to step (a) is about 8, and the pH of the lithium-depleted liquid resource provided according to step (b) is about 1.
Embodiment 89. The method of any one of Embodiments 1 to 70, wherein the pH of the concentration-adjusted liquid resource provided according to step (a) is about 7, and the pH of the lithium-depleted liquid resource provided according to step (b) is about 1.
Embodiment 90. The method of any one of Embodiments 1 to 89, wherein the lithium-selective sorbent comprises an ion exchange material.
Embodiment 91. The method of Embodiment 90, wherein the ion exchange material exchanges lithium ions and hydrogen ions.
Embodiment 92. The method of any one of Embodiments 90 to 91, wherein the ion exchange material absorbs lithium while releasing hydrogen ions, and absorbs hydrogen ions while releasing lithium.
Embodiment 93. The method of any one of Embodiments 90 to 92, wherein said ion exchange material comprises LiFePO₄, LiMnPO₄, Li₂MO₃ (M=Ti, Mn, Sn), Li₄Ti₅O₁₂, Li₄Mn₅O₁₂, LiMn₂O₄, Li_{1.6}Mn_{1.6}O₄, LiMO₂ (M=Al, Cu, Ti), Li₄TiO₄, Li₇Ti₁₁O₂₄, Li₃VO₄, Li₂Si₃O₇, Li₂CuP₂O₇, modifications thereof, solid solutions thereof, or a combination thereof.
Embodiment 94. The method of any one of Embodiments 90 to 93, wherein said ion exchange material is a coated ion exchange material with a coating that is selected from an oxide, a polymer, or combinations thereof.
Embodiment 95. The method of any one of Embodiments 90 to 94, wherein said ion exchange material is a coated ion exchange material with a coating that is selected from SiO₂, TiO₂, ZrO₂, polyvinylidene difluoride, polyvinyl chloride, polystyrene, polybutadiene, polydivinylbenzene, or combinations thereof.
Embodiment 96. The method of any one of Embodiments 90 to 95, wherein the ion exchange material is in the form of porous ion exchange beads.
Embodiment 97. The method of Embodiment 96, wherein the porous ion exchange beads comprise ion exchange particles that reversibly exchange lithium and hydrogen and a structural matrix material, such that a pore network may be constructed.
Embodiment 98. The method of Embodiment 97, wherein the structural matrix material is selected from the group consisting of polyvinyl fluoride, polyvinylidene difluoride, polyvinyl chloride, polyvinylidene dichloride, polyethylene, polypropylene, polyphenylene sulfide, polytetrafluoroethylene, sulfonated polytetrafluoroethylene, polystyrene, polydivinylbenzene, polybutadiene, sulfonated polymer, carboxylated polymer, poly-ethylene-tetrafluoroethyelene, polyacrylonitrile, tetrafluoroethylene-perfluoro-3,6-dioxa-4-methyl-7-octenesulfonic acid copolymer, copolymers thereof, and combinations thereof.
Embodiment 99. The method of any one of Embodiments 1 to 98, wherein the particle size of the lithium-selective sorbant is from about 0.1 microns to about 10 microns, from about 1 micron to about 100 microns, from about 10 microns to about 1000 microns, or from about 100 microns to about 1 cm.
Embodiment 100. The method of any one of Embodiments 1 to 99, wherein said liquid resource is a natural brine, a pretreated brine, a dissolved salt flat, seawater, concentrated seawater, a desalination effluent, a concentrated brine, a processed brine, an oilfield brine, a liquid from an ion exchange process, a liquid from a solvent extraction process, a synthetic brine, a leachate from an ore or combination of ores, a leachate from a mineral or combination of minerals, a leachate from a clay or combination of clays, a leachate from recycled products, a leachate from recycled materials, or combinations thereof.
Embodiment 101. The method of any one of Embodiments 1 to 100, wherein the eluent solution is an acidic eluent solution.
Embodiment 102. The method of Embodiment 101, wherein said acidic eluent solution comprises water, hydrochloric acid, sulfuric acid, nitric acid, mixtures thereof, or combinations thereof.
Embodiment 103. The method of any one of Embodiments 1 to 102, wherein the lithium concentration in the concentration-adjusted liquid resource is configured to maximize the useful lifetime of the lithium-selective sorbent, wherein said useful lifetime is defined by the amount of lithium produced before the lithium-selective sorbent needs to be replaced.
Embodiment 104. A system for lithium recovery from a liquid resource, the system comprising:
   a) a first subsystem that is configured to adjust the concentration of lithium in the liquid resource by combining the liquid resource with an adjusting fluid to yield a concentration-adjusted liquid resource; and
   b) a second subsystem configured to
      i. contact a lithium-selective sorbent to said concentration-adjusted liquid resource, wherein the lithium-selective sorbent absorbs lithium ions from said concentration-adjusted liquid resource to yield a lithium-depleted liquid resource that exits the second subsystem, and
      ii. subsequently contact the lithium-selective sorbent to an eluent solution, wherein the lithium-selective sorbent releases the sorbed lithium to yield a synthetic lithium solution.
Embodiment 105. A system for lithium recovery from a liquid resource, the system comprising:
   a) a first subsystem configured to adjust the concentration of lithium in the liquid resource by combining the liquid resource with an adjusting fluid to yield a concentration-adjusted liquid resource;
   b) a second subsystem configured to
      i. contact a lithium-selective sorbent to the concentration-adjusted liquid resource, wherein the lithium-selective sorbent absorbs lithium ions from the concentration-adjusted liquid resource to yield a lithium-depleted liquid resource that exits the second subsystem, and
      ii. subsequently contact the lithium-selective sorbent to an eluent solution, wherein the lithium-selective sorbent releases sorbed lithium to yield a synthetic lithium solution; and
   c) a third subsystem configured to add a portion of the lithium-depleted liquid resource to the first subsystem to adjust the concentration of lithium in the liquid resource, such that the adjusting fluid comprises the lithium-depleted liquid resource.
Embodiment 106. The system of Embodiment 104, wherein the adjusting fluid is the lithium-depleted liquid resource.
Embodiment 107. The system of Embodiment 104, wherein said adjusting fluid is water.
Embodiment 108. The system of Embodiment 104, wherein said adjusting fluid is an aqueous solution.
Embodiment 109. The system of Embodiment 108, wherein said adjusting fluid is an aqueous solution comprising one or more adjusting ions.
Embodiment 110. The system of Embodiment 108, wherein said adjusting fluid is an aqueous solution comprising lithium.
Embodiment 111. The system of Embodiment 110, wherein said adjusting fluid is an aqueous solution comprising lithium chloride.
Embodiment 112. The system of Embodiment 110, wherein said adjusting fluid is an aqueous solution comprising lithium carbonate.
Embodiment 113. The system of Embodiment 110, wherein said adjusting fluid is an aqueous solution comprising lithium hydroxide.
Embodiment 114. The system of Embodiment 110, wherein said adjusting fluid is an aqueous solution produced by processing the synthetic lithium solution produced by the second subsystem.
Embodiment 115. The system of any one of Embodiments 104 to 114, wherein the adjusting fluid further comprises boron.
Embodiment 116. The system of any one of Embodiments 104 to 115, wherein the adjusting fluid is filtered before it is added to the first subsystem.
Embodiment 117. The system of any one of Embodiments 104 to 116, wherein the first subsystem is further configured to adjust the pH of the liquid resource.
Embodiment 118. The system of any one of Embodiments 104 to 117, wherein the concentration-adjusted liquid resource is filtered before being fed into the second subsystem.
Embodiment 119. The system of any one of Embodiments 104 to 118, wherein the system is configured to adjust the concentration of lithium in the concentration-adjusted liquid resource such that the lithium-selective sorbent produces an increased total amount of lithium over its useful lifetime as compared to the total amount of lithium produced by the lithium-selective sorbent over its useful lifetime when the concentration of lithium in the liquid resource is not adjusted prior to entering the second subsystem.
Embodiment 120. The system of any one of Embodiments 104 to 119, wherein the system is configured to adjust the concentration of lithium in the concentration-adjusted liquid resource such that the efficiency of lithium extraction is improved.
Embodiment 121. The system of any one of Embodiments 104 to 120, wherein the system is configured to adjust the concentration of lithium in the concentration-adjusted liquid resource such that the purity of lithium in the synthetic lithium solution is increased as compared to the purity of lithium in the synthetic lithium solution when the concentration of lithium in the liquid resource is not adjusted prior to entering the second subsystem.
Embodiment 122. The system of any one of Embodiments 104 to 121, wherein the system is configured to adjust the concentration of lithium and the pH of the concentration-adjusted liquid resource such that the pH value of the lithium-depleted liquid resource exiting the second subsystem is higher as compared to the pH value of the lithium-depleted liquid resource exiting the second subsystem when the lithium concentration in the liquid resource is not adjusted prior to entering the second subsystem.
Embodiment 123. The system of any one of Embodiments 104 to 122, wherein the system is configured to adjust the lithium concentration in the concentration-adjusted liquid resource such that the quantity of reagents needed to maintain the pH of the concentration-adjusted liquid resource at an optimal value is lower as compared to the quantity of reagents needed to maintain the pH of the liquid resource at an optimal value when the lithium concentration in the liquid resource is not adjusted prior to entering the second subsystem.
Embodiment 124. The system of any one of Embodiments 104 to 123, wherein the second subsystem is configured to suspend the lithium-selective sorbent in a concentration-adjusted liquid resource.
Embodiment 125. The system of any one of Embodiments 104 to 123, wherein the second subsystem is configured to flow a concentration-adjusted liquid resource through an immobile bed of lithium-selective sorbent.
Embodiment 126. The system of any one of Embodiments 104 to 125, wherein the first subsystem is configured to decrease the concentration of lithium in the concentration-adjusted liquid resource relative to the concentration of lithium in the liquid resource.
Embodiment 127. The system of any one of Embodiments 104 to 125, wherein the first subsystem is configured to increase the concentration of lithium in the concentration-adjusted liquid resource relative to the lithium concentration in the liquid resource.
Embodiment 128. The system of any one of Embodiments 104 to 127, wherein the first subsystem is configured to continually adjust the concentration of lithium in the concentration-adjusted liquid resource leaving the first subsystem over time.
Embodiment 129. The system of any one of Embodiments 104 to 128, wherein the first subsystem is configured to maintain the concentration of lithium leaving the first subsystem at a constant.
Embodiment 130. The system of any one of Embodiments 104 to 129, wherein the first subsystem is configured to continually adjust the pH of the concentration-adjusted liquid resource leaving the first subsystem over time.
Embodiment 131. The system of any one of Embodiments 104 to 130, wherein the first subsystem is configured to adjust the pH of the concentration-adjusted liquid resource to be higher than that of the liquid resource entering the first subsystem.
Embodiment 132. The system of any one of Embodiments 104 to 130, wherein the system is configured to adjust the pH of the concentration-adjusted liquid resource to be lower than that of the liquid resource entering the first subsystem.
Embodiment 133. The system of any one of Embodiments 104 to 132, where the system further comprises a pH modulation unit, wherein the pH modulation is configured to adjust the pH of the concentration-adjusted liquid resource.
Embodiment 134. The system of Embodiment 133, wherein the pH modulation unit is configured to adjust the pH of the concentration-adjusted liquid resource by adding NaOH, LiOH, Ca(OH)₂, CaO, KOH, LiOH, NH₃, or combinations thereof, as pure chemical species or as aqueous solution of said species.
Embodiment 135. The system of any one of Embodiments 133 to 134, wherein the pH modulation unit is configured to adjust the pH of the concentration-adjusted liquid resource by adding NaOH.
Embodiment 136. The system of any one of Embodiments 133 to 134, wherein the pH modulation unit is configured to adjust the pH of the concentration-adjusted liquid resource by adding LiOH.
Embodiment 137. The system of any one of Embodiments 133 to 134, wherein the pH modulation unit is configured to adjust the pH of the concentration-adjusted liquid resource by adding Ca(OH)₂.
Embodiment 138. The system of any one of Embodiments 133 to 134, wherein the pH modulation unit is configured to adjust the pH of the concentration-adjusted liquid resource by adding CaO.
Embodiment 139. The system of any one of Embodiments 104 to 138, wherein the system is configured to combine flows of the liquid resource and the adjusting fluid in a ratio of flow from about 1:0.01 to about 1:1000.
Embodiment 140. The system of any one of Embodiments 104 to 138, wherein the system is configured to combine flows of the liquid resource and the adjusting fluid in a ratio of flow from about 1:0.1 to about 1:100.
Embodiment 141. The system of any one of Embodiments 104 to 138, wherein the system is configured to combine flows of the liquid resource and the adjusting fluid in a ratio of flow from about 1:0.1 to about 1:1.
Embodiment 142. The system of any one of Embodiments 104 to 138, wherein the system is configured to combine flows of the liquid resource and the adjusting fluid in a ratio of flow from about 1:1 to about 1:10.
Embodiment 143. The system of any one of Embodiments 104 to 142, wherein the system is configured to combine flows of the liquid resource and the adjusting fluid in a ratio that is variable with time.
Embodiment 144. The system of any one of Embodiments 104 to 143, wherein the system is configured to adjust the concentration of lithium in the concentration-adjusted liquid resource leaving the first subsystem to be from about 1 to about 10,000 mg/L.
Embodiment 145. The system of any one of Embodiments 104 to 143, wherein the system is configured to adjust the concentration of lithium in the concentration-adjusted liquid resource leaving the first subsystem to be from about 10 to about 3,000 mg/L.
Embodiment 146. The system of any one of Embodiments 104 to 143, wherein the system is configured to adjust the concentration of lithium in the concentration-adjusted liquid resource leaving the first subsystem to be from about 10 to about 100 mg/L.
Embodiment 147. The system of any one of Embodiments 104 to 143, wherein the system is configured to adjust the concentration of lithium in the concentration-adjusted liquid resource leaving the first subsystem to be from about 100 to about 1,000 mg/L.
Embodiment 148. The system of any one of Embodiments 104 to 143, wherein the system is configured to adjust the concentration of lithium in the concentration-adjusted liquid resource leaving the first subsystem to be from about 100 to about 500 mg/L.
Embodiment 149. The system of any one of Embodiments 104 to 143, wherein the system is configured to adjust the concentration of lithium in the concentration-adjusted liquid resource leaving the first subsystem to be from about 1,000 to about 3,000 mg/L.
Embodiment 150. The system of any one of Embodiments 104 to 149, wherein the system is configured to adjust the concentration of lithium in the concentration-adjusted liquid resource such that the pH value of the lithium-depleted liquid resource exiting the second subsystem is increased as compared to the pH value of the lithium-depleted liquid resource exiting the second subsystem when the lithium concentration of the liquid resource is not adjusted prior to entering the second subsystem.
Embodiment 151. The system of any one of Embodiments 104 to 150, wherein the system is configured to adjust the concentration of lithium in the concentration-adjusted liquid resource such that the number of protons released by the lithium-selective sorbent for a given decrease in measured pH of the lithium-depleted liquid resource exiting the second subsystem is increased as compared to the number of protons released by the lithium-selective sorbent for a given decrease in measured pH of the lithium-depleted liquid resource when the lithium concentration of the liquid resource is not adjusted prior to entering the second subsystem.
Embodiment 152. The system of any one of Embodiments 104 to 151, wherein the system is configured to adjust the concentration of lithium in the concentration-adjusted liquid resource such that the pH of the concentration-adjusted liquid resource entering the second subsystem is 7 or above, 8 or above, 9 or above, or 10 or above.
Embodiment 153. The system of any one of Embodiments 104 to 152, wherein the system is configured to adjust the concentration of lithium in the concentration-adjusted liquid resource such that the pH of the lithium-depleted liquid resource exiting the second subsystem is 1 or above, 2 or above, 3 or above, 4 or above, 5 or above, 6 or above, or 7 or above.
Embodiment 154. The system of any one of Embodiments 104 to 153, wherein the system is configured to adjust the concentration of lithium in the concentration-adjusted liquid resource such that the pH of the concentration-adjusted liquid resource entering the second subsystem is about 10, and the pH of the lithium-depleted liquid resource exiting the second subsystem is about 7.
Embodiment 155. The system of any one of Embodiments 104 to 153, wherein the system is configured to adjust the concentration of lithium in the concentration-adjusted liquid resource such that the pH of the concentration-adjusted liquid resource entering the second subsystem is about 9, and the pH of the lithium-depleted liquid resource leaving the second subsystem is about 6.
Embodiment 156. The system of any one of Embodiments 104 to 153, wherein the system is configured to adjust the concentration of lithium in the concentration-adjusted liquid resource such that the pH of the concentration-adjusted liquid resource entering the second subsystem is about 9, and the pH of the lithium-depleted liquid resource exiting the second subsystem is about 5.
Embodiment 157. The system of any one of Embodiments 104 to 153, wherein the system is configured to adjust the concentration of lithium in the concentration-adjusted liquid resource such that the pH of the concentration-adjusted liquid resource entering the second subsystem is about 8, and the pH of the lithium-depleted liquid resource exiting the second subsystem is about 7.
Embodiment 158. The system of any one of Embodiments 104 to 153, wherein the system is configured to adjust the concentration of lithium in the concentration-adjusted liquid resource such that the pH of the concentration-adjusted liquid resource entering the second subsystem is about 8, and the pH of the lithium-depleted liquid resource exiting the second subsystem is about 6.
Embodiment 159. The system of any one of Embodiments 104 to 153, wherein the system is configured to adjust the concentration of lithium in the concentration-adjusted liquid resource such that the pH of the concentration-adjusted liquid resource entering the second subsystem is about 8, and the pH of the lithium-depleted liquid resource exiting the second subsystem is about 5.
Embodiment 160. The system of any one of Embodiments 104 to 153, wherein the system is configured to adjust the concentration of lithium in the concentration-adjusted liquid resource such that the pH of the concentration-adjusted liquid resource entering the second subsystem is about 7, and the pH of the lithium-depleted liquid resource exiting the second subsystem is about 6.
Embodiment 161. The system of any one of Embodiments 104 to 153, wherein the system is configured to adjust the concentration of lithium in the concentration-adjusted liquid resource such that the pH of the concentration-adjusted liquid resource entering the second subsystem is about 7, and the pH of the lithium-depleted liquid resource exiting the second subsystem is about 5.
Embodiment 162. The system of any one of Embodiments 104 to 153, wherein the pH of the concentration-adjusted liquid resource provided according to step (a) is about 10, and the pH of the lithium-depleted liquid resource provided according to step (b) is about 3.
Embodiment 163. The system of any one of Embodiments 104 to 153, wherein the pH of the concentration-adjusted liquid resource provided according to step (a) is about 9, and the pH of the lithium-depleted liquid resource provided according to step (b) is about 4.
Embodiment 164. The system of any one of Embodiments 104 to 153, wherein the pH of the concentration-adjusted liquid resource provided according to step (a) is about 9, and the pH of the lithium-depleted liquid resource provided according to step (b) is about 2.
Embodiment 165. The system of any one of Embodiments 104 to 153, wherein the pH of the concentration-adjusted liquid resource provided according to step (a) is about 8, and the pH of the lithium-depleted liquid resource provided according to step (b) is about 4.
Embodiment 166. The system of any one of Embodiments 104 to 153, wherein the pH of the concentration-adjusted liquid resource provided according to step (a) is about 8, and the pH of the lithium-depleted liquid resource provided according to step (b) is about 3.
Embodiment 167. The system of any one of Embodiments 104 to 153, wherein the pH of the concentration-adjusted liquid resource provided according to step (a) is about 8, and the pH of the lithium-depleted liquid resource provided according to step (b) is about 2.
Embodiment 168. The system of any one of Embodiments 104 to 153, wherein the pH of the concentration-adjusted liquid resource provided according to step (a) is about 7, and the pH of the lithium-depleted liquid resource provided according to step (b) is about 2.
Embodiment 169. The system of any one of Embodiments 104 to 153, wherein the pH of the concentration-adjusted liquid resource provided according to step (a) is about 7, and the pH of the lithium-depleted liquid resource provided according to step (b) is about 4.
Embodiment 170. The system of any one of Embodiments 104 to 153, wherein the pH of the concentration-adjusted liquid resource provided according to step (a) is about 9, and the pH of the lithium-depleted liquid resource provided according to step (b) is about 1.
Embodiment 171. The system of any one of Embodiments 104 to 153, wherein the pH of the concentration-adjusted liquid resource provided according to step (a) is about 8, and the pH of the lithium-depleted liquid resource provided according to step (b) is about 1.
Embodiment 172. The system of any one of Embodiments 104 to 153, wherein the pH of the concentration-adjusted liquid resource provided according to step (a) is about 7, and the pH of the lithium-depleted liquid resource provided according to step (b) is about 1.
Embodiment 173. The system of any one of Embodiments 104 to 172, wherein the lithium-selective sorbent comprises an ion exchange material.
Embodiment 174. The system of Embodiment 173, wherein the ion exchange material exchanges lithium ions and hydrogen ions.
Embodiment 175. The system of any one of Embodiments 173 to 174, wherein the ion exchange material absorbs lithium while releasing hydrogen ions, and absorbs hydrogen ions while releasing lithium.
Embodiment 176. The system of any one of Embodiments 173 to 175, wherein said ion exchange material comprises LiFePO₄, LiMnPO₄, Li₂MO₃ (M=Ti, Mn, Sn), Li₄Ti₅O₁₂, Li₄Mn₅O₁₂, LiMn₂O₄, Li_{1.6}Mn_{1.6}O₄, LiMO₂ (M=Al, Cu, Ti), Li₄TiO₄, Li₇Ti₁₁O₂₄, Li₃VO₄, Li₂Si₃O₇, Li₂CuP₂O₇, modifications thereof, solid solutions thereof, or a combination thereof.
Embodiment 177. The system of any one of Embodiments 173 to 176, wherein said ion exchange material is a coated ion exchange material with a coating that is selected from an oxide, a polymer, or combinations thereof.
Embodiment 178. The system of any one of Embodiments 173 to 177, wherein said ion exchange material is a coated ion exchange material with a coating that is selected from SiO₂, TiO₂, ZrO₂, polyvinylidene difluoride, polyvinyl chloride, polystyrene, polybutadiene, polydivinylbenzene, or combinations thereof.
Embodiment 179. The system of any one of Embodiments 173 to 178, wherein the ion exchange material is in the form of porous ion exchange beads.
Embodiment 180. The system of Embodiment 179, wherein the porous ion exchange beads comprise ion exchange particles that reversibly exchange lithium and hydrogen and a structural matrix material, such that a pore network may be constructed.
Embodiment 181. The system of Embodiment 180, wherein the structural matrix material is selected from the group consisting of polyvinyl fluoride, polyvinylidene difluoride, polyvinyl chloride, polyvinylidene dichloride, polyethylene, polypropylene, polyphenylene sulfide, polytetrafluoroethylene, sulfonated polytetrafluoroethylene, polystyrene, polydivinylbenzene, polybutadiene, sulfonated polymer, carboxylated polymer, poly-ethylene-tetrafluoroethyelene, polyacrylonitrile, tetrafluoroethylene-perfluoro-3,6-dioxa-4-methyl-7-octenesulfonic acid copolymer, copolymers thereof, and combinations thereof.
Embodiment 182. The system of any one of Embodiments 104 to 181, wherein the particle size of the lithium-selective sorbent is from about 0.1 microns to about 10 microns, from about 1 micron to about 100 microns, from about 10 microns to about 1000 microns, or from about 100 microns to about 1 cm.
Embodiment 183. The system of any one of Embodiments 104 to 182, wherein the particle size of said lithium-selective sorbent is from about 1 micron to about 100 microns.
Embodiment 184. The system of any one of Embodiments 104 to 182, wherein the particle size of said lithium-selective sorbent is from about 100 micron to about 1000 microns.
Embodiment 185. The system of any one of Embodiments 104 to 182, wherein the particle size of said lithium-selective sorbent is from about 100 micron to about 500 microns.
Embodiment 186. The system of any one of Embodiments 104 to 185, wherein said liquid resource is a natural brine, a pretreated brine, a dissolved salt flat, seawater, concentrated seawater, a desalination effluent, a concentrated brine, a processed brine, an oilfield brine, a liquid from an ion exchange process, a liquid from a solvent extraction process, a synthetic brine, a leachate from an ore or combination of ores, a leachate from a mineral or combination of minerals, a leachate from a clay or combination of clays, a leachate from recycled products, a leachate from recycled materials, or combinations thereof.
Embodiment 187. The system of any one of Embodiments 104 to 186, wherein the eluent solution is an acidic eluent solution.
Embodiment 188. The system of Embodiment 187, wherein said acidic eluent solution comprises water, hydrochloric acid, sulfuric acid, nitric acid, mixtures thereof, or combinations thereof.
Embodiment 189. A method for lithium recovery from a liquid resource, the method comprising:
   a) adding an adjusting ion solution or adjusting ion solid to the liquid resource to form an ion adjusted liquid resource, wherein the ion adjusted liquid resource has an increased buffering capacity relative to the liquid resource;
   b) contacting a lithium-selective sorbent to the ion adjusted liquid resource, wherein the lithium-selective sorbent absorbs lithium ions from the ion adjusted liquid resource while releasing protons, to yield a lithium-depleted liquid resource; and
   c) contacting the lithium-selective sorbent to an acidic eluent solution, wherein said lithium-selective sorbent releases the sorbed lithium to yield a synthetic lithium solution;
   wherein the adjusting ion solution comprises one or more adjusting ions and a liquid, and wherein the adjusting ion solid comprises one or more adjusting ions in the solid state.
Embodiment 190. The method of Embodiment 189, wherein the increased buffering capacity results in the pH of the brine remaining at or above a pH of 1 during step (b).
Embodiment 191. The method of Embodiment 189, wherein the increased buffering capacity results in the pH of the brine remaining at or above a pH of 2 during step (b).
Embodiment 192. The method of Embodiment 189, wherein the increased buffering capacity results in the pH of the brine remaining at or above a pH of 3 during step (b).
Embodiment 193. The method of Embodiment 189, wherein the increased buffering capacity results in the pH of the brine remaining at or above a pH of 4 during step (b).
Embodiment 194. The method of Embodiment 189, wherein the increased buffering capacity results in the pH of the brine remaining at or above a pH of 5 during step (b).
Embodiment 195. The method of Embodiment 189, wherein the increased buffering capacity results in the pH of the brine remaining at or above a pH of 6 during step (b).
Embodiment 196. The method of Embodiment 189, wherein the increased buffering capacity results in the pH of the brine remaining at or above a pH of 7 during step (b).
Embodiment 197. The method of Embodiment 189, wherein the increased buffering capacity results in the pH of the brine remaining at or above a pH of 8 during step (b).
Embodiment 198. The method of Embodiment 189, wherein the increased buffering capacity results in the pH of the brine remaining at or above a pH of 9 during step (b).
Embodiment 199. The method of Embodiment 189, wherein the increased buffering capacity results in the pH of the brine maintaining a pH of between 3 to 12 during step (b).
Embodiment 200. The method of Embodiment 189, wherein the increased buffering capacity results in the pH of the brine maintaining a pH of between 4 to 11 during step (b).
Embodiment 201. The method of Embodiment 189, wherein the increased buffering capacity results in the pH of the brine maintaining a pH of between 5 to 10 during step (b).
Embodiment 202. The method of any one of Embodiments 189 to 201, wherein the adjusting ion solution or adjusting ion solid comprises a hydroxide, a carbonate, boron, a boron oxide, a boronic acid, a phosphate, a citrate, an acetate, a nitrate, a nitrite, an amine, or ammonia.
Embodiment 203. The method of any one of Embodiments 189 to 202, wherein the adjusting ion solution or adjusting ion solid comprises a hydroxide, a carbonate, a boronic acid, a phosphate, a citrate, or an acetate.
Embodiment 204. The method of any one of Embodiments 189 to 203, wherein the adjusting ion solution or adjusting ion solid comprises OH⁻, NH₃, SO₄²⁻, HSO₄, ClO₄, HCO₃⁻, CO₃²⁻, PO₄₃⁻, HPO₄²⁻, H₂PO₄, acetate, citrate, malonate or boron; wherein boron comprises one or more ions selected from the list of H₂BO₃—, HBO₃²⁻, BO₃³⁻, [B(OH)₄]⁻, [B₂O₄(OH)₄]²⁻, [BO₂]⁻, [B₂O₅]⁴⁻, [B₂O₇]²⁻, [B₄O₅(OH)₄]²⁻, [B₄O₉]⁶⁻, [B₅O₈]⁻, [B₈O₁₃]²⁻, BO₃³⁻, lithium salts thereof, sodium salts thereof, potassium salts thereof, calcium salts thereof, hydrates thereof, and combinations thereof.
Embodiment 205. The method of any one of Embodiments 189 to 204, wherein the adjusting ion solution or adjusting ion solid comprises a hydroxide and boron.
Embodiment 206. The method of any one of Embodiments 189 to 205, wherein the adjusting ion solution or adjusting ion solid comprises a hydroxide, boron, and a lithium salt.
Embodiment 207. The method of Embodiment 206 wherein the lithium salt is derived from the synthetic lithium solution of (c).
Embodiment 208. The method of any one of Embodiments 189 to 205, wherein the adjusting ion solid or adjusting ion solution comprises the lithium-depleted liquid resource.
Embodiment 209. The method of any one of Embodiments 189 to 208, wherein the ion adjusted liquid resource comprises a ratio of adjusting ion to lithium of about 0.1:1 to about 5:1.
Embodiment 210. The method of any one of Embodiments 189 to 209, wherein the ion adjusted liquid resource comprises a ratio of adjusting ion to lithium of about 0.2:1 to about 2:1.
Embodiment 211. The method of any one of Embodiments 189 to 210, wherein the overall lithium recovery is increased by at least 5%, at least 10%, at least 15%, at least 20%, at least 25%, or at least 30%.
Embodiment 212. The method of any one of Embodiments 189 to 211, wherein the overall lithium recovery is increased by about 10% to 50%.
Embodiment 213. The method of any one of Embodiments 189 to 212, wherein the overall lithium recovery is increased by about 20% to 40%.
Embodiment 214. The method of any one of Embodiments 189 to 213, further comprising adding at least a portion of the lithium-depleted liquid resource to the ion adjusting fluid.
Embodiment 215. The method of Embodiment 214, wherein the boron ions in the lithium-depleted liquid resource is recycled into the ion adjusting fluid.
Embodiment 216. The method of any one of Embodiments 189 to 215, wherein the concentration of lithium in the ion adjusted liquid resource provided according to step (a) is from about 1 to about 10,000 mg/L.
Embodiment 217. The method of any one of Embodiments 189 to 215, wherein the concentration of lithium in the ion adjusted liquid resource provided according to step (a) is from about 10 to about 3,000 mg/L.
Embodiment 218. The method of any one of Embodiments 189 to 215, wherein the concentration of lithium in the ion adjusted liquid resource provided according to step (a) is from about 10 to about 100 mg/L.
Embodiment 219. The method of any one of Embodiments 189 to 215, wherein the concentration of lithium in the ion adjusted liquid resource provided according to step (a) is from about 100 to about 1,000 mg/L.
Embodiment 220. The method of any one of Embodiments 189 to 215, wherein the concentration of lithium in the ion adjusted liquid resource provided according to step (a) is from about 100 to about 500 mg/L.
Embodiment 221. The method of any one of Embodiments 189 to 215, wherein the concentration of lithium in the ion adjusted liquid resource provided according to step (a) is from about 1,000 to about 3,000 mg/L.
Embodiment 222. The method of any one of Embodiments 189 to 215, wherein the concentration of lithium in the ion adjusted liquid resource provided according to step (a) is monitored and optionally adjusted one or more times to maintain a lithium concentrations between 1 to about 10,000 mg/L.
Embodiment 223. The method of any one of Embodiments 189 to 215, wherein the concentration of boron in the ion adjusted liquid resource provided according to step (a) is from about 1 to about 10,000 mg/L.
Embodiment 224. The method of any one of Embodiments 189 to 215, wherein the concentration of boron in the ion adjusted liquid resource provided according to step (a) is from about 10 to about 3,000 mg/L.
Embodiment 225. The method of any one of Embodiments 189 to 215, wherein the concentration of boron in the ion adjusted liquid resource provided according to step (a) is from about 10 to about 100 mg/L.
Embodiment 226. The method of any one of Embodiments 189 to 215, wherein the concentration of boron in the ion-adjusted liquid resource provided according to step (a) is from about 100 to about 1,000 mg/L.
Embodiment 227. The method of any one of Embodiments 189 to 215, wherein the concentration of boron in the ion adjusted liquid resource provided according to step (a) is from about 100 to about 500 mg/L.
Embodiment 228. The method of any one of Embodiments 189 to 215, wherein the concentration of boron in the ion adjusted liquid resource provided according to step (a) is from about 1,000 to about 3,000 mg/L.
Embodiment 229. The method of any one of Embodiments 189 to 228, wherein the amount of lithium produced by a quantity of lithium selective sorbant according to steps (b) and (c) during its useful lifetime increases by from about 50% to about 250% when the concentration of lithium in the liquid resource is adjusted according to step (a), as compared to the amount of lithium produced by an identical quantity of lithium-selective sorbent according to steps (b) and (c) during its useful lifetime when the lithium concentration of the liquid resource is not adjusted according to step (a).
Embodiment 230. The method of any one of Embodiments 189 to 229, wherein the pH of the ion adjusted liquid resource provided according to step (a) is about 9, and the pH of the lithium-depleted liquid resource provided according to step (b) is about 6.
Embodiment 231. The method of any one of Embodiments 189 to 229, wherein the pH of the ion adjusted liquid resource provided according to step (a) is about 10, and the pH of the lithium-depleted liquid resource provided according to step (b) is about 7.
Embodiment 232. The method of any one of Embodiments 189 to 229, wherein the pH of the ion adjusted liquid resource provided according to step (a) is about 9, and the pH of the lithium-depleted liquid resource provided according to step (b) is about 5.
Embodiment 233. The method of any one of Embodiments 189 to 229, wherein the pH of the ion adjusted liquid resource provided according to step (a) is about 8, and the pH of the lithium-depleted liquid resource provided according to step (b) is about 7.
Embodiment 234. The method of any one of Embodiments 189 to 229, wherein the pH of the ion adjusted liquid resource provided according to step (a) is about 8, and the pH of the lithium-depleted liquid resource provided according to step (b) is about 6.
Embodiment 235. The method of any one of Embodiments 189 to 229, wherein the pH of the ion adjusted liquid resource provided according to step (a) is about 8, and the pH of the lithium-depleted liquid resource provided according to step (b) is about 5.
Embodiment 236. The method of any one of Embodiments 189 to 229, wherein the pH of the ion adjusted liquid resource provided according to step (a) is about 7, and the pH of the lithium-depleted liquid resource provided according to step (b) is about 6.
Embodiment 237. The method of any one of Embodiments 189 to 229, wherein the pH of the ion adjusted liquid resource provided according to step (a) is about 7, and the pH of the lithium-depleted liquid resource provided according to step (b) is about 5.
Embodiment 238. The method of any one of Embodiments 189 to 229, wherein the pH of the ion adjusted liquid resource provided according to step (a) is about 10, and the pH of the lithium-depleted liquid resource provided according to step (b) is about 3.
Embodiment 239. The method of any one of Embodiments 189 to 229, wherein the pH of the ion adjusted liquid resource provided according to step (a) is about 9, and the pH of the lithium-depleted liquid resource provided according to step (b) is about 4.
Embodiment 240. The method of any one of Embodiments 189 to 229, wherein the pH of the ion adjusted liquid resource provided according to step (a) is about 9, and the pH of the lithium-depleted liquid resource provided according to step (b) is about 2.
Embodiment 241. The method of any one of Embodiments 189 to 229, wherein the pH of the ion adjusted liquid resource provided according to step (a) is about 8, and the pH of the lithium-depleted liquid resource provided according to step (b) is about 4.
Embodiment 242. The method of any one of Embodiments 189 to 229, wherein the pH of the ion adjusted liquid resource provided according to step (a) is about 8, and the pH of the lithium-depleted liquid resource provided according to step (b) is about 3.
Embodiment 243. The method of any one of Embodiments 189 to 229, wherein the pH of the ion adjusted liquid resource provided according to step (a) is about 8, and the pH of the lithium-depleted liquid resource provided according to step (b) is about 2.
Embodiment 244. The method of any one of Embodiments 189 to 229, wherein the pH of the ion adjusted liquid resource provided according to step (a) is about 7, and the pH of the lithium-depleted liquid resource provided according to step (b) is about 2.
Embodiment 245. The method of any one of Embodiments 189 to 229, wherein the pH of the ion adjusted liquid resource provided according to step (a) is about 7, and the pH of the lithium-depleted liquid resource provided according to step (b) is about 4.
Embodiment 246. The method of any one of Embodiments 189 to 229, wherein the pH of the ion adjusted liquid resource provided according to step (a) is about 9, and the pH of the lithium-depleted liquid resource provided according to step (b) is about 1.
Embodiment 247. The method of any one of Embodiments 189 to 229, wherein the pH of the ion adjusted liquid resource provided according to step (a) is about 8, and the pH of the lithium-depleted liquid resource provided according to step (b) is about 1.
Embodiment 248. The method of any one of Embodiments 189 to 229, wherein the pH of the ion adjusted liquid resource provided according to step (a) is about 7, and the pH of the lithium-depleted liquid resource provided according to step (b) is about 1.
Embodiment 249. The method of any one of Embodiments 189 to 248, wherein the lithium-selective sorbent comprises an ion exchange material.
Embodiment 250. The method of Embodiment 249, wherein the ion exchange material exchanges lithium ions and hydrogen ions.
Embodiment 251. The method of any one of Embodiments 249 to 250, wherein the ion exchange material absorbs lithium while releasing hydrogen ions, and absorbs hydrogen ions while releasing lithium.
Embodiment 252. The method of any one of Embodiments 249 to 251, wherein said ion exchange material comprises LiFePO₄, LiMnPO₄, Li₂MO₃ (M=Ti, Mn, Sn), Li₄Ti₅O₁₂, Li₄Mn₅O₁₂, LiMn₂O₄, Li_{1.6}Mn_{1.6}O₄, LiMO₂ (M=Al, Cu, Ti), Li₄TiO₄, Li₇Ti₁₁O₂₄, Li₃VO₄, Li₂Si₃O₇, Li₂CuP₂O₇, modifications thereof, solid solutions thereof, or a combination thereof.
Embodiment 253. The method of any one of Embodiments 249 to 252, wherein said ion exchange material is a coated ion exchange material with a coating that is selected from an oxide, a polymer, or combinations thereof.
Embodiment 254. The method of any one of Embodiments 249 to 253, wherein said ion exchange material is a coated ion exchange material with a coating that is selected from SiO₂, TiO₂, ZrO₂, polyvinylidene difluoride, polyvinyl chloride, polystyrene, polybutadiene, polydivinylbenzene, or combinations thereof.
Embodiment 255. The method of any one of Embodiments 249 to 254, wherein the ion exchange material is in the form of porous ion exchange beads.
Embodiment 256. The method of Embodiment 255, wherein the porous ion exchange beads comprise ion exchange particles that reversibly exchange lithium and hydrogen and a structural matrix material, such that a pore network may be constructed.
Embodiment 257. The method of Embodiment 256, wherein the structural matrix material is selected from the group consisting of polyvinyl fluoride, polyvinylidene difluoride, polyvinyl chloride, polyvinylidene dichloride, polyethylene, polypropylene, polyphenylene sulfide, polytetrafluoroethylene, sulfonated polytetrafluoroethylene, polystyrene, polydivinylbenzene, polybutadiene, sulfonated polymer, carboxylated polymer, poly-ethylene-tetrafluoroethyelene, polyacrylonitrile, tetrafluoroethylene-perfluoro-3,6-dioxa-4-methyl-7-octenesulfonic acid copolymer, copolymers thereof, and combinations thereof.
Embodiment 258. The method of any one of Embodiments 189 to 254, wherein the particle size of the lithium-selective sorbant is from about 0.1 microns to about 10 microns, from about 1 micron to about 100 microns, from about 10 microns to about 1000 microns, or from about 100 microns to about 1 cm.
Embodiment 259. The method of any one of Embodiments 189 to 258, wherein said liquid resource is a natural brine, a pretreated brine, a dissolved salt flat, seawater, concentrated seawater, a desalination effluent, a concentrated brine, a processed brine, an oilfield brine, a liquid from an ion exchange process, a liquid from a solvent extraction process, a synthetic brine, a leachate from an ore or combination of ores, a leachate from a mineral or combination of minerals, a leachate from a clay or combination of clays, a leachate from recycled products, a leachate from recycled materials, or combinations thereof.
Embodiment 260. The method of any one of Embodiments 189 to 159, wherein the eluent solution is an acidic eluent solution, wherein said acidic eluent solution comprises water, hydrochloric acid, sulfuric acid, nitric acid, mixtures thereof, or combinations thereof.
Embodiment 261. The method of any one of Embodiments 189 to 260, wherein the lithium concentration in the concentration-adjusted liquid resource is configured to maximize the useful lifetime of the lithium-selective sorbent, wherein said useful lifetime is defined by the amount of lithium produced before the lithium-selective sorbent needs to be replaced.
Embodiment 262. A system for lithium recovery from a liquid resource, the system comprising:
   a) a first subsystem that is configured to adjust the concentration of ions in the liquid resource by combining the liquid resource with an ion adjusting fluid or ion adjusting solid to form an ion adjusted liquid resource, wherein the ion adjusted liquid resource has an increased buffering capacity relative to the liquid resource; and
   b) a second subsystem configured to
      i. contact a lithium-selective sorbent to said ion adjusted liquid resource, wherein the lithium-selective sorbent absorbs lithium ions from said ion adjusted liquid resource to yield a lithium-depleted liquid resource that exits the second subsystem, and
      ii. subsequently contact the lithium-selective sorbent to an eluent solution, wherein the lithium-selective sorbent releases the sorbed lithium to yield a synthetic lithium solution;
   wherein the adjusting ion solution comprises one or more adjusting ions and a liquid, and wherein the adjusting ion solid comprises one or more adjusting ions in the solid state.
Embodiment 263. The system of Embodiment 262, further comprising a third subsystem configured to add at least a portion of the lithium-depleted liquid resource to the first subsystem as at least one component of the ion adjusting fluid.
Embodiment 264. The system of Embodiment 262, wherein the increased buffering capacity results in the pH of the brine remaining at or above a pH of 1 during step (b).
Embodiment 265. The system of Embodiment 262, wherein the increased buffering capacity results in the pH of the brine remaining at or above a pH of 2 during step (b).
Embodiment 266. The system of Embodiment 262, wherein the increased buffering capacity results in the pH of the brine remaining at or above a pH of 3 during step (b).
Embodiment 267. The system of Embodiment 262, wherein the increased buffering capacity results in the pH of the brine remaining at or above a pH of 4 during step (b).
Embodiment 268. The system of Embodiment 262, wherein the increased buffering capacity results in the pH of the brine remaining at or above a pH of 5 during step (b).
Embodiment 269. The system of Embodiment 262, wherein the increased buffering capacity results in the pH of the brine remaining at or above a pH of 6 during step (b).
Embodiment 270. The system of Embodiment 262, wherein the increased buffering capacity results in the pH of the brine remaining at or above a pH of 7 during step (b).
Embodiment 271. The system of Embodiment 262, wherein the increased buffering capacity results in the pH of the brine remaining at or above a pH of 8 during step (b).
Embodiment 272. The system of Embodiment 262, wherein the increased buffering capacity results in the pH of the brine remaining at or above a pH of 9 during step (b).
Embodiment 273. The system of Embodiment 262, wherein the increased buffering capacity results in the pH of the brine maintaining a pH of between 3 to 12 during step (b).
Embodiment 274. The system of Embodiment 262, wherein the increased buffering capacity results in the pH of the brine maintaining a pH of between 4 to 11 during step (b).
Embodiment 275. The system of Embodiment 262, wherein the increased buffering capacity results in the pH of the brine maintaining a pH of between 5 to 10 during step (b).
Embodiment 276. The system of any one of Embodiments 262 to 275, wherein the adjusting ion solution or adjusting ion solid comprises a hydroxide, a carbonate, boron, a boron oxide, a boronic acid, a phosphate, a citrate, an acetate, a nitrate, a nitrite, an amine, or ammonia.
Embodiment 277. The system of any one of Embodiments 262 to 276, wherein the adjusting ion solution or adjusting ion solid comprises a hydroxide, a carbonate, a boronic acid, a phosphate, a citrate, or an acetate.
Embodiment 278. The system of any one of Embodiments 262 to 277, wherein the adjusting ion solution or adjusting ion solid comprises OH⁻, NH₃, SO₄²⁻, HSO₄, ClO₄, HCO₃⁻, CO₃²⁻, PO₄₃⁻, HPO₄²⁻, H₂PO₄, acetate, citrate, malonate or boron; wherein boron comprises one or more ions selected from the list of H₂BO₃⁻, HBO₃²⁻, BO₃³⁻, [B(OH)₄]⁻, [B₂O₄(OH)₄]²⁻, [BO₂]⁻, [B₂O₅]⁴⁻, [B₂O₇]²⁻, [B₄O₅(OH)₄]²⁻, [B₄O₉]⁶⁻, [B₅O₈]⁻, [B₈O₁₃]²⁻, BO₃³⁻, lithium salts thereof, sodium salts thereof, potassium salts thereof, calcium salts thereof, hydrates thereof, and combinations thereof.
Embodiment 279. The system of any one of Embodiments 262 to 278, wherein the adjusting ion solution or adjusting ion solid comprises a hydroxide and boron.
Embodiment 280. The system of any one of Embodiments 262 to 279, wherein the adjusting ion solution or adjusting ion solid comprises a hydroxide, boron, and a lithium salt.
Embodiment 281. The system of Embodiment 280 wherein the lithium salt is derived from the synthetic lithium solution of (c).
Embodiment 282. The system of any one of Embodiments 262 to 281, wherein the adjusting ion solid or adjusting ion solution comprises the lithium-depleted liquid resource.
Embodiment 283. The system of any one of Embodiments 262 to 282, wherein the ion adjusted liquid resource comprises a ratio of adjusting ion to lithium of about 0.1:1 to about 5:1.
Embodiment 284. The system of any one of Embodiments 262 to 283, wherein the ion adjusted liquid resource comprises a ratio of adjusting ion to lithium of about 0.2:1 to about 2:1.
Embodiment 285. The system of any one of Embodiments 262 to 284, wherein the overall lithium recovery is increased by at least 5%, at least 10%, at least 15%, at least 20%, at least 25%, or at least 30%.
Embodiment 286. The system of any one of Embodiments 262 to 285, wherein the overall lithium recovery is increased by about 10% to 50%.
Embodiment 287. The system of any one of Embodiments 262 to 286, wherein the overall lithium recovery is increased by about 20% to 40%.
Embodiment 288. The system of any one of Embodiments 262 to 287, wherein the concentration of lithium in the ion-adjusted liquid resource provided according to step (a) is from about 1 to about 10,000 mg/L.
Embodiment 289. The system of any one of Embodiments 262 to 287, wherein the concentration of lithium in the ion-adjusted liquid resource provided according to step (a) is from about 10 to about 3,000 mg/L.
Embodiment 290. The system of any one of Embodiments 262 to 287, wherein the concentration of lithium in the ion-adjusted liquid resource provided according to step (a) is from about 10 to about 100 mg/L.
Embodiment 291. The system of any one of Embodiments 262 to 287, wherein the concentration of lithium in the ion-adjusted liquid resource provided according to step (a) is from about 100 to about 1,000 mg/L.
Embodiment 292. The system of any one of Embodiments 262 to 287, wherein the concentration of lithium in the ion-adjusted liquid resource provided according to step (a) is from about 100 to about 500 mg/L.
Embodiment 293. The system of any one of Embodiments 262 to 287, wherein the concentration of lithium in the ion-adjusted liquid resource provided according to step (a) is from about 1,000 to about 3,000 mg/L.
Embodiment 294. The system of any one of Embodiments 262 to 287, wherein the concentration of lithium in the ion-adjusted liquid resource provided according to step (a) is monitored and optionally adjusted one or more times to maintain a lithium concentration between 1 to about 10,000 mg/L.
Embodiment 295. The system of any one of Embodiments 262 to 287, wherein the concentration of boron in the ion-adjusted liquid resource provided according to step (a) is from about 1 to about 10,000 mg/L.
Embodiment 296. The system of any one of Embodiments 262 to 287, wherein the concentration of boron in the ion-adjusted liquid resource provided according to step (a) is from about 10 to about 3,000 mg/L.
Embodiment 297. The system of any one of Embodiments 262 to 287, wherein the concentration of boron in the ion-adjusted liquid resource provided according to step (a) is from about 10 to about 100 mg/L.
Embodiment 298. The system of any one of Embodiments 262 to 287, wherein the concentration of boron in the ion-adjusted liquid resource provided according to step (a) is from about 100 to about 1,000 mg/L.
Embodiment 299. The system of any one of Embodiments 262 to 287, wherein the concentration of boron in the ion-adjusted liquid resource provided according to step (a) is from about 100 to about 500 mg/L.
Embodiment 300. The system of any one of Embodiments 262 to 287, wherein the concentration of boron in the ion-adjusted liquid resource provided according to step (a) is from about 1,000 to about 3,000 mg/L.
Embodiment 301. The system of any one of Embodiments 262 to 300, wherein the amount of lithium produced by a quantity of lithium selective sorbent according to steps (b) and (c) during its useful lifetime increases by from about 50% to about 250% when the concentration of lithium in the liquid resource is adjusted according to step (a), as compared to the amount of lithium produced by an identical quantity of lithium-selective sorbent according to steps (b) and (c) during its useful lifetime when the lithium concentration of the liquid resource is not adjusted according to step (a).
Embodiment 302. The system of any one of Embodiments 262 to 301, wherein the pH of the concentration-adjusted liquid resource provided according to step (a) is about 9, and the pH of the lithium-depleted liquid resource provided according to step (b) is about 6.
Embodiment 303. The system of any one of Embodiments 262 to 301, wherein the pH of the concentration-adjusted liquid resource provided according to step (a) is about 10, and the pH of the lithium-depleted liquid resource provided according to step (b) is about 7.
Embodiment 304. The system of any one of Embodiments 262 to 301, wherein the pH of the concentration-adjusted liquid resource provided according to step (a) is about 9, and the pH of the lithium-depleted liquid resource provided according to step (b) is about 5.
Embodiment 305. The system of any one of Embodiments 262 to 301, wherein the pH of the concentration-adjusted liquid resource provided according to step (a) is about 8, and the pH of the lithium-depleted liquid resource provided according to step (b) is about 7.
Embodiment 306. The system of any one of Embodiments 262 to 301, wherein the pH of the concentration-adjusted liquid resource provided according to step (a) is about 8, and the pH of the lithium-depleted liquid resource provided according to step (b) is about 6.
Embodiment 307. The system of any one of Embodiments 262 to 301, wherein the pH of the concentration-adjusted liquid resource provided according to step (a) is about 8, and the pH of the lithium-depleted liquid resource provided according to step (b) is about 5.
Embodiment 308. The system of any one of Embodiments 262 to 301, wherein the pH of the concentration-adjusted liquid resource provided according to step (a) is about 7, and the pH of the lithium-depleted liquid resource provided according to step (b) is about 6.
Embodiment 309. The system of any one of Embodiments 262 to 301, wherein the pH of the concentration-adjusted liquid resource provided according to step (a) is about 7, and the pH of the lithium-depleted liquid resource provided according to step (b) is about 5.
Embodiment 310. The system of any one of Embodiments 262 to 301, wherein the pH of the ion adjusted liquid resource provided according to step (a) is about 10, and the pH of the lithium-depleted liquid resource provided according to step (b) is about 3.
Embodiment 311. The system of any one of Embodiments 262 to 301, wherein the pH of the ion adjusted liquid resource provided according to step (a) is about 9, and the pH of the lithium-depleted liquid resource provided according to step (b) is about 4.
Embodiment 312. The system of any one of Embodiments 262 to 301, wherein the pH of the ion adjusted liquid resource provided according to step (a) is about 9, and the pH of the lithium-depleted liquid resource provided according to step (b) is about 2.
Embodiment 313. The system of any one of Embodiments 262 to 301, wherein the pH of the ion adjusted liquid resource provided according to step (a) is about 8, and the pH of the lithium-depleted liquid resource provided according to step (b) is about 4.
Embodiment 314. The system of any one of Embodiments 262 to 301, wherein the pH of the ion adjusted liquid resource provided according to step (a) is about 8, and the pH of the lithium-depleted liquid resource provided according to step (b) is about 3.
Embodiment 315. The system of any one of Embodiments 262 to 301, wherein the pH of the ion adjusted liquid resource provided according to step (a) is about 8, and the pH of the lithium-depleted liquid resource provided according to step (b) is about 2.
Embodiment 316. The system of any one of Embodiments 262 to 301, wherein the pH of the ion adjusted liquid resource provided according to step (a) is about 7, and the pH of the lithium-depleted liquid resource provided according to step (b) is about 2.
Embodiment 317. The system of any one of Embodiments 262 to 301, wherein the pH of the ion adjusted liquid resource provided according to step (a) is about 7, and the pH of the lithium-depleted liquid resource provided according to step (b) is about 4.
Embodiment 318. The system of any one of Embodiments 262 to 301, wherein the pH of the ion adjusted liquid resource provided according to step (a) is about 9, and the pH of the lithium-depleted liquid resource provided according to step (b) is about 1.
Embodiment 319. The system of any one of Embodiments 262 to 301, wherein the pH of the ion adjusted liquid resource provided according to step (a) is about 8, and the pH of the lithium-depleted liquid resource provided according to step (b) is about 1.
Embodiment 320. The system of any one of Embodiments 262 to 301, wherein the pH of the ion adjusted liquid resource provided according to step (a) is about 7, and the pH of the lithium-depleted liquid resource provided according to step (b) is about 1.
Embodiment 321. The system of any one of Embodiments 262 to 320, wherein the lithium-selective sorbant comprises an ion exchange material.
Embodiment 322. The system of Embodiment 321, wherein the ion exchange material exchanges lithium ions and hydrogen ions.
Embodiment 323. The system of any one of Embodiments 321 to 322, wherein the ion exchange material absorbs lithium while releasing hydrogen ions, and absorbs hydrogen ions while releasing lithium.
Embodiment 324. The system of any one of Embodiments 321 to 323, wherein said ion exchange material comprises LiFePO₄, LiMnPO₄, Li₂MO₃ (M=Ti, Mn, Sn), Li₄Ti₅O₁₂, Li₄Mn₅O₁₂, LiMn₂O₄, Li_{1.6}Mn_{1.6}O₄, LiMO₂ (M=Al, Cu, Ti), Li₄TiO₄, Li₇Ti₁₁O₂₄, Li₃VO₄, Li₂Si₃O₇, Li₂CuP₂O₇, modifications thereof, solid solutions thereof, or a combination thereof.
Embodiment 325. The system of any one of Embodiments 321 to 324, wherein said ion exchange material is a coated ion exchange material with a coating that is selected from an oxide, a polymer, or combinations thereof.
Embodiment 326. The system of any one of Embodiments 321 to 325, wherein said ion exchange material is a coated ion exchange material with a coating that is selected from SiO₂, TiO₂, ZrO₂, polyvinylidene difluoride, polyvinyl chloride, polystyrene, polybutadiene, polydivinylbenzene, or combinations thereof.
Embodiment 327. The system of any one of Embodiments 321 to 326, wherein the ion exchange material is in the form of porous ion exchange beads.
Embodiment 328. The system of Embodiment 327, wherein the porous ion exchange beads comprise ion exchange particles that reversibly exchange lithium and hydrogen and a structural matrix material, such that a pore network may be constructed.
Embodiment 329. The system of Embodiment 328, wherein the structural matrix material is selected from the group consisting of polyvinyl fluoride, polyvinylidene difluoride, polyvinyl chloride, polyvinylidene dichloride, polyethylene, polypropylene, polyphenylene sulfide, polytetrafluoroethylene, sulfonated polytetrafluoroethylene, polystyrene, polydivinylbenzene, polybutadiene, sulfonated polymer, carboxylated polymer, poly-ethylene-tetrafluoroethyelene, polyacrylonitrile, tetrafluoroethylene-perfluoro-3,6-dioxa-4-methyl-7-octenesulfonic acid copolymer, copolymers thereof, and combinations thereof.
Embodiment 330. The system of any one of Embodiments 262 to 326, wherein the particle size of the lithium-selective sorbant is from about 0.1 microns to about 10 microns, from about 1 micron to about 100 microns, from about 10 microns to about 1000 microns, or from about 100 microns to about 1 cm.
Embodiment 331. The system of any one of Embodiments 262 to 330, wherein said liquid resource is a natural brine, a pretreated brine, a dissolved salt flat, seawater, concentrated seawater, a desalination effluent, a concentrated brine, a processed brine, an oilfield brine, a liquid from an ion exchange process, a liquid from a solvent extraction process, a synthetic brine, a leachate from an ore or combination of ores, a leachate from a mineral or combination of minerals, a leachate from a clay or combination of clays, a leachate from recycled products, a leachate from recycled materials, or combinations thereof.
Embodiment 332. The system of any one of Embodiments 262 to 331, wherein the eluent solution is an acidic eluent solution, wherein said acidic eluent solution comprises water, hydrochloric acid, sulfuric acid, nitric acid, mixtures thereof, or combinations thereof.
Embodiment 333. The system of any one of Embodiments 262 to 332, wherein the lithium concentration in the concentration-adjusted liquid resource is configured to maximize the useful lifetime of the lithium-selective sorbent, wherein said useful lifetime is defined by the amount of lithium produced before the lithium-selective sorbent needs to be replaced.
Embodiment 334. The system of any one of Embodiments 104 to 153, wherein the pH of the concentration-adjusted liquid resource provided by the first subsystem is about 10, and the pH of the lithium-depleted liquid resource provided by the second subsystem is about 3.
Embodiment 335. The system of any one of Embodiments 104 to 153, wherein the pH of the concentration-adjusted liquid resource provided by the first subsystem is about 9, and the pH of the lithium-depleted liquid resource provided by the second subsystem is about 4.
Embodiment 336. The system of any one of Embodiments 104 to 153, wherein the pH of the concentration-adjusted liquid resource provided by the first subsystem is about 9, and the pH of the lithium-depleted liquid resource provided by the second subsystem is about 2.
Embodiment 337. The system of any one of Embodiments 104 to 153, wherein the pH of the concentration-adjusted liquid resource provided by the first subsystem is about 8, and the pH of the lithium-depleted liquid resource provided by the second subsystem is about 4.
Embodiment 338. The system of any one of Embodiments 104 to 153, wherein the pH of the concentration-adjusted liquid resource provided by the first subsystem is about 8, and the pH of the lithium-depleted liquid resource provided by the second subsystem is about 3.
Embodiment 339. The system of any one of Embodiments 104 to 153, wherein the pH of the concentration-adjusted liquid resource provided by the first subsystem is about 8, and the pH of the lithium-depleted liquid resource provided by the second subsystem is about 2.
Embodiment 340. The system of any one of Embodiments 104 to 153, wherein the pH of the concentration-adjusted liquid resource provided by the first subsystem is about 7, and the pH of the lithium-depleted liquid resource provided by the second subsystem is about 2.
Embodiment 341. The system of any one of Embodiments 104 to 153, wherein the pH of the concentration-adjusted liquid resource provided by the first subsystem is about 7, and the pH of the lithium-depleted liquid resource provided by the second subsystem is about 4.
Embodiment 342. The system of any one of Embodiments 104 to 153, wherein the pH of the concentration-adjusted liquid resource provided by the first subsystem is about 9, and the pH of the lithium-depleted liquid resource provided by the second subsystem is about 1.
Embodiment 343. The system of any one of Embodiments 104 to 153, wherein the pH of the concentration-adjusted liquid resource provided by the first subsystem is about 8, and the pH of the lithium-depleted liquid resource provided by the second subsystem is about 1.
Embodiment 344. The system of any one of Embodiments 104 to 153, wherein the pH of the concentration-adjusted liquid resource provided by the first subsystem is about 7, and the pH of the lithium-depleted liquid resource provided by the second subsystem is about 1.
Embodiment 345. The method of Embodiment 189, wherein the increased buffering capacity results in the pH of the ion adjusted liquid resource remaining at or above a pH of 1 during step (b).
Embodiment 346. The method of Embodiment 189, wherein the increased buffering capacity results in the pH of the ion adjusted liquid resource remaining at or above a pH of 2 during step (b).
Embodiment 347. The method of Embodiment 189, wherein the increased buffering capacity results in the pH of the ion adjusted liquid resource remaining at or above a pH of 3 during step (b).
Embodiment 348. The method of Embodiment 189, wherein the increased buffering capacity results in the pH of the ion adjusted liquid resource remaining at or above a pH of 4 during step (b).
Embodiment 349. The method of Embodiment 189, wherein the increased buffering capacity results in the pH of the ion adjusted liquid resource remaining at or above a pH of 5 during step (b).
Embodiment 350. The method of Embodiment 189, wherein the increased buffering capacity results in the pH of the ion adjusted liquid resource remaining at or above a pH of 6 during step (b).
Embodiment 351. The method of Embodiment 189, wherein the increased buffering capacity results in the pH of the ion adjusted liquid resource remaining at or above a pH of 7 during step (b).
Embodiment 352. The method of Embodiment 189, wherein the increased buffering capacity results in the pH of the ion adjusted liquid resource remaining at or above a pH of 8 during step (b).
Embodiment 353. The method of Embodiment 189, wherein the increased buffering capacity results in the pH of the ion adjusted liquid resource remaining at or above a pH of 9 during step (b).
Embodiment 354. The method of Embodiment 189, wherein the increased buffering capacity results in the pH of the ion adjusted liquid resource maintaining a pH of between 3 to 12 during step (b).
Embodiment 355. The method of Embodiment 189, wherein the increased buffering capacity results in the pH of the ion adjusted liquid resource maintaining a pH of between 4 to 11 during step (b).
Embodiment 356. The method of Embodiment 189, wherein the increased buffering capacity results in the pH of the ion adjusted liquid resource maintaining a pH of between 5 to 10 during step (b).
Embodiment 357. The system of Embodiment 262, wherein the increased buffering capacity results in the pH of the ion adjusted liquid resource remaining at or above a pH of 1 while within the second subsystem.
Embodiment 358. The system of Embodiment 262, wherein the increased buffering capacity results in the pH of the ion adjusted liquid resource remaining at or above a pH of 2 while within the second subsystem.
Embodiment 359. The system of Embodiment 262, wherein the increased buffering capacity results in the pH of the ion adjusted liquid resource remaining at or above a pH of 3 while within the second subsystem.
Embodiment 360. The system of Embodiment 262, wherein the increased buffering capacity results in the pH of the ion adjusted liquid resource remaining at or above a pH of 4 while within the second subsystem.
Embodiment 361. The system of Embodiment 262, wherein the increased buffering capacity results in the pH of the ion adjusted liquid resource remaining at or above a pH of 5 while within the second subsystem.
Embodiment 362. The system of Embodiment 262, wherein the increased buffering capacity results in the pH of the ion adjusted liquid resource remaining at or above a pH of 6 while within the second subsystem.
Embodiment 363. The system of Embodiment 262, wherein the increased buffering capacity results in the pH of the ion adjusted liquid resource remaining at or above a pH of 7 while within the second subsystem.
Embodiment 364. The system of Embodiment 262, wherein the increased buffering capacity results in the pH of the ion adjusted liquid resource remaining at or above a pH of 8 while within the second subsystem.
Embodiment 365. The system of Embodiment 262, wherein the increased buffering capacity results in the pH of the ion adjusted liquid resource remaining at or above a pH of 9 while within the second subsystem.
Embodiment 366. The system of Embodiment 262, wherein the increased buffering capacity results in the pH of the ion adjusted liquid resource maintaining a pH of between 3 to 12 while within the second subsystem.
Embodiment 367. The system of Embodiment 262, wherein the increased buffering capacity results in the pH of the ion adjusted liquid resource maintaining a pH of between 4 to 11 while within the second subsystem.
Embodiment 368. The system of Embodiment 262, wherein the increased buffering capacity results in the pH of the ion adjusted liquid resource maintaining a pH of between 5 to 10 while within the second subsystem.
Embodiment 369. The system of any one of Embodiments 262 to 287, wherein the concentration of lithium in the ion-adjusted liquid resource provided by the first subsystem is from about 1 to about 10,000 mg/L.
Embodiment 370. The system of any one of Embodiments 262 to 287, wherein the concentration of lithium in the ion-adjusted liquid resource provided by the first subsystem is from about 10 to about 3,000 mg/L.
Embodiment 371. The system of any one of Embodiments 262 to 287, wherein the concentration of lithium in the ion-adjusted liquid resource provided by the first subsystem is from about 10 to about 100 mg/L.
Embodiment 372. The system of any one of Embodiments 262 to 287, wherein the concentration of lithium in the ion-adjusted liquid resource provided by the first subsystem is from about 100 to about 1,000 mg/L.
Embodiment 373. The system of any one of Embodiments 262 to 287, wherein the concentration of lithium in the ion-adjusted liquid resource provided by the first subsystem is from about 100 to about 500 mg/L.
Embodiment 374. The system of any one of Embodiments 262 to 287, wherein the concentration of lithium in the ion-adjusted liquid resource provided by the first subsystem is from about 1,000 to about 3,000 mg/L.
Embodiment 375. The system of any one of Embodiments 262 to 287, wherein the concentration of lithium in the ion-adjusted liquid resource provided by the first subsystem is monitored and optionally adjusted one or more times to maintain a lithium concentration between 1 to about 10,000 mg/L.
Embodiment 376. The system of any one of Embodiments 262 to 287, wherein the concentration of boron in the ion-adjusted liquid resource provided by the first subsystem is from about 1 to about 10,000 mg/L.
Embodiment 377. The system of any one of Embodiments 262 to 287, wherein the concentration of boron in the ion-adjusted liquid resource provided by the first subsystem is from about 10 to about 3,000 mg/L.
Embodiment 378. The system of any one of Embodiments 262 to 287, wherein the concentration of boron in the ion-adjusted liquid resource provided by the first subsystem is from about 10 to about 100 mg/L.
Embodiment 379. The system of any one of Embodiments 262 to 287, wherein the concentration of boron in the ion-adjusted liquid resource provided by the first subsystem is from about 100 to about 1,000 mg/L.
Embodiment 380. The system of any one of Embodiments 262 to 287, wherein the concentration of boron in the ion-adjusted liquid resource provided by the first subsystem is from about 100 to about 500 mg/L.
Embodiment 381. The system of any one of Embodiments 262 to 287, wherein the concentration of boron in the ion-adjusted liquid resource provided by the first subsystem is from about 1,000 to about 3,000 mg/L.
Embodiment 382. The system of any one of Embodiments 262 to 300, wherein the amount of lithium produced by a quantity of lithium selective sorbent in the second subsystem during its useful lifetime increases by from about 50% to about 250% when the concentration of lithium in the liquid resource is adjusted by the first subsystem, as compared to the amount of lithium produced by an identical quantity of lithium-selective sorbent in the second subsystem during its useful lifetime when the lithium concentration of the liquid resource is not adjusted by the first subsystem.
Embodiment 383. The system of any one of Embodiments 262 to 301, wherein the pH of the ion adjusted liquid resource provided by the first subsystem is about 9, and the pH of the lithium-depleted liquid resource provided by the second subsystem is about 6.
Embodiment 384. The system of any one of Embodiments 262 to 301, wherein the pH of the ion adjusted liquid resource provided by the first subsystem is about 10, and the pH of the lithium-depleted liquid resource provided by the second subsystem is about 7.
Embodiment 385. The system of any one of Embodiments 262 to 301, wherein the pH of the ion adjusted liquid resource provided by the first subsystem is about 9, and the pH of the lithium-depleted liquid resource provided by the second subsystem is about 5.
Embodiment 386. The system of any one of Embodiments 262 to 301, wherein the pH of the ion adjusted liquid resource provided by the first subsystem is about 8, and the pH of the lithium-depleted liquid resource provided by the second subsystem is about 7.
Embodiment 387. The system of any one of Embodiments 262 to 301, wherein the pH of the ion adjusted liquid resource provided by the first subsystem is about 8, and the pH of the lithium-depleted liquid resource provided by the second subsystem is about 6.
Embodiment 388. The system of any one of Embodiments 262 to 301, wherein the pH of the ion adjusted liquid resource provided by the first subsystem is about 8, and the pH of the lithium-depleted liquid resource provided by the second subsystem is about 5.
Embodiment 389. The system of any one of Embodiments 262 to 301, wherein the pH of the ion adjusted liquid resource provided by the first subsystem is about 7, and the pH of the lithium-depleted liquid resource provided by the second subsystem is about 6.
Embodiment 390. The system of any one of Embodiments 262 to 301, wherein the pH of the ion adjusted liquid resource provided by the first subsystem is about 7, and the pH of the lithium-depleted liquid resource provided by the second subsystem is about 5.
Embodiment 391. The system of any one of Embodiments 262 to 301, wherein the pH of the ion adjusted liquid resource provided by the first subsystem is about 10, and the pH of the lithium-depleted liquid resource provided by the second subsystem is about 3.
Embodiment 392. The system of any one of Embodiments 262 to 301, wherein the pH of the ion adjusted liquid resource provided by the first subsystem is about 9, and the pH of the lithium-depleted liquid resource provided by the second subsystem is about 4.
Embodiment 393. The system of any one of Embodiments 262 to 301, wherein the pH of the ion adjusted liquid resource provided by the first subsystem is about 9, and the pH of the lithium-depleted liquid resource provided by the second subsystem is about 2.
Embodiment 394. The system of any one of Embodiments 262 to 301, wherein the pH of the ion adjusted liquid resource provided by the first subsystem is about 8, and the pH of the lithium-depleted liquid resource provided by the second subsystem is about 4.
Embodiment 395. The system of any one of Embodiments 262 to 301, wherein the pH of the ion adjusted liquid resource provided by the first subsystem is about 8, and the pH of the lithium-depleted liquid resource provided by the second subsystem is about 3.
Embodiment 396. The system of any one of Embodiments 262 to 301, wherein the pH of the ion adjusted liquid resource provided by the first subsystem is about 8, and the pH of the lithium-depleted liquid resource provided by the second subsystem is about 2.
Embodiment 397. The system of any one of Embodiments 262 to 301, wherein the pH of the ion adjusted liquid resource provided by the first subsystem is about 7, and the pH of the lithium-depleted liquid resource provided by the second subsystem is about 2.
Embodiment 398. The system of any one of Embodiments 262 to 301, wherein the pH of the ion adjusted liquid resource provided by the first subsystem is about 7, and the pH of the lithium-depleted liquid resource provided by the second subsystem is about 4.
Embodiment 399. The system of any one of Embodiments 262 to 301, wherein the pH of the ion adjusted liquid resource provided by the first subsystem is about 9, and the pH of the lithium-depleted liquid resource provided by the second subsystem is about 1.
Embodiment 400. The system of any one of Embodiments 262 to 301, wherein the pH of the ion adjusted liquid resource provided by the first subsystem is about 8, and the pH of the lithium-depleted liquid resource provided by the second subsystem is about 1.
Embodiment 401. The system of any one of Embodiments 262 to 301, wherein the pH of the ion adjusted liquid resource provided by the first subsystem is about 7, and the pH of the lithium-depleted liquid resource provided by the second subsystem is about 1.

### EXAMPLES

The following examples are for illustrative purposes only and are not intended to limit the scope of the disclosure.

### Example 1: Improved Ion Exchange Performance when Lithium is Extracted from a Natural Brine with Adjusted Li Concentration

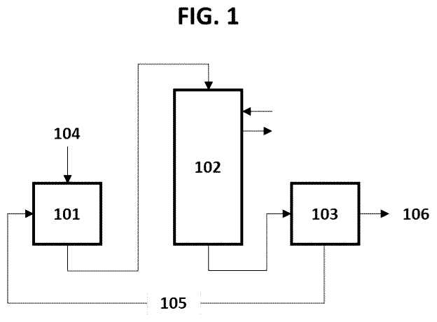

With reference to FIG. 1, a liquid resource comprising a natural brine (104) is pumped from a natural reservoir. The natural brine contains 75,000 mg/L Na, 500 mg/L Ca, 5,000 mg/L Mg, 2,500 mg/L Li, and other dissolved species. This natural brine is pumped to treatment system 101, comprising a mixing tank, wherein mixing is achieved via a hydrofoil impeller. In this mixing tank, the inlet brine is mixed with a lithium-depleted liquid resource comprising a raffinate (105), to provide a concentration-adjusted liquid resource comprising a brine with adjusted lithium concentration, containing 75,000 mg/L Na, 500 mg/L Ca, 5,000 mg/L Mg, 500 mg/L Li. Simultaneously, an aqueous NaOH solution, at a concentration of 50 wt %, is also pumped into treatment system 101, to adjust the pH to a value of 9.

A lithium-selective ion exchange material comprising Li₂Mn₂O₅ is loaded into a vessel (102). Said vessel is an ion exchange device comprising a column fitted with a retaining screen at the outlet, which allows fluid to flow out of said column while a bed of solid ion-exchange material is retained within the column. The brine with adjusted lithium concentration flows into said vessel, and the lithium is absorbed from the brine into the lithium-selective ion exchange material, as the lithium-selective ion exchange material releases protons.

This lithium-depleted liquid resource exiting vessel 102, termed raffinate, contains 75,000 mg/L Na, 500 mg/L Ca, 5,000 mg/L Mg, 100 mg/L Li, and other dissolved species. It is fed into splitting system 103. Aqueous NaOH, at a concentration of 50 wt %, is also pumped into treatment system 103 to adjust the pH of the raffinate to that of the natural brine liquid resource. In splitting system 103, part of the raffinate stream is redirected (105) to flow into treatment system 101 where it is mixed with the liquid resource. The rest of the raffinate leaves the system (106). The recycle ratio of flow of raffinate to dilute the liquid resource (105) to raffinate that leaves the system (106) is 1:5.

After the lithium-selective ion exchange material is loaded with lithium, flow of brine with adjusted lithium concentration is ceased, and any residual brine with adjusted lithium concentration is washed from the lithium-selective ion exchange material in vessel 102 with water. An acidic chloride solution is flowed into the vessel to elute lithium from the lithium-selective ion exchange material, wherein the lithium-selective ion exchange material absorbs protons while releasing lithium. The lithium-selective ion exchange material releases lithium and into the acidic chloride solution to provide a synthetic lithium solution comprising a lithium eluate that contains lithium at a concentration of 3,500 mg/L.

The cycle of lithium loading onto the ion exchange material with the concentration-adjusted liquid resource and lithium elution from the ion exchange material with acid is repeated 1000 times, to produce synthetic lithium solutions comprising lithium chloride. The partial recycle of the lithium-depleted liquid resource to adjust the concentration of lithium in the liquid resource results in an overall lithium recovery from said liquid resource of 96%; this compares to a single-pass lithium recovery of 80% in vessel 102, which would be the overall lithium recovery provided no recycle stream of raffinate was present.

Operation of system 102 at a lower single-pass recovery of 80% of the concentration-adjusted liquid resource, as opposed to a single-pass recovery of the original liquid-resource at 96% recovery is advantageous to the performance of the lithium extraction process for the following, but not limited to, reasons: Li absorption occurs after 1 hour of liquid resource to ion-exchange material contact time in the former, compared to 4 hour in the latter; the purity of the lithium eluate is 90% in the former, as compared to 85% in the latter, the pH of the lithium-depleted raffinate exiting system 102 is maintained above at an optimal value of 4 at all times, and the total number of cycles of ion-exchange achieved before the ion-exchange beads are replaced is 1000 in the former, and 250 in the latter.

### Example 2: Improved Lithium Recovery when Lithium is Extracted from a Natural Brine with Adjusted Li Concentration

With reference to FIG. 2A, a liquid resource comprising a natural brine (204) is pumped from a natural reservoir. The brine contains 75,000 mg/L Na, 500 mg/L Ca, 5,000 mg/L Mg, 2,500 mg/L Li, and other dissolved species. This brine is pumped to treatment system 201, where the liquid resource is mixed with lithium-depleted liquid resource comprising raffinate (205), to produce a concentration-adjusted liquid resource comprising a brine with adjusted lithium concentration. An aqueous NaOH solution, at a concentration of 50 wt %, is also pumped into brine treatment system 201, to adjust the pH of the concentration-adjusted liquid resource to a value of 9.

A lithium-selective ion exchange material comprising ion exchange beads comprising ion exchange particles of Li₂TiO₃ with a TiO₂ coating and a structural matrix material comprising polyvinyl chloride is loaded into ion exchange device (202). Said ion exchange device comprises agitated tanks fitted with a retaining screen at the outlet, which allows fluid to flow out of said tanks while the ion-exchange material is retained within the tanks. The brine with adjusted lithium concentration flows into said ion exchange device, and the lithium is absorbed from the brine with adjusted lithium concentration into the lithium-selective ion exchange material, as the lithium-selective ion exchange material releases protons.

This lithium-depleted liquid resource exiting 202, termed raffinate, is fed into splitting system 203. In splitting system 203, part of the raffinate stream is redirected (205) to flow into treatment system 201, where it is mixed with the liquid resource. The rest of the raffinate leaves the system (206).

After the lithium-selective ion exchange material is loaded with lithium, flow of brine with adjusted lithium concentration is ceased, and any residual brine with adjusted lithium concentration is washed from the lithium-selective ion exchange material in vessel 202 with water. An acidic chloride solution is flowed into the ion exchange device to elute lithium from the lithium-selective ion exchange material, wherein the lithium-selective ion exchange material absorbs protons while releasing lithium. The lithium-selective ion exchange material releases lithium and into the acidic chloride solution, which leaves the system.

The recovery of lithium in 202 equals the fraction of lithium entering system 202 that is absorbed into the lithium-selective ion-exchange beads. The overall system recovery of lithium equals the fraction of lithium entering the overall system (through 204 in FIG. 2A) that is captured by the lithium extraction system (said system comprising 201, 202, and 203) before it leaves said system (through 206 in FIG. 2A); stated differently, the overall system recovery of lithium equals 1—(concentration of Li in 206)/(concentration of lithium in 204). With reference to FIG. 2B, the overall system recovery of lithium is shown as a function of the ratio of flow being recycled (205) to flow leaving the system (206). At a given recovery of lithium in 202, recycling of a portion of lithium-depleted brine (205) to adjust the concentration of Li in the liquid resource in 201 results in an overall system recovery of lithium that is always higher than the recovery of lithium in 202. Thus, the partial recycle of lithium-depleted brine to adjust the concentration of the lithium-containing liquid resource results in an increase overall recovery of lithium by the lithium extraction system.

### Example 3: Improved Lithium Recovery when Lithium is Extracted from a Natural Brine with Li Concentration Adjusted by a Lithium Carbonate Solution

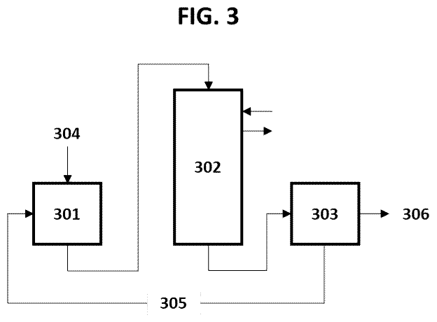

With reference to FIG. 3, a liquid resource comprising a natural brine (304) is pumped from a natural reservoir. The natural brine contains 100,000 mg/L Na, 500 mg/L Ca, 500 mg/L Mg, 1,500 mg/L Li, and other dissolved species.

This natural brine is pumped to treatment system 301, where the liquid resource is mixed with an aqueous lithium solution comprising a lithium carbonate mother liquor (305) provided by a lithium crystallizationunit. Said lithium carbonate mother liquor is produced by processing a synthetic lithium solution comprising lithium sulfate eluted from ion exchange device 302 such that the lithium sulfate is converted into lithium carbonate. The lithium carbonate mother liquor contains approximately 1,400 mg/L of Li, 65,000 mg/L of sodium, and 10,000 mg/L of carbonate. Said lithium carbonate mother liquor is mixed with said natural brine in a ratio of 1:20 to provide a concentration-adjusted liquid resource. Simultaneously, an aqueous NaOH solution, at a concentration of 50 wt %, is also pumped into treatment system 301, to adjust the pH of the concentration-adjusted liquid resource to a value of 9. The concentration-adjusted liquid resource is subsequently filtered to remove solids that may be present.

The resulting concentration-adjusted liquid resource contains 1023 mg of lithium per liter. The amount of NaOH required to adjust the pH of said concentration-adjusted liquid resource to a value of 9 is decreased by 5% when said lithium carbonate mother liquor is mixed with the liquid resource, as compared to the amount of NaOH required to adjust the pH of the liquid resource to a value of 9 when the lithium carbonate mother liquor is not added thereto. Thus, the process of adjusting the lithium concentration of the liquid resource results in a decrease in the amount of NaOH required to adjust the pH to 9, thereby lowering the reagent consumption associated with conducting a method of lithium recovery from a liquid resource.

Ion exchange material comprising ion exchange beads comprising ion exchange particles of olivine Li₂Mn₂O₅ coated with a 10 nm layer of TiO₂, incorporated into a polytetrafluoroethylene structural matrix material, are loaded into ion exchange device (302). Said ion exchange device comprises a cylindrical vessel with three concentric compartments separated by a porous partition. Fluid flows into the outermost compartment, radially inwards into a second concentric compartment loaded with the ion exchange beads, and radially inwards into the third (innermost) compartment, which is configure to direct the flow out of the vessel. Thus, flow of the liquid resource occurs radially through a bed of ion exchange beads retained within the vessel. The brine with adjusted lithium concentration flows into said vessel, and the lithium is absorbed from the brine into the ion exchange beads, as the ion exchange beads release protons.

This lithium-depleted liquid resource exiting ion exchange device 302, termed raffinate, contains 100,000 mg/L Na, 500 mg/L Ca, 500 mg/L Mg, 100 mg/L Li, and other dissolved species. The pH the raffinate exiting 302, produced from the concentration-adjusted liquid resource initially contacting the ion exchange material, is 6, due to release of protons by the ion exchange material. If the liquid resource would have been processed through ion exchange device 302 without previously combining the liquid resource with the lithium carbonate mother liquor, said pH of the raffinate produced therefrom would be 4, resulting in conditions that are too acidic for ideal performance parameters for lithium recovery. Thus, the process of adjusting the lithium concentration of a liquid resource results in improved performance parameters for lithium recovery by ion exchange device 302.

After the ion exchange material is loaded with lithium, flow of concentration-adjusted liquid resource is ceased, and any residual concentration-adjusted liquid resource is washed from the ion exchange material in 302 with water. An acidic sulfate solution is flowed into the vessel to elute lithium from the ion exchange material, wherein the ion exchange material absorbs protons while releasing lithium. The ion exchange material releases lithium into the acidic sulfate solution to provide a synthetic lithium solution with a lithium concentration of 3,000 mg/L. Said synthetic lithium solution comprising lithium sulfate is sent to lithium crystallization unit 303, where its pH is adjusted to neutral, residual impurities are removed, and it is mixed with sodium carbonate to precipitate lithium carbonate and provide a lithium carbonate mother liquor. The precipitated lithium carbonate is collected as a solid product (306), while the lithium carbonate mother liquor (305) is pumped to 301 to adjust the concentration of the liquid resource.

The cycle of lithium recovery by the ion exchange material from the concentration-adjusted liquid resource and lithium elution from the ion exchange material with acid is repeated 1500 times, to produce synthetic lithium solutions comprising lithium sulfate. If the lithium concentration in the liquid resource fed to ion exchange device 302 had not been adjusted with the lithium carbonate mother liquor, the change in operating pH in 302 would have resulted in a an increase in the required contact time between the ion exchange material and the liquid resource from 1 to 3 hours, a decrease in the lithium purity of the synthetic lithium solution from 93% to 85%, the pH of the raffinate exiting system 302 is maintained above an optimal value of 3 at all times, and a decrease in the total number of cycles before the ion exchange beads must be replaced from 1500 to 400.

### Example 4: Lithium Extraction from a Liquid Resource with Variable Adjusted Lithium Concentration

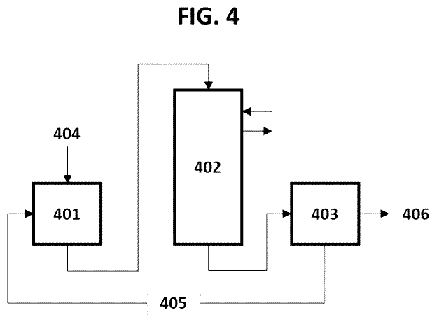

With reference to FIG. 4, a liquid resource comprising a natural brine (404) is pumped from a natural reservoir. The natural brine contains 100,000 mg/L Na, 250 mg/L Ca, 1,000 mg/L Mg, 1,000 mg/L Li, and other dissolved species. This natural brine is pumped to treatment system 401, comprising a mixing tank, wherein mixing is achieved via a propeller impeller. In this mixing tank, the inlet natural brine is mixed with raffinate stream (405) to yield a concentration-adjusted liquid resource. Simultaneously, an aqueous NaOH solution, at a concentration of 50 wt %, is also pumped into treatment system 401, to adjust the pH of the concentration-adjusted liquid resource to a value of 9.

A lithium-selective ion exchange material comprising Li₂Mn₂O₅ coated with a 5 nm layer of MnO₂, embedded in a polyethylene structural matrix material, is loaded into an ion exchange device (402). Said ion exchange device is a filter press whose filter chambers are loaded with ion exchange material, and wherein said chambers are washed with the concentration-adjusted liquid resource from which lithium is extracted. The concentration-adjusted liquid resource flows into said ion exchange device, and the lithium is absorbed from the concentration-adjusted liquid resource into the lithium-selective ion exchange material as the lithium-selective ion exchange material releases protons.

This lithium-depleted liquid resource exiting ion exchange device 402, termed raffinate, contains 100,000 mg/L Na, 250 mg/L Ca, 1,000 mg/L Mg, 100 mg/L Li, and other dissolved species. It is fed into splitting system 403. Aqueous NaOH, at a concentration of 50 wt %, is also pumped into treatment system 403 to adjust the pH of the raffinate to that of the natural brine liquid resource. In splitting system 403, part of the raffinate stream is redirected (405) to flow into brine treatment system 401 where it is mixed with the liquid resource. The rest of the raffinate leaves the system (406).

The ratio of flow of raffinate to dilute the liquid resource (405) to raffinate that leaves the system (406) is adjusted continuously in time to adjust the concentration of the concentration-adjusted liquid resource exiting treatment system 401. The concentration of lithium in the concentration-adjusted liquid resource exiting system 401 is maintained at 250 mg/L during the first 5 minutes of contact between the ion exchange material and the concentration-adjusted liquid resource by maintaining the volumetric flow ratio of stream 405 and 404 at 3:1; subsequently, the concentration of lithium exiting system 401 is maintained at 500 mg/L during the remainder of the lithium absorption cycle, by maintaining the volumetric flow ratio of stream 405 and 404 at 2:1.

After the lithium-selective ion exchange material is loaded with lithium, flow of concentration-adjusted liquid resource is ceased, and any residual concentration-adjusted liquid resource is washed from the lithium-selective ion exchange material in ion exchange device 402 with water. An acidic chloride solution is flowed into the ion exchange device 402 to elute lithium from the lithium-selective ion exchange material, wherein the lithium-selective ion exchange material absorbs protons while releasing lithium. The lithium-selective ion exchange material releases lithium and into the acidic chloride solution to provide a synthetic lithium solution with a lithium concentration of 1,000 mg/L.

The cycle of lithium loading of the ion exchange material with the liquid resource and lithium release from the ion exchange material with acid is repeated 2000 times, to produce synthetic lithium solutions comprising lithium chloride.

The partial recycle of the raffinate to adjust the concentration of lithium in the liquid resource results in an overall recovery of lithium from said liquid resource of 90%; this compares to a single-pass recovery of lithium of 40-80% in ion exchange device 402, which would be achieved if no recycle stream was present. Operation of ion exchange device 402 at a lower inlet lithium concentration than that in the liquid resource, which is adjusted with time, is advantageous to the performance parameters of the lithium extraction process for the following, but not limited to, reasons: lithium absorption is complete after about 0.5 hours of liquid resource to ion-exchange material contact time in the former, compared to 3 hour in the latter; the lithium purity of the synthetic lithium solution is 90% in the former, as compared to 80% in the latter, the pH of the raffinate exiting ion exchange device 402 is maintained above at an optimal value of 5 at all times, and the total number of cycles of ion-exchange achieved before the ion exchange material must be replaced is 2000 in the former, and 500 in the latter.

### Example 5: Lithium Extraction from a Liquid Resource with Variable Adjusted Boron Concentration

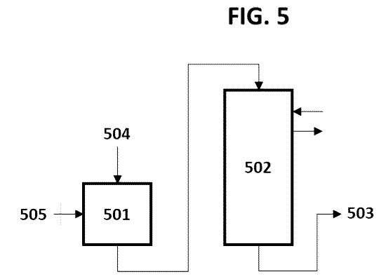

With reference to FIG. 5, a liquid resource comprising a natural brine (504) is pumped from a natural reservoir. The natural brine contains 10,000 mg/L Na, 5,000 mg/L Ca, 100 mg/L Mg, 200 mg/L Li, and other dissolved species. This natural brine is pumped to treatment system 501, comprising a mixing tank comprising baffles and a high-shear mixer. In this mixing tank, the inlet natural brine is mixed with a dissolved boric acid stream (505), to result in a concentration of 1 mole of boron to 1 mole of lithium in the liquid resource. Thus, the liquid resource comprises a natural brine with an adjusted boron concentration. Simultaneously, an aqueous NaOH solution, at a concentration of 25 wt %, is also pumped into treatment system 501, to adjust the pH to a value of 9.5, yielding an ion adjusted liquid resource that comprises one or more adjusting ions.

A lithium-selective ion exchange material comprising Li₄Mn₅O₁₂ embedded in a polyvinylchloride structural matrix material, is loaded into an ion exchange device (502). Said ion exchange device is a filter press whose filter chambers are loaded with ion exchange material, and wherein ion adjusted liquid resource is flown through said chambers so as to contact the ion adjusted liquid resource with the ion exchange material. The ion adjusted liquid resource flows into said ion exchange device, and the lithium is absorbed from the ion adjusted liquid resource into the lithium-selective ion exchange material, as the lithium-selective ion exchange material releases protons.

This lithium-depleted liquid resource exiting vessel 502, termed raffinate, contains 10,000 mg/L Na, 5,000 mg/L Ca, 100 mg/L Mg, 50 mg/L Li, and other dissolved species.

After the lithium-selective ion exchange material is loaded with lithium, flow of ion adjusted liquid resource is ceased, and any residual ion adjusted liquid resource is washed from the lithium-selective ion exchange material in vessel 502 with water. An acidic sulfate solution is flowed into the chambers of ion exchange device 502 to elute lithium from the lithium-selective ion exchange material, wherein the lithium-selective ion exchange material absorbs protons while releasing lithium. The lithium-selective ion exchange material releases lithium and into the acidic sulfate solution to yield a synthetic lithium solution comprising lithium at a concentration of 2,000 mg/L.

The cycle of lithium loading of the ion exchange material with the liquid resource and lithium release from the ion exchange material with acid is repeated 1000 times, to produce synthetic lithium solutions comprising lithium sulfate.

The addition of boron in the form of adjusting ions into the liquid resource to modulate the ion content in the liquid resource is advantageous to performance parameters of ion exchange, as it results in the pH of the raffinate 503 exiting the ion exchange device 502 remaining at a value above 5, as compared to a pH of less than 2 in the raffinate when no boron was previously added to the liquid resource. The higher pH of the raffinate results in a higher driving force for lithium absorption by the ion exchange material, and a faster rate of lithium absorption thereby. The resulting overall lithium recovery from said ion adjusted liquid resource is 85% in ion exchange device 502; this compares to a single-pass lithium recovery of 60% in ion exchange device 502 if the natural brine were fed into 502 at the same pH but without the addition of boron.

### Example 6: Consequences of Ion Concentrations on Brine Buffering and Lithium Extraction

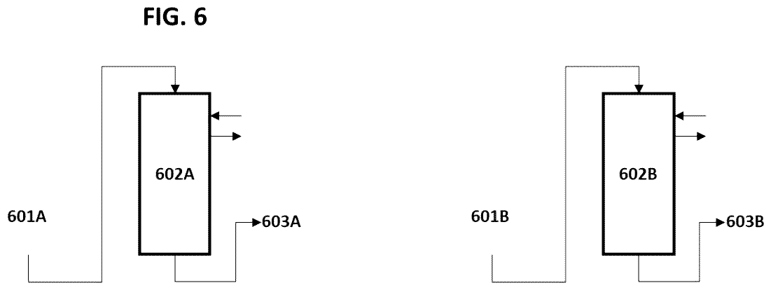

With reference to FIG. 6, lithium was extracted from a liquid resource comprising a natural brine (601A), wherein said brine contains approximately 800 mg/L boron (B), 2500 mg/L lithium (Li), and other dissolved species including Na, K, Ca and Mg. The molar ratio of B:Li in this brine is therefore approximately 20:100. The pH of the brine was adjusted with a 25% NaOH solution to achieve a value of approximately 8.9; pH adjustment beyond this point was not practical, as solid magnesium compounds begin to precipitate following the addition of additional NaOH. When the pH of the brine was adjusted to this value, the dissolved B species provided a buffering capacity that results in approximately 24 moles of H⁺ per 100 moles of Li⁺ being required to decrease the pH of the brine below a value of 4.

Lithium-selective ion exchange beads were loaded into an ion exchange device comprising an agitated tank fitted with a particle trap at its outlet (602A), wherein the ion exchange material is suspended in the agitated liquid. When the liquid resource was flowed into said ion exchange device, the lithium was absorbed from the liquid resource as the lithium-selective ion exchange beads released protons. After the lithium-selective ion exchange beads were loaded with lithium, the lithium-selective ion exchange beads were treated with an acidic chloride solution to elute lithium, wherein the lithium-selective ion exchange beads absorbed protons while releasing lithium. The synthetic lithium solution, or lithium eluate, thus produced (603A) comprised approximately 55% of the lithium atoms originally present in the liquid resource.

Separately, the brine 601A was subjected to an adjustment of its ion concentration to yield a concentration-adjusted liquid resource in the form of adjusted brine 601B. The brine 601A was adjusted in lithium concentration by mixing said brine with a lithium-depleted liquid resource, wherein said lithium-depleted resource was produced by absorbing lithium from brine 601A in an ion exchange device. Brine 601A was combined with the lithium-depleted liquid resource in a ratio of approximately 1 volume of brine 601A to 3 volumes of lithium-depleted liquid resource, thus producing adjusted brine 602A. The resulting adjusted brine had a concentration of approximately 600 mg/L of Li, wherein the concentration of all other ions including B (800 mg/L) remains approximately the same. Thus, the molar ratio of B:Li in this brine was approximately 80:100. The pH of said brine was adjusted with a 25% NaOH solution to reach a value of approximately 9; pH adjustment beyond this point is not practical, as solid magnesium compounds begin to precipitate upon further addition of NaOH. When the pH of the adjusted brine 602A was adjusted to this value, the dissolved B species provided a buffering capacity that results in approximately 85 moles of H⁺ per 100 moles of Li⁺ being required to decrease the pH of the brine below a value of 4.

Lithium-selective ion exchange beads were loaded into an ion exchange device comprising an agitated tank fitted with a particle trap at its outlet (602B), wherein the ion exchange material was suspended in the liquid. When the concentration-adjusted liquid resource flowed into said ion exchange device, the lithium was absorbed from the liquid resource as the lithium-selective ion exchange beads released protons. After the lithium-selective ion exchange beads were loaded with lithium, the lithium-selective ion exchange beads were treated with an acidic chloride solution to elute lithium, wherein the lithium-selective ion exchange beads absorbed protons while releasing lithium. The synthetic lithium solution, or lithium eluate, thus produced (603B) comprised approximately 90% of the lithium atoms originally present in the concentration-adjusted liquid resource.

Thus, the additional buffering capacity provided by modifying the ratio of boron to lithium in the adjusted brine (601B), as compared to the ratio of boron to lithium in the fresh brine (601A), enabled more lithium to be absorbed by the lithium-selective ion exchange beads while the pH of the liquid resource remained above 4, despite the release of a greater number of protons into the liquid resource. Because optimal lithium uptake requires the pH of the liquid resource to remain above 4, modifying the buffering capacity was advantageous to the performance parameters of lithium recovery and the ion-exchange process.

### Example 7: Consequences of Ion Concentrations on Lithium Extraction

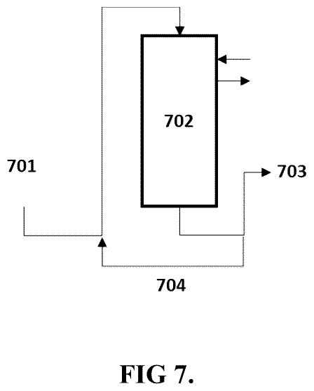

With reference to FIG. 7, lithium was extracted from a liquid resource comprising a natural brine (701), wherein said brine contains approximately 300 mg/L boron (B), 1000 mg/L lithium (Li), and other dissolved species including Na, K, Ca and Mg. The pH of the brine was adjusted with a 25% NaOH solution to achieve a value of approximately 7.7; pH adjustment above this point was not practical, as solid magnesium compounds begin to precipitate following the addition of additional NaOH. When the pH of the brine was adjusted to this value, the dissolved B species provided a buffering capacity that results in approximately 20 moles of H⁺ per 100 moles of Li⁺ being required to decrease the pH of the brine below a value of 4.

Lithium-selective ion exchange beads were loaded into an ion exchange device (702), comprising a column fitted with a retaining screen at the outlet, which allows fluid to flow out of said column while a packed bed of solid ion-exchange material is retained within the column. Said column contains a packed bed of ion exchange beads approximately 2.5 cm in diameter and approximately 3 cm in length. The brine (701) flows into said vessel, and the lithium is absorbed from the brine into the lithium-selective ion exchange material, as the lithium-selective ion exchange material releases protons. Extraction of lithium from the liquid resource 701 by the ion exchange device (702) provides a stream 704 containing a lithium-depleted liquid resource.

After the lithium-selective ion exchange beads were loaded with lithium, the lithium-selective ion exchange beads were treated with an acidic chloride solution to elute lithium, wherein the lithium-selective ion exchange beads absorbed protons while releasing lithium. The synthetic lithium solution, or lithium eluate, thus produced (703) comprised approximately 89% of the lithium atoms originally present in the liquid resource. The synthetic lithium solution contained sodium, magnesium, calcium, and other impurities; the mass ratio of lithium to sodium, magnesium, and calcium, was approximately 5:1, 5:1, and 16:1, respectively.

The incoming stream of liquid resource 701 was subsequently treated to adjust its ion concentration, yielding a concentration-adjusted liquid resource. The liquid resource 701 was adjusted in lithium concentration by mixing said liquid resource with a diverted stream 704, comprising the lithium-depleted liquid resource produced by absorbing lithium in ion-exchange device 702. Liquid-resource 701 was combined with the lithium-depleted liquid resource in a ratio of approximately 1 volume of 701 to 3.5 volumes of 704. The resulting stream had a concentration of approximately 290 mg/L of Li, wherein the concentration of all other ions including B remained approximately the same. The pH of said brine was adjusted with a 25% NaOH solution to reach a value of approximately 7.3. When the pH of the adjusted brine was adjusted to this value, the dissolved B species provided a buffering capacity that results in approximately 100 moles of H⁺ per 100 moles of Li⁺ being required to decrease the pH of the brine below a value of 4.

Upon adjustment of the lithium concentration of 701 by mixing with diverted lithium-depleted liquid resource 704, the operating parameters of lithium extraction device 702 were adjusted. The time required to complete the lithium extraction step was decreased by 40%. As a result, the synthetic lithium solution, or lithium eluate, thus produced (703) comprised approximately 66% of the lithium atoms in the concentration-adjusted liquid resource entering ion exchange device 702. Notwithstanding, eluate 703 comprised approximately 87% of the lithium atoms entering the system in liquid resource 701, because lithium atoms that are not recovered in a single contact of concentration-adjusted liquid resource with the lithium-selective ion exchange beads in 702 are recycled through 704, to adjust the concentration of 701.

Thus, by adjusting the lithium concentration in the liquid resource, the overall recovery of lithium atoms in the liquid resource is maintained at approximately the same amount (87-89%), while decreasing the time that lithium extraction step requires to complete by 40%. The synthetic lithium solution produced contained sodium, magnesium, calcium, and other impurities; the mass ratio of lithium to sodium, magnesium, and calcium, was approximately 8:1, 10:1, and 10:1. Thus, by adjusting the lithium concentration in the liquid resource, the ratio of lithium to impurities increases, resulting in the production of a synthetic lithium solution with enhanced lithium purity.

1. A method for lithium recovery from a liquid resource, the method comprising:
(a) adjusting the concentration of lithium in the liquid resource by addition of an adjusting fluid or adjusting solid to the liquid resource to yield a concentration-adjusted liquid resource;
(b) contacting a lithium-selective sorbent to the concentration-adjusted liquid resource, wherein the lithium-selective sorbent absorbs lithium ions from the concentration-adjusted liquid resource to yield a lithium-depleted liquid resource; and
(c) contacting the lithium-selective sorbent to an eluent solution, wherein said lithium-selective sorbent releases the sorbed lithium, producing a synthetic lithium solution.

2. The method of claim 1, wherein (a) comprises adjusting the concentration of lithium in the liquid resource by addition of an adjusting fluid; and wherein said adjusting fluid is the lithium-depleted liquid resource, produced as per (b).

3. The method of claim 1, wherein (a) comprises adjusting the concentration of lithium in the liquid resource by addition of an adjusting fluid; and wherein said adjusting fluid is the synthetic lithium solution, produced as per (c); or wherein said adjusting fluid is an aqueous solution produced by further processing the synthetic lithium solution of (c).

4.-6. (canceled)

7. The method of claim 1, wherein (a) comprises adjusting the concentration of lithium in the liquid resource by addition of an adjusting fluid; and wherein said adjusting fluid is an aqueous solution comprising lithium.

8. (canceled)

9. (canceled)

10. The method of claim 7, wherein said adjusting fluid further comprises boron, carbonate, phosphate, or a combination thereof.

11. (canceled)

12. (canceled)

13. The method of claim 1, wherein (a) further comprises adjusting the pH of the liquid resource; such that the pH of the lithium-depleted liquid resource provided according to (b) is 1 or above.

14. (canceled)

15. The method of claim 1, wherein the method is repeated in cycles.

16. The method of claim 1, wherein the lithium-selective sorbent exhibits a longer durability when contacted with the concentration-adjusted liquid resource as compared to the liquid resource, wherein said durability is determined by the amount of lithium produced by a given quantity of the lithium-selective sorbent over its useful lifetime.

17. The method of claim 1, wherein the lithium-selective sorbent degrades at a slower rate, such that the lithium-selective sorbent has a useful lifetime of 2 times or more compared to that of a lithium-selective sorbent used in a method without (a).

18.-20. (canceled)

21. The method of claim 1, wherein the value of pH of the lithium-depleted liquid resource provided according to (b) is higher when (a) is conducted versus when (a) is not conducted; and wherein the lithium concentration in the concentration-adjusted liquid resource is modulated such that the pH of the lithium-depleted liquid resource provided according to (b) is 1 or above.

22. The method of claim 1, wherein the quantity of reagents needed to maintain the pH of the liquid resource at an optimal value is lower when the lithium concentration in said liquid resource is adjusted per (a), as compared to when the lithium concentration of the liquid resource is not adjusted per (a).

23. The method of claim 1, wherein the recovery of lithium from the liquid resource is increased when the lithium concentration in said liquid resource is adjusted per (a), as compared to when the lithium concentration of the liquid resource is not adjusted per (a).

24. The method of claim 1, wherein the amount of time that (b) requires to complete is decreased when the lithium concentration in said liquid resource is adjusted per (a), as compared to when the lithium concentration of the liquid resource is not adjusted per (a).

25. The method of of claim 24, wherein the amount of time that (b) requires to complete decreases by 10% or more.

26.-35. (canceled)

36. The method of claim 13, wherein the pH of the liquid resource is adjusted with a base selected from NaOH, LiOH, Ca(OH)₂, CaO, KOH, NH₃, or combinations thereof.

37. (canceled)

38. The method of claim 1, wherein (a) comprises adjusting the concentration of lithium in the liquid resource by addition of an adjusting fluid; and wherein the ratio of liquid resource to adjusting liquid that is combined according to (a) is from about 1:0.01 to about 1:1000.

39. The method of claim 38, wherein the ratio of liquid resource to adjusting liquid that is combined according to (a) is varied.

40.-49. (canceled)

50. The method of claim 1, wherein the lithium-selective sorbent comprises an ion exchange material; wherein said ion exchange material comprises LiFePO₄, LiMnPO₄, Li₂MO₃ (M=Ti, Mn, Sn), Li₄Ti₅O₁₂, Li₄Mn₅O₁₂, LiMn₂O₄, Li_{1.6}Mn_{1.6}O₄, LiMO₂ (M=Al, Cu, Ti), Li₄TiO₄, Li₇Ti₁₁O₂₄, Li₃VO₄, Li₂Si₃O₇, Li₂CuP₂O₇, modifications thereof, solid solutions thereof, or a combination thereof.

51.-58. (canceled)

59. The method of claim 1, wherein the average particle size of the lithium-selective sorbent from about 10 microns to about 1000 microns.

60. The method of claim 1, wherein said liquid resource is a natural brine, a pretreated brine, a dissolved salt flat, seawater, concentrated seawater, a desalination effluent, a concentrated brine, a processed brine, an oilfield brine, a liquid from an ion exchange process, a liquid from a solvent extraction process, a synthetic brine, a leachate from an ore or combination of ores, a leachate from a mineral or combination of minerals, a leachate from a clay or combination of clays, a leachate from recycled products, a leachate from recycled materials, or combinations thereof.

61. The method of claim 1, wherein the eluent solution is an acidic eluent solution; wherein said acidic eluent solution comprises water, hydrochloric acid, sulfuric acid, nitric acid, mixtures thereof, or combinations thereof.

62.-148. (canceled)
